(19) United States
(12) Patent Application Publication
(10) Pub. No.: US 2026/0132054 A1
(43) Pub. Date: May 14, 2026

(54) DEVICES, SYSTEMS, AND METHODS FOR REDUCING FOULING IN WATER FLOW SYSTEMS

(71) Applicant: BioFouling Technologies, Inc., Aberdeen, NC (US)

(72) Inventors: Jerry KASTER, Shorewood, WI (US); Brian McMurray, Aberdeen, NC (US); Mike TERMINI, Port Saint Lucie, FL (US); Jake FLITTNER, Pinehurst, NC (US); Cliff SHARPE, Southern Pines, NC (US); Emily RALSTON, Melbourne Beach, FL (US); Bradley ROBACK, Carthage, NC (US)

(21) Appl. No.: 19/388,081

(22) Filed: Nov. 13, 2025

Related U.S. Application Data
(63) Continuation of application No. PCT/US24/30101, filed on May 17, 2024.
(60) Provisional application No. 63/467,280, filed on May 17, 2023.

(51) Int. Cl. C02F 1/00

(52) U.S. Cl. CPC C02F 1/004; C02F 2201/006; C02F 2303/20; C02F 2303/24

(57) ABSTRACT

Disclosed are devices, methods and/or systems for use in protecting water flow systems from biofouling and/or other related contamination. One or more devices are introduced into the water flow system, such as downstream of the water supply (e.g., a lake, an ocean, a river, a water reservoir, or other water supply—including contained water supplies) and upstream of various surfaces/systems of the water flow system for which biofouling protection is desired. The device(s) include a defined volume for the water and at least one structure that is positioned therein in a use configuration so as to interact with the water in the defined volume to form “conditioned water” that passes downstream into the water flow system. Such devices prevent, limit, and/or reduce biofouling within the water flow system.

### CROSS-REFERENCE TO RELATED APPLICATIONS

This application is a continuation of Patent Cooperation Treaty Patent Application Serial No. PCT/US24/30101, filed May 17, 2024 and entitled “DEVICES, SYSTEMS, AND METHODS FOR REDUCING FOULING IN WATER FLOW SYSTEMS”, which claims priority to and benefit thereof from U.S. Provisional Patent Application No. 63/467,280 filed May 17, 2023, entitled “DEVICES, SYSTEMS, AND METHODS FOR REDUCING FOULING IN WATER FLOW SYSTEMS,” the disclosures of which are incorporated by reference herein in their entireties.

### TECHNICAL FIELD

Embodiments of the present invention relate generally to protecting water flow systems from biofouling and/or other related contamination.

### BACKGROUND OF THE INVENTION

Biofouling, contamination, scaling and corrosion can severely impact the performance, effective life cycle, strength and durability of water flow systems. For example, the growth and attachment of various organisms onto surfaces, structures and/or items exposed to aquatic environments, known as biofouling, is a significant global problem for numerous industries. Biofouling results from the interaction between various plant and/or animal species with aspects of the surfaces to which they ultimately attach and the fluids in which they live. Despite the appearance of simplicity, the process of biofouling is a highly complex web of interactions effected by a myriad of micro-organisms, macro-organisms and the ever-changing characteristics of their aquatic environment. Biofouling is commonly defined as the undesirable phenomenon of adhesion and accumulation of biotic deposits on surfaces submerged and/or in contact with water or other fluids. In addition to fouling organisms and the biofilms, biofouling can further encompass many types of accumulation of biotic and/or abiotic deposits on a surface in contact with a fluid which may directly and/or indirectly originate from and/or relate to various types of microfouling or microbial biofouling within a water system, such as where fouling organisms reach and/or retain inorganic particles (e.g., salts and/or corrosion products) as a result of other types of fouling developed in the process.

The economic and operational impacts of biofouling are of paramount concern for many industries. Aside from biofouling induced damage and corrosion of various surfaces exposed to aquatic environments and the presence and growth of biofouling, which impedes fluid flow and the proper operation of moveable components, another significant economic consequence of biofouling is the formation, colonization and growth of biofouling organisms on a wide variety of surfaces within water flow systems. Such biofouling formation frequently requires various maintenance needs (e.g., replacement of parts, down time for cleaning, chemical washes, etc.) and/or otherwise lead to reduced performance (e.g., less water flow due to clogging, turbulence, and/or cavitation as well as reductions in heat exchange due to surface contamination, among many other negative effects of biofouling).

A wide variety of methods have historically been used in attempts to halt and/or reduce biofouling build-up on surfaces and/or in various water flow systems. One common attempt at ameliorating biofouling is the use of intake filtration. However, the large volumes and/or high-water velocities often required for typical raw water intake system functionality limits such efforts to simply filter out fish and/or larger debris from the water flow source. Further, said filters must be periodically replaced and the build-up on the upstream or “dirty” side of the filter is an ever-present issue that must otherwise be dealt with through periodic and costly maintenance processes. In addition to filtering, water systems, especially industrial water systems, often attempt to treat a raw water flow with some form of chemical wash, most commonly bleach but also possibly gaseous chlorine, bleach/sodium bromide, chlorine dioxide, monochloramine, and monobromamine. In addition to the high cost of purchasing and/or operating such systems, the added substances may be strong oxidizing agents (especially in the case of chlorine) and/or are often ineffective to control biofouling and/or can cause deleterious effects far beyond their intended environment of use—e.g., once released they can damage organisms in the surrounding aquatic environment. In addition, many of these substances can and often do enhance corrosion, scaling and/or degradation of the very surfaces and/or related components of the water systems they are meant to protect. Moreover, such treatments often require expensive remediation efforts for discharge water to prevent any harmful effects from passing into downstream aquatic environments after release of the treated water. An additional problem at many facilities are the numerous and onerous limits and controls which governmental agencies place on the use of antifouling chemical treatments in water systems, For example, chlorine treatments are only allowed for less than 9 (nine) percent of any day in the US, thus giving microbes and/or other fouling organisms an excellent opportunity to settle, colonize and form protective biofilm layers when such chlorine treatment systems are nonoperational—or even when such treatment systems are operating, for many organisms. Similar limits and/or safety concerns exist for many other antifouling chemicals that might be added to raw water in attempts to reduce and/or limit fouling within the water system.

In many instances, industries have essentially accepted that biofouling, corrosion and/or scale formation is bound to occur within their water supply and distribution systems, and these industries budget for expected system degradation and/or need for removal of fouled systems from said operations on a regular and frequent basis to clean, repair and/or remediate the effects of the inevitable fouling, corrosion and/or scale formation in these devices. Obviously, such activities can remove affected systems from service, are often quite expensive, are labor intensive, are time consuming and, especially in the case of cleaning, often cause additional damage and/or fail to alleviate existing damage to fouled surfaces. Moreover, the need for frequent remediation requirements can force a business to purchase excess capacity and/or additional system resources for their water supply and distribution systems, so as to accommodate system/subsystem down-time during such evolutions.

Therefore, there exists a need for improved devices, systems and methods that eliminate or reduce the amount of biofouling and/or corrosion on surfaces exposed to an aquatic environment, such as for water flow systems.

### SUMMARY OF THE INVENTION

The various inventions disclosed herein include the realization of a need for improved cost-effective methods, apparatus and/or systems for protecting a variety of surfaces from micro- and/or macro-fouling and/or the formation of biofouling for extended periods of time of exposure to aquatic environments, including in situations where it may be impractical, impossible and/or inconvenient to fully isolate a surface or structure from the presence of fouling organisms and/or other effects within and/or adjacent to an aqueous environment. Improved antifouling devices could be particularly relevant and useful for both water flow-through (e.g., Once Through Cooling or “OTC”) systems as well as closed flow loop (e.g., “recirculating”) systems where environmental or “raw” water or other liquid in an aqueous environment is being utilized, circulated, consumed and/or being released (e.g., industrial water for cooling, heating or other uses, as well as water in municipal and potable water systems and/or freshwater distillation, marine water cooling/storage/ballast systems, among others).

Various embodiments of the present invention provide methods, systems, and devices (e.g., “antifouling” methods, systems, and devices) for providing protection for water flow systems by reducing/limiting and/or preventing biofouling on surfaces and/or within fluid within the water flow systems. In some embodiments, one or more devices may be installed or otherwise “inputted” into the water flow system, such as at a location downstream of the water supply (e.g., a lake, an ocean, a water reservoir, or other water supply (including contained water supplies)) and upstream of various surfaces/systems of the water flow system for which biofouling protection is desired. The device(s) may include a defined volume, an average, minimum and/or maximum volumetric flow rate or mass flow rate for the water (e.g., during pump operation) and at least one structure that interacts with the water in the defined volume to form “conditioned water” that passes downstream into the water flow system.

The at least one structure may be or may become permeable and may be formed of a wide variety of materials (e.g., fabric, metal, plastic, rubber, rock, etc.). The at least one structure may be arranged into a use configuration that is positioned within the defined volume of the device. Water flowing into the defined volume may be directed along and/or through a plurality of flow paths formed by the use configuration of the at least one structure prior to exiting the device through an outlet into the remainder of the water flow system. In this regard, the plurality of flow paths may be formed by one or more channels designed to lead the water to an outlet of the defined volume and/or one or more pores formed into the at least one structure. By providing the at least one structure in such a use configuration, the plurality of flow paths desirably increase a ratio of a contact surface area formed by the at least one structure from the inlet to the outlet as compared to an original flow path provided by the defined volume (e.g., without the at least one structure formed into a use configuration therein). This leads to the water (or other fluid) having an increased path to the outlet and induces mixing and conditioning of the water within the defined volume. These activities can reduce, limit, and/or prevent formation of biofouling within the water in the defined volume, such as on surfaces within the water therein and/or generally within the water itself. In some embodiments, biocide(s) or other chemicals may be coated onto or within one or more portions of the at least one structure (e.g., on one or more sides, within the pores, within the structure material itself, etc.) such that the water passing through the plurality of flow paths and intermixing within the defined volume may have increased contact with the biocide—which may also aid in preventing, reducing, and/or limiting biofouling with the water flow system.

Notably, various embodiments of the present invention contemplate many different use configurations of the at least one structure. For example, the at least one structure may be arranged in a linear or direct flow arrangement (e.g., crossflow), such that waterflow passes across one or more faces of the structure, while other embodiments may incorporate a curved or spiral pattern (e.g., single spiral, double spiral, triple spiral, etc.) so as to define a spiral pathway along the structure which leads to the outlet. The structure(s) may be permeable and so water may flow through the structure(s) between channels—thereby forming a plurality of flow paths. Another example use configuration of the at least one structure can include a folded, bent or pleated pattern, where “pleating” and “pleated” are intended to encompass a wide variety of structures having one or a plurality of creased, bent or folded portions, typically where the fabric is bent back towards itself, including, but not limited to, folded or bent structures and/or portions thereof, parallel and/or non-parallel fold lines, and structures incorporating incomplete and/or partially folded lines, as well as structures having one or a series of folds, including a plurality of parallel folds, that may be doubled back upon themselves in a variety of shapes and arrangements, such as an accordion and/or radial and/or concentric pleated pattern. Another example use configuration of the at least one structure may include a plurality of loose structures (e.g., shaped structures, cube-shaped structures, strip-like structures, permeable rock structures, among others) that are positioned within the defined volume to define a plurality of flow paths therearound and therethrough leading to the outlet. Another example use configuration of the at least one structure includes a plurality of blade-like structures extending at least partially across the defined volume at different heights and/or different directions. The blade-like structures may be stationary and/or they may rotate (such as under the influence of the force of the water flowing through the system and/or from driven rotation by one or more motors). Such an example embodiment may create turbulent water flow as the water moves around and/or through the blade-like structures. Another example use configuration of the at least one structure includes a plurality of strip-like structures, wherein each of the plurality of strip-like structures are fixedly attached on one end within the defined volume and loose on the other end within the defined volume. In some alternative embodiments, the plurality of strip-like structures may be attached on both ends. The flexible nature of the strip-like structures may cause interaction with and mixing of the water as the water passes around and/or through the strip-like structures. Another example use configuration of the at least one structure includes at least one tube-like structure defining a first flow path along a channel defined within the at least one tube-like structure and one or more second flow paths extending through one or more pores within a wall of the at least one tube-like structure such that water within the defined volume is able to flow through either or both of the first flow path and the one or more second flow paths before leaving the defined volume through the outlet. Various embodiments of the present invention contemplate many other types of use configurations of the at least one structure positioned within the defined volume (e.g., interfolded structures, folded structures, rolled structures, among others).

Notably, in some embodiments, the designed use configuration provides for a beneficial and long-lasting device. In this regard, in various embodiments, there can be little to no pressure differential or systemic effect across the defined volume (e.g., within the canister or cartridge), particularly over an extended period of time of use, such as weeks, months, or years. In some cases, the little to no pressure differential may be due to a lack of clogging or buildup within the use configuration. In some cases, this can be achieved by ensuring that there is even flow distribution within the use configuration—which may be achieved by the specifically designed use configuration (such as provided by various embodiments described herein). Notably, one benefit achieved by some such embodiments is an overall reduction in pump usage through various water flow systems—thereby reducing power usage and maintenance requirements. In fact, many of the system components disclosed herein can significantly improve consequences of biofouling in a variety of existing systems, including reductions in (1) production losses due to the decrease in efficiency and the scheduled and unscheduled shutdowns of the installation, (2) maintenance costs, resulting from the elimination of biofouling deposits with chemical and/or mechanical devices, (3) increased corrosion processes in metallic components, induced by microbiological corrosion (MIC) or other processes (3) increased consumption of water, electricity, fossil fuels, and other sources to counteract the effects of biological fouling, (4) increases in manufacturing costs of heat exchangers to consider an acceptable biological fouling without losing design power and to be able to mechanically clean them, and (5) increases in environmental risks due to the use of biocides and/or CO2 emissions to the environment to counteract biological fouling. The systems disclosed herein can similarly reduce many consequences of macrofouling in water systems, including (1) high costs caused by the complexity of the cleaning of the macroorganisms of the installation, (2) losses of power produced by the loss of flow and thermal efficiency in the heat exchangers of a refrigeration installation, (3) costs produced by the management of the macrofouling waste after its removal from the installation, and (4) production of faults due to the accumulation of macroorganisms in auxiliary systems, such as valve drives, grids, pumps, instrumentation, etc.

In many industrial water systems, it may be desirous to maximize laminar flow within the piping of the water supply system in an attempt to minimize fluid flow resistance and/or improve pumping efficiency, while maximizing turbulent flow within heat exchange components in an attempt to optimize heat transfer within those components. In a similar manner, in some embodiments it may be desirous to have a laminar fluid flow within the canister, which may reduce flow resistance and/or minimize stress on the fabric matrix therein, while in other embodiments it may be desirous to obtain a turbulent fluid flow within the canister, which can promote increased elution, increase trans-pore fluid flow, fabric matrix motion and/or mixing of fluid within the canister. In various embodiments a combination of laminar and turbulent flow may be highly desirable within the same canister. Similarly, laminar and/or turbulent flow(s) within a given canister may be the result of changing fluid flows within the entire water supply system, such as where a lower fluid flow through the canister is increased due to an increased demand for cooling water from the water supply system.

In various embodiments, an average and/or target flow rate of the fluid passing through the canister or cartridge may be desired, such as during normal operation (e.g., average or typical flow during pump operation) of an antifouling system. In one exemplary embodiment, a canister may have a desirable operational flow rate of 40 gallon per minute (GPM), while other designs may accommodate lesser and/or greater fluid flow raters (e.g., maximum, minimum and/or average flow rates) during pump operation, such as less than 3.8 liters per minute or LPM (<1 GPM), 3.8 LPM (1 GPM), 7.6 LPM (2 GPM), 11.4 LPM (3 GPM), 15.1 LPM (4 GPM), 19 LPM (5 GPM), 37.9 LPM (10 GPM), 56.8 LPM (15 GPM), 5.7 LPM (20 GPM), 94.6 LPM (25 GPM), 113.6 LPM (30 GPM), 132.5 LPM (35 GPM), 151.4 LPM (40 GPM), 170.3 LPM (45 GPM), 189.3 LPM (50 GPM), 208.2 (55 GPM), 227.1 LPM (60 GPM), 246.1 LPM (65 GPM), 265 LPM (70 GPM), 283.9 LPM (75 GPM), 302.8 LPM (80 GPM), 321.8 LPM (85 GPM), 340.7 LPM (90 GPM), 359.6 LPM (95 GPM), 378.5 LPM (100 GPM) or greater, as well as any range among and/or between any of the various rates previously described. In at least a few exemplary embodiments, fluid flow rates such as 50.7 LPM (13.4 GPM), 71.9 LPM (19 GPM) and 151.4 LPM (40 GPM) were demonstrated to provide significant antifouling protection to the canister contents and/or various downstream substrates and/or surfaces. In various embodiments, fluid flow rates ranges of 37.9 (10 GPM) to 151.4 LPM (40 GPM) (inclusive) and/or 132.5 LPM (35 GPM) to 159 LPM (42 GPM) (inclusive) demonstrated significant reduction of biofouling as well. For various maritime applications and smaller vessels (e.g., 6.1 meters to 45.7 meters or 20-150 ft), a water low of 151.4 LPM (40 GPM) through the antifouling system may be optimal for single water intakes supplying multiple systems. In other embodiments, a system providing 30.3 LPM to 45.4 LPM (8-12 GPM) of treated water may be optimal for dedicated intakes serving a single piece or type equipment. In other embodiments, larger industrial applications and/or larger ships may have much higher intake requirements, which may be provided by a much large antifouling system capacity and/or by the use of multiple cartridges in a manifold arrangement. In some embodiment, where a desired volume of waterflow may increase dramatically, a higher pressurization of the cartridge might be desired.

In various alternative embodiments, it may be desirous to target a desired velocity of fluid flow passing through the canister and/or along and/or through the coated fabric matrix within the canister during pump operation, such as a flow velocity of 0.030 meter per second or MPS (0.1 foot per second or FPS) or less. In other embodiments, flow rates of 0.03 MPS (0.1 FPS), 0.061 MPS (0.2 FPS), 0.152 MPS (0.5 FPS), 0.274 MPS (0.9 FPS), 0.30 MPS (1 FPS), 0.61 MPS (2 FPS), 0,914 MPS (3 FPS), 1.22 MPS (4 FPS), 1.52 MPS (5 FPS), 3.05 MPS (10 FPS) or greater, as well as any range among and/or between any of the various velocities previously described, may be desirous. In various exemplary embodiments, fluid flow velocities of 0.043 MPS (0.14 FPS), 0.045 MPS (0.147 FPS), 0.232 MPS (0.76 FPS) and 0.238 MPS (0.78 FPS) were demonstrated to provide significant antifouling protection to the canister contents and/or various downstream substrates and/or surfaces.

In some embodiments, it may be desirous to target a total volume of water passing through the canister, such as a total of 11,356,235 liters (3 million gallons) of water or greater which passes through a pleated cylinder embodiment, providing significant antifouling protection to the canister contents and/or various downstream substrates and/or surfaces. Depending upon the intended use of such water or other fluid, as well as the industrial scale of the facility, a given canister design and/or system may create a significant volume of “treated” water passing therethrough, provide significant antifouling protection to the canister contents and/or various downstream substrates and/or surfaces.

In some embodiments, the device (or a portion thereof) may be replaceable, such that a replaceable canister or cartridge is formed. In this regard, in some embodiments, the water flow system may benefit from quick and easy replacement of the at least one structure. In some cases, different use configurations may be interchangeable within the device, which may allow for customization and/or repurposing of the device.

In some embodiments, an antifouling system may incorporate a plurality of devices in a single installation, with an input bulk water flow through the system being initially split into a plurality of individual water streams (e.g., by a manifold arrangement) such that each individual water stream can pass through at least one device. Once the individual water streams have passed through their respective device(s), the individual output water streams may be combined into a single output water stream and exit the antifouling system for use thereafter. In such an example embodiment, if desired, one or more of the individual devices may be selectively isolated from the bulk water flow to allow for repair, maintenance and/or replacement of the individual device without undesirably impacting or reducing the entire bulk water flow travelling through the system. In some embodiments, only a portion of the water may pass through a device, allowing for a bypass path for the water in the water flow system.

In some embodiments, the antifouling system may include a supplemental treatment system, dosing device, material and/or other system components which can desirably alter the water chemistry of the water flow in a desired manner, such as by reducing, neutralizing, or enhancing one or more chemical properties within the water flow by sparging the water flow with a gas (e.g., nitrogen or methane) and/or by adding or exposing the water stream to an oxygen reducing agent (e.g., sulfur dioxide or sodium sulfite in powder or layered bed form) or other chemical compound(s). In yet another embodiment, the addition of fresh water or treated water as a “dosing agent” might be utilized to form a separation gradient between fresh and saltwater flows to intentionally exacerbate the differential between the two layers, thus desirably maximizing a change in water chemistry between the same that may inhibit fouling organisms from colonization of various locations and/or in various situations. In such systems, which may optionally include a plurality of replaceable modules and/or chemical reservoirs or dispensers, some of these antifouling systems may be equipped with components to affect water chemistry of individual water streams while other system components may be equipped with the various material and/or cartridge embodiments described herein. After respective treatments, individual treated water streams may then be recombined, and the combined water stream directed to a desired use.

In some embodiments, the antifouling system can provide biofouling protection for the various components of the antifouling system itself, while in other embodiments the antifouling system might provide some level of biofouling protection for the adjacent, surrounding and/or downstream surfaces and/or corresponding water flow in the water flow system, while in still other embodiments, the antifouling system could provide biofouling protection for various combinations thereof.

In various embodiments, such as described above and herein, the antifouling system is designed to prevent, limit, and/or reduce biofouling in the water flow system (e.g., in the water itself and/or on downstream surfaces). In this regard, the antifouling system creates an environment in the water flow system that prevents, limits, and/or reduces biofouling. This is accomplished in many different ways, and without being bound by theory, it is believed that the antifouling system accomplishes this by one or more of many different features/functions/system synergies it provides/causes. For example, the plurality of flow paths created by the antifouling system create or induce an alteration or change in the type, quantity and/or “mix” of various micro- and/or macro-organisms associated with the production, development, growth and or make-up of biofilms that would otherwise form on surfaces within the water flow system. This desirably reduces the thickness, speed, extent, type, durability and/or adhesive/cohesive properties of biofilms and their formation (e.g. the biofilm's attachment to the surface and/or cohesive strength), as well as potentially alters the various biofilms formed thereby, including changes in surface biofilm composition, thickness and/or structural integrity. As another example, in some embodiments, the activities of the disclosed antifouling system components may promote the formation or growth of a transient, temporary and/or relatively durable “artificial” surface biofilm, coating, film or layer on one or more surfaces and/or objects which can potentially inhibit, hinder, avoid and/or prevent the subsequent settling, recruitment and/or colonization of the surface/object by unwanted types of biofouling organisms for various time periods, including extended time periods, even where the antifouling system components may be absent, removed and/or nonoperational. As another example, an increased mixing of the water can occur due to the plurality of flow paths within the defined volume forces mixing and interaction with the structure(s) in the use configuration—thereby increasing the desirable mixing effect for preventing, limiting, and/or reducing biofouling in the water itself. In embodiments where biocide or other chemicals are provided, the increased effects induced by the structure(s) in the use configuration provide for increased exposure to the biocide or other chemicals, particularly in combination with the mixing effect—thereby preventing, limiting, and/or reducing biofouling in the water itself (e.g., there is an increase of actual contact time in which the fouling organisms are in physical contact with the antifouling agents on the surface and within the surrounding aquatic environment).

By preventing, limiting, and/or reducing biofouling in the water flow systems, significant benefits can be achieved. An example benefit includes a reduction in maintenance (time and expense) for the water flow system and corresponding applications thereof (e.g., surfaces and other components of the water flow system need less replacement and are more effective longer without the otherwise significant biofouling build-up that would occur without the benefits of the various antifouling systems described herein). Another example benefit is increased efficiency of operation of water flow systems and the systems that use the water flow system (e.g., heat exchangers, industrial applications, etc.). Biofouling has a great influence on the thermal performance of heat exchangers, due to the accumulation of biotic deposits with insulating characteristics in heat exchange surfaces. This accumulation adds not only an additional thermal resistance to the flow of heat but a greater frictional resistance to the passage of the fluid. The formation of these biofilms produces important modifications, since they alter the physical-chemical conditions at the metal-solution interface and form barriers for the exchange of elements between the metallic surface and the surrounding liquid medium. Among the negative consequences, the decrease of the heat output of the heat exchangers and the lower durability of the construction materials of the equipment are significant. Still more, by limiting, preventing, or reducing biofouling, water flow systems may be useable for other applications that may have been otherwise unthinkable or unworkable until introduction of the benefits provided by various antifouling systems described herein.

One of ordinary skill in the art should understand that there are a wide variety of applications for the various systems and devices disclosed herein. It should also be understood by those of ordinary skill in the art that the disclosed invention contemplates the protection of a myriad range of surfaces, including, but not limited to, any surface or material used with or in combination or in conjunction with any use of water, such as, large water consumption using a water flow system. Other mechanisms similarly impacted by biofouling that may be addressed using the present disclosure include microelectrochemical drug delivery devices, papermaking and pulp industry machines, underwater instruments and/or sensors, fire protection system piping, and sprinkler system nozzles. Besides interfering with mechanisms, biofouling also occurs on the surfaces of living marine organisms, where it is commonly known as epibiosis. Biofouling is also found in almost all circumstances where water-based liquids are in contact with and/or have wetted other materials. Industrially important impacts are on the maintenance of agriculture, membrane systems (e.g., membrane bioreactors and reverse osmosis spiral wound membranes) and water cycles of large equipment and power stations. Biofouling can also occur in oil pipelines carrying oils with entrained water, especially those carrying used oils, cutting oils, oils rendered water-soluble through emulsification, and hydraulic oils. Biofouling may also occur in various heating uses, such as with boilers. In this regard, various antifouling systems described herein can be utilized and/or easily adapted in view of this disclosure for effective use with any water or fluid flow systems. Still other examples include marine water storage and cooling systems such as sea chests, power and utility cooling systems, ballast tanks, etc.

### BRIEF DESCRIPTION OF THE DRAWINGS

The foregoing and other objects, aspects, features, and advantages of embodiments will become more apparent and may be better understood by referring to the following description, taken in conjunction with the accompanying drawings, in which:

FIG. 1 illustrates a schematic diagram of an example water flow system utilizing an example antifouling device, in accordance with various embodiments described herein;

FIG. 2A illustrates a schematic diagram of another example water flow system utilizing an example antifouling device, in accordance with various embodiments described herein;

FIG. 2B illustrates a schematic diagram of an example water flow system with a heat exchanger utilizing an example antifouling device, in accordance with various embodiments described herein;

FIG. 2C illustrates an example water flow system with a sea chest utilizing an example antifouling device, in accordance with various embodiments described herein;

FIG. 2D illustrates another example water flow system with a sea chest utilizing an example antifouling device, in accordance with various embodiments described herein;

FIG. 2E illustrates an example water flow system for a water management piping system utilizing an example antifouling device, in accordance with various embodiments described herein;

FIG. 3 illustrates a schematic diagram of another example water flow system utilizing multiple example antifouling devices, in accordance with various embodiments described herein;

FIG. 4A illustrates an example roll of material, in accordance with various embodiments described herein;

FIGS. 4B-C illustrate an example sheet of material, in accordance with various embodiments described herein;

FIG. 4D illustrates an example shaped structure of material, in accordance with various embodiments described herein;

FIG. 4E illustrates an example rock-shaped structure of material, in accordance with various embodiments described herein;

FIG. 5 illustrates a cross-sectional view of an example material, in accordance with various embodiments described herein;

FIG. 6A depicts an uncoated polyester fabric;

FIG. 6B depicts the fabric of FIG. 10A coated with a coating;

FIG. 6C depicts an uncoated spun polyester fabric;

FIG. 6D depicts the fabric of FIG. 10C coated with a coating;

FIG. 6E depicts an uncoated spun polyester cloth;

FIG. 6F depicts an uncoated side of the spun polyester cloth of FIG. 6D after coating;

FIG. 7 depicts permeabilities of various materials that may be suitable for use in an antifouling device, in accordance with various embodiments described herein;

FIG. 8 illustrates an example antifouling device, in accordance with various embodiments described herein;

FIG. 9 illustrates an example antifouling device with reinforcement features, in accordance with various embodiments described herein;

FIG. 10 illustrates an example antifouling device utilizing a spiral use configuration, in accordance with various embodiments described herein;

FIGS. 11A-C illustrate example flow paths for the antifouling device shown in FIG. 10, in accordance with various embodiments described herein;

FIGS. 12A-C illustrate example components of the antifouling device shown in FIG. 10, in accordance with various embodiments described herein;

FIG. 13A is a schematic cross-sectional view of an example antifouling device, illustrating use of spacer elements, in accordance with various embodiments described herein;

FIG. 13B illustrates an example spacer element assembly, in accordance with various embodiments described herein;

FIG. 13C depicts an alternative embodiment of a spacer element;

FIG. 13D depicts the spacer element of FIG. 13C being assembled into another embodiment of an antifouling device;

FIG. 13E depicts an end view of the assembled antifouling device of FIG. 13D;

FIG. 14 illustrates an example permeable plate for encouraging diffused water flow through the antifouling device, in accordance with various embodiments described herein;

FIG. 15 illustrates a schematic of the example antifouling device shown in FIG. 10 being filled up with water, in accordance with various embodiments described herein;

FIG. 16 illustrates potential backflushing of a spiral use configuration, in accordance with various embodiments described herein;

FIGS. 17A-D illustrate different spiral use configuration variations, in accordance with various embodiments described herein;

FIGS. 18A through 18C depict exemplary embodiments of coating configurations for surfaces used in example spiral use configurations, in accordance with various embodiments described herein;

FIG. 19 depicts a side cross-sectional view of an alternative embodiment of a material arranged in a radial inward spiral wound configuration, in accordance with various embodiments described herein;

FIG. 20 depicts a side cross-sectional view of another alternative embodiment of a cartridge assembly which incorporates a material formed and arranged in a radially outward spiral water flow path, in accordance with various embodiments described herein;

FIG. 21 depicts a side cross-sectional view of another alternative embodiment of a material arranged in a radially inward spiral water flow path, wherein the cartridge assembly is oriented horizontally, in accordance with various embodiments described herein;

FIGS. 22-23 illustrate additional example embodiments of a spiral use configuration that involve providing counter cross flow through a double spiral, in accordance with various embodiments described herein;

FIGS. 24A-B illustrate an example antifouling device usage within a piping system, in accordance with various embodiments described herein;

FIGS. 24C-D illustrate another example antifouling device usage within another piping system, in accordance with various embodiments described herein;

FIGS. 24E-F illustrate an example antifouling device usage within a sea chest, in accordance with various embodiments described herein;

FIG. 24G illustrates an example antifouling device usage within an alternative embodiment of a sea chest, in accordance with various embodiments described herein;

FIG. 25A illustrates an example antifouling device utilizing shaped structures in a use configuration, in accordance with various embodiments described herein;

FIGS. 25B-C illustrate alternative example shaped structures, in accordance with various embodiments described herein;

FIG. 26 illustrates an example antifouling device utilizing rock-shaped structures in a use configuration, in accordance with various embodiments described herein;

FIG. 27A illustrates an example antifouling device utilizing blade-like structures in a use configuration, in accordance with various embodiments described herein;

FIG. 27B illustrates a cross-sectional view of the antifouling device shown in FIG. 27A, in accordance with various embodiments described herein;

FIG. 27C illustrates an example blade-like structure, in accordance with various embodiments described herein;

FIG. 28A illustrates an example antifouling device utilizing blade-like structures in a use configuration, in accordance with various embodiments described herein;

FIG. 28B illustrates a close-up view of the example blade-like structures shown in FIG. 28A, in accordance with various embodiments described herein;

FIG. 29A illustrates an example antifouling device utilizing tube-like structures in a use configuration, in accordance with various embodiments described herein;

FIG. 29B illustrates a close-up view of the example tube-like structures shown in FIG. 29A, in accordance with various embodiments described herein;

FIG. 30A illustrates a vertical cross-sectional view of an example antifouling device utilizing pleated structures in a use configuration, in accordance with various embodiments described herein;

FIG. 30B illustrates a perspective view of the example pleated structures shown in FIG. 30A, in accordance with various embodiments described herein;

FIG. 30C illustrates a horizontal cross-sectional view of the example pleated structures shown in FIG. 33B, in accordance with various embodiments described herein;

FIGS. 31A through 31D depict various views of one exemplary embodiment of an antifouling device incorporating a pleated insert;

FIG. 32A depicts an elongated sheet of material that is folded or pleated along fold lines;

FIG. 32B depicts the material sheet of FIG. 32A which is connected at opposing ends and/or overlapped to form a rounded or star-shaped insert configuration;

FIGS. 32C through 32E depict various views of a securement ring having a plurality of protrusions or ribs extending therefrom;

FIGS. 32F and 32G depict views of exemplary cartridge bodies or tubes to accommodate the insert of FIG. 32B and rings of FIGS. 32C through 32E;

FIGS. 33A and 33B depict views of an alternative embodiment of an antifouling device incorporating a pleated insert;

FIG. 33C depicts a cross-sectional view of the antifouling device of FIG. 33A with water flowing therethrough;

FIGS. 34A through 34C depict various views of another exemplary embodiment of an antifouling system which incorporates a first antifouling cartridge, a second antifouling cartridge and a connector connected therebetween;

FIG. 35A illustrates an example antifouling device utilizing strip-like structures in a use configuration, in accordance with various embodiments described herein;

FIG. 35B illustrates a close-up view of an example strip-like structure shown in FIG. 35A, where the strip-like structure has been rolled up, in accordance with various embodiments described herein;

FIG. 35C illustrates another example antifouling device utilizing strip-like structures in a use configuration, where the strip-like structures are secured on both ends within the defined volume, in accordance with various embodiments described herein;

FIG. 35D illustrates another example strip-like structure, in accordance with various embodiments described herein;

FIG. 35E illustrates another example antifouling device utilizing strip-like structures in a use configuration, in accordance with various embodiments described herein;

FIG. 35F illustrates a “strip tank” embodiment that was utilized in various testing, in accordance with various embodiments described herein;

FIG. 35G illustrates a “skirt tank” embodiment that was utilized in various testing, in accordance with various embodiments described herein;

FIGS. 36A through 36C depict various water chemistry factors measured for experimental testing of the strip tank and skirt tank embodiments;

FIGS. 37A through 37D depict various biota present for experimental testing of the strip tank and skirt tank embodiments;

FIG. 37E depicts debris levels within cooling tube analogs for experimental testing of the strip tank and skirt tank embodiments;

FIG. 37F depicts biota found on artificial substrate analogs for experimental testing of the strip tank and skirt tank embodiments;

FIG. 37G depicts biota found on the wall and inner cylinder of the strip tank test system during experimental testing of the strip tank embodiments;

FIG. 38 depicts a schematic representation of one exemplary embodiment of an antifouling system employing multiple antifouling devices of differing heights and reservoir barrels to treat a cooling water or other industrial water flow, in accordance with various embodiments described herein;

FIGS. 39A through 39E depict various water chemistry measurements taken during experimental testing;

FIGS. 40A through 40E depict various views of fouling that naturally occurred on control surfaces and related system components used during experimental testing;

FIG. 40F depicts views of fouling organisms visibly present in a control receiving tank of the experimental testing;

FIG. 40G depicts fouling on an inlet strainer for the control system of the experimental testing;

FIG. 41A depicts various views of the surfaces of the surface in water treated by the 26″ antifouling device during the experimental testing;

FIG. 41B depicts a view of a receiving tank of the 26″ antifouling device used during the experimental testing;

FIG. 42A depicts various views of the surfaces of the surface in water treated by the 36″ antifouling device during the experimental testing;

FIG. 42B depicts a view of a receiving tank of the 36″ antifouling device used during the experimental testing;

FIG. 43A depicts various views of the surfaces of the surface in water treated by the 46″ antifouling device during the experimental testing;

FIG. 43B depicts a view of a receiving tank of the 46″ antifouling device used during the experimental testing;

FIG. 44A depicts various views of the surfaces of the surface in water treated by the 56″ antifouling device during the experimental testing;

FIG. 44B depicts a view of a receiving tank of the 56″ antifouling device used during the experimental testing;

FIGS. 45A through 45C depict fouling on inlet strainers for the 26″, the 36″ and the 46″ antifouling devices, respectively, used during the experimental testing;

FIG. 46A depicts a perspective view of cooling tubes used during the experimental testing;

FIGS. 46B and 46C depict views of the unfouled cooling tube interiors used during the experimental testing;

FIG. 47 depicts unrinsed 56″, 46″, 36″ and 26″ material spiral use configurations, respectively, used during the experimental testing;

FIG. 48 depicts a view of the bottom of the 26″ height spiral use configuration shown in FIG. 47, illustrating mussels which had colonized the diffuser space;

FIG. 49 depicts sediment build up on an edge of the material of a spiral use configuration during experimental testing;

FIGS. 50A through 50F depict various views of another experimental test of an antifouling system in a saltwater environment;

FIG. 51A depicts a control tank used during the experimental testing, taken after six months of operation;

FIG. 51B depicts a tank protected by the antifouling system used during the experimental testing, taken after six months of operation;

FIG. 52A depicts a suspended control surface in the control tank used during the experimental testing, taken after six months of operation;

FIG. 52B depicts a surface placed control surface in the control tank used during the experimental testing, taken after six months of operation;

FIG. 52C depicts a suspended protected surface in the tank protected by the antifouling system used during the experimental testing, taken after six months of operation;

FIG. 52D depicts a surface placed protected surface in the tank protected by the antifouling system used during the experimental testing, taken after six months of operation;

FIG. 53A depicts a washed suspended control surface in the control tank used during the experimental testing, taken after six months of operation;

FIG. 53B depicts a washed surface placed control surface in the control tank used during the experimental testing, taken after six months of operation;

FIG. 53C depicts a washed suspended protected surface in the tank protected by the antifouling system used during the experimental testing, taken after six months of operation;

FIG. 53D depicts a washed surface placed protected surface in the tank protected by the antifouling system used during the experimental testing, taken after six months of operation;

FIGS. 54A and 54B depict charts of the water temperature and waterflow speed for an experimental test of various exemplary embodiments;

FIG. 54C depicts biofouling cover for various exemplary embodiments of the experimental test of FIGS. 54A and 54B;

FIG. 54D depicts various precent cover results for the experimental test of FIGS. 54A and 54B;

FIGS. 55A through 55C depict fouling community diversity for the exemplary embodiments of the experimental test of FIGS. 54A and 54B;

FIG. 55D depicts an amount of material captured at an entrance of a pleated canister;

FIG. 55E depicts a disassembled insert from the pleated canister of FIG. 55D;

FIG. 55F depicts a diversity of organisms from a substrate protected by a pleated canister;

FIG. 55G depicts a diversity of organisms from an unprotected substrate used as a control;

FIG. 56 depicts biofouling cover for another experimental test of various exemplary embodiments;

FIG. 57A through 57E depict fouling community diversity for the exemplary embodiments of the experimental test of FIG. 56;

FIGS. 58A through 58C depict fouling organism cover on exemplary canisters for vertical direct flow treatment, horizontal spiral treatment and control;

FIG. 59 graphically depicts percent cover versus date for an experimental test using two large canisters, two small canisters and a control;

FIGS. 60A through 60E depict various taxonomic groups on the substrates from the experimental test of FIG. 59;

FIG. 60F depicts a view of a control substrate from the experimental test of FIG. 59;

FIG. 60G depicts a view of a substrate protected by small canisters in the experimental test of FIG. 59;

FIG. 60H depicts a view of a substrate protected by large canisters in the experimental test of FIG. 59; and

FIG. 61 depicts design and performance characteristics of the various canister designs from the experimental test of FIG. 59.

### DETAILED DESCRIPTION OF THE INVENTION

The disclosures of the various embodiments described herein are provided with sufficient specificity to meet statutory requirements, but these descriptions are not necessarily intended to limit the scope of the claims. The claimed subject matter may be embodied in a wide variety of other ways, may include different steps or elements, and may be used in conjunction with other technologies, including past, present and/or future developments. The descriptions provided herein should not be interpreted as implying any particular order or arrangement among or between various steps or elements except when the order of individual steps or arrangement of elements is explicitly described.

Disclosed herein are a variety of antifouling systems that may be utilized in proximity to or upstream from a surface or other objects that are wetted by, located within and/or which contain an aqueous environment that is susceptible to fouling and/or biofouling and/or the accumulation or buildup of biofilm and/or sediments or other substances. In various embodiments, antifouling systems, devices and methods are disclosed that can protect surfaces from various effects of aqueous biofouling, including the creation and potential retention of biofouling resistance by surfaces for various periods of time after components of the disclosed antifouling systems may be depleted, halted in operation and/or removed. In various embodiments, the antifouling system components described herein can be provided in an assembled and/or preassembled fashion, and such antifouling systems are desirably relatively easy for use, maintenance and/or repair by untrained and/or minimally trained personnel.

In various embodiments, “water” or “aqueous water” can refer to salt or marine water, fresh water, brackish water and/or raw or unprocessed water including “grey” or “black” water, as well as other aqueous fluids that include any amount of water or do not include any water but may suffer from aqueous biofouling. It should further be understood that any reference to salt water, fresh water, brackish water and/or other fluids herein with regards to a specific antifouling system design should not be construed, interpreted or inferred as constituting a limitation on the ability of that antifouling system design to address biofouling in other types of water and/or other fluids. Thus, embodiments disclosed as having antifouling potential in salt water could also have antifouling potential in fresh water, brackish water and/or other fluids, while embodiments disclosed as having antifouling potential in fresh water similarly may have antifouling potential in salt water, brackish water and/or other fluids, and so on.

In the various embodiments described herein the term “material” is intended to encompass any type of material, such as fabric, rubber, metal, plastic, stone/rock, or any other type or shape/configuration of material. The material may, in some embodiments, form a 3-dimensional material or material sheet. The material, in some embodiments, may be flexible. The material, in some embodiments, may be formed of natural and synthetic fabrics, natural and synthetic membranes, natural and synthetic sheets, and fabrics, membranes, films and sheets made from natural and/or synthetic materials, or combinations thereof, as well as other three-dimensional constructs such as solid and/or semi-solid material sheets. The material may be permeable or become permeable. Notably, in many embodiments described herein, the “material” forms one or more structures that may be arranged in various use configurations to be positioned within a defined volume for operation within the water flow system.

In various embodiments disclosed herein, the terms “conditioned” or “treated” in use with “environment or water or fluid or system” are meant to broadly encompass some and/or all of a flow of water or other fluid which passes in a defined volume, in proximity to and/or around and/or through at least one structure of an antifouling system designed for preventing, limiting, or reducing biofouling such that the water is altered in some manner (e.g., altering one or more chemistry properties in the water and/or the water flow) due to the antifouling system's impact, design/configuration, presence and/or chemicals/compounds contained therein. In some embodiments, the “conditioned” or “treated” water (or other fluids) may be combined or mixed with various other water (e.g., fresh, salt, brackish, etc.), optionally including untreated water, in a desired manner to achieve various of the advantages described herein.

In various embodiments, surface(s) to be protected (e.g., surfaces within a water flow system at and/or downstream of one or more antifouling systems or devices and/or surfaces within the antifouling system itself) may be a surface or subsurface portion made of any material, including but not limited to metal surfaces, fiberglass surfaces, PVC surfaces, plastic surfaces, rubber surfaces, wood surfaces, concrete surfaces, glass surfaces, ceramic surfaces, natural structure surfaces, synthetic structure surfaces, fabric surfaces, textile surfaces, and/or any combinations thereof. Notably, the surface or subsurface may form any part of an apparatus or system within the water flow system (e.g., pipe surface, tank surface, etc.) or further downstream system (e.g., pipe surface, tank surface, etc.).

The terms “cartridge” or “canister” as used herein are meant to broadly encompass a removable and/or replaceable component or element of the antifouling system which contains, encloses and/or holds the material (e.g., in the form of one or more structures arranged in a use configuration) and/or any related frames, anchoring components and/or support devices for the material, and in various embodiments may include a housing which can engage with an optional housing or fitting attached to the water flow system. In various embodiments, a cartridge or canister may simply include the material and/or any support components that allow a user to remove and/or replace the material from the canister or other housing.

A “reservoir” or “tank” as used herein is generally meant to encompass a volume of space which is capable of storing and/or retaining an aqueous fluid or liquid such as water for a defined period of time, or which allows some quantity of fluid to remain minimally disturbed, quiescent, stationary and/or at a relatively low flow velocity relative to a normal water flow in the system (e.g., including temporal and/or permanent stagnant volumes, branches, dead ends, dead legs and/or backwater/backflow regions of a water system) for a defined or extended time period. Reservoirs may include regions having a single inlet/outlet, as well as regions having inlet(s) and outlet(s) separated by a distance or spacing, which can include (but should not be limited to) storage tanks or ponds, barrels, pressure tanks, housings, enclosures, containers, barrels, settling tanks, large diameter pipes, ballast tanks and/or sea chests or weirs. Reservoirs may be fully contained by artificial materials or may be bounded by natural and/or artificial features such as dams, berms, quays, seawalls, the air, the earth and/or the like.

The terms “coating” or “paint” as used herein are meant to broadly encompass additional materials and/or compounds which may be impregnated, coated, painted, embedded, printed, injected, covered, laminated, brushed, rolled, dipped, sprayed, encapsulated and/or screen coating or otherwise added to the material utilized in the disclosed antifouling systems. Exemplary coatings can include paints, coatings, clogging or clotting agents, surface films and/or other additives which optionally include at least one agent which affects the tendency for one or more organisms to foul a protected surface (optionally including the material and coated surfaces themselves) in the conditioned environment. Coatings can optionally include additives such as biocidal and/or bio-toxic substances, nanowires and/or nanoparticles (e.g., metals such as copper and silver wires and nanowires), oils and non-toxic substances as well as colorants, pigments, solvents, alcohols, polymers, copolymers and/or monomers, binders, waxes, soaps, surfactants, resins, thixotropic agents, viscosity modifiers, hydrophobic materials such as fluorocarbons, hydrocarbons and poly(dimethylsiloxanes), eluates and/or additives including, but not limited to, papain, butanolide, cardenolides, ethylene glycol and/or poly(ethylene glycol). Some non-toxic fouling protective strategies against biofouling contemplated herein may include coatings and materials incorporating nontoxic and nonbiocidal additives as well as smooth and slippery surfaces on which organisms cannot settle. Such “non-stick” coatings can be based on nanotechnologies or organic polymers with additional antimicrobial properties. A variant of some non-toxic antifouling coatings can be based on hydrophobic surfaces with extremely low friction. Such smooth layers, which can prevent the adhesion of larger microorganisms, may comprise fluoropolymers or silicone such as, for example, polydimethylsiloxane (PDMS), which includes silicon and oxygen atoms and has a self-polishing cleaning effect which depends on the flow strength at the coated surface. In some embodiments, such coatings may also incorporate hydrophilic properties that effectively prevent the adhesion of bacteria and the formation of biofilms.

### Example Water Flow Systems

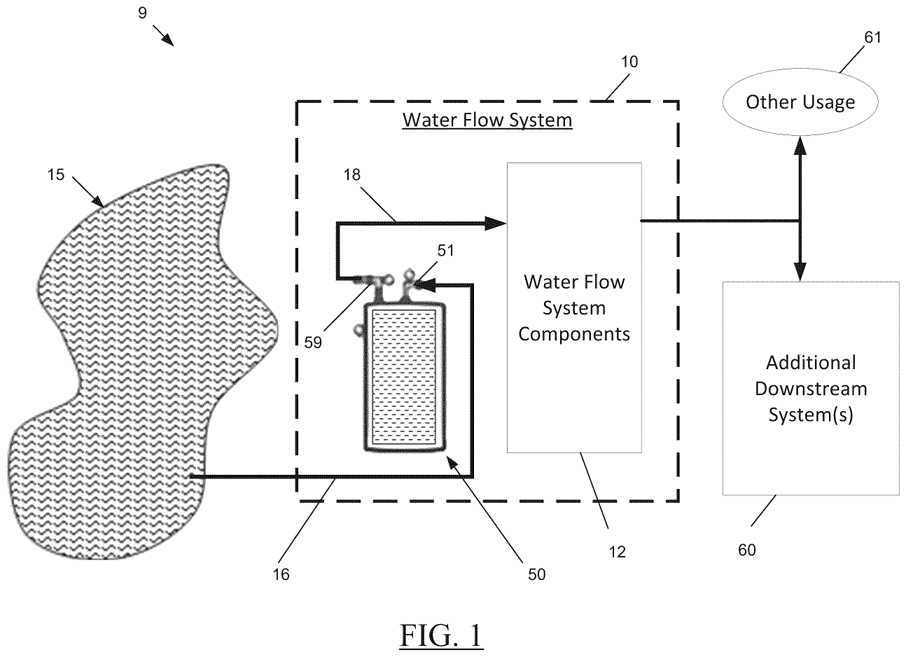

As detailed herein, various embodiments of the present invention provide antifouling systems that are designed to prevent, limit, and/or reduce biofouling within water flow systems and downstream systems (e.g., within the water (or other fluid) and on surfaces within the various systems (including the antifouling system itself)). FIG. 1 illustrates an example environment 9 that includes a water supply source 15 (e.g., a lake—although any type of water (or other fluid) supply source is contemplated). Water (or other fluid) travels (e.g., through one or more pipes or other conduits 16) to a water flow system 10 including one or more water flow system components 12. As described further herein, embodiments of the present invention contemplate use with any type of water flow system, including water flow systems that utilize any flow rates of water. Notably, the water flow system may include additional components for utilization of the water for purposes other than or in addition to water flow. For example, the water flow system (while termed a “water flow system” herein) may include many other water flow system components 12 that may optionally have nothing to do with the water or the usage of water running through the water flow system. Example water flow systems are described further herein.

The water from the water flow system 10 may, in some cases, be passed to additional downstream system(s) 60 and/or on for other usage 61. In such an example, the water flow system may be used to provide water to the other systems and/usages, although (as is consistent with the above description) embodiments of the present invention also contemplate where the water flow system(s) include such systems/usages therein. Example additional downstream systems 60 include any commercial, industrial, and/or residential systems that utilize the water. Likewise, any other type of usage for the water from the water flow systems, such as for consumption, is also contemplated.

Notably, according to various embodiments described herein, one or more antifouling devices 50 may be positioned within or upstream of the water flow system 10 so as to provide “conditioned” water to the water flow system 10 and/or downstream systems or usages. In this regard, the water traveling from the water supply source 15 may pass into an inlet 51 of the antifouling device 50 where, as described herein, the water enters a defined volume and interacts with one or more structures (e.g., arranged in a use configuration) before exiting through an outlet 59 to pass through one or more pipes or other conduits 18 as conditioned water. Thereafter the conditioned water is utilized within the water flow system 10 and/or downstream system(s)/usages. Notably, while the antifouling device 50 is shown within the water flow system 10 in FIG. 1, the antifouling device 50 may be positioned upstream or downstream of the water flow system in some embodiments.

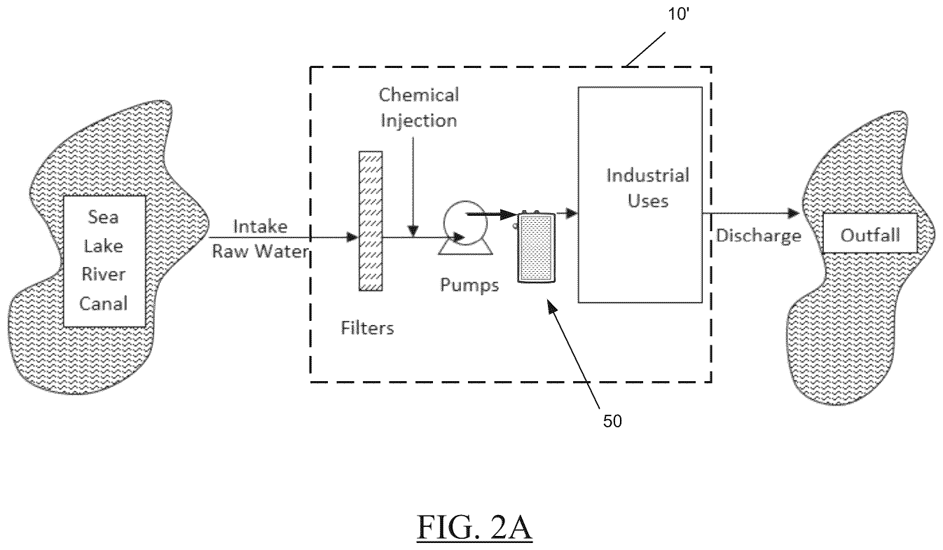

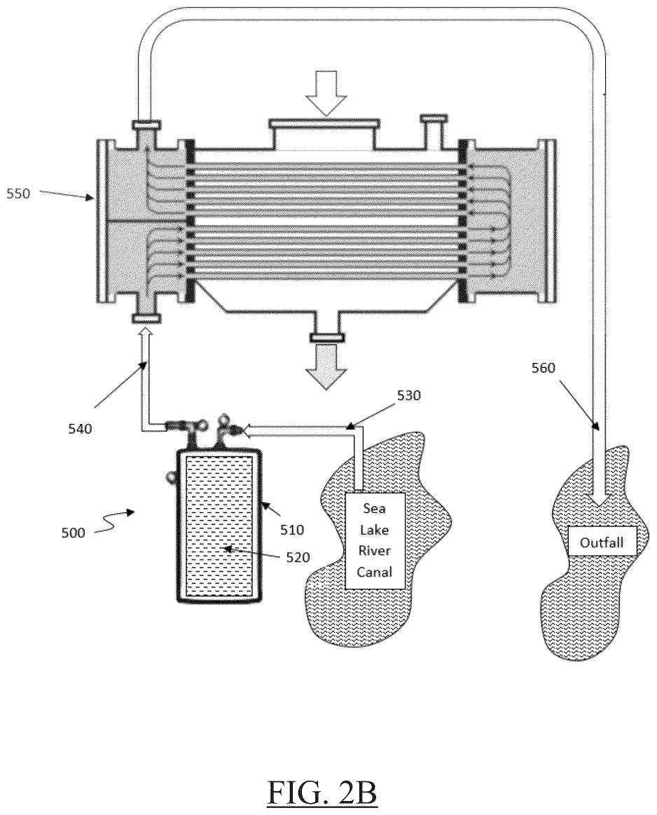

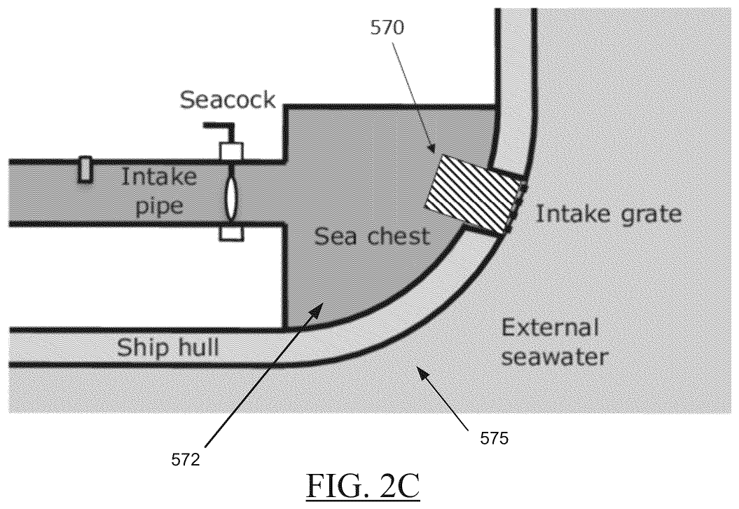

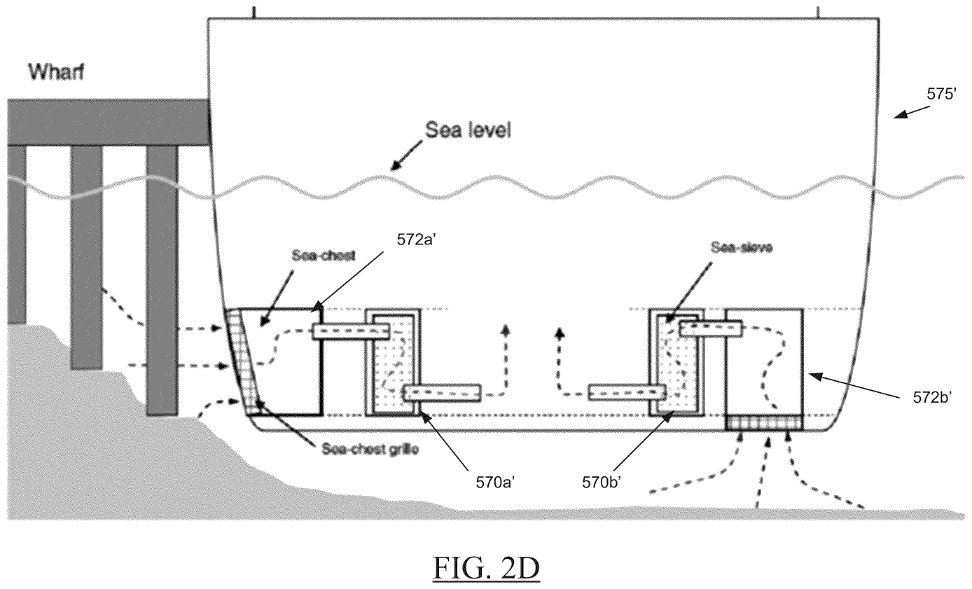

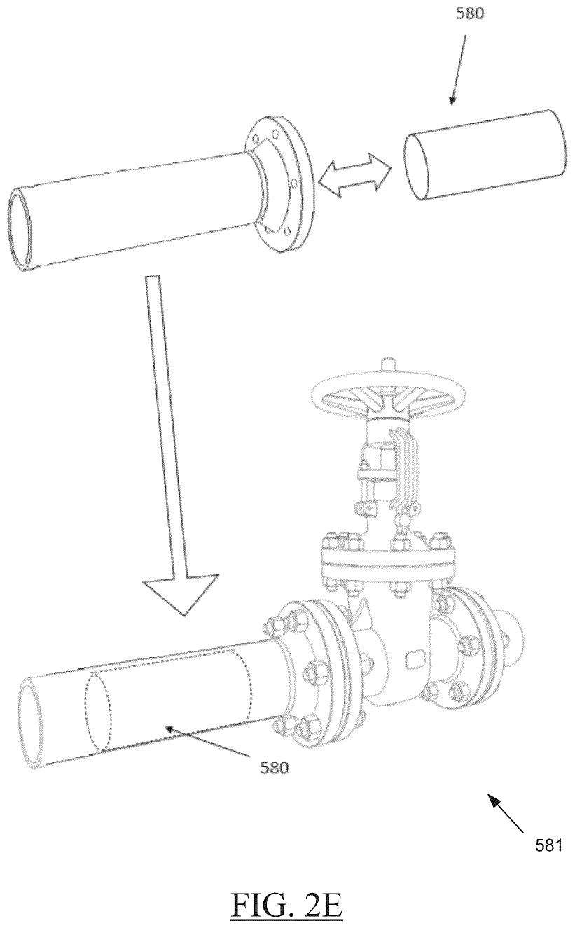

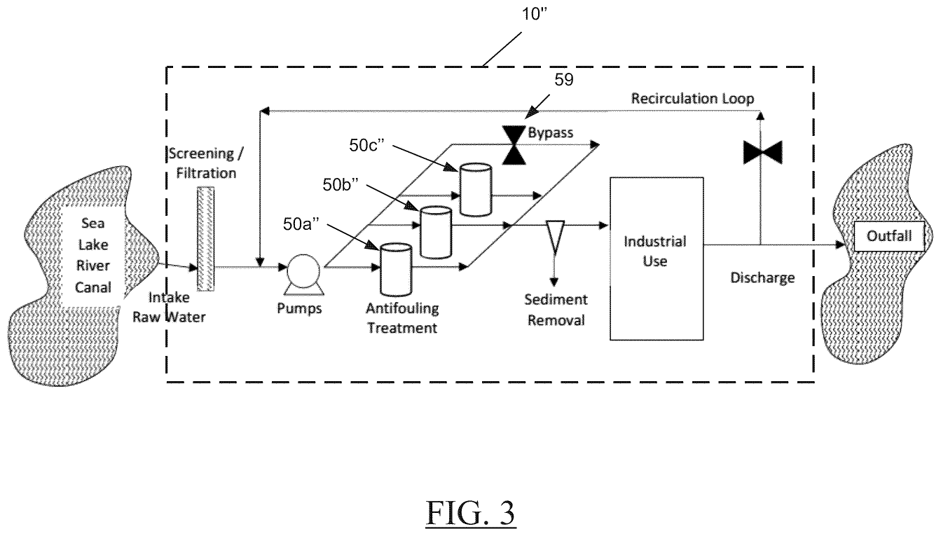

As noted above, the antifouling device 50 is designed to provide conditioned water so as to protect one or more surface(s) within the water flow system 10 (and/or the antifouling device 50 itself, and/or downstream of water flow system 10). Example components that include such surfaces include tubing, tanks, enclosures, boundary walls, valves, nodes, water treatment and chemical injection components, sampling equipment, heat exchangers, condensers, impellers, sensors and/or other devices within the water flow system 10 or other systems (e.g., the antifouling device 50 and/or other downstream system(s)/usages). Additional non-limiting examples of surfaces include piping, valves, pumps, sensors, heat exchanger tubing, filtration system equipment, such as, marine or fresh water filtration and/or cooling systems, boat intakes, membrane filters, water inlet filters, piping and/or storage tanks; lifts and boat storage structures; irrigation water storage tanks and irrigation piping and/or equipment; and/or any portions thereof, including water management systems and/or system components, such as locks, dams, valves, flood gates and seawalls; booms and floats; waste water systems; reserve osmosis water systems; commercial water plants; water systems used for structure heating, injecting, processing, washing, diluting, cooling, and/or transporting; smelting facility systems, petroleum refineries and industries producing chemical products, food, and paper products. Additional example water flow systems include power plants, manufacturing facilities, desalination plants, refineries, fire protection facility equipment and/or sprinkler systems, water treatment plants, intake and circulation systems in vessels of the recreational, military and/or industrial vessel and shipping industries, oil and gas industry facilities, water management and control systems, irrigation systems, manufacturing systems, scientific research systems, military (including the Corps of Engineers) systems, and/or fishing industry systems, as well as many others. FIGS. 2A-3 illustrate various example water flow systems for which various antifouling devices described herein may be useful in preventing, limiting, and/or reducing biofouling therein.

FIG. 2A depicts an exemplary “once-through” industrial water supply and distribution system 10′, in which raw water is drawn from a natural water source or reservoir such as an ocean, a lake, a river, a canal, a well or the like. This raw water is typically initially screened, filtered or strained to remove large solid contaminants and various organic debris, and then a variety of chemicals, compounds and/or other additives may be injected into the water stream for a variety of reasons, including to disinfect the water and/or accelerate the rate of flocculation (among many uses). The chemically treated water is then pumped for use in a variety of industrial uses and used water or “waste” water is then treated and recycled or discharged to the environment (e.g., the “outfall”). In an example embodiment, an antifouling device 50 is positioned within the industrial water supply and distribution system 10′ and configured to provide conditioned water for the industrial uses.

FIG. 2B illustrates one exemplary industrial environment that utilizes an antifouling device 500. The antifouling device 500 may comprise a combination of a housing 510 and one or more replaceable cartridges 520, wherein each replaceable cartridge desirably contains one or more structures in a use configuration therein, such that water or some other fluid entering 530 the system (e.g., from an untreated or unconditioned water source) would desirably pass over and/or through the one or more structures within the antifouling device 500 as it travels through the cartridge from an inlet to an outlet, whereby the water or other fluid then would exit the cartridge (e.g., now leaving as “treated” or “conditioned” water), passing into a supply tube 540 into a heat exchanger 550 to subsequently contact and/or pass over a surface (e.g., a heat transfer surface in the heat exchanger) upon which biofouling typically appears, but in the conditioned or treated water flow, the surface would not undergo the normal biofilm formation and/or fouling progression typically experienced by an equivalent surface in an untreated water stream. Thereafter, the conditioned or treated water exits the heat exchanger 550 and eventually is discharged 560 to an outfall. In some embodiments, the antifouling device 500 may not include a replaceable cartridge, as in various described embodiments herein.

FIG. 2C depicts an exemplary embodiment of an antifouling device 570 positioned at an inlet of a sea chest 572 for a floating vessel 575. External sea (or lake) water may enter the antifouling device 570 through an intake grate and become conditioned water prior to entering the sea chest 572. FIG. 2D illustrates another example floating vessel 575′ that includes two sea chests 572a′ and 572b′. Each includes an antifouling device 570a′ and 570b′, respectively. Notably, the external water may enter the sea chests 572a′, 572b′ prior to interacting with the antifouling devices 570a′, 570b′—as illustrated. Once the conditioned water is formed, the conditioned water may be used within the floating vessel 575′, such as for ballasts, engine cooling, among other things.

FIG. 2E depicts another exemplary embodiment of an antifouling device 580 positioned within a detachable pipeline or water supply system 581. Accordingly, water flowing through the pipes passes through the antifouling device 580 positioned therein—thereby providing conditioned water downstream. In this regard, the antifouling device 580 may be positioned to form part of a piping network and/or be fitted (e.g., retrofitted) into one or more pipes or other conduits. As noted herein, in some embodiments, the antifouling device may be replaceable.

FIG. 3 illustrates another example water flow system 10″. Notably, in the illustrated embodiment, multiple antifouling devices 50a″, 50b″, 50c″ have been installed in parallel. Further, a bypass 59 is also installed in parallel to allow water to bypass the antifouling devices to remain untreated. In some embodiments, the untreated water may be recombined with the treated/conditioned water within the water flow system. Notably, such an example approach that utilizes multiple antifouling devices enables multiple benefits, such as enabling maintenance and/or replacement of one or more antifouling devices while the system remains operational. In some embodiments, a bypass may be provided in a system with a single antifouling device, such as to enable maintenance regarding the single antifouling device without causing the system to stop operation completely.

In some embodiments, a considerable portion and/or all of the water or other fluid within a water flow system will have desirably passed along and/or through one or more antifouling devices and the material contained therein, while in some other embodiments some portion of a fluid flow in a water flow system may bypass and/or otherwise not pass through the antifouling devices. In some cases, an aqueous flow of water or other liquid may benefit from “partial” treatment of the water flow. Accordingly, in various embodiments, some portions of a water flow may “bypass” or otherwise avoid various components and/or treatment provided by the antifouling devices without significantly degrading the antifouling effects thereof for the entirety of the water flow.

### Example Antifouling Material

Various embodiments of the present invention utilize material as part of the antifouling methods, systems, and devices disclosed herein. The material may, in some embodiments, form one or more structures that can be utilized in the antifouling systems to provide antifouling protection—such as described herein. As noted above, the term “material” is intended to encompass any type of material, such as fabric, rubber, metal, wood, fibers, leather, glass, ceramics, composite materials, foams, plastic, stone/rock, or any other type of material. The material may, in some embodiments, form a 3-dimensional material or material sheet. The material, in some embodiments, may be flexible. The material, in some embodiments, may be formed of natural and synthetic fabrics, natural and synthetic membranes, natural and synthetic sheets, and fabrics, membranes, films and sheets made from natural and/or synthetic materials, or combinations thereof, as well as other three-dimensional constructs such as solid and/or semi-solid material sheets.

### Material—Permeability

The material may be permeable or become permeable. In this regard, the material includes one or more pores, perforations and/or openings formed therein from a first side to a second side (e.g., between opposing sides, although the pores, perforations and/or openings may be formed between any two sides of the material (e.g., a first side an adjacent end or side). The material may become permeable after being placed in the water flow system or otherwise. In this regard, the one or more pores, perforations and/or openings may be coated over or otherwise “closed” upon initial manufacturing and may open at some point thereafter, such as during use or right before use within the water flow system. In this regard, the permeable material described herein desirably allows an aqueous fluid to flow around and through the material in a disclosed desired fashion.

The permeability (and configuration arrangement as described herein) of the material may desirably be optimized and/or suited to the local environment within which the antifouling system will be placed. In some embodiments, the material selected for each application may incorporate a moderate to high level of permeability, although materials with extremely low or no permeabilities may still be effective providing sufficient water flow while still accommodating specific required uses. In many cases, the local environmental conditions (e.g., water flow, temperature, bio-floral type, growing season, salinity, available nutrients and/or oxygen, sediments or pollutants, etc.) and/or local water conditions/velocity (e.g., due to currents and/or tides) could affect the desired permeability and/or other design considerations.

A variety of materials disclosed herein are potentially suitable for use in various embodiments of the present invention, with exemplary permeabilities of these materials in uncoated and coated states. For example, it was experimentally determined that a permeability range of 0.5 ml/s/cm² to 25 ml/s/cm² to 50 ml/s/cm² to 75 ml/s/cm² to 100 ml/s/cm² or from about 0.1 ml/s/cm² to about 100 ml/s/cm², cm² or from about 1 ml/s/cm² to about 75 ml/s/cm², or from about 1 ml/s/cm² to about 10 ml/s/cm², or from about 1 ml/s/cm² to about 5 ml/s/cm², or from about 5 ml/s/cm² to about 10 ml/s/cm², or from about 10 ml/s/cm² to about 20 ml/s/cm², or from about 10 ml/s/cm² to about 25 ml/s/cm², or from about 10 ml/s/cm² to about 50 ml/s/cm², or from about 20 ml/s/cm² to about 70 ml/s/cm², or from about 10 ml/s/cm² to about 40 ml/s/cm², or from about 20 ml/s/cm² to about 60 ml/s/cm², or from about 75 ml/s/cm² to about 100 ml/s/cm², or from about 60 ml/s/cm² to about 100 ml/s/cm², or from about 10 ml/s/cm² to about 30 ml/s/cm², might be sufficient (depending upon local conditions) to prevent significant amounts of fouling from occurring on and/or within the cartridge and/or on the protected surface, while still allowing sufficient water flow (as well as any combination of the various ranges disclosed herein). In various aspects of the invention, the material may have a water permeability (milliliters of water per second per square centimeter of material) of about 100 or less, about 90 or less, about 80 or less, about 70 or less, about 60 or less, about 50 or less, about 40 or less, about 30 or less, about 25 or less, about 20 or less, about 10 or less, about 5 or less, about 4 of or less, about 3 or less, about 2 or less, about 1 or less, about 0.5 or less, about 0.1 or less, about 1 or greater, about 0.5 or greater, about 0.1 or greater, from about 0.1 to about 100, from about 0.1 to about 90, from about 0.1 to about 80, from about 0.1 to about 70, from about 0.1 to about 60, from about 0.1 to about 50, from about 0.1 to about 40, from about 0.1 to about 30, from about 0.1 to about 25, from about 0.1 to about 20, from about 0.1 to about 10, from about 0.1 to about 5, from about 0.5 to about 100, from about 0.5 to about 90, from about 0.5 to about 80, from about 0.5 to about 70, from about 0.5 to about 60, from about 0.5 to about 50, from about 0.5 to about 40, from about 0.5 to about 30, from about 0.5 to about 25, from about 0.5 to about 20, from about 0.5 to about 10, from about 0.5 to about 5, from about 1 to about 100, from about 1 to about 90, from about 1 to about 80, from about 1 to about 70, from about 1 to about 60, from about 1 to about 50, from about 1 to about 40, from about 1 to about 30, from about 1 to about 25, from about 1 to about 20, from about 1 to about 10, or from about 1 to about 5.

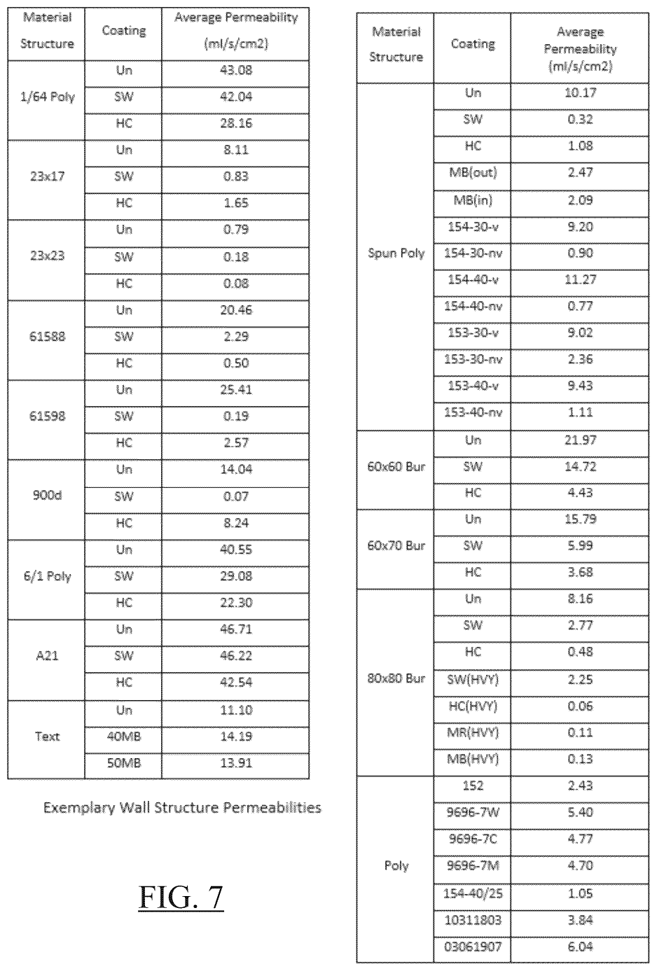

In various embodiments, an optimal and/or desired permeability level for a permeable material can approximate any of the permeabilities identified in FIG. 7, or inclusive ranges therebetween in virtually any combinations thereof, and in some embodiments can include permeabilities ranging from 100 ml/s/cm2 to 0.01 ml/s/sm2. In various alternative embodiments, a structure or other permeable material may be utilized in or on one or more walls of the enclosure, including materials having a permeability range from 0.06 ml/s/cm2 to 46.71 ml/s/cm2, or from 0.07 ml/s/cm2 to 46.22 ml/s/cm2, or from 0.08 ml/s/cm2 to 43.08 ml/s/cm2, or from 0.11 ml/s/cm2 to 42.54 ml/s/cm2, or from 0.13 ml/s/cm2 to 42.04 ml/s/cm2, or from 0.18 ml/s/cm2 to 40.55 ml/s/cm2, or from 0.19 ml/s/cm2 to 29.08 ml/s/cm2, or from 0.32 ml/s/cm2 to 28.16 ml/s/cm2, or from 0.48 ml/s/cm2 to 25.41 ml/s/cm2, or from 0.50 ml/s/cm2 to 22.30 ml/s/cm2, or from 0.77 ml/s/cm2 to 21.97 ml/s/cm2, or from 0.79 ml/s/cm2 to 20.46 ml/s/cm2, or from 0.83 ml/s/cm2 to 15.79 ml/s/cm2, or from 0.90 ml/s/cm2 to 14.72 ml/s/cm2, or from 1.05 ml/s/cm2 to 14.19 ml/s/cm2, or from 1.08 ml/s/cm2 to 14.04 ml/s/cm2, or from 1.11 ml/s/cm2 to 13.91 ml/s/cm2, or from 1.65 ml/s/cm2 to 11.27 ml/s/cm2, or from 2.09 ml/s/cm2 to 11.10 ml/s/cm2, or from 2.25 ml/s/cm2 to 10.17 ml/s/cm2, or from 2.29 ml/s/cm2 to 9.43 ml/s/cm2, or from 2.36 ml/s/cm2 to 9.20 ml/s/cm2, or from 2.43 ml/s/cm2 to 9.02 ml/s/cm2, or from 2.47 ml/s/cm2 to 8.24 ml/s/cm2, or from 2.57 ml/s/cm2 to 8.16 ml/s/cm2, or from 2.77 ml/s/cm2 to 8.11 ml/s/cm2, or from 3.68 ml/s/cm2 to 6.04 ml/s/cm2, or from 3.84 ml/s/cm2 to 5.99 ml/s/cm2, or from 4.43 ml/s/cm2 to 5.40 ml/s/cm2, and/or from 4.70 ml/s/cm2 to 4.77 ml/s/cm2.

In many cases, because the specific fouling organisms, the incidence of fouling incursion and/or rate of fouling growth in a given region and/or water body can be highly dependent upon a multiplicity of interrelated factors, as well as the local and/or seasonal conditions of the intended area of use and the intended surface to be protected, among other things, the acceptable ranges of permeability for a given material in a given antifouling device may vary widely—thus a permeability that may be optimal and/or suitable for one exemplary cartridge and material type, design and/or location may be less optimal and/or unsuitable for another type, design and/or location. Accordingly, the desired permeability values and ranges thereof should be interpreted as general trends of the ability of a given antifouling device design and/or permeability to provide antifouling protection in a given body of water, but should not be interpreted as precluding the use of a given material in other cartridge or enclosure designs and/or water or other fluid conditions.

In various embodiments, the permeability of fibrous material and/or other cartridge materials can desirably be maintained within a desired range of permeabilities over its useful life in situ (or until the desired antifouling biofilm layer has been established, if desired), such that any potential increases in the permeability of the material due to a variety of conditions might desirably approximate various expected decreases in the material's permeability due to clogging of the pores by organic and/or inorganic debris (including any clogging or biofouling of the material and/or its pores that may occur). This equilibrium will desirably maintain the integrity and/or functioning of the material, the cartridge and/or other antifouling system configurations, and the characteristics of the protected environment over an extended period of time, providing significant protection for the cartridge, the material and/or the protected surface(s).

In various embodiments, “permeability” can desirably be utilized as one exemplary metric for some aspects of the material configuration, cartridge and/or other system components, as it may be somewhat difficult to measure and/or determine an “effective” porosity of the openings in the entirety of a spun poly and/or burlap material due to the “fuzziness” and/or randomness in the architecture of the material, which may be compounded by variations in the flexibility and/or form of the material in wet and/or dry conditions, which Applicant believes can optionally be important to the effectiveness of various embodiments of the disclosed antifouling systems and devices. In various embodiments, the antifouling system can comprise one or more walls with openings and/or pores formed therethrough. In some desirable embodiments, some or all of the openings through the wall(s) can comprise a tortuous or “crooked” flow path, where the tortuosity ratio (T) is defined as a ratio of the actual length of the flow path (Lₜ) to the straight-line distance (L) between the ends of the flow path, according to the following equation:

$$\begin{matrix}{L}_{t} \\ \text{?}\end{matrix}$$

$$\text{?} \text{indicates text missing or illegible when filed}$$

The water permeability of a material can be a function of numerous factors, including the composition of the material, the method and type of construction of the material, whether the material is coated or uncoated, whether the material is dry, wet or saturated, whether the material is itself fouled or clogged in some manner and/or whether the material has been “pre-wetted” prior to testing and/or use in the aqueous environment. Moreover, because permeability of a given material may alter over time, even for a single material there may be a range of acceptable and/or optimal water permeabilities. In various aspects of the present invention, the water permeability of a given material may be an initial minimum permeability sufficient to allow water flow through a minimum number of the pores of the material, while in other embodiments the permeability may be greater. If desired, permeability of a given material may change over time, such as where release of biocide or other additives may cause or be a result of erosion and/or degradation of a carrier material with the pores (e.g., enlarging the flowable space within the pore when the material erodes away). In other embodiments the water permeability of a given material may be an initial maximum permeability sufficient to allow some water flow to pass transverse to the material, with pore size potentially reducing due to potential clogging and/or fouling of the material pores over time.

In various embodiments, an apparatus by which the permeability of candidate materials can be assessed in the laboratory can be prepared, such as a water column pressure test apparatus commonly known to those of ordinary skill in the art. For example, an exemplary test apparatus can utilize a pump to supply water from a reservoir to a column of water of a specific height with a test sample inserted onto the bottom of the column. There can optionally be an overflow integrated into the design so that the height of the water in the column desirably remained constant, if desired. The test sample size can be varied, as desired. In one test setup, the water in a column above a 10.2 cm×10.2 cm (4″×4″) fabric coupon can remain constant at a height of approximately 7.62 cm (approximately 3 inches), providing a 1723.7 Pascal (0.25 PSI) “head” pressure. The permeability of each fabric coupon can then be calculated by measuring the volume of water per unit time per unit area exposed to the water column. If desired, the material could be tested in a pre-wetted condition, while in other tests the material could be dried prior to initiation of the test. In at least one exemplary embodiment, using a dried sample with the permeability testing, it was observed that water did not flow through the testing apparatus evenly for accurate measurements.

### Material—Examples

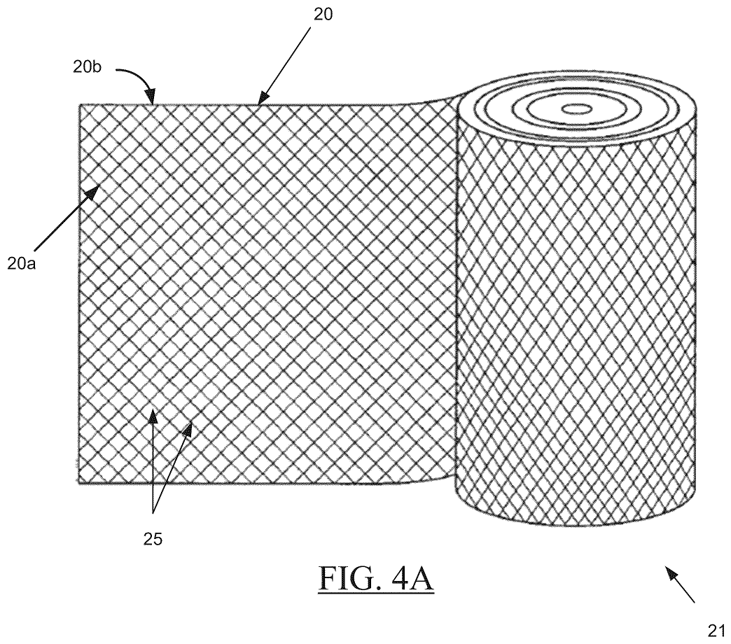

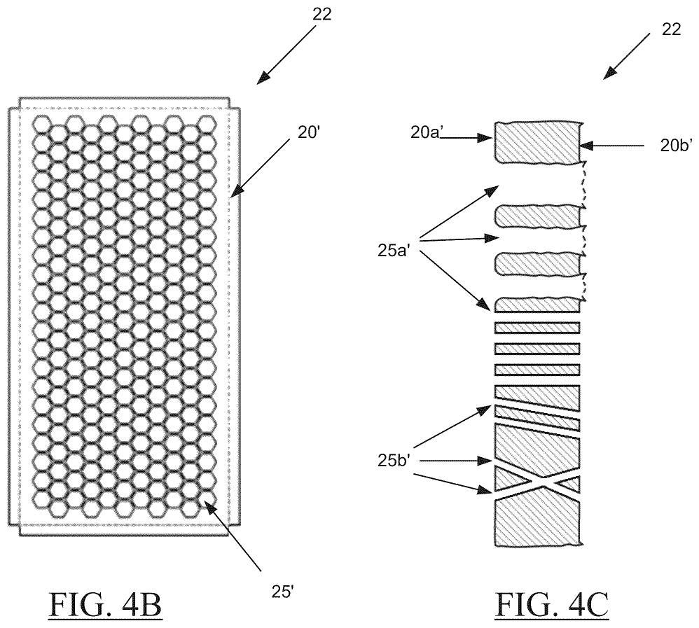

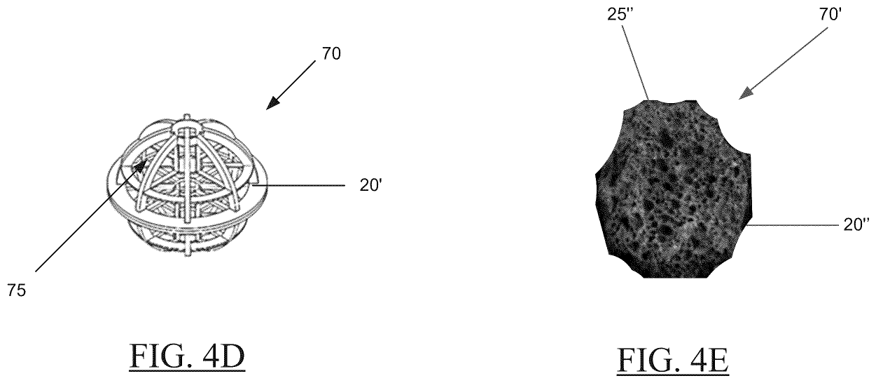

FIG. 4A depicts one exemplary embodiment of a roll 21 of material 20 for use in various antifouling systems. In this regard, in some embodiments, the material 20 may be formed into a roll 21, such as for ease of transport. In some embodiments, the material 20 may be sold separately and/or in addition to an antifouling device—such as may be useful for replacement of the material therein.

The illustrated material 20 includes multiple pores 25 formed into the material. In this regard, the pores 25 enable water (or other fluid) to pass through the pores, such as from a first side 20a to a second side 20b. The pores may be formed during manufacturing, which may occur during formation of the material (e.g., during weaving, fabrication, or other manufacturing technique) or after formation of the base material (e.g., through one or more cuts, perforations, elongation or stretching actions and/or other pore formation technique).

The material 20 can be utilized in a variety of ways to form components for the various antifouling systems disclosed herein. Desirably, the material can comprise a flexible fibrous material—in this case a fibrous material having a generally complex 3-dimensional structure—which can include natural and synthetic fabrics, natural and synthetic membranes, natural and synthetic sheets, and/or fabrics, membranes, films and sheets made from a combination of natural and synthetic materials. The material can be constructed from natural and/or artificial fibers using a variety of techniques known in the art, including but not limited to weaving, knitting, felting, non-woven manufacturing techniques and/or other structure construction known by those of skill in the art. Various embodiments of the disclosed antifouling systems can utilize components formed from readily available natural and/or synthetic materials, or combinations thereof, including (but not limited to) burlap, jute, canvas, wool, cellulosics, silk, cotton, hemp, linen, muslin, materials of the polymer classes of polyolefins (such as polyethylenes, ultra-high molecular weight polyethylenes, polypropylenes, copolymers, etc.), polyesters, polyethylenes, nylons, polyurethanes, rayons, polyamides, polyacrylics, and epoxies, combinations of polymers and copolymers, fiberglass compositions, staple nonwovens, melt-blown nonwovens, spunbond nonwovens, flashspun nonwovens and/or fiberglass nonwovens, permeable polymeric sheets, structures constructed from polymeric fibers or filaments, permeable films and membranes, knitted polyester or other structures, woven polyester or other structures, spun polyester or other structures, or various combinations thereof. Depending upon the particular material or material combinations used, the three-dimensional flexible material(s) may be formed into textile structures, permeable sheets and/or other configurations that provide a material capable of accomplishing the antifouling properties as described herein.

In some embodiments, the material may be a three-dimensional sheet material and/or fibrous material fashioned from interwoven and/or intertwined strands of thread formed into a lattice-like, mesh, mat or fenestrated arrangement, which in various embodiments may incorporate one or more flat, smooth, non-flat and/or non-smooth layer(s). In some embodiments, a plurality of horizontally positioned elements interwoven with a plurality of vertically positioned elements may be utilized (as well as various combinations of other fiber elements aligned in various directions), which can include multiple stacked, separated and/or interwoven layers. The flexible materials may include one or more spaced apart layers, which may include baffles or various interconnecting sections. Desirably, each yarn or other thread element(s) in the material will include a number of individual strands, with at least a portion of the strands extending outward from the thread core elements at various locations and/or directions, thereby creating a three-dimensional network of interwoven threads and thread strands in the material (which may include tortuous and/or non-tortuous pathways or pores through the fabric). In various embodiments, the various elements of the material may be arranged in virtually any orientation, including diagonally, or in a parallel fashion relative to each other, thereby forming right angles, or in virtually any other orientation, including three dimensional orientations and/or randomized distributions (e.g., felt matting) and/or patterns. In addition, while in some embodiments there may be a significant spacing between the individual elements, in other embodiments the spacing can be decreased to a much tighter pattern in order to form a tight pattern with little or no spacing in between individual strands or strand groupings. In various example embodiments, the elements, such as threads and/or fibers, may be made of natural or synthetic polymers, but could be made of other materials such as metals, nylons, cotton, or combinations thereof.

If desired, in some embodiments, the material may have a relatively complex three-dimensional structure formed by intertwined fibers or bundles of fibers (e.g., yarns). As used herein, “intertwined” can mean that the component fibers may be non-woven, woven, braided, knitted, felted, fused, interlaced or otherwise intermingled to produce a fibrous material capable of the various water flow and exchange features discussed herein. As well known in the art of fabric construction, the manner in which fibers are layered and/or intertwined can desirably create a pattern of open and closed spaces in the 3-dimensional flexible material, the open spaces therein defining interstices. Desirably, the fibers that may make up the flexible material are, for example, single filaments, bundles of multiple filaments, filaments of a natural or a synthetic composition, or a combination of natural and synthetic compositions. In various aspects of the invention, the fibers can have an average diameter (or “average filament diameter”) of: about 1.27 mm (50 mils) or less, about 0.635 mm (25 mils) or less, about 0.254 mm (10 mils) or less, about 6 mils or less, about 0.127 mm (5 mils) or less, about 0.1016 mm (4 mils) or less, about 0.0762 mm (3 mils) or less, about 0.0508 mm (2 mils) or less, about 0.0254 mm (1 mil) or less, about 0.0127 mm (0.5 mils) or less, about 0.01016 mm (0.4 mils) or less, about 0.00762 mm (0.3 mils) or less, about 0.00508 mm (0.2 mils) or less, or about 0.00254 mm (0.1 mils) or less.

In many embodiments, the fibrous material and/or flexible material may be highly ciliated, which means that the material can include tendrils or hair-like appendages (e.g., fibers) projecting from its surface or into the pores or open spaces in the 3-dimensional flexible structure that create a fibrous material. The tendrils or hair-like appendages may be a portion of or incorporated into the material that makes up the 3-dimensional flexible material. Alternatively, the tendrils or hair-like appendages may be formed from a separate composition adhered or attached to the flexible material. For example, the tendrils or hair-like appendages may be attached to and/or project from an adhesive layer, which itself may be attached to the surface of the flexible material. In aspects of the invention, the tendrils or hair-like appendages may project from the surface of the fibrous material, while in other aspects the tendrils or hair-like appendages may extend inward from the fibrous materials and/or inwards towards and/or into other threads and/or fibers of the material and/or structure. In various aspects of the invention, the tendrils or hair-like appendages may be resilient and/or may vibrate and/or sway due to enclosure and/or water movement. In various embodiments, the combination of the ciliation itself and/or the movement of the tendrils or hair-like appendages may also discourage the settlement of biofouling organisms on or in the surface of the material and/or the enclosure/cartridge wherein the material resides.

In various embodiments, a material suitable for use in an antifouling system could comprise one or more layers of a woven or knitted structure. For example, the woven fabric may have picks per cm (“ppcm”) or picks per inch (“ppi” or weft yarns per inch) of from about 1.18 to about 59.06 ppcm (about 3 to about 150, ppi), from about 1.97 to about 39.37 ppcm (about 5 to about 100, ppi), from about 3.94 to about 19.69 ppcm (about 10 to about 50, pp1), from about 5.91 to about 9.84 ppcm (about 15 to about 25 from ppi) from about 7.87 to about 15.75 ppcm (about 20 to about 40 ppi) and/or approximately 7.87 ppcm (approximately 20 ppi.). In other aspects of the invention, the woven fabric has ends per cm (epcm) or ends per inch (“epi” or warp yarns per inch) of from about 1.18 epcm to about 59.06 epcm (about 3 to about 150 epi), from about 1.97 epcm to about 39.37 epcm (about 5 to about 100, epi), from about 3.94 epcm to about 1.97 epcm (about 10 to about 50 epi), from about 5.91 epcm to about 9/84 epcm (about 15 to about 25 epi), from about 7.87 epcm to about 15.75 epcm (about 20 to about 40 epi) and/or approximately 7.87 epcm (about 20 epi) or approximately 9.45 epcm (approximately 24 epi). In still other various other aspects of the invention, a knitted fabric may have courses per cm (“cpcm”) or courses per inch (“cpi”) of from about 1.18 to about 47.24 cpcm (about 3 to about 120 cpi), from about 1.97 cpcm to about 39.37 epcm (about 5 to about 100 cpi), from about 3.94 cpcm to about 19.69 cpcm (about 10 to about 50 cpi), from about 5.91 cpcm to about 9/84 cpcm (about 15 to about 25 cpi), from about 7.87 cpcm to about 15.75 cpcm (about 20 to about 40 cpi) and/or approximately 14.17 cpcm (approximately 36 cpi) or approximately 14.57 cpcm (approximately 37 cpi). In even other aspects of the invention, the knitted fabric has wales per cm (“wpcm”) or wales per inch (“wpi”) of from about 1.18 to about 31.50 wpcm (about 3 to about 80, wpi), from about 1.97 to about 23.62 wpcm (about 5 to about 60 wpi), from about 3.94 wpcm to about 19/69 wpcm (about 10 to about 50, wpi), from about 5.91 wpcm to about 9.84 cpcm (about 15 to about 25 wpi), from about 7.87 wpcm to about 15.75 wpcm 20 to about 40 and/or approximately 14.17 wpcm (approximately 36 wpi) or approximately 14.57 wpcm (approximately 33.7 wpi).

Accordingly, in some embodiments, a woven structure may have a yarn size density (e.g., the weft multiplied by the warp yarns per unit area) of from about 1.4 to about 3488 per cm2 (about 9 to about 22,500 per in2), from about 15.5 to about 3100 per cm2 (about 100 to about 20,000, from per in2), from about 77.5 to about 2325 per cm2 (about 500 to about 15,000, from per in2), from about 155 to about 1550 per cm2 (about 1,000 to about 10,000, per in2), from about 388 to about 1240 per cm2 (about 2,500 to about 8,000, from per in2), from about 620 to about 930 per cm2 (about 4,000 to about 6,000, per in2), from about 388 to about 620 per cm2 (about 2,500 to about 4,000, in2), from about 775 to about 2325 per cm2 (about 5,000 to about 15,000, per in2), from about 1550 to about 3100 per cm2 (about 10,000 to about 20,000, per in2), from about 1240 to about 3875 per cm2 (about 8,000 to about 25,000, per in2), from about 3.1 to about 15.5 per cm2 (about 20 to about 100, per in2), form from about 4.7 to about 7.8 per cm2 (about 30 to about 50, per in2), about 7 per cm2 (about 45, per in2), or about 6.2 yarns per cm2 (about 40 yarns per square inch). In other aspects, the yarns of a woven or knit structure may have a size of from about 40 denier to 70 denier, about 40 denier to 100 denier, about 100 denier to about 3000 denier, about 500 to about 2500 denier, about 1000 to about 2250 denier, about 1100 denier, about 2150 denier, or about 2200 denier.

In some embodiments, a woven material made from Textured Yarn or Spun Polyester Yarn may be highly desirous for use in creating exemplary material sheets, spiral wound materials, elements and/or modules for the antifouling system, with the Spun Polyester Yarn optionally having a significant number of fiber ends that extend from the yarn at various locations (e.g., a relatively higher level of ciliation) and optionally in multiple directions, desirably leading to a relatively complex 3-dimensional macro-structure and/or more tortuous path(s) from the external to internal surfaces of the structure. In various embodiments, it may be desirable for portions of the material to incorporate openings having a tortuosity ratio greater than 1.25, while in other embodiments a tortuosity ratio greater than 1.5 for various openings in the material may be more desirable.

### Material—Exemplary Basis Weight

In one exemplary embodiment, a desirable spun polyester fiber based woven material can be utilized as a material within a replaceable cartridge, with the structure having a BASIS WEIGHT (weight of the base structure before any coating or modifications are included) of approximately 410 Grams/Meter² (See Table 1 below).

TABLE 1
Exemplary Structure Specifications

| Structure Name | 100% polyester woven canvas structure (loomstate) | |
|---|---|---|
| Content | 100 Polyester (virgin) | |
| Yarn Count | Warp | 10 s/4 |
| | Filing | 10 s/4 |
| Density | Warp | 7.87/cm ± 1 (or 20/inch ± 3) |
| | Filing | 7.87/cm ± 1 (or 20/inch ± 2) |
| Weight | 410 gsm ± 3% (12.09 OZ/sqy) | |
| Width | 162.56/165.1 cm (64/65″) | |
| | Overall | 157.48 cm (62″) |
| | Cuttable | 154.94 cm (61″) |

| | |
|---|---|
| Edge | Ultrasonic trim (Edge fused to prevent fraying) |
| Color | Natural white |
| Finishing | No finishing |
| Dyeing | Not dyed |
| Washing | Not washed |
| Roll Length | 100 Meters |
| Packing | Rolling with plastic bag inside and weave bag |
| | outside, 3-inch-high strength paper tube |

In at least one exemplary embodiment, a woven or knit structure may have a base weight per unit area from about 34 to about 814 g/m2 (about 1 to about 24 ounces per square yard (about 34 to about 814 g/m2), from about 34 to about 509 g/m2 (about 1 to about 15 ounces per square yard,), from about 68 to about 678 g/m2 (about 2 to about 20 ounces per square yard (about 68 to about 678 g/m2), from about 339 to about 542 g/m2 (about 10 to about 16 ounces per square yard ( ), about 339 to 407 g/m2 (about 542 g/m2), about 12 ounces per square yard (about 407 g/m2), or about 237 g/m2 (about 7 ounces per square yard (about 237 g/m2), or about 102 g/m2 (about 3 ounces per square yard).

In another more specific aspect of the present invention, a desirable spun polyester fiber based woven structure can be utilized as a material, with the material having a BASIS WEIGHT (weight of the base structure before any coating or colorants or other modifications may be included) of approximately 410 Grams/Meter2. Depending upon a variety of factors, one three-dimensional characteristic of some materials can include a material wall thickness which ranges from 0.0635 cm to 0.14605 cm (0.025 inches to 0.0575 inches) or greater, with some more desirable embodiments being approximately 0.05207 cm (0.0205 inches) thick, other embodiments being approximately 0.081026 cm (0.0319 inches) thick, still other embodiments being approximately 0.122428 cm (0.0482 inches) thick and/or others being approximately 0.145034 cm (0.0571 inches) thick.

Another example type of material is illustrated in FIG. 4B. FIG. 4B illustrates the material 20′ as metal formed into a sheet 22. With reference to FIGS. 4B-4C, the material 20′ includes one or more pores 25′ (e.g., fenestrations, holes, etc.) that, with reference to FIG. 4C, extend from a first side 20a′ to a second side 20b′. Notable, the pores can be formed in any direction with any shape or size. For example, first pores 25a′ are formed directly from the first side 20a′ to the second side 20b′ in a straight direction, whereas second pores 25b′ are formed from the first side 20a′ to the second side 20b′ at an angle relative to the length dimension of the sheet 22. In the illustrated embodiment, first pores 25a′ of the sheet 22 include a set of punched holes (for the top three holes), with a turn-in zone at the hole entry point (e.g., the bent entry), an irregular inner surface for the cutting zone (the first ⅓ of each hole) and the breakaway zone of the punch hole (last ⅔ of the hole), and a burr at the exit point for each punch hole. Punching metal sheet can be relatively inexpensive for high-speed/large scale processes and can create a larger surface area for the inner faces of the punched opening that may, for example, retain more coating, provide a more secure surface for the coating to adhere to, and/or otherwise provide more surface area for the sheet 22. Regarding the second pores 25b′, those holes are illustrated as being drilled or milled holes (or may be laser or plasma cut). Such holes may typically have a smoother inner surface and little debris or rough edges extending out of the hole. As illustrated, the top 4 holes of this type are first pores 25a′, extending directly from the first side 20a′ to the second side 20b′. The next 2 holes of that group are second pores 25b′ and are angled holes, and the bottom two holes are also second pores 25b′ and are bent in different directions where the holes cross (and communicate with each other) at their centers in the midpoint of the sheet 22. Accordingly, any type of hole or hole structure can be utilized in various embodiments herein.

FIG. 4D illustrates formation of a shaped structure 70 from the metal or other material 20′. Notably, the shaped structure 70 includes holes 75 for fluid to flow therethrough. The material 20′ may itself also have pores in some embodiments. Notably, the shaped structure may be formed into any shape, e.g., ball-shaped, sphere-shaped, cube-shaped, prism-shaped, etc.

FIG. 4E illustrates another example material 20″ in the form of an open cell porous structure, foam or rock. In the illustrated embodiment, the rock material 20″ is in the form of a rock-like structure 70′ (e.g., lava rock). The rock material 20″ desirably includes pores 25″ for fluid to pass therethrough.

As noted above, any other type of material is contemplated by various embodiments of the present invention, and the above described and illustrated types of material are provided for explanatory purposes.

### Example Coatings, Paints and Additives

In various embodiments, at least one coating (optionally comprising one or more additive ingredients and/or biocides, colorant, paint, gels, hydrogels, oils, and/or other substance(s) or additive(s)) may be added to or incorporated into the material, which may be applied to a surface of and/or otherwise incorporated into components of the material. In some embodiments, this may include integration into polymer blends, fibers, filaments, yarns and/or yarns bundles of the structure with any process commonly known to one skilled in the art, with the coating or paint or additive optionally comprising one or more biocidal and/or bio-toxic substances, where the additive or other substance can be released, dispensed and/or eluted into fluid flowing along or through the material and/or through the various pores or openings thereof.

In some embodiments, the coating may contain one or more water soluble and/or degradable resins or other degradable material which encapsulate one or more substances or additives. In such a coating, the resin or degradable material (e.g., Polylactic acid (PLA) or similar compounds) may encapsulate or otherwise contain the substance(s), and once the resin or material is contacted by water, the water can penetrate and break up the resin structure, allowing the contained substance(s) to be released into the environment. In another preferred embodiment, a degradable material, similar to a film or sheet material, may be impregnated with at least one substance, causing the substance to release when the material degrades. Such an arrangement could desirably provide a highly effective base or structure for controlled substance dosing of water or other fluid passing along and/or through the fibrous material, which may concurrently improve the mixing of the substance or additive with the water within the pores and/or other areas of the fibrous material and/or other areas of the protected environment (e.g., within the channel).

In various embodiments, the material and/or other components within an antifouling system may include and/or incorporate additives and/or compounds which may be impregnated, coated, covered, laminated and/or otherwise integrated into the underlying material(s) (hereinafter more broadly referred to as “coating” or “coated” materials). In various embodiments, such coatings could optionally include one or more substances which directly affect fouling organisms and/or render the material less susceptible and/or impervious to the effects of biofouling or other effects, such as coatings that might create surface conditions of low drag, low adhesion, differing wettability, various desirable micro-texture profiles, coatings that render the surface(s) more easily and/or effectively groomed or cleaned, coatings which include sloughing surfaces or planes, coatings which repel or attract various substances, coating that alter surface charges and/or charge interactions between surfaces and suspended substances or fouling organisms and and/or coatings which contain, release, dispense and/or elute a wide variety of chemical cues, secretions, biocidal substances and/or toxins. In at least one exemplary embodiment, one or more biocidal substances may be integrated or mixed into a coating and/or contained within the material which may interact with the water or other fluid to, for example, desirably inhibit the attachment, settling and/or growth of biofouling organisms within fluid streams or flows. In some cases, the additives (e.g., biocides or other substances) within the coating may directly affect spores, propulgates, larvae and/or juvenile forms of fouling organisms as they pass through and/or near the coated material and/or individual pores therein, where these organisms may be exposed to the chemical or compound which may inactivate and/or inhibit the organism's ability to attach, settle and/or grow within and/or on the pores of the material and/or on wetted surfaces in the fluid flow. In some embodiments, the chemical or compound may remain attached to and/or embedded within the coating, while in other embodiment the additive may release, dispense, elute and/or be otherwise dispensed into the fluid streams passing along the material surface and/or through the pores.

In some embodiments, the material may include a topography that is designed to hold onto and/or control release of the coating and/or additive—thereby leading to desirable usage life of the resultant antifouling system. For example, in some embodiments, a three-dimensional aspect of the material may aid in retaining of the coating and/or additive, some such three-dimensional aspects of the material being described herein.

In various embodiments, a material having a plurality of pores extending therethrough can incorporate or contain a coating or paint having at least one chemical or compound contained therein, which may optionally be at least one biocidal or toxic agent or other additive. In various embodiments, at least some of the pores of the material may remain permeable subsequent to the coating and/or application process. Additionally or alternatively, in some embodiments, one or more coatings may cover or at least partially cover the pores. However, the pores may be opened later, making the material permeable. This may occur after the coating phase, such as during manufacturing and/or once water (or other fluid) is introduced to the material (such as after deployment of the material with the antifouling system). In some embodiments, a coating can be applied to at least one surface of the material, with some portion of the coating passing into and/or or through the pores, while other embodiments can include coatings on a single side or both opposing surfaces of the material.

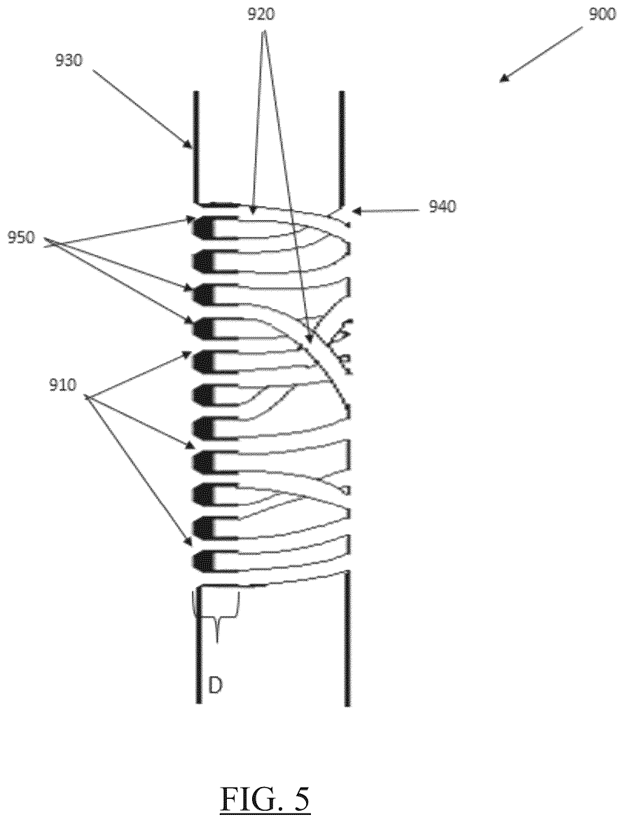

FIG. 5 depicts a cross-sectional view of an example material 900 with various pores or other openings 910, 920 extending from a front face 930 to a back face 940 of the material 900. A coating 950 or other additive substance is shown, wherein some portions of this coating substance extends from the front face 930 at least some distance “D” into the pores or other openings 910, 920 of the material 900. In various embodiments, the coating substance(s) desirably penetrates some average distance “D” into the structure of the material and/or structure wall openings/pores (e.g., a 3%, 5%, 10%, 15%, 20%, 25%, 50%, 75% or greater depth of penetration into the material). Various sizes of pores are contemplated herein. In an example embodiment, the coating extends into the pores such that the plurality of pores have an average pre-coating minimum pore opening of at least 25 micrometers and an average post-coating minimum pore opening between 75 and 25 micrometers (e.g., an increase in average pore size after coating). In other embodiments, the average pre-coating minimum pore opening may be at least 25 micrometers and an average post-coating minimum pore opening of 25 micrometers or less (e.g., a decrease in average pore size after coating). In still other embodiments, the average pre-coating minimum pore opening may be at least 25 micrometers and an average post-coating minimum pore opening may be approximately 25 micrometers (e.g., maintenance of an average pore size before and after coating).

Desirably, the coating substance, which may be “stiffer” or more flexible in a dried configuration than the material to which is it applied, can desirably be applied in such a manner so as to allow the material to be bent and/or molded to some desired degree (e.g., the coating will desirably not appreciably or severely “stiffen” the material to an unworkable degree for fabrication or ease-of-use by customers, such as for rolling into a spiral wound material), allowing the material to be formed into a desired shape and/or to be wrapped (e.g., into roll form, into a use configuration, or otherwise). In various embodiments, the coating penetration depth may average no more than half of the depth through a sheet of permeable material. In the disclosed embodiment, the coating of a single surface of the material with some amount of coating extending into the pores but not fully coating the opposing side desirably allows the coated material to be easily bent and/or formed into a desired spiral shape (e.g., allowing flexion and/or contraction of the underlying material) without unacceptably damaging, cracking and/or compromising the coating layer (e.g., such as by causing portions of the coating to separate and/or fall off of the material). Notably, however, any coating application configuration is contemplated.

For example, the material may be coated, painted and/or impregnated with a coating which desirably adheres to and/or penetrates the material to a desired depth, which could include surface coatings of the material on only one side of the material, as well as coatings that may penetrate from 1% to 99%, or 25%, or 50%, or 75% or 100% of the way through the material, as well as coatings that may fully penetrate through the material and/or coat some or all of the opposing side of the material), coat one side, coat two sides, or coat all sides of the material including coatings on both sides of the material which do not penetrate the pores to an appreciable degree and/or which do not fully extend through the pores from each side of the material). In various alternative embodiments, the coating may penetrate up to 5% into the pores of the material (e.g., from one coated side and/or from both coated sides of the material, for all percentages described herein), up to 10% into the pores of the material, up to 15% into the pores of the material, up to 20% into the pores of the material, up to 25% into the pores of the material, up to 30% into the pores of the material, up to 35% into the pores of the material, up to 40% into the pores of the material, up to 45% into the pores of the material, up to 50% into the pores of the material, up to 55% into the pores of the material, up to 60% into the pores of the material, up to 65% into the pores of the material, up to 70% into the pores of the material, up to 75% into the pores of the material, up to 80% into the pores of the material, up to 85% into the pores of the material, up to 90% into the pores of the material, up to 95% into the pores of the material, up to 99% into the pores of the material, up to 100% of the way through the pores of the material and/or extend out of the pores onto the opposing surface of the material.

In at least one embodiment, the coating may be on or embedded within the material surface facing towards a surface or article that needs protection or on the surface opposite of the surface or article. In some embodiments, the coating or paint contains at least one or more (e.g., 2, 3, 4, 5, 6 or more) different additives or chemicals (including but not limited to optional biocides) and/or compounds that affect water chemistry, reduce biofouling and/or alter various natural biofilm accumulation. In various embodiments, the presence of the coating or paint along the 3-dimensional flow paths along and/or through the material and/or cartridge (e.g., as the microorganisms pass by the material and/or through the openings and/or pores of the material itself) desirably provides a larger surface area and proves more effective than a standard 2-dimensional “planar” antifouling paint coverage (e.g., a hard-planar coating) utilized on rigid, submerged surfaces in marine use today. In various aspects, especially where the material is highly fibrillated and/or ciliated, the coating on the disclosed materials can desirably provide a significantly higher “functional surface area” of the material for the coating to adhere to, which desirably increases the potential for antifouling efficacy as a larger fluid to coating surface can be obtained thereby and/or organisms may be more likely to be located near to and/or in contact with these small fibers (and the paint, coating or additive(s) resident thereupon or therein) as they pass through the antifouling device.

Because there can be an extremely large number of “pores” or other openings within a given area or volume of material, the effective surface area of the coated material within the water flow can be many times greater than that of an equivalent flat surface. In many instances, an amount of additive released or dispensed into a water flow through such porous material can be a factor of 1.1, 1.5, 2, 3, 4, 5, 6, 7, 8, 9, 10, 100, 1000 or more times greater than the amount released from an equivalently sized flat surface. Moreover, because any additive can be released directly into each of the myriad water streams passing through the material pores (optionally on a continuous basis), the distribution and effectiveness of continuous and/or localized concentrations of additive within the water stream are greatly enhanced as compared to bulk or periodic dosing from one or more individual locations along the water stream, which are highly localized in their effect and/or are quickly diluted by the bulk water flow. In addition, a flexible material can be manipulated (e.g., compressed and/or expanded) in a variety of ways to further enhance its utility in various environments (e.g., compressing and/or crumpling or “scrunching” a material, which may reduce its overall size but retain its larger effective surface area).

### Example Coating Application(S)

In various embodiments, a coating may be applied to the material, a supplemental element, a surface, an associated device, a portion of a reservoir and/or other areas separate from the material, the inside and/or outside of a housing or other component of the antifouling device itself and/or to other enclosure components after the antifouling device has been fully assembled and/or constructed, while in other embodiments the coating may be applied to some or all the material and/or components of the antifouling device prior to assembly and/or construction. In still other embodiments, some components of the antifouling device could be pre-coated and/or pretreated, while other portions could be coated after assembly. Moreover, where processing and/or treatment steps during the manufacture and/or assembly may involve techniques that may negatively affect the quality and/or performance of the biocide or other coating characteristics, it may be desirous to perform those processing and/or treatment steps to the antifouling device and/or related components prior to application of the coating thereof. For example, where a heat sensitive additive and/or chemical may be desired, material processing techniques involving elevated temperatures might be employed to create and/or process the material walls before application of the coating thereof (e.g., to reduce the opportunity for heat-related degradation of the additive and/or coating).

In various embodiments, a coating material or other additive (including an optional biocide coating or other material) may be applied to and/or incorporated into the material, potentially resulting in an altered level of permeability of the material, which might convert a material that may be less suitable for protecting a surface from biofouling to one that is more desirable for protecting a surface from biofouling once in a coated condition. For example, an uncoated polyester material, which experimentally demonstrates a relatively high permeability to liquids (e.g., 150 mL of a liquid passed through a test structure in less than 50 seconds), may be particularly useful when coated to a desired level with a coating to a moderately permeable level (e.g., 100 mL of a liquid passed through a test structure in between 50 to 80 seconds) and/or a very low permeability level (e.g., little to no liquid passed through the test structure). In this manner, using one or more coatings, a deliberate permeability level can optionally be manufactured and/or “dialed into” or tuned for a particular application via manufacturing techniques.

A coating containing one or more chemicals or additives may be applied to a material in a multitude of ways, including by adding the coating to one or both sides of a material with the coated material subsequently placed in the antifouling device (e.g., in the use configuration), injecting the coating within the antifouling device, extruding a coating onto a one or more surfaces of the antifouling device, submerging the antifouling device and/or surfaces thereof within a coating bath, or other coating techniques well known in the art.

In some embodiments, the coating application process may optionally include the employment of an “air knife” or similar pressurized air/blower-based techniques that create an air velocity impulse or impact directly onto the surface of the material to desirably shear away unwanted coating and/or particulates without causing direct mechanical contact to the material. In still other embodiments, the coating application process can optionally include the application of a suction or vacuum to one or both surfaces of the material or portions thereof (including application to either the coated surface, the uncoated surface and/or both surfaces), such as a bottom surface of the material, which desirably can draw some portion of the coating into the pores and/or out of the pores while desirably maintaining patency (e.g., an “open” condition) of at least some of the pore openings through the material (e.g., the coating desirably will not close or “clog” a portion and/or majority of the pores through the material after application thereto). Desirably, these coating application processes can induce or force varying amount of the coatings into the various pores and/or openings within the material, including optionally between the individual constituent fibers of the fabric threads themselves.

In one exemplary embodiment, a dual-sided coating can be created on a material by coating a first side of the material and then utilizing a vacuum to draw a portion of the coating through pores and/or openings in the material to the second side of the material. If desired, the second side coating may only be a partial surface coating and/or may comprise a full thickness coating of the second side, and in some embodiments the second side coating may have a different thickness than a thickness of the first side coating, such as in an embodiment where the second side coating may be thinner than the first side coating. Use of such a vacuum forming process can also facilitate permeability of the coated material. In various embodiments, coating of the second side of the material (e.g., “driving” the coating to the underside of the material) can be one preferred manufacturing technique of coated materials for use in a pleated use configuration and/or for sensor covers and the like.

Other methods of inserting and/or applying a coating or anti-fouling agent, such as the use of spray-on applications as known to one of skill in the coating art, are also contemplated herein. Additionally, the material and/or cartridge need not necessarily contain individual fibrous materials, but may instead be made of fibers and/or contain a perforated and/or pliable sheet which contain an agent embedded therein and/or coated on the material.

The material may be coated with any amount of coating. In some embodiments, the material may exhibit an add-on after application of the coating. Example add-on weights for the paint/coating include: approximately 5 grams/meter² to 500 grams/meter², from about 5 grams/meter² to about 50 grams/meter², from about 10 grams/meter² to about 40 grams/meter², from about 15 grams/meter² to about 30 grams/meter², from about 50 grams/meter² to 480 grams/meter², from about 100 grams/meter² to 300 grams/meter², from about 400 grams/meter² to 420 grams/meter², from about 120 grams/meter² to 280 grams/meter², and/or a range of up to +10% of 224 grams/meter². In at least one exemplary embodiment, a material could include a fabric having a target add-on weight of a biocide component alone, which forms part of the coating, of from about 5 grams/meter² to about 50 grams/meter², from about 10 grams/meter² to about 40 grams/meter², from about 15 grams/meter² to about 30 grams/meter² and from about 20 grams/meter² to about 25 grams/meter² of biocide. In at least one exemplary embodiment, a preferred coating weight of 150 to 190 grams per square meter is provided.

### Example 1—Coated Material

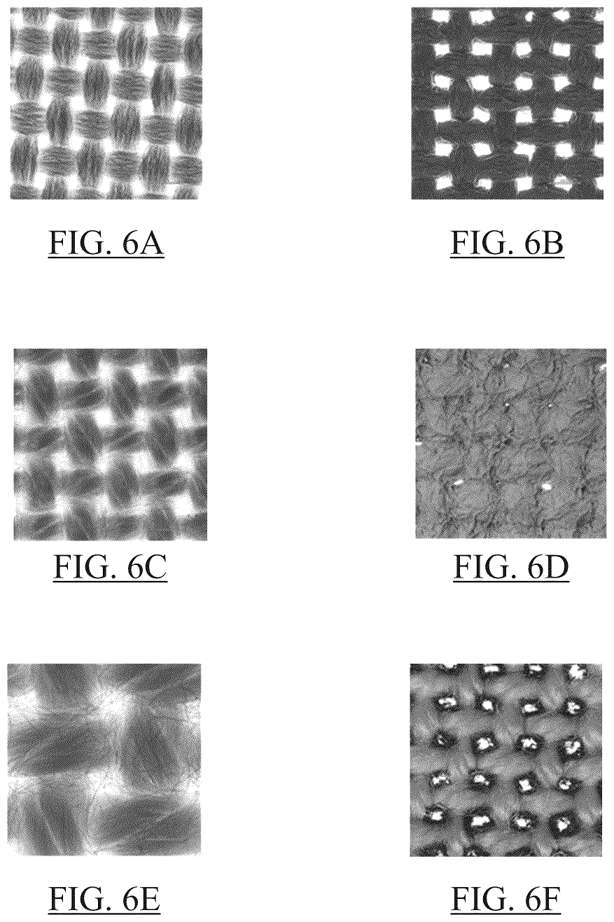

In various tests, different varieties of cloth were manufactured, coated and utilized in the construction and testing of a material-based antifouling system. In a first embodiment (shown in FIG. 6A with a scale bar of 1000 μm), a textured polyester cloth was coated with a coating containing an additive (in this embodiment, a biocide additive) on a first surface, with a significant amount of this coating penetrating completely through the cloth to the opposing second surface (with some areas of coating on the second surface being thicker and/or thinner than in other areas). FIG. 6B depicts this coated cloth at a bar scale of approximately 1000 μm. On average, this coated cloth had 81.17 (±0.36) pores/cm2 (523.54 (±2.33) pores/in²), with approximately less than 5 percent of the pores occluded (on average).

### Example 2—Coated Material

FIG. 6C depicts another preferred embodiment of a 100% spun polyester material, with FIG. 6D depicting this material coated with a coating. During testing, the uncoated 100% polyester material demonstrated a permeability of 10.17 ml/s/cm² of the material, while the coated poly materials had permeabilities of 0.32 ml/s/cm² and 1.08 ml/s/cm². After 23 days of immersion, the permeability for both coated materials were not significantly changed, with the uncoated poly material experiencing very minimal fouling and the coated poly materials experiencing virtually no macrofouling. In various other embodiments, however, other approaches to preparing spun polyester yarn, such as core-spinning staple fiber around a continuous core, open end spinning, ring spinning, and/or air jet spinning are believed to yield favorable results as well.

### Example 3—Coated Material

In an additional embodiment, an uncoated spun polyester cloth (shown in FIG. 6E with a scale bar of 500 μm) was coated with a coating on a first surface, with a significant amount of this coating penetrating partially through the fibers and/or pores of the cloth (in some embodiments, up to or exceeding 50% penetration through the cloth). FIG. 6F shows the opposing uncoated side of the material at 1000 μm (also depicting coating within the various pores of the material), with this figure also demonstrating the significant pore size reduction that can be accomplished using this coating technique, when desired. On average, this coated cloth had 76.43 (±0.55) pores/cm2 (493 (±3.53) pores/in²), with approximately 7 to 10 percent of the pores fully occluded by the coating material (on average).

### Coated Material—Test Results

Experimentally, all of these material embodiments demonstrated desirable levels of permeability and functionality when placed in a use configuration within an antifouling device, which performance may be due, at least in part, to the high number of small pores, the smaller size of the fibers, and or various combinations thereof. The various coating methods were very effective in coating and penetrating the material to a desired level and produced a highly effective additive for incorporation into a material for use in a cartridge or other component configuration.

### Combining Coated and Uncoated Materials

In some embodiments, it may be desirous to utilize a combination of coated and uncoated material in a single antifouling system, which might also include the periodic use of uncoated materials during certain immersion periods (e.g., fall or winter) when the fouling pressure may be such that unprotected surfaces could remain free of macrofouling, with ultimate replacement with coated materials when the fouling pressures may increase (e.g., spring or summer).

Coatings that Convey Information

In some embodiments, the use of various printing processes for the application of coatings on/in the material could have an optional benefit of allowing the incorporation of visible patterns and/or logos into and/or on the antifouling system components, which could include marketing and/or advertising materials to identify the source of the system (e.g., system manufacturer) as well as identification of one or more users (e.g., a particular marina and/or boat owner/boat name) and/or identification of the anticipated use area and/or conditions (e.g., “salt water immersion only” or “use only in Jacksonville Harbor” or “summer use only”). If desired, various indicators could be incorporated to identify the age and/or condition of the antifouling device or components thereof, including the printing of a “replace by” date on the outside of a replaceable cartridge and/or directly on the material therein, for example. If desired, the visible patterns could be printed using the biocide coating itself, which could incorporate supplemental pigments, inks and/or dyes into the coating mix, or the additional logos, etc. could be printed using a separate additive. In various alternative embodiments, the optional coating might not contain any biocide additives, but could be added to the material for various other reasons described herein, including as useful for identification and/or advertising purposes.

### Antifouling Devices

As detailed herein, various embodiments of the present invention provide antifouling systems that are designed to prevent, limit, and/or reduce biofouling within water flow systems and/or downstream systems (e.g., within the water (or other fluid) and on surfaces within the various systems (including the antifouling system itself)). As illustrated, for example, in FIG. 1, some example antifouling systems provide an antifouling device that is positionable within (or upstream or downstream of) a water flow system to provide conditioned water for the water flow system (or downstream thereof), where such conditioned water prevents, limits, and/or reduces biofouling within the water flow system (including the antifouling system) and/or downstream systems.

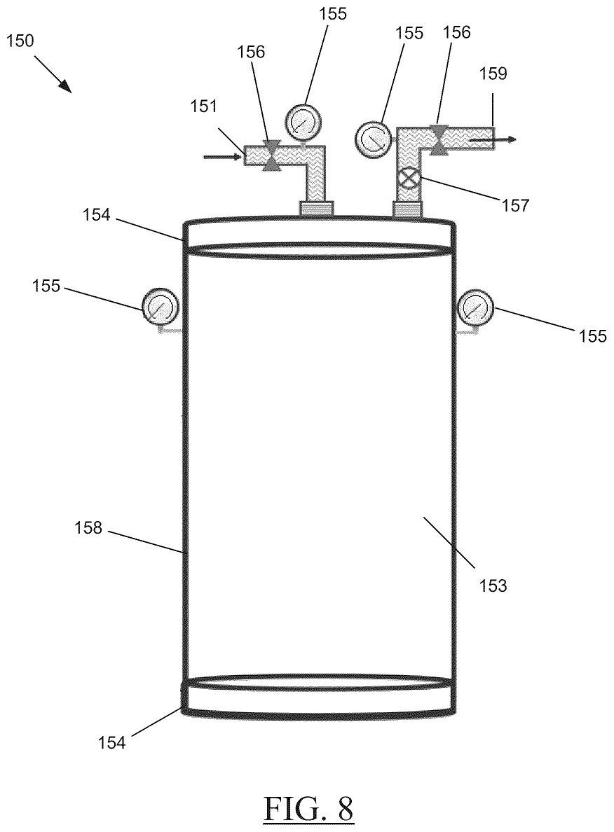

An example antifouling device 150 is illustrated in FIG. 8. The antifouling device 150 includes a housing 158 enclosing a defined volume 153 (although in some embodiments one or more components other than a housing may be used to form the defined volume, such as one or more walls, other enclosure features, etc.). The device also may include a variety of additional components, such as a removeable top and/or bottom 154, pressure gauges 155, valves 156 and flow sensors 157. Water (or other fluid) enters the defined volume 153 through an inlet 151 and exits through an outlet 159 (although, in some embodiments, multiple inlets and/or outlets may be used). Notably, the antifouling device 150 includes one or more structures contained therein in a use configuration, where the one or more structures are formed of various material—such as various types of material described herein. In this regard, by positioning the one or more structures within the defined volume 153, the water interacts with the one or more structures on its way to the outlet, and during that time (e.g., the “dwell time”), the water forms conditioned water—thereby providing antifouling protection for downstream systems (such as described herein).

Notably, the defined volume 153 is shown empty in FIG. 8 because various embodiments of the present invention contemplate many different “use configurations” of structure(s) that could be positioned therein to provide the desirable antifouling protection. Some example “use configurations” are further described herein. As an introduction, some example “use configurations” include forming the material into one or more spirals (e.g., single spiral, double spiral, etc.) for positioning inside the defined volume; forming the material into a plurality of strips or other shaped structures that are positioned within the defined volume; forming the material into one or more loose structures (e.g., shaped structures, other-shaped structures, rock-like structures, etc.) that are positioned within the defined volume in a loose manner; forming the material into one or more blade-like structures that are positioned within the defined volume; among many other configurations. Notably, the material may be any type of material, may be flexible or rigid, along with many other variations. In many embodiments, the material will comprise one or more pores or holes to enable fluid flow therethrough.

In some embodiments, the use configurations commonly create one or more features that aid in providing the antifouling protection. In this regard, positioning of the one or more structures arranged in the use configuration within the defined volume creates a plurality of flow paths leading from the inlet to the outlet. For example, one or more channels or first pathways may be formed by walls or sides of the material, while one or more second pathways may be formed through the walls of the material (e.g., through the pores or holes therein). The water thus intermixes as it travels along any or all of the plurality of pathways. This aids in formation of the conditioned water prior to the water exiting through the outlet.

Another common feature created by the use configurations is providing for increased contact surface area within the defined volume. In this regard, without the one or more structures so arranged inside the defined volume, there is a shortened path from the inlet to the outlet such that little contact surface area (e.g., relative contact surface area between the water and a surface) may be required for water to pass to the outlet. Instead, with the introduction of one or more structure(s) arranged in a use configuration within the defined volume, the plurality of flow paths divide up the defined volume so as to increase a ratio of a contact surface area of the one or more structures with the water when compared to contact surface area of water flowing freely through the defined volume (e.g., without one or more structures positioned therein). Likewise, this provides an increased “dwell time” of the water within the defined volume and interacting with the one or more structures in the use configuration. Accordingly, the water experiences the beneficial effects of the antifouling device to form conditioned water.

In some embodiments, the design of the use configuration can include the provision of a plurality of flow paths within and/or through the defined volume such as, for example, a first flow path through openings and/or pores of a permeable material within the defined volume (e.g., sometimes referred to herein as “trans-pore” flow) and a second flow path which passes over and along, but not through, the permeable material within the defined volume. In some embodiments, the flow of water through the plurality of flow paths may be described as laminar flow with micro-surface turbulence along and/or through the material. In some optional embodiments, the use configuration can be designed such that a ratio of water flow along the first and second flow paths in a given defined volume at a first water flow rate can be different than a ratio of water flow along the first and second flow paths in the same defined volume at a second water flow rate. For example, water flowing through a use configuration in a defined volume at a relatively lower flow rate may be more likely to pass through the permeable material than via a passage along or around, but not through, the permeable material, while water flowing through the same use configuration in the defined volume at a relatively higher flow rate may be more likely to pass along or around the permeable material as compared to the amount of water passing through the permeable material. It should also be understood that the individual molecules of water within the water flow may utilize various combinations of the disclosed flow paths during their passage through the defined volume, such as a water molecule which first passes through a wall of the material, and then travels along a channel, and then again passes through a different location in a wall of the material, etc.

In some embodiments, such as described herein, one or more coatings (e.g., biocide, other additives, etc.) may be applied to and/or embedded within the material (or portions thereof) used to form the one or more structures arranged in the use configuration. In such embodiments, the water entering the defined volume and interacting with the one or more structures will be exposed to the coating—which aids in forming the conditioned water.

In many instances, the inclusion of one or more coatings or other additives (and/or optional biocides) to the material can significantly affect water contact with and/or dosing efficiency into the water flow within the defined volume. When a bulk water flow enters the defined volume and contacts the material, this flow is “broken” or fragmented into numerous individual streams of water which pass through openings, pores and/or gaps in the material (including between the individual threads of the material weave) as well as other streams that pass along the interwall channel along the tortuous path between the walls of the material and/or other structures within the antifouling device. Such individual streams of water may desirably pass by the individual threads of the material, with many of the threads having a coating or additive which may be released into the water flow. These streams of water and the eluants therein will continue passing through the material and/or may rejoin the channel flow, wherein these different flows may desirably mix, agitate and distribute the water and eluants throughout the various water streams to varying degrees. Once past the material, the water streams will have recombined into a bulk flow or stream of “treated” water, which may have created a desired chemistry difference within the water and/or where fouling organisms within the water stream may have been affected by the eluant and/or water chemistry changes during and/or after their passage through and/or along the material.

Another significant advantage provided by various features of the present invention relates to the construction and arrangement of the individual fibers of the disclosed permeable materials, which grant the use configuration an improved ability to create turbulent flow micro-vortices and “mix” and/or otherwise agitate environmental water within the pores, apertures, voids and/or various openings in the material, as well as along the various surfaces of the material. This mixing effect can greatly enhance the homogeneity and/or uniformity of the water within and/or after passing through the material and/or within the defined volume.

In some embodiments, such as where a coating is provided, this mixing effect can greatly enhance the effectiveness of the released eluant, in that the concentration of an eluant may be greatest in water proximate to the pore walls, but this eluant can be efficiently mixed into the water stream even before the water leaves the walls. Such an arrangement can ensure adequate dosing of eluant to fouling organisms proximate to the pore walls, and also ensures sufficient eluant contact with other fouling organisms in the water stream, even at much lower overall concentrations. In this manner, the individual stream dosing accomplished by the material in the disclosed antifouling systems represents a significant improvement over existing chemical treatment systems currently in use.

In various embodiments, features of the disclosed embodiments can (1) desirably increase surface contact time and/or surface area between the material and the water flow, (2) control and/or alter the volume and/or rate of water flow and/or dwell time of water within certain regions of the treated environment, (3) can include system components that act as flow restrictors, nodes and/or flow directors, and/or (4) can include components that induce mixing and/or laminar/non-laminar flows of fluid within the water flow systems, including within, around, along past and/or tangential to the material itself and/or within or between individual pores of the material (including turbulent flows, laminar flows and/or various combinations thereof).

In some embodiments, where a water flow rate within the system may vary significantly over time or pursuant to other requirements, a desirable antifouling system might provide a maximum effectiveness during periods of stagnant or low water flow (including, but not limited to, periods of non-operation, maintenance and/or standby operation of equipment containing surfaces to be protected, as well as improved antifouling protection to areas which typically experience reduced or quiescent flow such as backwater or deadhead locations), with the antifouling system possibly providing somewhat lesser levels of antifouling effectiveness during periods of higher water flow (which in many cases may be situations where less fouling naturally occurs due to the higher flow rates causing difficulty for the fouling organisms to settle or be retained on the targeted surface). In many instances, macrofouling and/or microfouling of surfaces can be aggravated when the flow rate of water through the antifouling system is slow, stopped or during intermittent operation. In such cases, it may be desirous for the antifouling system to be designed to provide maximum protection during such low flow or stop periods, where fouling effects may be maximized.

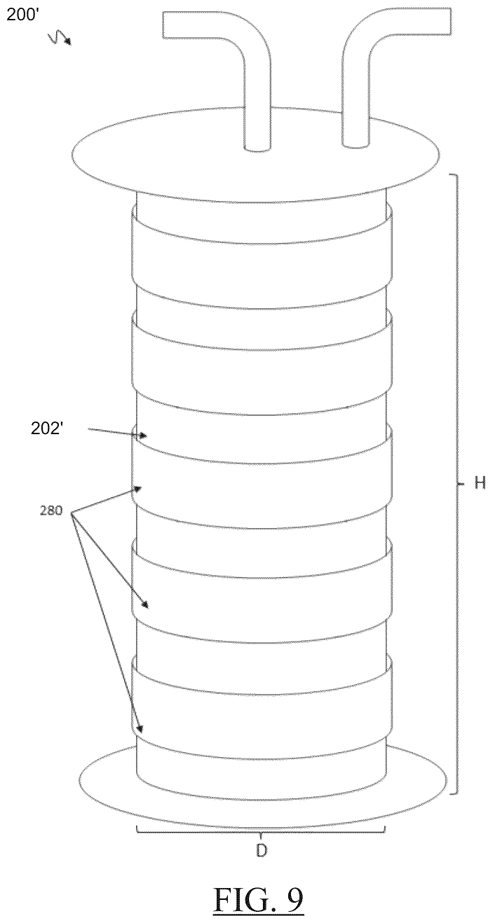

FIG. 9 depicts an exemplary antifouling device 200′. In the illustrated embodiment, the housing 202′ comprises a generally cylindrical tube or ducting of PVC having a 6 mm wall thickness (although any wall thickness is contemplated). The housing 202′ may be reinforced with one or more reinforcement features. In the illustrated embodiment, the housing 202′ is reinforced with a series of metallic pressure support rings 280 distributed along the length of the housing 202′. Depending upon the intended environment of use and/or anticipated system pressures, as well as the material and thickness the housing is constructed from, various reinforcement features (such as the pressure support rings) can optionally be added, such as to accommodate higher pressures and/or water flow rates/volumes in the system. In the disclosed embodiment, the employment of such support rings allowed a thinner walled (e.g., 6 mm thick) housing to be employed as an experimental test fixture, which resulted in significant savings in weight and mass/inertia for the 16″ diameter and 48″ height housing 202′. In this embodiment, the dry housing 202′ weight (including an example one or more structures in a use configuration of a spiral therein) was desirably between 40 and 65 pounds (inclusive), and more desirably approximately 55 pounds, wherein such weights and/or masses allowed a single individual to easily perform maintenance on the antifouling device. When filled with water or other fluids during system operation, the disclosed example antifouling device 202′ is anticipated to weigh approximately 350 pounds, so draining and/or dewatering of the housing and material prior to replacement (such as by using a drain valve near the bottom of the housing) may be desirable.

### Useful Life of Antifouling System(S)

In various embodiments, the antifouling system may include one or more replaceable parts, such as for maintenance purposes and/or to address changes in system requirements (e.g., seasonal differentials in fouling amounts and/or types). In this regard, in some embodiments, the antifouling device (or portion(s) thereof) may be replaceable. For example, some embodiments provide a replaceable canister (e.g., including a housing with the one or more structures positioned therein) or replaceable cartridge (e.g., an assembly that holds the one or more structures that are positioned within the defined volume, and which may not include a housing). The replaceable canister or cartridge may be quickly and easily replaced within the antifouling device to provide for altered and/or updated antifouling protection. As noted herein, the canister or cartridge includes one or more structures arranged in a use configuration, and, thus, by virtue of the replaceable canister or cartridge, the one or more structures in the use configuration may be easily replaced. This could include changing to a new use configuration and/or different structures (as will be apparent to one of ordinary skill in the art in view of this disclosure).

Depending upon a variety of operating conditions and/or volume requirements, an antifouling system may comprise a single replaceable canister/cartridge or the system may comprise multiple replaceable canisters/cartridges. In various embodiments, a desirable antifouling system design could include a plurality of replaceable canisters/cartridges that are individually removeable and/or replaceable to permit the antifouling system to maintain normal function for an indefinite period as a biofouling inhibitor, with the maximum flow capacity of the system intended to accommodate removal and/or isolation of at least one replaceable canister/cartridge without negatively impacting normal operation of the water system (e.g., to allow normal system operation to continue during a single canister/cartridge maintenance and/or repair).

Replacement of the parts of the antifouling system could be useful for providing a refresh of the one or more structures, and may aid in effectiveness of the antifouling system. In this regard, the one or more structures have shown incredible resiliency—in some cases, the effectiveness of the one or more structures arranged in the use configuration may decrease as time goes by (such as due to various environmental conditions, such as clogging, potential breakage, or other issues). In various embodiments, the amount of time until replaceable components lose their effectiveness can vary based on numerous factors, including the particular aquatic environment, the season, the temperature, the makeup of marine organisms present, temperature, light, salinity, wind, water speed, etc. It should be noted that, based on the conditions of the aquatic environment, the antifouling system may temporarily lose antifouling and/or environment creating effects, only to regain its antifouling/environment creating effect(s) when the conditions return to normal or to some desired measure. For example, the system components such as those described herein may be utilized to provide antifouling protection to a protected surface on a periodic basis, which may include an interruption of biofouling protection on occasions when water flow proximate to the protected surface may be increased, decreased and/or some other water flow changes may be desired (including cross-flow and/or reverse flow or “backwash” of fluid through a material), with biofouling protection potentially resuming at time periods where water flow proximate to the protected surface has resumed at a “normal” or desired level or direction (which may be the same or different from the pre-change water flow level).

In various embodiments, the term “useful life,” as used herein, can mean the amount of time from the deployment of the antifouling system (or wetting or other “activation” of a given replaceable canister/cartridge) to the time when a component may lose its effectiveness and allow or cause an undesirable level of macro-fouling to begin on the surface, while “system life” can mean the amount of time the antifouling system itself, or the various components thereof (which may include the useful life of the individual antifouling system components and well as the estimated system life in-toto where replaceable components of the antifouling system and/or other installed components are regularly cleaned, maintained and/or replaced on a periodic basis) remains physically intact and effective adjacent to and/or upstream from the surface itself (which may be exceeded by the “useful life” of the biofouling protection provided by the replaceable material or other antifouling system components in some embodiments). In various aspects of the present invention, one or both of the useful life and/or system life of antifouling system components and the overall system can be: not less than 3 days, not less than 7 days, not less than 15 days, not less than 30 days or 1 month, not less than 60 days or 2 months, not less than 90 days or three months, not less than 120 days or 4 months, not less than 150 days or 5 months, not less than 180 days or 6 months, not less than 270 days, not less than 1 year, not less than 1.5 years, not less than 2 years, not less than 3 years, not less than 4 years, or not less than 5 years and/or 5 years or more. Thus, it may be desirable to replace the canister/cartridge and/or other system components on a corresponding periodic maintenance basis to ensure continued optimal performance of the antifouling system. Such recommended periodic replacement may depend on the circumstances (e.g., water environment, flow rates, volumes, the season, among many other factors), and some example periodic replacement periods include biweekly, monthly, bimonthly, every 6 months, every year, among many other example periods.

In this regard, in some embodiments, an antifouling system desirably creates one or more conditions that prevent and/or inhibit a variety of fouling activities within the protected environment, such as by inducing the creation of antifouling biofilms or other conditions within the protected environment and/or inducing behavior of various organisms within the protected environment to inhibit the settlement, colonization and/or growth of fouling organisms on protected surfaces. For example, such inhibitory activities could include direct effects on the fouling organisms themselves (e.g., inhibiting colonization and/or growth or promoting detachment) as well as effects on organisms that may create and/or develop biofilms within the protected environment and/or on predatory organisms that may prey on fouling organisms within the protected environment. Such inhibitory effects may be permanent, durable and/or long lasting, or may be temporary for a desired period of time, such as for 1 or 2 seconds or less, for 5 seconds or less seconds, for 30 seconds or less, for 1 minute or less, for 5 minutes or less, for 10 minutes or less, for 30 minutes or less, for 1 hour or less, for 6 hours or less, for 12 hours or less, for 1 day or less, for 2 days or less, for 3 days or less, for 7 days or less, for 15 days or less, for 30 days or less, for 60 days or less, for 90 days or less, for 6 months or less, for 12 months or less or for other lengths of time within some or all of the protected environment or various portions thereof.

In some embodiments, the antifouling device with one or more structures in a use configuration are designed to provide sufficient protection from biofouling. Such biofouling protection can be measured in many different ways and various tests were performed, which are provided further herein and which easily illustrate significant benefits from some of the example embodiments. Notably, there may be many variables to consider when quantifying successful biofouling protection and this may vary depending on the circumstance. For example, various embodiments of the present invention may provide biofouling protection that equates to inhibiting biofouling (which may optionally include antifouling effects on all types of biofouling organisms for a given area as well as antifouling effects on one or more specific targeted fouling species) on a certain percentage of surface area of a defined surface area of a surface downstream of the antifouling device over a period of time. Such a test to see if the device performed properly and as expected could occur by defining a reduction of biofouling versus a control system over a same period of time and, in some cases, even at a same relative position within the water flow system. In some cases, the reduction in biofouling could be determined in the reverse, with the test looking for a percentage of biofouling coverage of the surface area (which is a standard testing being performed) For example, various embodiments of the present invention may show a reduction of biofouling with a percentage reduction of 1% up to 100% of a surface area of 1 square foot of surface over the course of 30 days, measured at a distance of, for example, 1 foot to 10 feet within the water flow system downstream of the antifouling system. Other example desirable reduction of biofouling coverage ranges include, for example, a reduction of 5% to 25% coverage, a reduction of 25% to 50% coverage, a reduction of 50%-100% coverage, a reduction of 75% to 100% coverage, a reduction of 85% to 100% coverage, among others. Likewise, other time periods are contemplated, such as 14 days, 20 days, 2 months, 3 months, 6 months, 1 year, etc. Similarly, other distances are contemplated, such as 10 cm downstream, 1 m downstream, 10 m downstream, 100 m downstream, etc. Further, in some embodiments, volume of water within the defined volume of the antifouling device and/or flow rate may also be factors.

In some embodiments, a test to see if the device performed properly and as expected could occur by weighing the material in the use configuration (e.g., the material alone and/or in canister or cartridge form) before and after usage, such usage occurring over a period of time, such as 30 days (although other time periods are contemplated, such as 1 week, 3 weeks, 1 month, 2 months, 3 months, etc.). Notably, a desirable use configuration will produce relatively little extra weight after usage (when dried out after the usage). Such weight percentage increase may be in the range of 0%-5%, for example (although other ranges are contemplated, such as 0%-10%, 0%-15%, etc.). Notably, not increasing in weight significantly illustrates that little biofouling and/or sediment buildup has occurred within the antifouling system during such usage.

Notably, the designed use configurations (such as those described herein) provide for beneficial and long lasting usage. In this regard, in various embodiments, there is little to no pressure differential across the defined volume (e.g., within the canister or cartridge), particularly over an extended period of time of use, such as weeks, months, or years. For example, pressure measurements at the inlet of the defined volume may experience between 0%-5% increase in pressure readings (although other ranges are contemplated) over the course of days (e.g., 1 day, 10 days, 30 days, 100 days, more than 100 days, etc.), weeks (e.g., 1 week, 2 weeks, 3 weeks, 10 weeks, 50 weeks, more than 50 weeks, etc.), or years (e.g., 1 year, 2 years, 5 years, more than 5 years, etc.). In some cases, the little to no pressure differential may be due to a lack of clogging or buildup within the use configuration. In some such cases, this can be achieved by ensuring that there is even flow distribution within the use configuration—which may be achieved by the specifically designed use configuration (such as provided by various embodiments described herein). Such even flow distribution, for example, can be seen by having few pockets of chemically altered flow (e.g., pockets of liquid with low oxygen or other chemical imbalances) through the use configuration. This leads to longer lasting useful life of the use configuration, and, can lead to an overall reduction in pump usage through various water flow systems—thereby reducing power usage and maintenance requirements.

### Permeable, Non-Permeable, Combination Elements

The various embodiments disclosed herein further contemplate a variety of different materials which may be utilized as components described herein, including the use of permeable materials, non-permeable materials and/or various combinations thereof in an insert for a canister or other element. In one exemplary embodiment, a canister might incorporate an insert or other structure comprising both permeable and non-permeable materials, one or both of which may be coated, non-coated and/or incorporate a biocide or other chemicals thereon/therein. For example, a first portion of a canister insert may incorporate non-permeable elements, while a second portion of the canister insert may incorporate permeable elements. Alternatively, an insert may include both permeable and non-permeable portions on the same sheet of material or within a single insert element. In other embodiments, a canister might include an insert primarily and/or solely comprising non-permeable and/or inflexible materials (e.g., a coated or uncoated metal or polymer sheet), which may optionally include embodiments where a large canister or reservoir volume provides for an extended residence time and/or dwell time for the treated water supply.

### Example Use Configuration—Spiral(S)

In various embodiments, construction of material utilized in the various embodiments or components described herein may include causing the material (or portions thereof) to form a use configuration that includes overlapping or passing over (e.g., adjacently laying or spaced apart therefrom) other material portions/sections so as to create a treatment surface, an enclosure, a bounded region and/or one or more channels and/or tortuous pathways within the defined volume of the antifouling device. Accordingly, in some embodiments, the material may be formed into one or more structures, such as one or more material sheets that are then laid in a use configuration. In some embodiments, the material sheet(s) (e.g., structure(s) of material) may form a spiral-shape (e.g., a use configuration) that is positionable within the defined volume of the antifouling device.

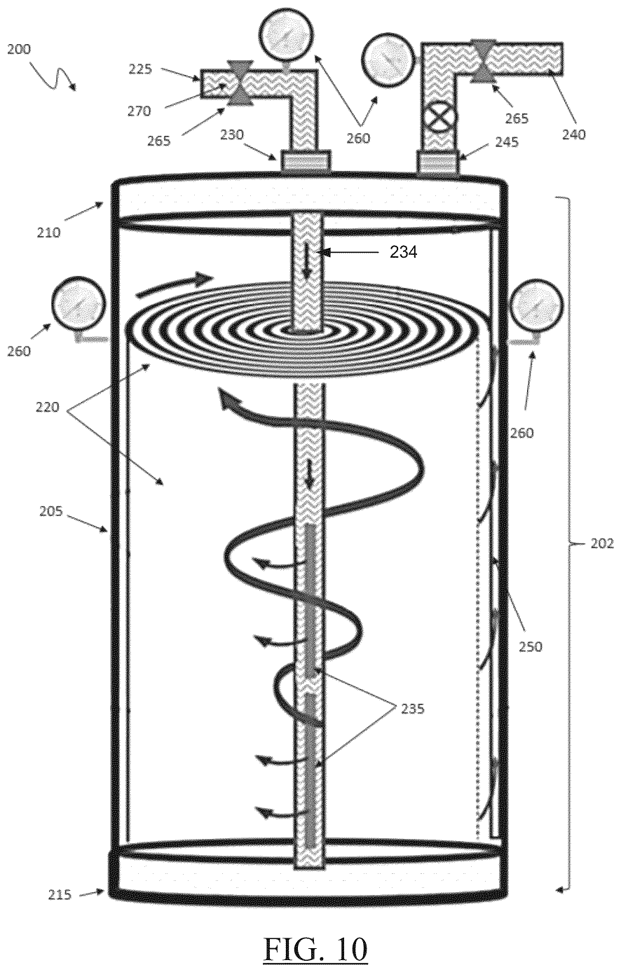

FIG. 10 depicts an example antifouling device 200 that includes an antifouling material, which in this embodiment is a length of a material positioned and secured in a spiral-wrapped configuration around a centrally positioned water inlet tube. Desirably, the disclosed antifouling device design incorporates a water inlet 225 which directs some portion of a water flow into the defined volume such that the water can follow a spiral (and/or similar shaped) path between the adjacent curved spiral walls of the material from the inlet 225 to an outlet 240 of the antifouling device. Notably, the material is or becomes permeable such that the material has one or more pores to enable fluid to pass therethrough. In the illustrated embodiment, the material is a fabric sheet with a plurality of pores. This arrangement and design of the use configuration of the material desirably permits a plurality of flow paths from the inlet 225 to the outlet 240. For example, a first flow path of water occurs along elongated channel(s) formed by the spiral fabric walls, and a second flow path of water occurs through the one or more pores in the three-dimensional walls of the permeable material.

As best seen in FIG. 10, the antifouling device 200 includes a housing 202 with a body 205 with a releasably sealed top 210 and a bottom 215. The material in the form of a flexible, permeable material sheet is formed into a spiral use configuration 220 and positioned within the housing 202. In some embodiments, such as the illustrated embodiment, the material sheet is coated, such as with a biocide (such as described herein). The spiral use configuration includes a 38.1 cm (15-inch) diameter, and the material sheet is approximately 9.75 meter (32 feet) in longitudinal length, although such height/diameter and/or material width/length may vary depending upon a variety of anticipated operating conditions and/or design constraints. An inlet 225 includes an inlet conduit 234 that passes through a coupling 230 in the top 210 and extends into a central region of the housing 202 (within the defined volume), the inlet conduit 234 has one or more vertical inlet openings 235 formed therein to allow water to flow out of the inlet conduit 234 and into the spiral passage formed by the material—which, in some exemplary embodiments, can comprise 1.27 cm (0.5 inch) wide by 25.4 cm (10-inch) long slots. In the illustrated embodiment, there are two inlet openings 235 positioned near a bottom of the body 205 such that the water or other fluid enters the material spiral near the bottom of the body 205. While a top of the spiral use configuration 220 is depicted in FIG. 10, it should be understood that in this embodiment the spiral wound material may extend fully to the top and bottom of the body 205 where the material can be secured and/or sealed to one or both of the top 210 and bottom 215 (or to a material frame structure extending to these areas). In some embodiments, one or more locking mechanisms may be provided to “lock” or “unlock” attachment of the spiral use configuration. The outlet 240 is attached through a coupling 245 in the top 210.

In the depicted embodiment, an outer wall of the spiral use configuration 220 can be spaced apart from the body 205 by a gap 250 of approximately 0.5 inches, although such spacing may vary depending upon a variety of operating conditions and/or design constraints. Various pressure gauges 260 and valves 265 can be provided to allow the antifouling system operation and performance to be fully monitored and to allow various antifouling system components to be isolated and/or taken “offline” and/or returned to operation during replacement of the canister and/or cartridge and/or other repair/maintenance. During operation, water 270 or other fluids may enter the inlet 225, pass along and/or through the spiral use configuration and ultimately pass out of the outlet 240 to a receiving tank or for other use in the water flow system (as described herein).

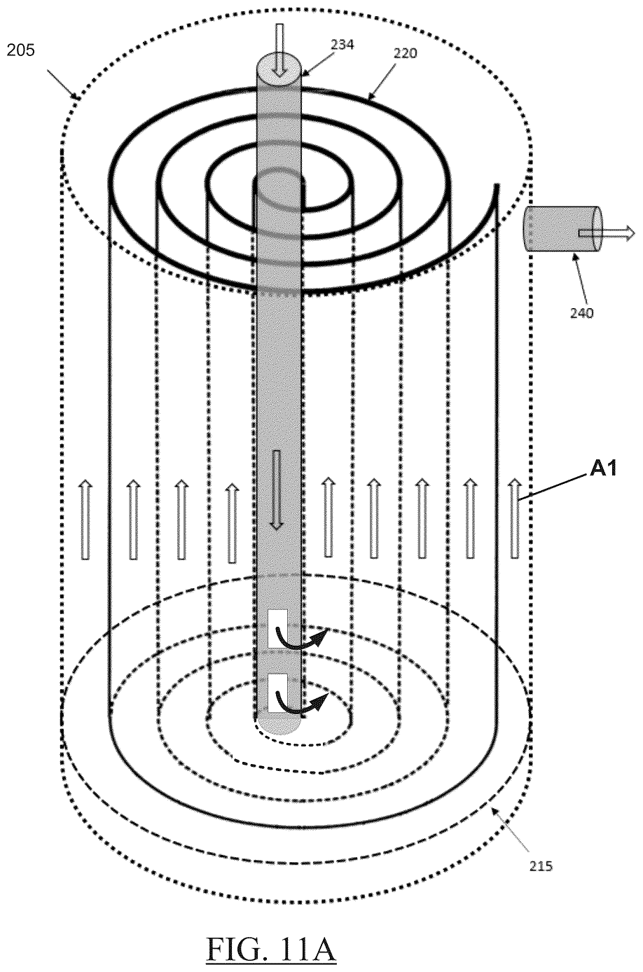

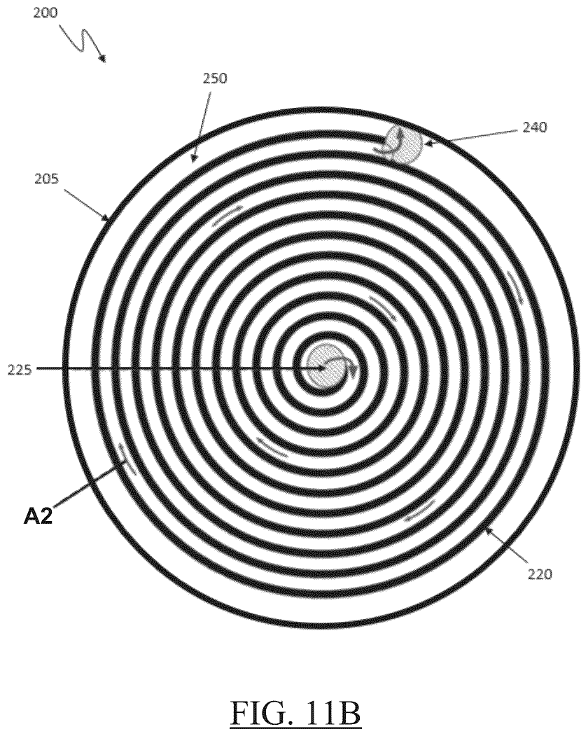

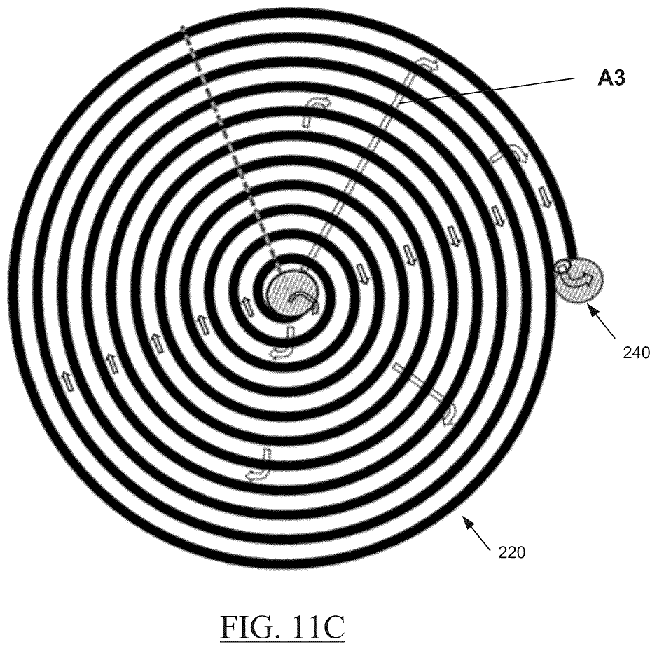

FIGS. 11A-C illustrate example water flow through the antifouling device 200 with the spiral use configuration 220 along various flow paths (notably, while FIGS. 11A-C may separately illustrate example flow paths, these flow paths may, for example, occur simultaneously in various use configurations, such as the spiral use configuration 220). FIG. 11A illustrates a perspective schematic view showing the spiral use configuration 220 of the material sheet. As illustrated, water may flow upwardly (e.g., along arrow A1) within the channels of the spiral use configuration 220 and toward the outlet 240. FIG. 11B illustrates a top schematic view showing the spiral use configuration 220 of the material sheet. As illustrated, water may flow in a spiral pattern (e.g., along arrow A2) within the channels of the spiral use configuration 220 and toward the outlet 240. FIG. 11C illustrates a top schematic view showing the spiral use configuration 220 of the material sheet. As illustrated, water may flow through the walls of the material sheet (e.g., along arrow A3) through the pores of the material of the spiral use configuration 220 and toward the outlet 240. Accordingly, the spiral use configuration provides a plurality of flow paths that encourage water to intermix within the defined volume.

It should be understood that the while the channel and through-wall flows are depicted in a simplified form in FIGS. 11A-C (e.g., by the channel arrows and the outwardly extending arrows), flow within the channels and/or through the material walls will be significantly more complex. For example, while the channel flow is shown as traveling generally along the spiral path from inlet to outlet, the individual water molecules with this flow path may travel in virtually any direction within the channel and/or along the materials walls, including transverse, angled, cross channel and/or opposite to the general travel path. Similarly, while passage of water molecules is shown as passing transverse through the material walls, the actual passages through the material, and the associated path of water molecules, are much more complex in 3 dimensions. Thus, a wide variety of complex paths within the walls of the material and/or along the interwall channels and/or combinations thereof are contemplated herein as well. It should also be understood that a bulk water flow in a vertical direction along the interwall spaces (e.g., from the lower inlet to the higher outlet) is anticipated in this embodiment, with the flow path of individual water molecules through and/or along the material spiral similarly following a very complex and somewhat random flow within the defined volume. Depending upon the operating pressure, operating conditions, system configurations and/or flow rate (among many other considerations), the trans-pore water flow paths may predominate in some situations, while the channel flow paths may predominate in others. Once the various components of the bulk water flow leave the material and approach the outlet, the water flow can then pass through the outlet and exit the antifouling device.

As will be described in more detail, the disclosed combination of trans-pore flow and channel flow in various disclosed embodiments contributes greatly to the performance and efficiency of the antifouling system, in that, in some embodiments, the trans-pore flow of water can significantly increase the availability and effectiveness of any substances or additives that may be present and/or released from the material, while the channel flow accommodates a wide variation in water flow rates through the cartridge with little or no pressure drop, and both flows also facilitate improved mixing and anti-clogging aspects of the system.

In the disclosed embodiment, the antifouling system provides an exemplary treatment exposure path of approximately 9.75 meters (32 feet) in a longitudinal direction along the spiral pathway of the spiral use configuration, which is a significant increase as compared a direct path from the inlet to the outlet without the spiral use configuration being positioned within the defined volume. In this current embodiment, the water flow through the depicted antifouling system is desirably initially directed along the longitudinal (e.g., horizontal) length of the curved spiral material, e.g., for a 9.75 meter (32-foot) length of the spiral material tested, the effective exposure length is assumed to be 9.75 meters (32 feet). Surprisingly, the elongated horizontal flow path in this embodiment did not create a considerable dynamic head pressure within the device, even under extremely high flow rate and pressure conditions. It is believed that the combination of the permeable flexible material and the spiral use configuration design allows the system to accommodate a wide variety of flow rates and/or pressures without compromising system effectiveness or desired antifouling operation.

The disclosed antifouling system design desirably operates at water flow and/or pressure levels that can optionally be adjusted on an as-needed basis to accommodate existing water supply requirements, such as at normal municipal water plant levels (e.g., less than 60 psi) or other existing system flow rates and/or pressures as required in the intended application or water system. The disclosed system components can be very compact in volume, size and footprint with regard to their output effectiveness, with various exemplary physical and operational characteristics provided in Tables 2 through 4. Exemplary flow dimensions and other operating parameters of the disclosed embodiment at 189.3 LPM (50 gal/min) are provided, which demonstrates that the material spiral within the device can operate twice as efficiently as Applicant's previously tested G1 crossflow design embodiments, which were still shown to provide significant antifouling protection during prior experiments. Where the antifouling system components have been designed to adequately manage hydraulic pressures, head, flow rates, etc., the depicted antifouling system embodiment is expected to have a capacity to treat at least 348.3 liters (92 gallons) of water flow per minute (for each unit).

TABLE 2
Cartridge Characteristics

| | Cartridge | | | | | | | | |
|---|---|---|---|---|---|---|---|---|---|
| | Nominal | | Fabric | Central | | Fabric + | | | |
| ID | Size | | Turns | Space | | Coating | | Spiral | |
| Number | Ht in × Dia | | number | Diameter | | Width | | Spacing | |
| G2 | 122 × 40.6 | cm | 14 | 60.3 | mm | 2 | mm | 9.525 | mm |
| G2 | 48 × 16 | in | 14 | 2.375 | in | 0.079 | in | 0.375 | in |

| | Spiral | | Spiral | | Spiral | | Spiral | | Total Area | |
|---|---|---|---|---|---|---|---|---|---|---|
| ID | Diameter | | Length | | Height | | Fabric | | Spiral Fabric | |
| Number | mm | | M | | M | | M²/side | | M² | |
| G2 | 383 | mm | 9.74 | M | 1.14 | M | 11.11 | M²/side | 22.22 | M² |
| G2 | 15 | in | 32 | ft | 55.1 | in | 119.9 | ft² | 239.2 | ft² |

TABLE 3
Flow Characteristics

Area of 2-inch inflow pipe 10-0.75 in dia outlets = 28.39 cm² (4.4 in²)
Area of 2-inch inflow pipe 6-1″ dia outlets = 30.32 cm² (4.7 in²)
Area of vertical spiral outflow = 109 cm² (16.9 in²)
Area of outer ring for upwards flow = 147.1 cm² (22.8 in²)
Area of 2-inch inflow pipe = 20.3 cm² (3.14 in²)
Area of 3-inch outflow pipe = 45.8 cm² (7.1 in²)
G2 at 50 gal/min in 4.5x exposure path of G1 prior design
G2 92 gal/min is optimally 8.35x exposure path of G1 prior design

For this experimental design, a Dynamic Exposure Turnover (DET) calculation (specific to G1 & G2 comparison—not generalized) and a Stochastic Flow Potential can be calculated as follows:

TABLE 4
G2:G1 DET Calculation
Dynamic Exposure Turnover (DET) = F/L = flow/length of treatment
Stochastic Flow Potential = F_{G1}/L_{G1}:x(F)_{G2}/L_{G2} =
350.8 liters/min (92.67 gal/min)

| | | | |
|---|---|---|---|
| Where: F_{G1} = | L_{G1} = 1.17 meter | F_{G2} = x(F)_{G2} | L_{G2} = 9.75 |
| 42 liters/min | (3.833 feet) | | meter (32 feet) |
| (11.1 gal/min) | | | |

| | |
|---|---|
| Calculated: | DET_{G1} = F_{G1}/L_{G1} = 2.90 |
| | DET_{G2} = 92.67_{G2}/L_{G2} = 2.896 |
| Projected for | DET_{G2} = 1.56 |
| 50 gal/min: | |
| | DET_{G1:G2} = 2.90/1.56 = 1.86 |
| | 189 liters/min or 50 gal/min = 54% of capacity |

Depending upon the size of pores in the material, as well as the shape, size and/or degree of tortuosity, a material wall of greater and/or lesser thicknesses than those specifically described herein may be utilized in various antifouling system designs with varying degrees of success and various materials. In various alternative embodiments, the flexible base materials, fibers and/or threads utilized in construction of the disclosed use configurations may have a wide variation in thickness and/or length depending on the desired surface to be protected or specific application. For example, in some aspects of the invention the thickness of the flexible material may be from about 0.00254 cm (0.001 inches) to about 1.27 cm (0.5 inches), from about 0.0127 cm (0.005 inches) to about 0.635 cm (0.25 inches), from about 0.0254 cm (0.01 inches) to about 0.254 cm (0.1 inches), about 0.0508 cm (0.02 inches), about 0.0762 cm (0.03 inches), about 0.1016 cm (0.04 inches), about 0.127 cm (0.05 inches), or about 0.1524 cm (0.06 inches). Accordingly, variations in thickness and/or in permeability within a material sheet are contemplated by various embodiments described herein (including in other use configurations described herein).

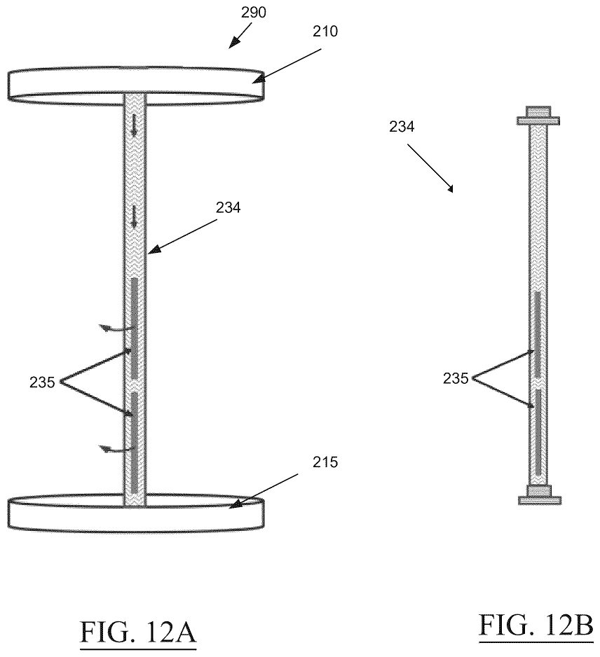

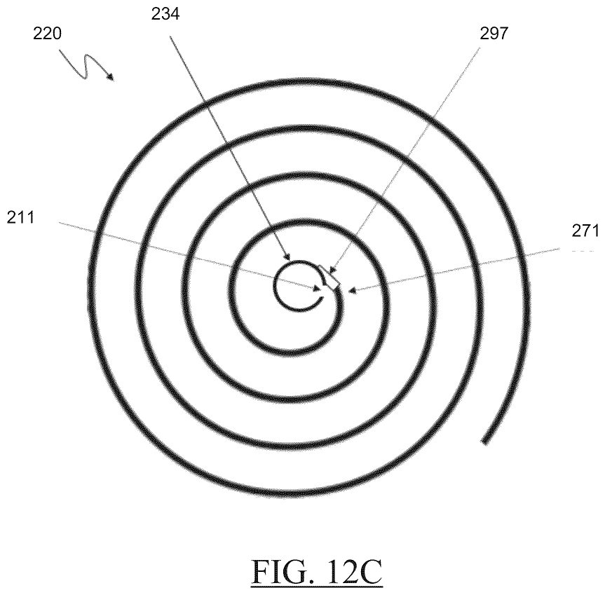

FIGS. 12A-B depict an exemplary frame structure 290 which incorporates a central inlet conduit 234, a top plate 210 and a bottom plate 215, wherein the frame structure 290 can support and secure the material sheet formed into the spiral use configuration 220 previously described. In the exemplary embodiment, the central inlet conduit 234 includes two or more openings 235 (in an exemplary embodiment, each slot may be 1.27 cm×25.4 cm or 0.5″×10″), and can further include a fin or stiffening element (see FIG. 12C) which extends across the openings and desirably redirects water flow leaving the openings as they enter the material spiral pathway. In the disclosed embodiment, the top and bottom of the material or fabric can be attached to the top and bottom plates, such as by an adhesive or epoxy resin or other physical attachment means, and a leading, inner edge of the material spiral (e.g., adjacent to the central inlet conduit openings) can be secured to the fin or stiffening element, such as by an adhesive, welding, crimping and/or direct physical attachment, such as by using a slot and spline design or similar arrangement. In at least one alternative embodiment, a similar stiffening element may optionally be provided on an outlet end of the spiral material, which would desirably stiffen this portion of the spiral material as it approaches the outer portions of the spiral and/or near the water outlet. If desired, such a support arrangement could facilitate backflushing and/or backflow of the spiral material for cleaning or other purposes, as this similar stiffening element would desirably prevent collapse and/or sealing of the spiral in a possible reverse flow situation. Alternatively, the trailing end of the material spiral may be left free, which may facilitate movement of that portion of the material and potentially facilitate flushing of sediments, etc.

As best seen in FIGS. 10 and 12A, the water inlet conduit 234 in this embodiment can incorporate a plurality of water inlet openings 235, which are depicted as positioned towards the bottom end of the inlet conduit 234. Desirably, these water inlet openings 235 guide water passing from the inlet conduit 234 out into the spiral material, with the elongated slotted openings directing a significant amount of the water flow outward from the inlet conduit in the vicinity of the lower half and/or bottom surface of the material (and into the spiral pathway). As best seen in FIG. 12C, a stiffening element 297 such as a thin plastic or metal beam member, can be attached to an inner vertical edge of the material (e.g., positioned at an inner edge of the spiral wound material) to desirably stiffen the material and/or connect the material to structures adjacent or part of the water inlet tube. In various embodiments, this stiffening element may be positioned such that a higher pressure/velocity water exiting from the water inlet opening(s) desirably initially contacts and/or is otherwise redirected by the stiffening element towards the channel or gap between the curved walls of the spiral material, which can assist with initiating the longitudinal/helical channel flow as well as sediment scouring and/or removal of sediments or fouling organisms from the lower surfaces of the cartridge, and also potentially minimizes water impact damage and/or degradation of the material due to the direct flow and momentum change of the higher pressure/velocity water exiting the inlet slots and contacting the flexible material surfaces. In one exemplary embodiment, the stiffening element could include a ridged extension portion which slides down a receiver track which is attached to and/or forms part of the inlet water tube (not shown). In the illustrated embodiment, the material 211 is secured at a leading edge 271 by the support structure or stiffening element 297, and also secured at upper and lower edges around the spiral shape by connection to the sealed top 210 and bottom 215, which structures are depicted in FIG. 12A If desired, the frame structure 290 (or portions thereof) when attached to the material sheet in the use configuration, may form a removable/replaceable cartridge which could be inserted into and/or removed from the device.

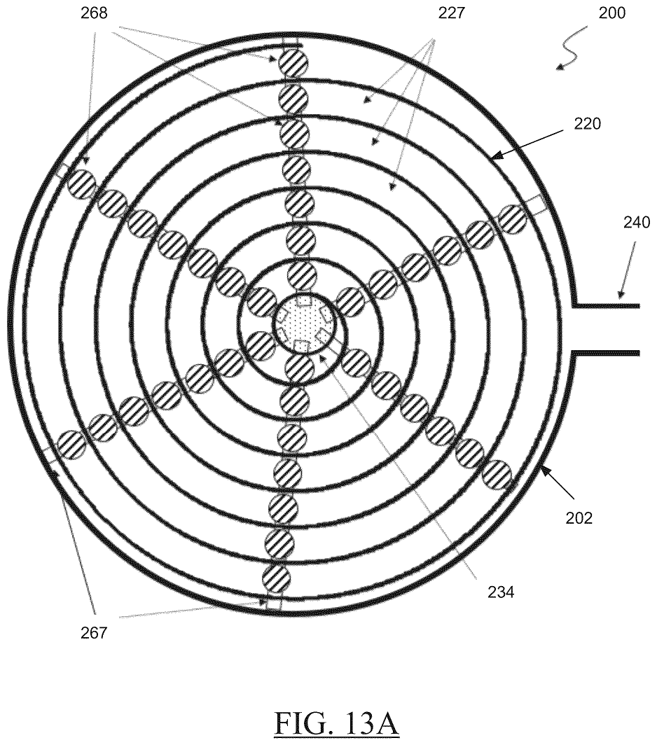

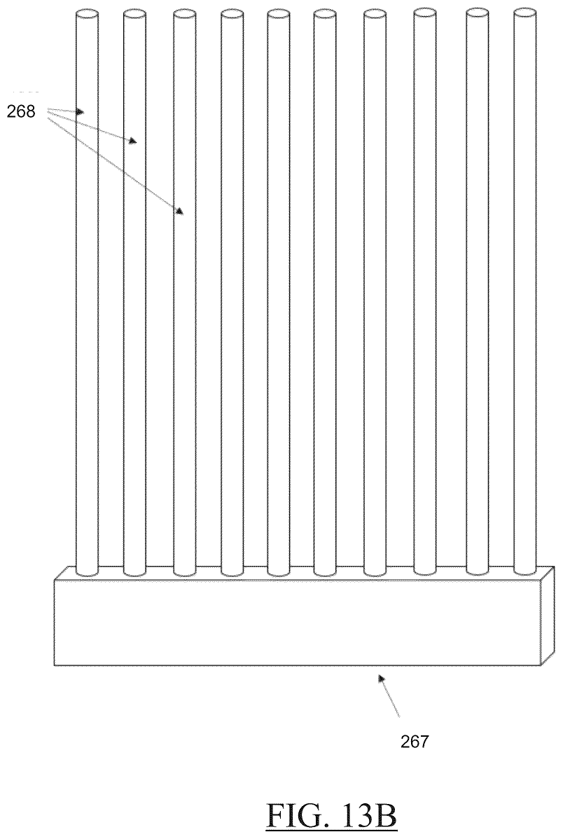

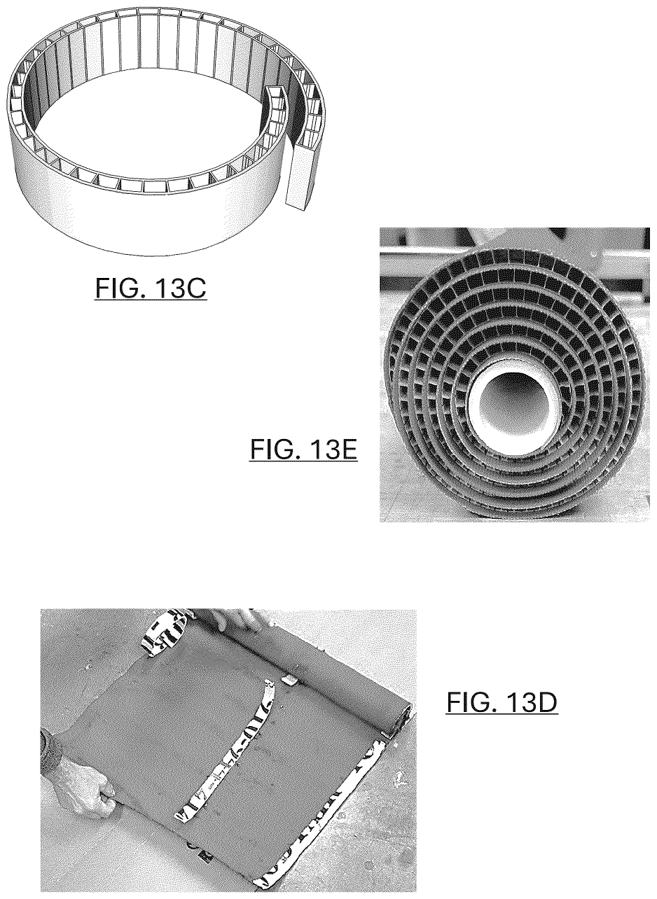

The material may be formed into (and/or kept in) the spiral use configuration in many different ways. In the illustrated embodiment of a single spiral design, the material sheet is rolled with spacing between adjacent spiral walls to form the spiral channels. If desired, spacers may be used to keep the channel spacing between the walls of material sheet. FIG. 13A illustrates a schematic cross-sectional view of the spiral use configuration 220 positioned within the housing 202 of the antifouling device 200. Notably, the spacing of the channels 227 between adjacent walls of the material sheet is kept by one or more spacers 268. The spacers 268 extend upwardly from a base 267 that extends underneath the spiral use configuration 220. The base 267 and spacers 268 are further illustrated in FIG. 13B. Notably, the spacers 268 aid in keeping appropriate separation between adjacent material sheet walls, but also allows water to pass therearound (such as through the channels 227), which may be accomplished by some slight space around the spacers and/or the flexible nature of the walls of the spiral use configuration 220. The illustrated embodiment includes multiple bases 267 that extend radially from the central inlet conduit 234 at different angles to provide adequate support for the material sheet for the spiral use configuration 220. Notably, any number of spacers or bases (or other similar features) may be used to aid in formation of the spiral use configuration. As noted above, the spacers 267 and bases 268 may remain attached to the spiral use configuration 220 such as to form a replaceable cartridge and/or part of a replaceable canister. FIG. 13C depicts an alternative spacer element comprising a corrugated plastic spacer strip, which can be installed in a spiral or other use configuration, such as in FIG. 13D. FIG. 13E depicts an end view of the spacer element in a spiral wound use configuration. If desired, the spacer or other elements could optionally be coated with a biocide or non-biocide coating, such as the various coatings described herein.

The material sheets may be spaced with minimal or no distance of spacing between each layer or a significant distance of spacing between each layer. In various embodiments, some layers may be in direct contact with one or more adjacent layers while in other embodiments, adjacent layers may be separated by spacing of 0.0254 cm ( 1/100 of an inch) or less, 0.0508 cm ( 1/50 of an inch) or less, 0.1016 cm ( 1/25 of an inch) or less, 0.254 cm ( 1/10 of an inch) or less, 0.635 cm (0.25 inches) or less, 1.27 cm (0.5 inches) or less, 2.54 cm (1 inch) or less, or greater separations. In some other embodiments, layers may be separated by larger distances such as 2.54 cm (1 inch) or more, 15.24 cm (6 inches) or more, 30.48 cm (1 foot) or more, 3.05 meters (10 feet) or more or 30.5 meters (100 feet) or more. If desired, some material sheets could be separated by a porous intermediate material or filler.

In one exemplary embodiment, a sheet of material 9.75 meters (32 feet) in length can be formed in an Archimedean spiral, where the inner diameter of the spiral is 2.54 cm (1″) and the outer diameter of the spiral is 38.1 cm (15″), with a spacing between each spiral winding of approximately 1.14 cm (0.45″) (e.g., forming a channel width of approximately 1.02 cm or 0.4″) and approximately 15.5 turnings (e.g., complete rotations about the spiral center) of the material around the spiral from leading to trailing edge of the material.

One exemplary method of forming the flexible material sheet into a spiral use configuration having a desired spacing can include the employment of a first temporary spacing mat and a second temporary spacing mat, each mat having a material thickness equal to or approximating a desired wall spacing, with these mats positioned along the upper and lower edges of the material sheet, and the entire material assembly rolled into a single unit. The material sheet can be rolled into the desired spiral design, with the temporary spacing mats used to maintain this initial spacing. Thereafter, the spacing mats can then be removed, and spacers introduced to maintain the wall spacing as desired. Alternatively, a heat settable bonding film or similar settable adhesive/epoxy spacing tape may be utilized in place of the spacing mats described herein, with the adhesive spacing tape desirably actuated to maintain the material in a spiral or other shape while concurrently adhering the material to the top and/or bottom of the surrounding frame structure.

In various embodiments disclosed herein, the material may be secured to and/or suspended by a wide variety of support structures and/or connection mechanisms. For example, portions of the material may be secured by a hook or compression tab or similar mechanical attachment to one or more structural locations, or edges or other portions of a material may be adhered or bonded onto or into one or more components of the antifouling device 200. In other embodiments, to provide a securing mechanism, the material and/or device components can include fastening elements, such as but not limited to loop and hook type fasteners, such as VELCRO®, snaps, buttons, clasps, clips, buttons, glue strips, epoxies, glues, taper or interference fit connections, compression fittings and sleeves and/or zippers.

In some embodiments, the material may include closeable and/or openable features such as twist lock arrangements, snap tops, Velcro or hook and loop fastener components, zippers, magnetic closures and/or cross-stitched features. Alternative connection means could include the use of adhesives, physicals connections (e.g., clamps or compression members) and/or potting materials, as known by those of skill in the art. In various embodiments, the stiffening element (which may be a thin plastic or metal beam member) could be attached to an edge of a material within the device to desirably stiffen the material and/or allow the material to be attached to other components. Other stiffening members may optionally be added to the material itself, or optionally may be clamped around the material at various locations, including at one or more ends and/or at various points along the length of the material, as desired. Various connection types could be utilized to connect one or more material sheets together or allow removal and replacement of material from the antifouling device.

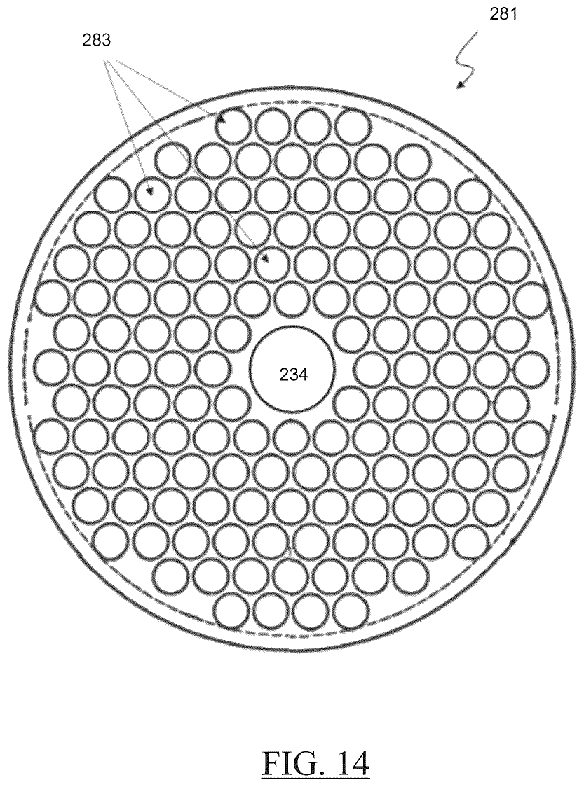

In some embodiments, additional water directing features may be employed. For example, FIG. 14 illustrates a perforated plate 281 that may be, for example, positioned at a lower end of the housing 202. In this example embodiment, the perforated plate 281 is positioned at the lower end of the material sheet arranged in the spiral use configuration 220, with the water inlet conduit 234 extending through the perforated plate 281 so as to supply inlet water to a void or opening below the perforated plate 281, which allows the water to diffuse radially across the bottom of the spiral use configuration 220 before entering the spiral use configuration 220 (e.g., through one of the perforation holes 283) before working its way through the plurality of flow paths and, ultimately, to the outlet (as described herein).

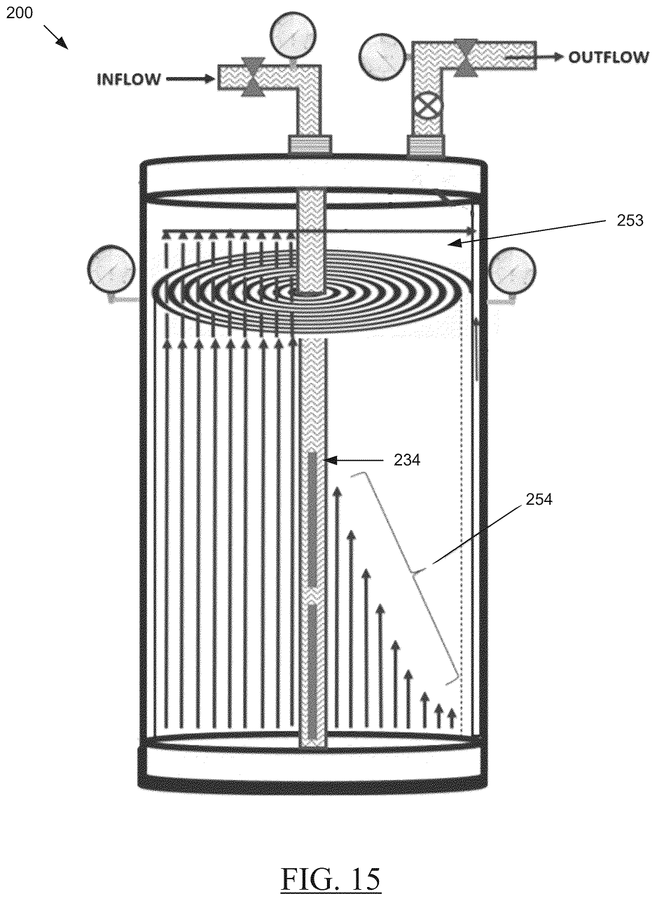

As best shown in FIG. 15, it may be highly desirable in some embodiments to fill the defined volume 253 of the antifouling device 200 slowly with fluid or water, which allows the fluid to enter the lower portion of the defined volume 253 through the inlet conduit 234 at the center of the spiral, and subsequently pass down the channels and/or through the material, eventually equalizing the water level and pressure within the defined volume 253 (and, in some embodiments, desirably any remaining air or other gas is expelled from the defined volume before full system pressure and flow are applied thereto). By initially filling the defined volume 253 slowly in this manner, an initial flow of water entering the defined volume will desirably follow a progressive water fill pattern 254, and not produce a hydraulic pressure wave or momentum-based surge of water (e.g., a “water hammer” or similar effect) that might damage the material or various system components.

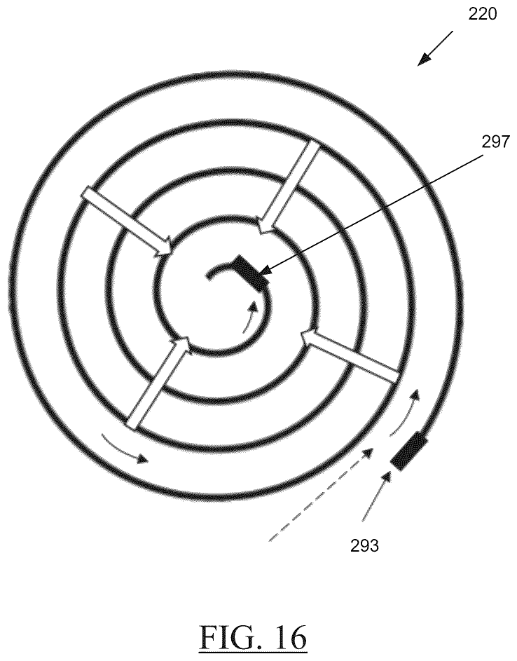

In some embodiments, the antifouling device may be designed to enable cleaning or backflushing of the one or more structures that are arranged in a use configuration. For example, with reference to FIG. 16, the spiral use configuration 220 may be designed to enable backflushing of water or other fluid (e.g., cleaning or other type fluid) from the outlet toward the inlet. In this regard, the water or other fluid may flow backwards along the plurality of flow paths described herein. In some embodiments, an outlet stiffening element 293 may be attached proximate the outlet and used to direct water or other fluid traveling in a backflush manner from the outlet into the spiral use configuration 220. Further, in some embodiments, the stiffening element 297 at the inlet may also aid in directing the water or other fluid into the inlet. Such backflushing may, for example, help re-open potentially clogged pores and/or channels and/or remove various sediment or other debris that may have settled within the defined volume during use.

### Spiral Use Configuration—Additional Benefits/Variations

In various specific embodiments, the use of a material arranged in a spiral use configuration (or other similar configurations) can dramatically increase the “effective surface area” of the material contained within the defined volume, while still allowing for sufficient water volume flows and the ingestion, processing and/or ejection of sediments or other materials during operation of the antifouling system. During experimental development, an initial treatment exposure path of 1.43 meters (4.67 feet) for a first generation crossflow spiral wound material was modified in the current spiral flow embodiment to a treatment exposure flow path of 14.63 meters (48 feet) (e.g., longitudinal flow following the winding of the spiral) without significantly increasing pressure drop and/or water flow resistance between the inlet and outlet of the antifouling device—representing an order of magnitude difference in effective water flow treatment and dosing for this design with little to no reduction of flow capacity. This improvement was deemed particularly useful for antifouling protection, including for controlling “hard to control species” of fouling organisms. Moreover, such an improvement facilitated the creation of much smaller devices, including assemblies having an end-to-end length of less than 0.45 meters (1.5 feet) and/or a diameter of less than 45.72 cm (18 inches), if desired.

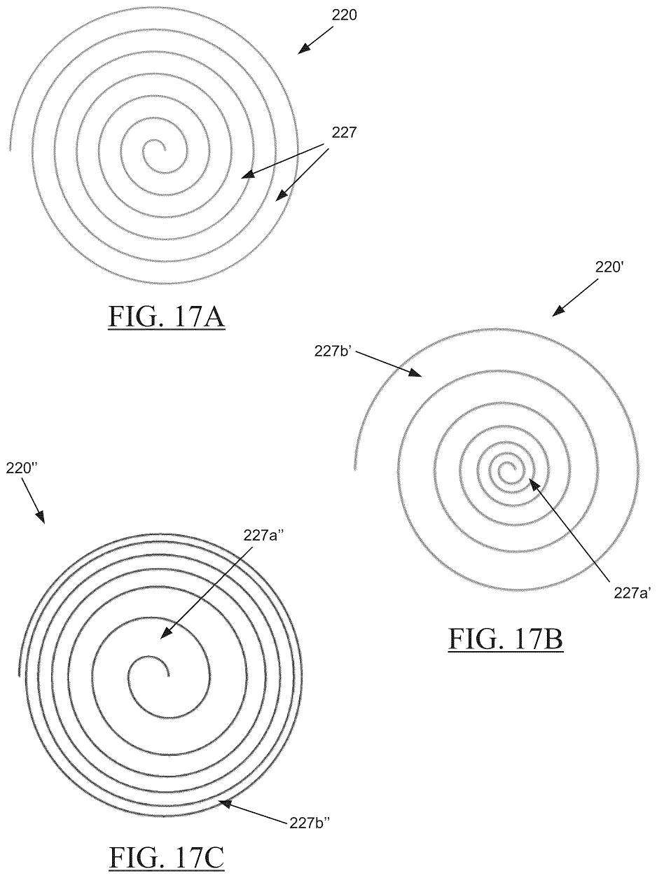

As best seen in FIGS. 17A through 17E, the spiral use configuration may take various forms based on one or more material sheet(s) being formed into one or more structures in different designs. For example, the interwall spacing in a material sheet arranged in a spiral design can be a constant value throughout the spiral (e.g., a uniform or Archimedes spiral) (see the channels 227 of the spiral use configuration 220 shown in FIG. 17A), or the interwall spacing can increase as the spiral winds outward from the center (see the increase in spacing width of the channels (e.g., from 227a′ to 227b′) of the spiral use configuration 220′ shown in FIG. 17B), or the interwall spacing can decrease as the spiral winds outward (see the decrease in spacing width of the channels (e.g., from 227a″ to 227b″) of the spiral use configuration 220″ shown in FIG. 17C), and/or the spiral can have irregular spacing of varying degrees and/or be unconstrained/variable in its spacing between the beginning and end of the material or portions thereof (not shown). Moreover, the material arranged in a spiral wound configuration could comprise a single elongated sheet of material (such as shown FIG. 17A through 17C), or two or more material sheets could create the spiral use configurations.

In some embodiments, a plurality of different spiral paths along which the fluid can desirably flow can be formed into the spiral use configuration (such as by forming a double or triple (or more) spiral). FIG. 17D illustrates an example spiral use configuration 220″ ″ with a double spiral being formed. In the illustrated embodiment, two material sheets 224a, 224b are formed into a double spiral pattern extending outwardly from the inlet conduit 234. This forms two “separate” spiral shaped pathways 227 (the term “separate” here is meant to denote that the spiral pathways leading from the inlet conduit 234 to respective outlets 240a, 240b (which may converge in the defined volume or thereafter) are distinct—however when material with pores or other openings are used the water or other fluid may flow between the pathways as described herein). Notably, the double spiral shown in FIG. 17D includes channels of decreasing width, however, any configuration of channel spacing is contemplated for various double (or triple or more) spiral designs. In various embodiments, there may be additional benefits that can be achieved by using two different material sheets, such as using two different types of material (which may have different properties) and/or may have similar properties but different coatings (e.g., different biocides or other additives on/in the different material sheets). In this regard, each material sheet may possess some difference from the opposing material sheet, such as a difference in composition, construction, coating and/or additives, which in some embodiments could optionally include one or more biocides or other additives, such as a first material sheet which might contain Econea and a second material sheet might contain zinc pyrithione, or alternatively where individual sheets might each contribute to a different water chemistry factors, etc.

In some embodiments, the antifouling system component could incorporate a material sheet comprising a plurality of two, three, four, five, six, seven, eight, nine, ten or more material sheets layered together, such as a material wall structure having a plurality of layers, which could include material wall structures incorporating multiple layers having the same, similar or differing permeabilities in each layer, same, similar or different materials in each layer and/or same, similar or differing thicknesses in each layer (such as with a multilayer material configuration). In this embodiment, a first overlayer might be a removable and/or replaceable overlayer and/or a pretreatment layer, with removal of the first overlayer/pretreatment layer (which may include a “tear away” or replaceable or other type of connection section), thus revealing an intact second underlayer, and removal of the second underlayer revealing an intact third underlayer (not shown), etc., all upstream from the protected surface (with optional replacement of one or more layers after removal if “refreshing” of a removed layer may be desired). If desired, a first overlayer could be removable, with the remaining underlayer(s) left intact, and then a replacement first overlayer could be positioned around the intact underlayer(s), such as where the first overlayer may become sufficiently fouled or eluant depleted to justify removal and/or replacement. In some embodiments, the multiple over and/or underlayers could comprise a plurality of sacrificial layers, with each layer removed as it becomes sufficiently fouled, revealing a virgin or semi-virgin layer below (e.g., still surrounding and protecting the surface). In some embodiments, the underlayers could remain in position for an extended period of time, can be changed or replaced or removed every day, week, month, 3 months, 6 months even 1, 2, 3, 4 and/or 5 years or more, with periodic removal, replacement, and/or refreshing of the exterior layer and/or underlayer(s) as previously described (e.g., removal of a fouled layer and immediate and/or delayed replacement with a new overlayer). Such an antifouling system could have many applications in salt, fresh and/or brackish water, if desired.

In some embodiments, the antifouling system may include a plurality of layers of material along and/or through which some portion of a stream of water may pass, with each layer or portion thereof contributing to different conditioning properties for the water. If desired, the various layers could comprise the same or different materials, and/or the layers could contain and/or release varying levels of chemicals and/or other additives (optionally including one or more biocides), which might include layers providing extremely high levels of eluant application and/or “superdosing” of water flows in various of the applications described herein, such as where an initial dosing level of a biocide or a water chemistry compound may be provided to initially create desired artificial conditions and/or inhibit fouling activity within the water system upon insertion (which conditions may naturally and/or artificially evolve to different water chemistry conditions at a later time). If desired, subsequent layers/stages could provide more moderate eluant levels to be maintained and/or reduced, depending upon a variety of factors and/or system objectives.

In at least one non-limiting example, a three-layered material for an antifouling system might include a first layer to condition water and/or change its chemical composition in some initial manner, a second layer to protect the material surface and/or cartridge from direct fouling, and a third layer which induces the formation of an antifouling biofilm on various downstream surfaces of the water system. If desired, the multiple layers may be incorporated into a single replaceable module, or each layer may be removeable and/or replaceable individually within three separate replaceable modules that could be placed in serial and/or parallel in the water system.

As noted herein, in some embodiments, various spiral use configurations of the antifouling device may be designed to include different configurations of coatings (e.g., biocides) on different sides of walls and/or different material sheets. Such example embodiments would create the ability to utilize different coating configurations and/or different properties on different contact surfaces for the water within the defined volume. This may be beneficial for desired antifouling protection, such as by promoting mixing, which could include chemical mixing, as well as the use of chemicals and/or biocide combinations that may be incompatible and/or reactive if contained within a single coating. It may, additionally or alternatively, be beneficial for ease of manufacturing—while still enabling the desired result within the use configuration.

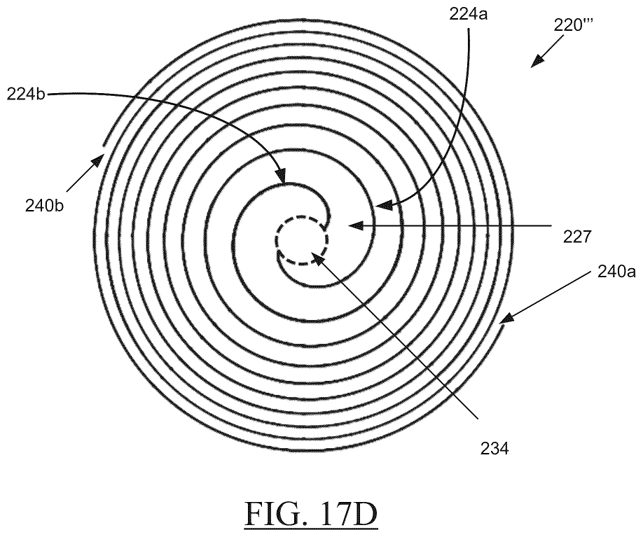

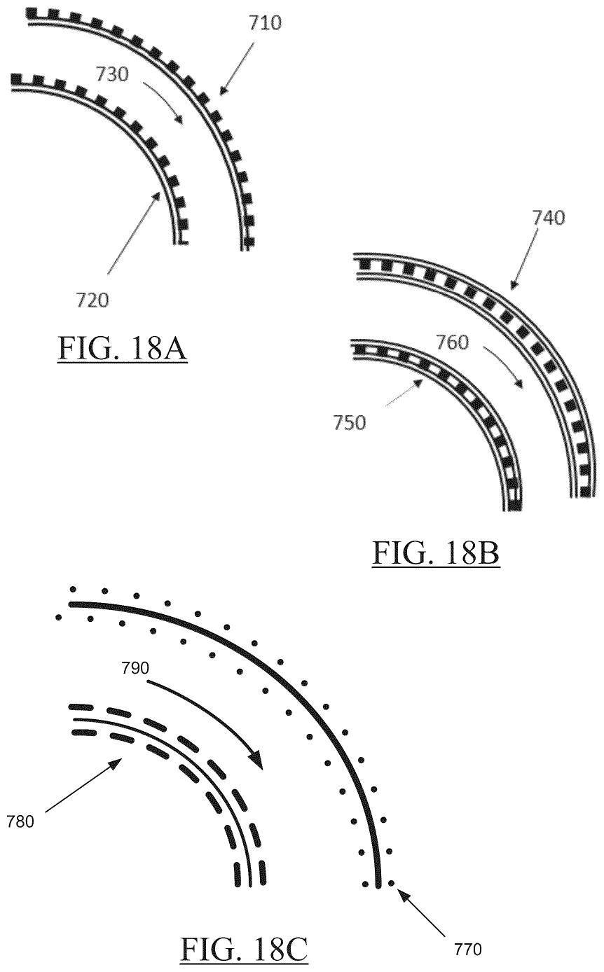

FIG. 18A depicts one exemplary embodiment of a first spiral material wall 710 and a second spiral material wall 720 with a channel water flow therebetween indicated by arrow 730. In this embodiment, a coating has been placed on an outer surfaces of the first spiral material wall 710 and the second spiral material wall 730 (which may desirably include some amount of coating extending into and/or through the pores of the fabric), and the coated or “painted” side of the wall has been positioned on outward wall edge of the spiral path. In this embodiment, the flow of water will desirably pass over and/or “scour” the outward edge at an increased velocity, which will remove sediments, dirt and/or deposits from the uncoated surface (which surface may also be eluting to assist with such sediment removal), thereby keeping the uncoated surface relatively clean and unclogged and allowing water flow through the pores of the uncoated side.

FIG. 18B depicts another exemplary embodiment of a first spiral material wall 740 and a second spiral material wall 750 with a water flow therebetween indicated an arrow 760. In this embodiment, a chemical or other additive containing coating has been placed on both sides of the spiral material walls, desirably increasing the levels of chemical or other additive released and/or further improving cleaning of the material walls by scouring action of the water flow.

FIG. 18C depicts another exemplary embodiment of a first spiral material wall 770 and a second spiral material wall 780 with a water flow therebetween indicated an arrow 790. In this embodiment, a chemical or other additive containing coating has been placed on both sides of the spiral material walls, but the coatings and the spiral material walls are different, such as in a double (or more) spiral configuration. This desirably allows for different materials and coatings to be utilized within the use configuration.

### Spiral Use Configuration—Additional Variations

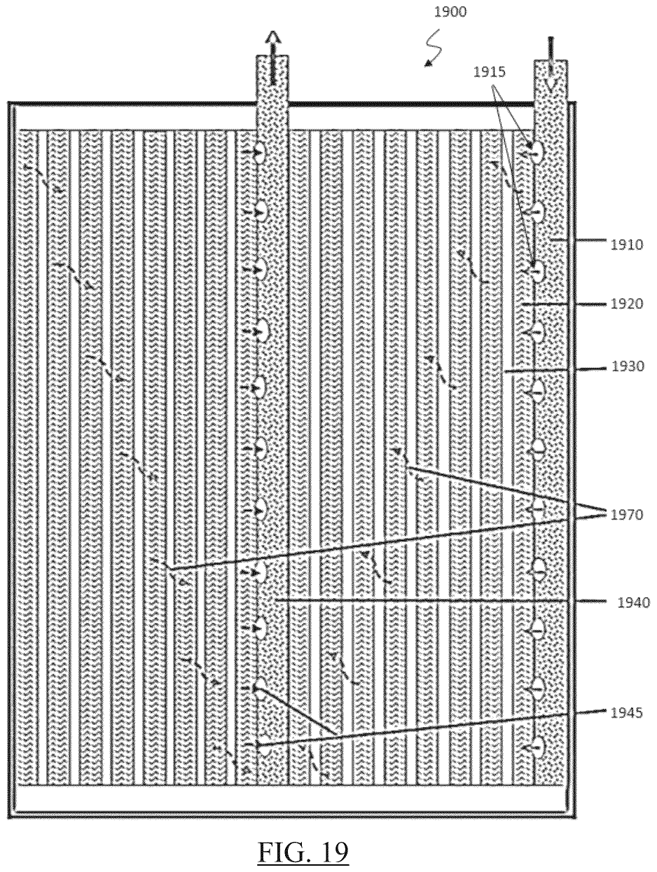

Various embodiments of the present invention contemplate many different use configurations for one or more structures for the antifouling device(s). Likewise, various different types of spiral use configurations are contemplated herein. FIG. 19 depicts an alternative embodiment of a spiral use configuration 1900 for an antifouling protection system, wherein the material and associated spiral use configuration incorporate features that induce a generally horizontal inward circular flow about the spiral wound material (e.g., relative to the spiral wound orientation of the material), with the water flow traveling from the intake pipe to the outlet pipe. This spiral use configuration 1900 receives water from an elongated water inlet tube 1910 positioned at a perimeter of the spiral wound material 1930, the inlet tube 1910 including a plurality of perforations 1915 along its length. The spiral use configuration 1900 provides conditioned water to a centrally positioned water outlet tube 1940 having a plurality of perforations 1945 along its length. If desired, the sidewalls of the coated material may optionally be sealed to the upper and/or lower surfaces using epoxy or similar potting/securement compounds to minimize water flow around and/or adjacent to these materials. In these embodiments, some portion of the water from the inlet tube may travel along a spiral interwall path 1970 in the space 1920 between the material walls, where it eventually exits the spiral material through the perforations 1945 of the outlet tube 1940 located in the center of the spiral. Simultaneously, other portions of the water from the inlet tube will desirably pass-through perforations and/or openings in the material walls themselves. Of course, various combinations of both water flow types will typically occur simultaneously within the assembly during normal operation.

In this embodiment, the water flow through the material will desirably experience a relatively higher surface contact time and/or mixing/dwell time as it follows a flow path along the spiral interwall path 1970, which will desirably increase the effectiveness of any additives and/or optional biocides it contains relative to various fouling organisms within this water flow, as described herein. In addition, various components of the water flow may pass through pores or perforations 1945 in at least one wall of the material, which will desirably contact and/or pass closely adjacent to any coating within those openings. In addition to the compact size of the disclosed embodiment and the significant coating contact time, the present embodiment can easily accommodate a reverse flow (e.g., backflush) treatment mode, which can allow for reverse flow cleanout of the device and/or various attached system components (e.g., water flow system and related components) as well as cleaning of the material and/or the assembly without causing a significant service disruption.

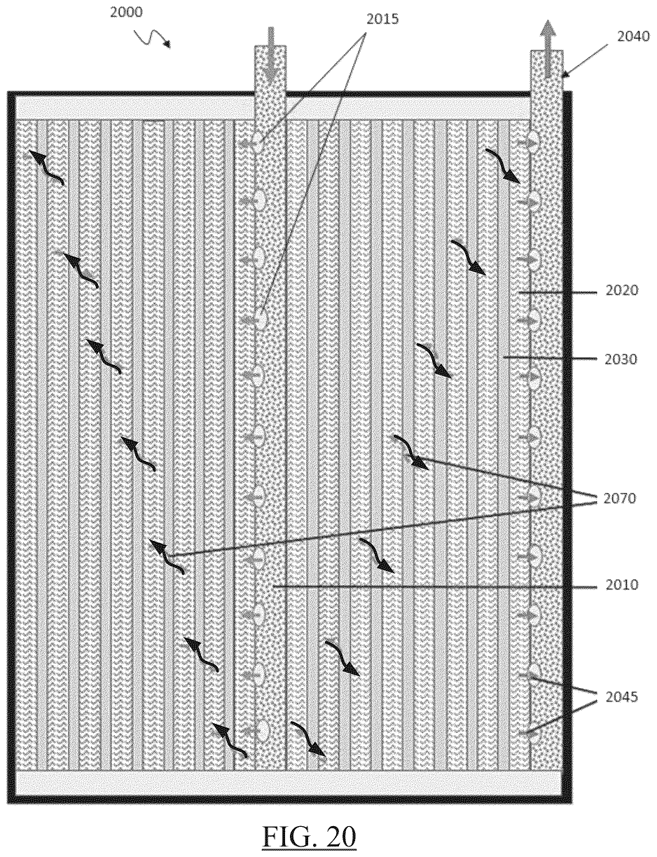

FIG. 20 depicts another alternative embodiment of a spiral use configuration 2000 for an antifouling system, wherein the material and associated spiral use configuration incorporate features that induce a generally horizontal outward circular flow about the spiral wound material (e.g., relative to the spiral wound orientation of the material), with the water flow traveling from the intake pipe to the outlet pipe. The spiral use configuration 2000 receives water from an elongated water inlet tube 2010 positioned at a center of the spiral wound material 2030, the inlet tube 2010 including a plurality of perforations 2015 along its length (which could alternatively include any number of perforations or positioning of perforation on the inlet and/or outlet tube, including discrete openings or slots along the entirety of the inlet and/or outlet tubes and/or openings at the top, the bottom and or any combinations thereof). The spiral use configuration 2000 provides conditioned water to a peripherally positioned water outlet tube 2040 having a plurality of perforations 2045 along its length, wherein the spiral material is wound around the inlet tube 2010. If desired, the sidewalls of the material may optionally be sealed to the upper and/or lower surfaces to minimize water flow around and/or adjacent to these materials. In these embodiments, some portion of the water from the inlet tube may desirably travel along a spiral interwall path 2070 in the space 2020 between the fabric walls of the material, where it eventually exits the spiral material through the perforations 2045 of the outlet tube 2040. Simultaneously, other portions of the water from the inlet tube may desirably pass-through perforations and/or openings in the material walls.

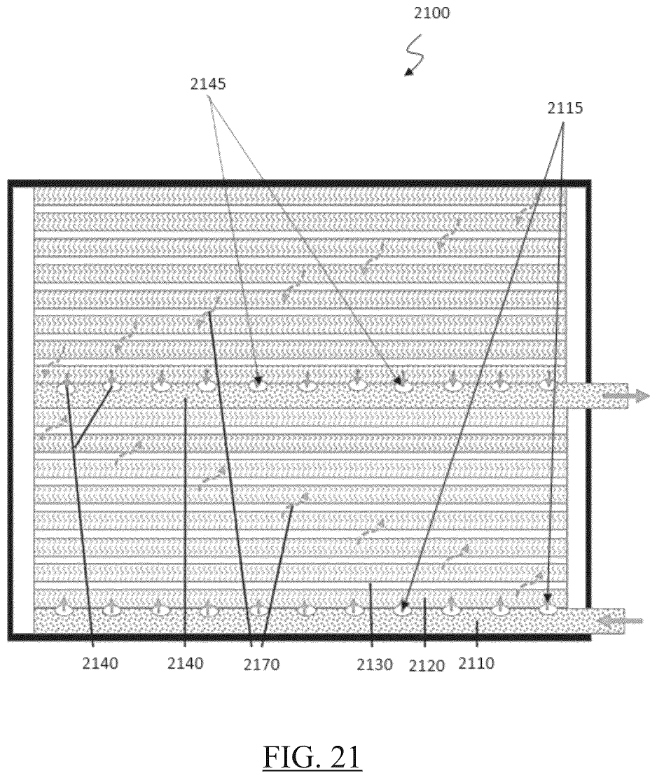

FIG. 21 depicts another alternative embodiment of spiral use configuration 2100, wherein the spiral use configuration incorporates features that induce a generally vertical or longitudinal “circular inward” water flow arrangement (e.g., relative to the spiral wound orientation of the material, or as viewed from the vertical intake and outlet piping). This spiral use configuration 2100 receives water from an elongated water inlet tube 2110 positioned at a perimeter of the spiral wound material 2130, the inlet tube 2110 including a plurality of perforations 2115 along its length. The spiral use configuration 2100 also includes a centrally positioned water outlet tube 2140 having a plurality of perforations 2145 along its length, wherein the spiral material is wound around the outlet tube 2140. If desired, the sidewalls of the material may optionally be sealed to the left and/or right surfaces to minimize water flow around and/or adjacent to these materials. In these embodiments, some portion of the water from the inlet tube will desirably travel along a spiral interwall path 2170 in the space 2120 between the material walls, where it eventually passes through a water exit of the spiral material proximate to the outlet tube 2140. Simultaneously, other portions of the bulk fluid flow from the inlet tube will desirably pass-through perforations and/or openings in the material walls.

In this horizontal spiral embodiment, like in various other embodiments described herein, the spiral use configuration may form part of an assembly that may optionally include a specialized container and/or cradle system to facilitate material removal and/or replacement without requiring evacuation of water from the antifouling system (e.g., to prevent or avoid leakage during operation and/or maintenance). If desired, this embodiment may be particularly useful for use in pressurized systems where the temperature of the cooling water may be expected to exceed 212 degrees Fahrenheit (e.g., the boiling point of pure water at atmospheric pressure) on a frequent basis, thereby allowing for higher levels of heat transfer without requiring significant additives in a known manner.

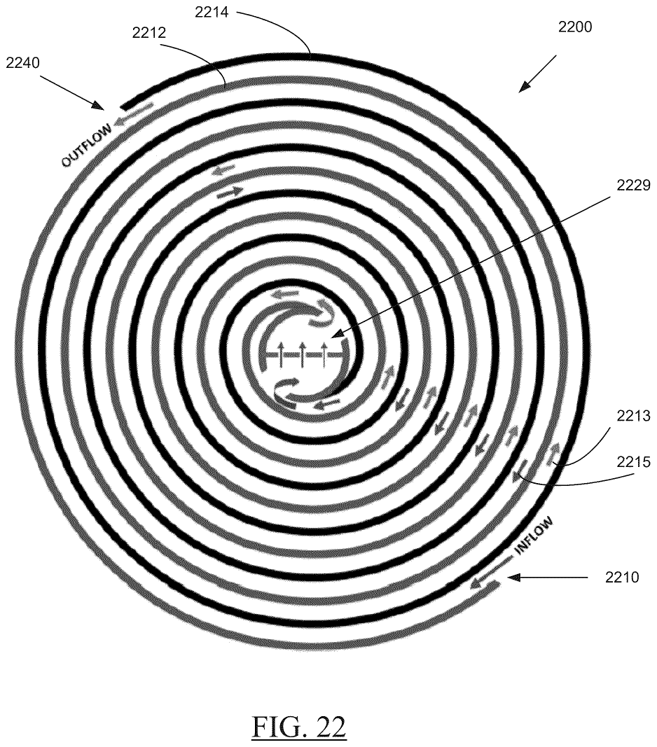

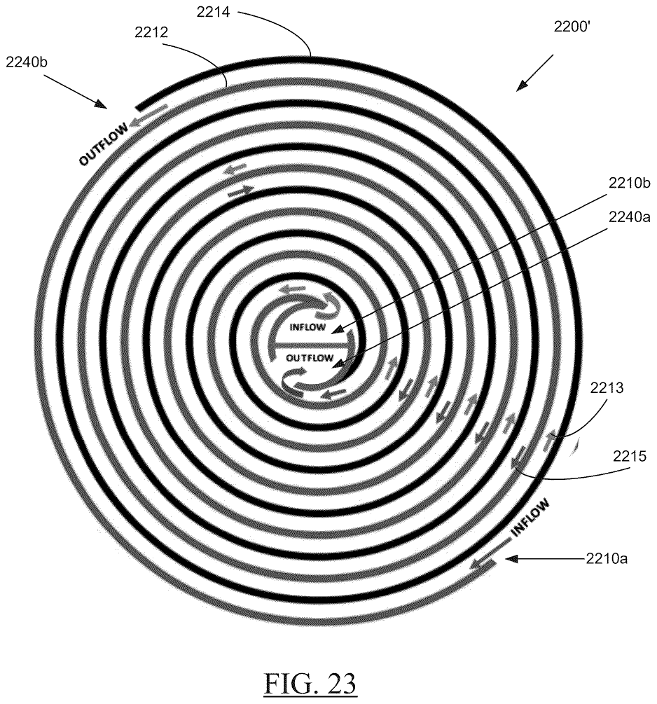

FIG. 22 depicts another example spiral use configuration 2200 in the form of a double spiral formed from a first material sheet 2212 and a second material sheet 2214. Water enters the spiral use configuration 2200 from an inlet 2210 and travels along the spiral pathway (in addition to across the material sheet walls—such as through one or more pores) through a central flow through tube 2229 and ultimately to an outlet 2240. Notably, this spiral use configuration 2200 design forms a counter current flow between adjacent channels in the spiral use configuration 2200 (consider flow directions in the channels as indicated by 2213 and 2215). Notably, the counter current encourages exchange across opposing flows through the material sheet walls. In this regard, the material sheet operates as a flux between adjacent channels. FIG. 23 illustrates an example alternate embodiment of a spiral use configuration 2200′ similar to the spiral use configuration 2200. However, the spiral use configuration 2200′ of FIG. 23 includes two inlets 2210a, 2210b and two outlets 2240a, 2240b. A first channel flow path leads from the first inlet 2210a to the first outlet 2240a, and a second channel flow path leads from the second inlet 2210b to the second outlet 2240b. This example provides for increased mixing, but also creates two separate channel flow paths which provides two separate inlets for fluid to enter the device and two separate outlets for conditioned fluid to exit the device.

### Example Spiral Use Configuration in Pipe

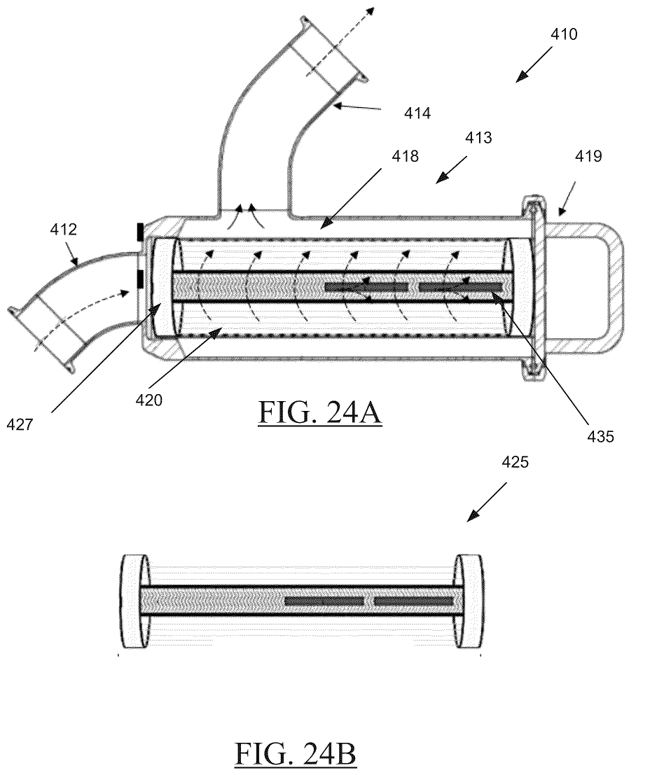

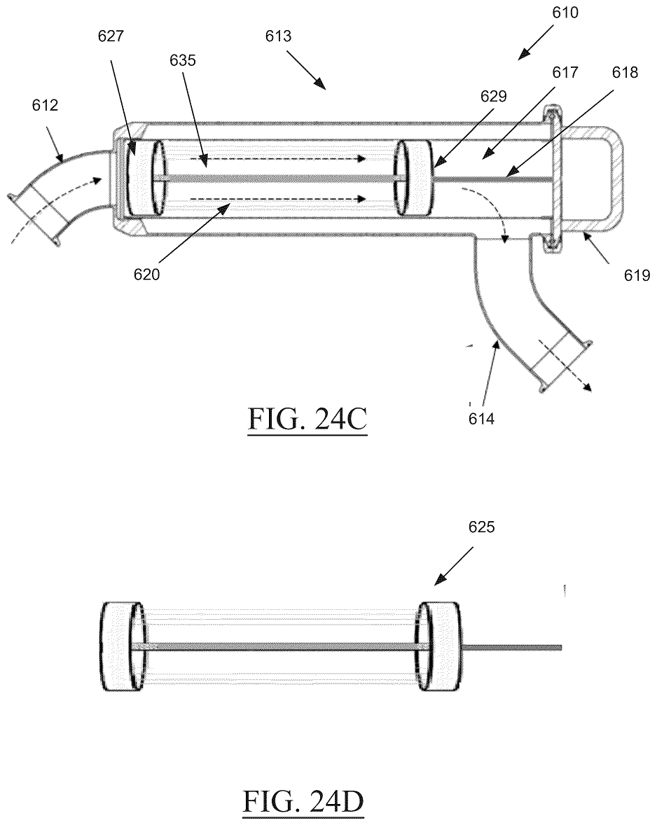

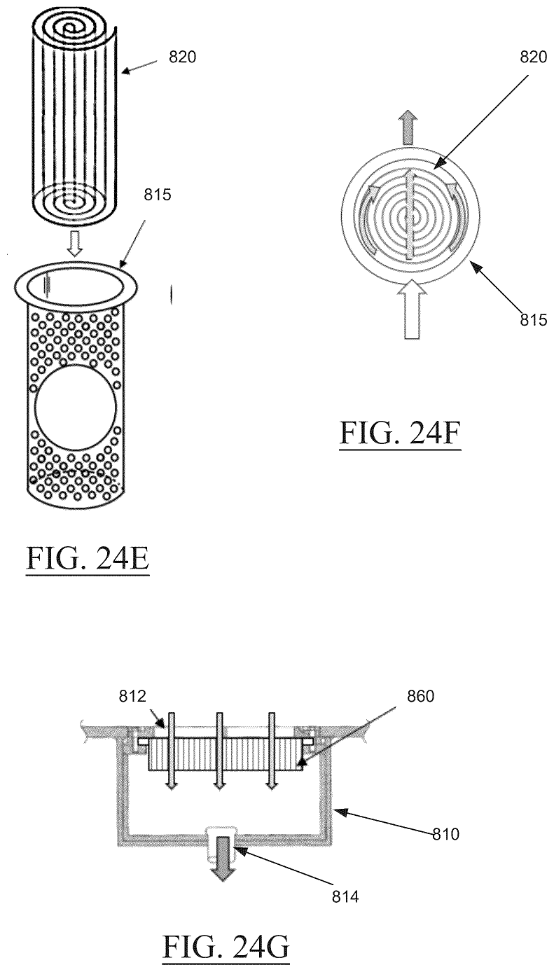

As noted herein, various different types of water flow systems are contemplated for usage with various antifouling systems described herein. As previously noted, FIG. 2E illustrates an example antifouling device 580 positioned within a piping system 581. Notably, a spiral use configuration (or other use configurations as detailed herein, including curved, pleated, bent, folded, layered, strip and/or tubular configurations) may be designed to fit within a pipe or a portion of a piping system, such as an antifouling device insert portion. FIGS. 24A-D illustrate some example spiral use configurations that are usable in piping systems. FIG. 24A depicts a schematic cross-sectional view of an example pipe system 410 that includes an antifouling device insert portion 413 within the pipe system 410, where an inlet pipe 412 leads to the antifouling device insert portion 413 and an outlet pipe 414 reconnects flow to the pipe system 410. The antifouling device insert portion 413 includes an end cap 419 that is openable to enable insertion or removal of an antifouling device in the form of a replaceable cartridge 425 (shown alone in FIG. 24B) (although various embodiments contemplate use with any other antifouling device, such as those described herein). When inserted into the antifouling device insert portion 413, the replaceable cartridge 425 includes an inlet 427 that receives water from the inlet pipe 412. Water flows through the inlet conduit and out one or more openings 435 which direct the water into the spiral use configuration 420 for conditioning of the water as it flows along the plurality of flow paths leading to an open space 418 for exiting through the outlet pipe 414. Such a system allows for easy maintenance and provides conditioned water (or other fluid) to the pipe system 410. FIGS. 24C-D illustrate an alternative example embodiment for another example pipe system 610 that includes an antifouling device insert portion 613 within the pipe system 610, where an inlet pipe 612 leads to the antifouling device insert portion 613 and an outlet pipe 614 reconnects flow to the pipe system 610. The antifouling device insert portion 613 includes an end cap 619 that is openable to enable insertion or removal of an antifouling device in the form of a replaceable cartridge 625 (shown alone in FIG. 24D) (although various embodiments contemplate use with any other antifouling device, such as those described herein). When inserted into the antifouling device insert portion 613, the replaceable cartridge 625 includes an inlet 627 that receives water from the inlet pipe 612. Water flows in a cross-flow pathway through the spiral use configuration 620 for conditioning of the water as it flows along the plurality of flow paths leading to an open space 618 for exiting through the outlet pipe 614. In the illustrated embodiment, a spacer element 617 is provided to ensure that there is sufficient open space 518 in the antifouling device insert portion 613.

FIGS. 24E-F illustrate another example spiral use configuration 820 that is usable in various water flow systems. The spiral use configuration 820 is positionable within a strainer device 815 that can be positioned within the water flow system to provide antifouling protection therein, such as in a sea chest strainer of a vessel. FIG. 24F illustrates example flow paths formed by the spiral use configuration 820. While FIGS. 24E-F illustrate a spiral use configuration, any other designed use configuration may be used in other embodiments.

FIG. 24G illustrates another example use configuration 860, which may be pleated, curved, bent, folded, layered, strip, tubular, multi-layer or spiral use configurations, or any other designed use configuration. The use configuration 860 is positioned at an inlet 812 of a sea chest 810 for receiving sea or lake water and for providing conditioned water through an outlet 814 of the sea chest 810 (such as to the remainder of a water flow system of a vessel).

### Other Example Use Configurations

Various embodiments of the present invention contemplate many different use configurations for one or more structures of the material. In this regard, a wide variety of shapes and/or constructions/packing techniques are contemplated by such embodiments, including, but not limited to, accordion or folded material structures; X or U or C-shaped material structures; round, oval or spiral shaped material structures; loose structures (e.g., shaped structures, cube-shaped structures, strip-like structures, permeable foam or rock structures, among others); blade-like structures; fixed strip-like structures; tube-like structures; among many others. Notably, various embodiments of the present invention contemplate even combining different use configurations together in a defined volume, such as, for example, by including accordion (or pleated) structures in a flow path within the defined volume along with a spiral design, such as described above. In some embodiments, the use configuration may thus form a tortious pathway leading from the inlet to the outlet—such as pathway having, for example, a plurality of flowpaths that encourage mixing via turbulent behavior. The following description provides some example use configurations contemplated by various embodiments.

### Example Use Configuration—Loose Structures

Another example use configuration of the at least one structure includes a plurality of loose structures (e.g., shaped structures, strip-like structures, permeable rock structures, among others) that are positioned within the defined volume to define a plurality of flow paths therearound and therethrough leading to the outlet.

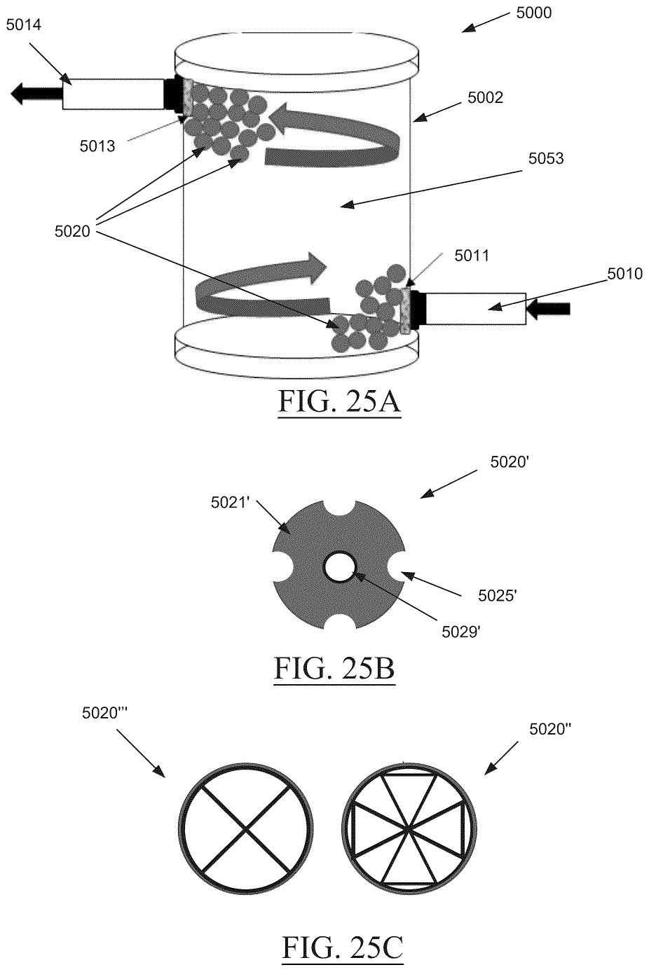

FIGS. 25A-C illustrate an example antifouling device 5000 with a body 5002 enclosing a defined volume 5053. A plurality of loose-structures in the form of shaped structures 5020 are loosely positioned within the defined volume (e.g., in a use configuration). An inlet 5010 provides water (or other fluid) into the defined volume 5053. After the water passes through an inlet strainer 5011 (such as for keeping the shaped structures within the defined volume), the water follows along one of a plurality of flow paths formed around and/or through the plurality of loose shaped structures 5020 positioned within the defined volume 5053 before exiting through an outlet strainer 5013 for an outlet 5014 as conditioned water. Notably, the shaped structures 5020 may be loosely positioned within the defined volume 5053, such as by being poured or dumped, although in some embodiments, the shaped structures may be loosely but purposefully positioned, such as along a number of predetermined paths or troughs. In some embodiments, especially where large amounts of sediments are intended to be ingested and processed by the device, the shaped structures 5020 may be designed to float or freely move within the water in the defined volume 5053, and/or the water inlet may be placed at a lower or bottom surface of the device, so as to move or otherwise “dislodge” sediments from the structures and prevent clogging. In such embodiments, the density of the shaped structures 5020 may be designed such that the shaped structures are lighter than water and/or possess sufficient buoyancy (including negatively buoyant structures) to be displaced to varying degrees by the inlet stream of water. However, in some embodiments, some or all of the shaped structures 5020 may be designed not to float within the water and, instead, sink to the bottom of the defined volume (or whatever intermediate structure they are placed/positioned within).

FIG. 25B illustrates an example shaped structure 5020′ with a body 5021′ that has one or more holes 5025′ for enabling fluid flow through the body 5021′ (such as described herein). The illustrated shaped structure 5020′ includes 6 openings arranged about the body 5021′. Further, a coating 5029′ is applied to the shaped structure 5020′, such as around and penetrating at least partially through the one or more of the holes 5025′. In this regard, the water passing by the body 5021′ and/or through the holes 5025′ may interact with the coating (which may contain a biocide therein). FIG. 25C illustrates example cross-sections of shaped structures 5020″ and 5020′″ that may be utilized, such as to provide a desired density for the shaped structures.

Notably, various embodiments of the present invention contemplate any shaped loose structures that can be positioned within the defined volume in a loose manner. Other example shapes include square-shaped structures, “X” shaped structures, strip-like structures (even if balled-up, rolled-up, or otherwise shaped), among many other shapes.

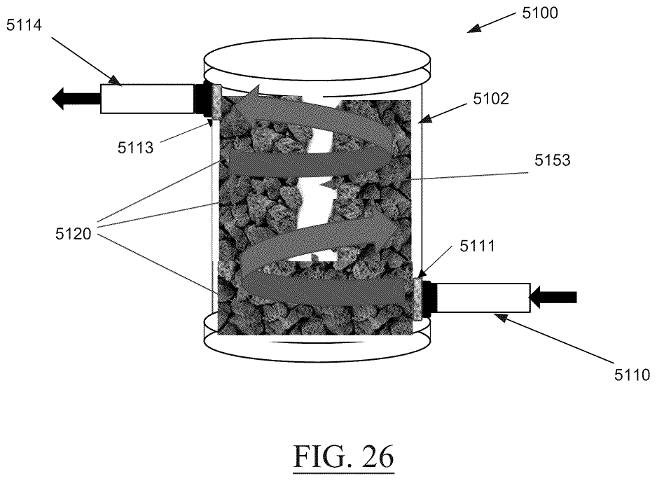

FIG. 26 illustrates another example antifouling device 5100 with a body 5102 enclosing a defined volume 5153. A plurality of loose-structures in the form of foam or rock-shaped structures 5120 are loosely positioned within the defined volume (e.g., in a use configuration). An inlet 5110 provides water (or other fluid) into the defined volume 5153. After the water passes through an inlet strainer 5111 (such as for keeping the rock-shaped structures within the defined volume), the water follows along one of a plurality of flow paths formed around and/or through the plurality of loose rock-shaped structures 5120 positioned within the defined volume 5153 before exiting through an outlet strainer 5113 for an outlet 5114 as conditioned water. Notably, the rock-shaped structures 5020 may be loosely positioned within the defined volume 5153, such as by being poured or dumped, although in some embodiments, the rock-shaped structures may be loosely but purposefully positioned, such as along a number of predetermined paths or troughs. In some embodiments, the rock-shaped structures 5120 may be designed to sink to the bottom of the defined volume (or whatever intermediate structure they are placed/positioned within). However, in some embodiments, the rock-shaped structure 5120 may be designed to float or freely move within the water in the defined volume. In some embodiments, the rock-shaped structures 5120 may be at least partially coated (such as with biocide). Notably, in some embodiments, the rock-shaped structures 5120 may actually be naturally-formed rocks, such as lava rocks, while in other embodiments, the rock-shaped structures 5120 may be artificially formed.

### Example Use Configuration—Blade-Like Structures

Another example use configuration of the at least one structure includes a plurality of blade-like structures extending at least partially across the defined volume at different heights and/or in different directions (such as forming various baffles within the defined volume). The blade-like structures may be stationary and/or they may rotate and/or otherwise move (such as under the influence of the force of the water flowing through the system and/or from driven rotation by one or more motors). Such an example embodiment may create turbulent water flow as the water moves around and/or through the blade-like structures.

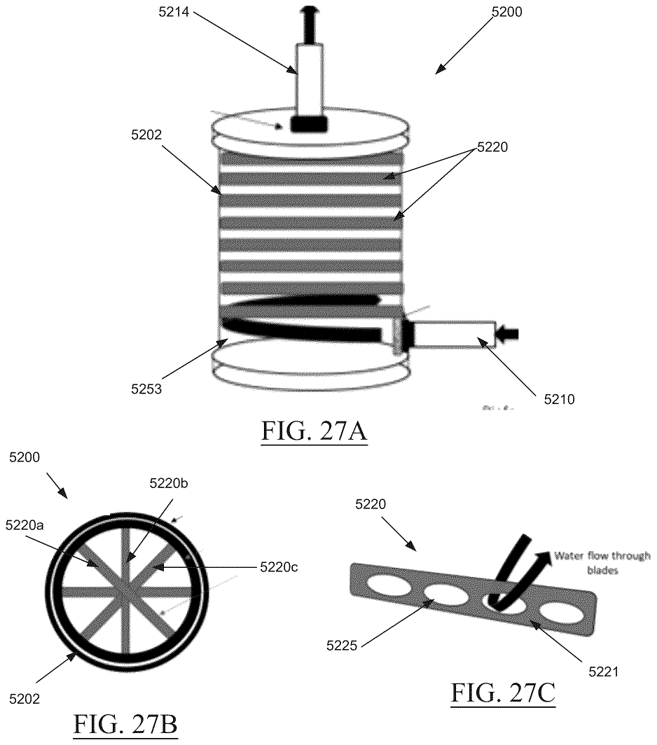

FIGS. 27A-C illustrate an example antifouling device 5200 with a body 5202 enclosing a defined volume 5253. A plurality of blade-like structures 5220 extend across the defined volume (e.g., in a use configuration) at different heights and/or in different directions. An inlet 5210 provides water (or other fluid) into the defined volume 5253. The water follows along one of a plurality of flow paths formed around and/or through the plurality of blade-like structures 5220 positioned within the defined volume 5253 before exiting through an outlet 5214 as conditioned water. FIG. 27B illustrates a cross-sectional view of the antifouling device 5200 showing three example blade-like structures 5220a, 5220b, and 5220c arranged in different directions within the defined volume. FIG. 27C illustrates an example blade-like structure 5220 with a body 5221 that has one or more holes 5225 for enabling fluid flow through the body 5221 (such as described herein). The illustrated blade-like structure 5220 includes 4 openings arranged about the body 5221. In some embodiments, a coating is applied to the blade-like structure 5220, such as around and penetrating at least partially through the one or more of the holes 5225. In this regard, the water passing by the body 5221 and/or through the holes 5225 may interact with the coating (which may contain a biocide therein).

Notably, various embodiments of the present invention contemplate any shaped structures that can be positioned within the defined volume in such a similar manner as shown in FIGS. 27A and 27B, as a “blade-like” shape is meant to provide an example. Other example shapes include square-shaped structures, “X” shaped structures, strip-like structures, among many other shapes.

In illustrated embodiment, the blade-like structures 5220 are stationary. However, additionally or alternatively, in some embodiments, the blade-like structures 5220 may be movable within the defined volume, such as under the influence of the water (or other fluid) passing by and/or from being driven by one or more motors or other mechanisms. The movement may be in any direction (e.g., horizontal rotation, vertical rotation, lateral movement in any direction, etc.).

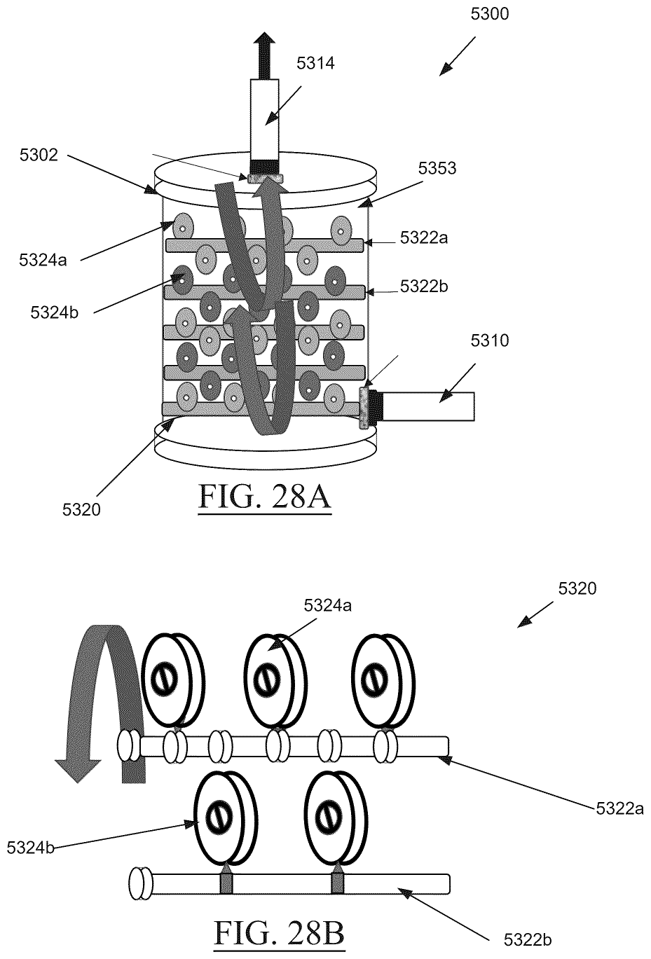

FIGS. 28A-B illustrate an example antifouling device 5300 with a body 5302 enclosing a defined volume 5353. A plurality of blade-like structures 5320 extend across the defined volume (e.g., in a use configuration) at different heights and/or in different directions. An inlet 5310 provides water (or other fluid) into the defined volume 5353. The water follows along one of a plurality of flow paths formed around and/or through the plurality of blade-like structures 5320 positioned within the defined volume 5353 before exiting through an outlet 5314 as conditioned water. Notably, the illustrated blade-like structures 5320 take the form of a rod 5322a, 5322b that includes a plurality of rotatable discs 5324a, 5324b. FIG. 28B illustrates a close-up view of the blade-like structures. The discs 5324a, 5324b of the blade-like structures 5320 are movable within the defined volume, such as being rotatable about their respective rods 5322a, 5322b. This rotation may, for example, occur under the influence of the water (or other fluid) passing by and/or from being driven by one or more motors or other mechanisms. This rotation creates turbulent flow that further aids in mixing of the water to form conditioned water within the defined volume. In some embodiments, at least a portion of the discs 5324a, 5324b and/or rods 5322a, 5322b may be coated (such as with biocide). In some embodiments, the discs 5324a, 5324b and/or rods 5322a, 5322b may include one or more pores or holes to further enable fluid flow therethrough.

### Example Use Configuration—Tube-Like Structures

Another example use configuration of the at least one structure includes at least one tube-like structure defining a first flow path along a channel defined within the at least one tube-like structure and one or more second flow paths extending through one or more pores within a wall of the at least one tube-like structure such that water within the defined volume is able to flow through either or both of the first flow path and the one or more second flow paths before leaving the defined volume through the outlet.

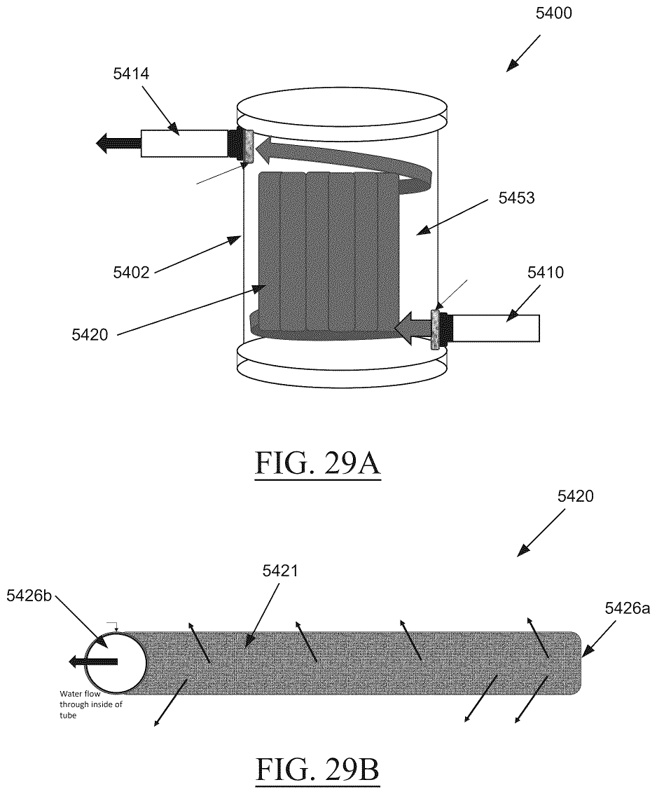

FIGS. 29A-B illustrate an example antifouling device 5400 with a body 5402 enclosing a defined volume 5453. One or more tube-like structures 5420 extend within the defined volume (e.g., in a use configuration). An inlet 5410 provides water (or other fluid) into the defined volume 5453. The water follows along one of a plurality of flow paths formed around and/or through the one or more tube-like structures 5420 positioned within the defined volume 5453 (e.g., with reference to FIG. 29B, through a channel of the tube-like structure 5420, such as between 5426a and 5426b, and/or across one or more walls 5421 defining the one or more tube-like structures 5420) before exiting through an outlet 5414 as conditioned water. Notably, in some embodiments, the channel may lead directly from the inlet 5410 to the outlet 5414 and still water may pass in and out of the walls 5421 of the tube-like structure 5420 to provide the desired plurality of flow paths. Additionally or alternatively, the one or more tube-like structures 5420 may not extend specifically between the inlet 5410 and the outlet 5414 and, instead, may extend some length within the defined volume, creating one or more shortened channels for water to be directed within. In some embodiments, a coating is applied to at least a portion of the tube-like structure(s) 5420. In this regard, the water passing by and/or through the walls 5421 of the tube-like structures 5420 may interact with the coating (which may contain a biocide therein).

In some embodiments, the disclosed tube-like structures might comprise one or more flexible and/or moveable tube(s) (e.g., similar to the construction of a “tube man”, skydancer or “Tall Boy” structure of flexible, inflatable tubes, commercially available from TentAndTable of Amherst, NY, USA), which may include permeable and/or non-permeable fabric sections or portions thereof. In some embodiments, displacement and/or movement of various tube sections can enhance sediment ingestion and/or removal as well as inhibition of biofouling thereupon.

### Example Use Configuration—Pleated Structures

Another example use configuration of the at least one structure includes one or more pleated structures positioned within the defined volume to define multiple flow paths therein. For example, in a cylindrical-type defined volume, pleated structures of increasing diameter may be placed relative to a central axis of the defined volume to define first vertical flow paths (in between adjacent pleated structures) and one or more second flow paths extending through one or more pores within a wall of the pleated structures such that water (or other fluid) within the defined volume is able to flow through either or both of the first flow path and the one or more second flow paths before leaving the defined volume through the outlet. Notably, any shaped defined volume may be utilized and the pleated structures may be positioned in different arrangements, such as perpendicular to a direct path between the inlet and outlet, parallel to a direct path between the inlet and outlet, and/or different angles and/or in different planes relative thereto.

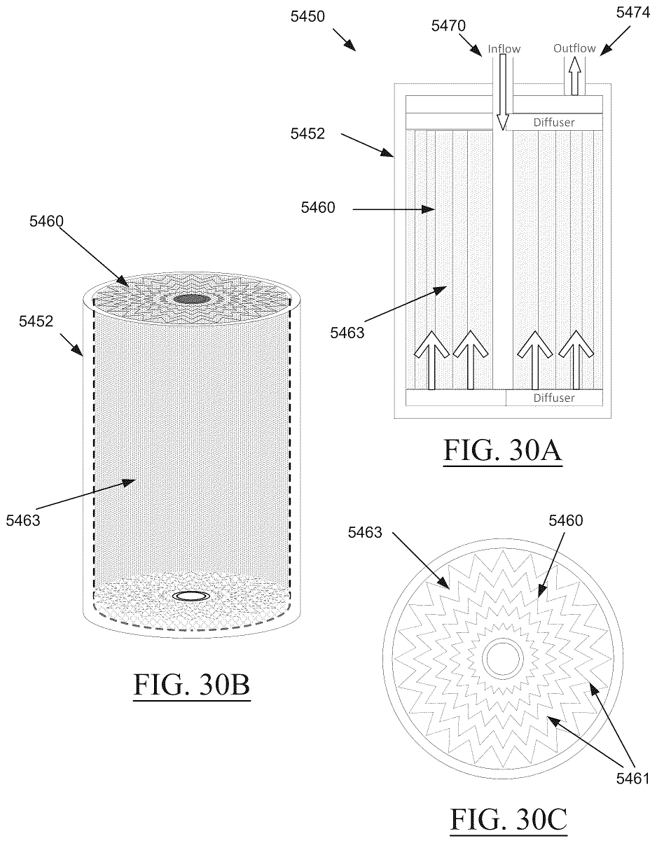

FIGS. 30A-C illustrate an example antifouling device 5450 with a body 5452 enclosing a defined volume 5463. One or more pleated structures 5460 extend within the defined volume (e.g., in a use configuration). An inlet 5470 provides water (or other fluid) into the defined volume 5463. The water follows along one of a plurality of flow paths formed around and/or through the pleated structures 5460 positioned within the defined volume 5463 (e.g., with reference to FIG. 30A, in between the pleated structures 5460, such as illustrated by the arrows leading upwardly near the bottom of the defined volume 5463, and/or across one or more walls 5461 defining the pleated structures 5460) before exiting through an outlet 5474 as conditioned water. In some embodiments, a coating is applied to at least a portion of the pleated structure(s) 5460. In this regard, the water passing by and/or through the walls 5461 of the pleated structures 5460 may interact with the coating (which may contain a biocide therein).

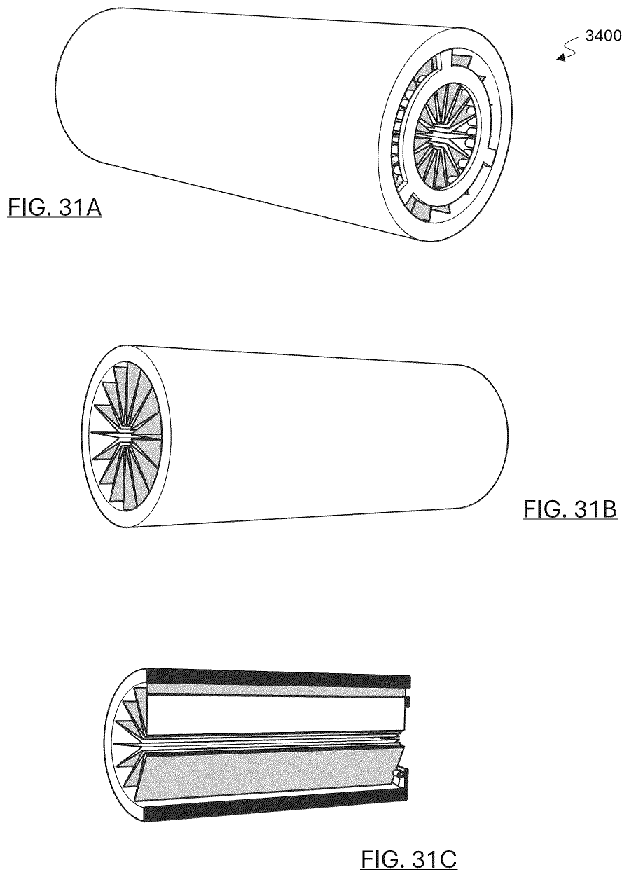

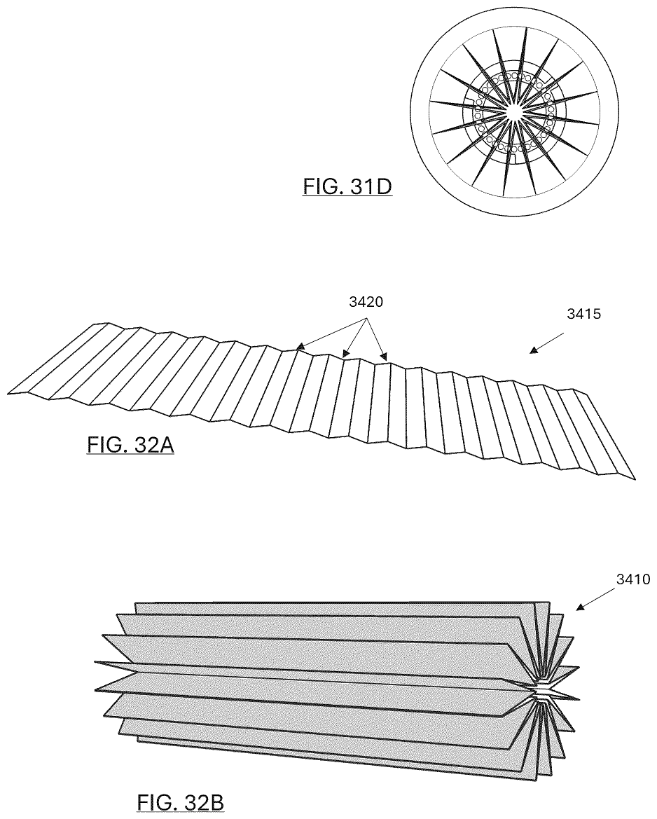

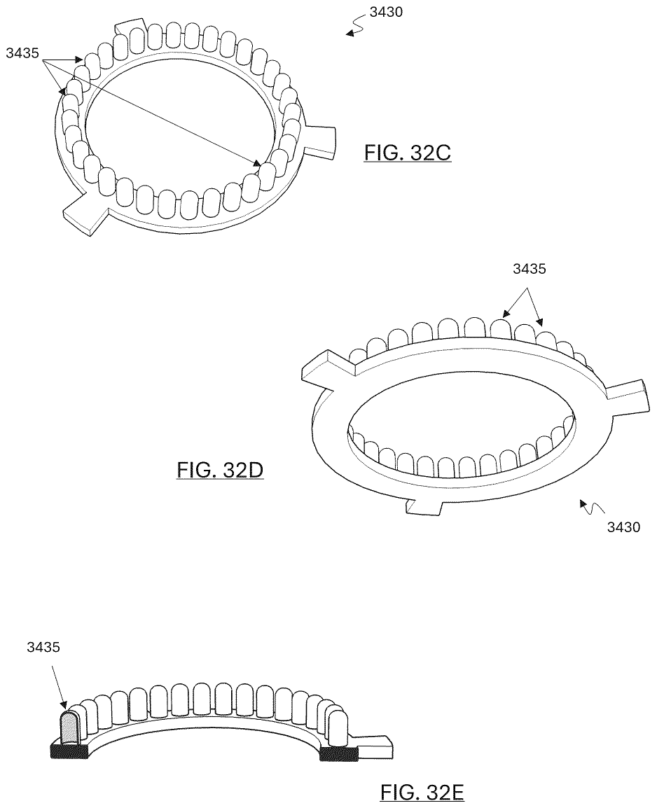

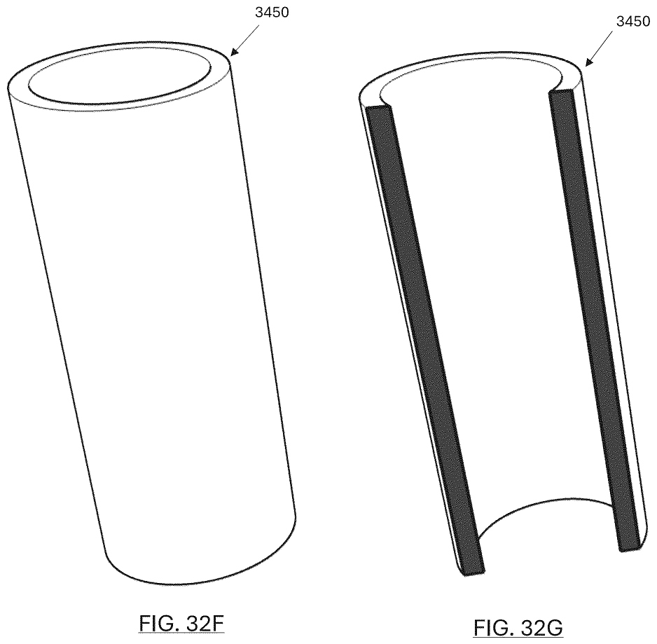

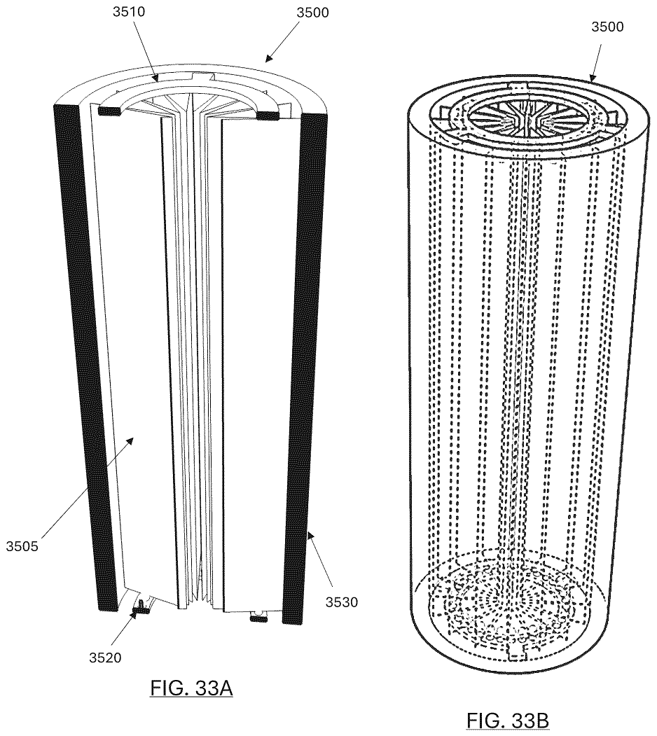

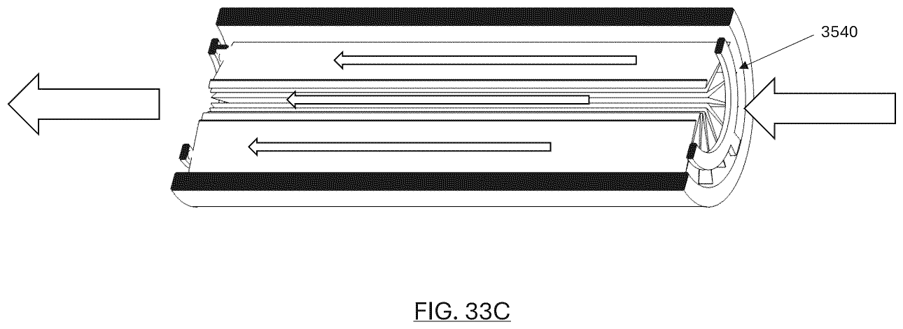

FIGS. 31A through 31D depict various views of another exemplary embodiment of an antifouling device 3400 incorporating a pleated insert 3410. A pleated insert 3410 can initially comprise an elongated sheet 3415 of material, which is folded or pleated along fold lines 3420 as depicted in FIG. 32A, and a resulting pleated or accordion-shaped material can then be connected at the opposing ends and/or overlapped to form a radially arranged, rounded and/or star-shaped configuration (e.g., a concentric arrangement), such as depicted in FIG. 32B. A securement ring 3430 (depicted in FIGS. 32C through 32E), having a plurality of protrusions or ribs 3435 extending therefrom, can be placed over one or both ends of the insert 3410, with the ribs 3435 desirably sandwiching and securing folds of insert 3410 therebetween. FIGS. 32F and 32G depict exemplary cartridge bodies or tubes 3450 into which the insert and ring(s) can be inserted, such as depicted in FIG. 31C (e.g., a one ring configuration) and FIG. 33A (e.g., a two ring configuration).

In one exemplary embodiment, folding of the sheet can be accomplished by “scoring” or partially cutting into the fabric sheet along one or more of the intended fold lines, which can desirably “break” the coating surface and/or partially extend into the fabric (e.g., a slight cut line into the fabric), depending upon a desired coating depth, a desired fabric thickness and/or other considerations. The material can then be folded in a direction away from the cut lines in a pleated or repeating pattern. The material may be folded by hand, or a pleating machine may be used, which can optionally cause or form the a “score line,” “crack” or other line of weakness formed in/into the fabric at intended bend location(s), and then bend the fabric as desired. In at least one embodiment, a plurality of crack lines can be formed in opposing sides of the fabric in a staggered or “zig-zag” fashion, which facilitates bending of the coated fabric in an accordion-like (e.g., back and forth) and/or radial/concentric pleated shapes. In some other embodiments, it may be preferred to incorporate a flexible coating material which allows processing and/or bending of the material without need for scoring or cracking of portions of the coating layer.

The pleated material may be held or constrained in a desired position/orientation within the cartridge in a variety of ways. The material may simply be folded and held in a desired position by the outer walls of the cartridge, or ridges or projections contained therein, or rings or spacers (as previously described) may be used to maintain positioning of the material. In other embodiments, the pleated material may be glued or polyurethane dipped/molded using various known commercial manufacturing methods, in a manner similar to currently available air and/or water filters.

In some embodiments, folding of the pleats will desirably create a plurality of geometric “shapes” in the material which can significantly enhance the structural rigidity of the pleated material. For example, folding of the pleated surfaces can grant a triangular or polygonal cross section to various regions of the material, which will allow the pleats (or portions thereof) to flex and/or move laterally while preventing unwanted longitudinal collapse or “shortening” of the pleated structure. In essence, the folding (e.g., pleating or corrugation) will increases the stiffness of the folded structure, with an increased ‘bending stiffness’ or ‘flexural rigidity’ of the structure being equal to the product of Young's Modulus € and the area moment of inertia (I). Folding, pleating and/or corrugation will increase I, thereby increasing the stiffness, which means that the pleated structure can withstand larger loads before collapse. In addition, a pleated structure may withstanding higher water flows because the shape of the channel(s) need not be completely uniform. Water passing through the cartridge can be diffused into a wider entrance and into the ‘triangle’ shaped channels, where the water may cross various sectional boundaries without having to pass through pores or openings in the permeable fabric to reach a new flow channel.

In the disclosed embodiment, the inherent rigidity of the pleated material and/or the presence of the ‘spacer rings’ will desirably assist in separating and/or securing the individual pleat surfaces at the entry and exit ends of the coated material. Desirably, the spacer rings will separate the pleated surfaces to varying degrees, and also position or “center” the fabric structure within the cylinder body. In some embodiments, the spacer/pleated fabric panel can optionally slide freely along the tube during assembly and/or disassembly, but will desirably not move in the cartridge assembly as it has a ‘hard’ stop against the PVC caps on each end of the cartridge.

FIGS. 33A and 33B depict cross-sectional and shadowed views of another embodiment of an antifouling device 3500, wherein an insert 3505 has been sandwiched between an upper ring 3510 and a lower ring 3520, positioned within a tube body 3530.

FIG. 33C depicts an exemplary channel flow pattern of fluid through the antifouling device of FIGS. 33A and 33B. In this embodiment, a fluid such as water can pass from a water supply line, reservoir or other source (not shown), and initially flow through openings 3540 formed in the upper ring 3510, pass along and/or through the elongated permeable walls 3550 of the insert 3505, exit through openings 3560 in the lower 3520, and then travel further into the water supply system. Because water can easily flow through the passages between the folds of the insert in this configuration, a significantly high water flow—e.g., in excess of 71.9 liters/min (19 gallons per minute), 151.5 liters/min (40 gallons per minute), 159 liters/min (42 gallons per minute), 378.5 liters/min (100 gallons per minute) or even greater in some configurations—can be achieved through the cartridge, while still allowing for flow back and/or forth through the permeable walls of the insert as previously described. If desired, the ring or other elements could optionally be coated with a biocide or non-biocide coating, such as the various coatings described herein, which may reduce or delay biofouling at an entry point of the cartridge and/or along the length of the insert.

One significant advantage of the pleated insert configuration is that this configuration allows significant amounts of water to freely flow down the channels of the insert (e.g., between the individual pleats of the material), while some of the water may pass through the permeable pleated walls themselves (with one or both of the these waterflow paths receiving eluted biocides and/or other chemical constituents where coatings may be present on or in the material). While the channel and through-wall flows might be statically modelled and/or estimated, the actual flow along and/or through the material walls will be significantly more complex. For example, the individual pleats of the insert will likely flex and/or “flap” to varying degrees during water flow, which create transient regions of higher and/or lower pressure within the cartridge, thereby affecting both channel flow and through-wall flow on a continual basis. Thus, a wide variety of complex paths along and/or within the walls of the material and/or along the interpleat channels and/or combinations thereof are contemplated herein as well. It should also be understood that a bulk water flow along the longitudinal axis of the pleated insert (e.g., from the inlet to the outlet) is anticipated in this embodiment, with the flow path of individual water molecules through and/or along the insert following a very complex and somewhat random flow within the defined volume. depending upon the operating pressure, operating conditions, system configurations and/or flow rate (among many other considerations).

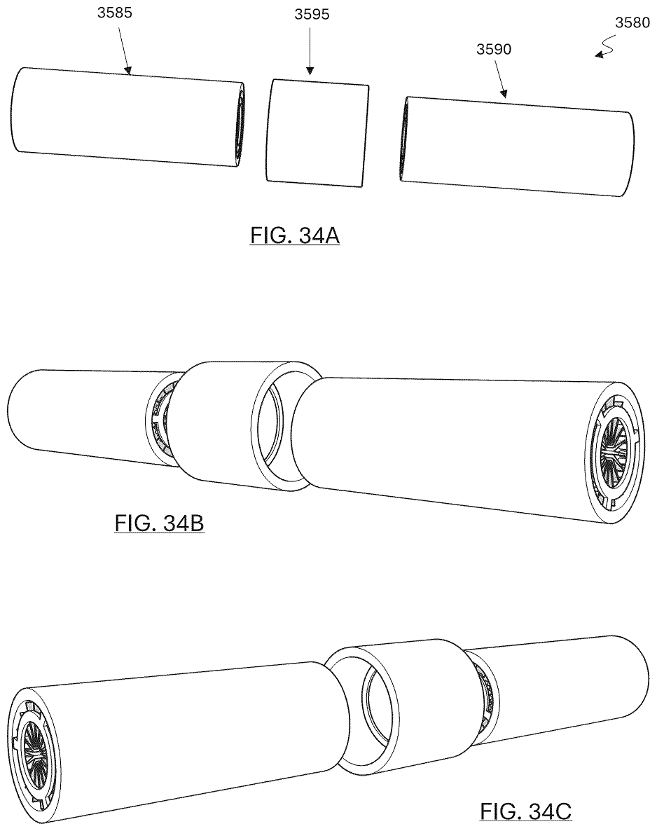

FIGS. 34A through 34C depict another exemplary embodiment of an antifouling system 3580 which incorporates a first antifouling cartridge 3585, a second antifouling cartridge 3590 and a connector 3595 therebetween. In this embodiment, water can flow linearly through the first and second cartridges, which can be placed in-line into a water supply line, wherein the waterflow can be occasionally interrupted to allow the cartridges to be easily removed and/or replaced, as well as allow replacement of the inserts therein, as desired.

In another exemplary embodiment, a plumbing loop or similar arrangement may be provided to direct some portion of an output of a canister back to the inlet of the same canister, such as where a certain portion or percentage of treated water will recirculate back to the canister entrance point to provide fouling protection at the raw water entrance.

### Example Use Configuration—Strip-Like Structures

Another example use configuration of the at least one structure includes a plurality of strip-like structures, wherein each of the plurality of strip-like structures are fixedly attached on one end within the defined volume and loose on the other end within the defined volume. In some embodiments, the plurality of strip-like structures may be attached on both ends. The flexible nature of the strip-like structures may cause interaction with and mixing of the water as the water passes around and/or through the strip-like structures.

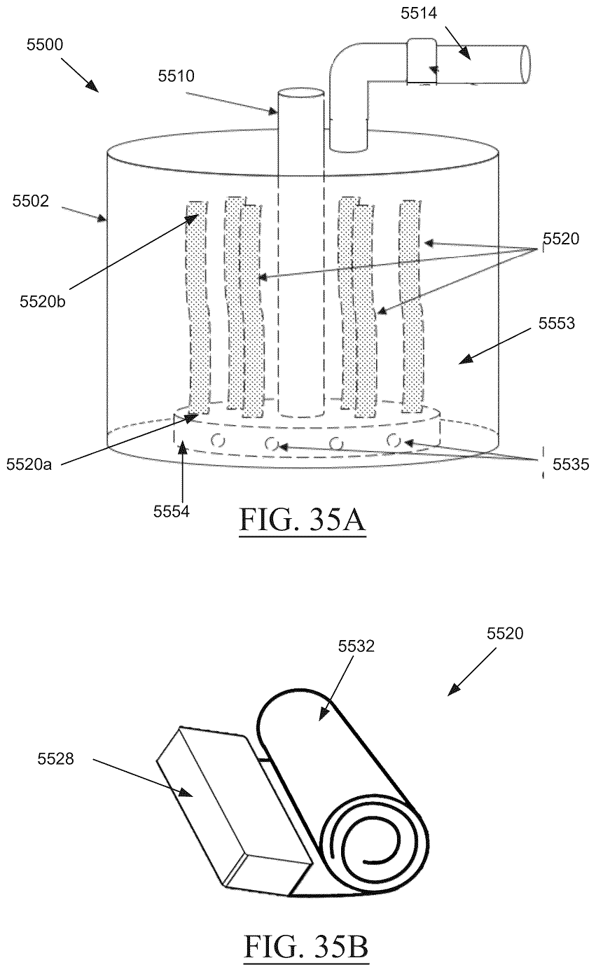

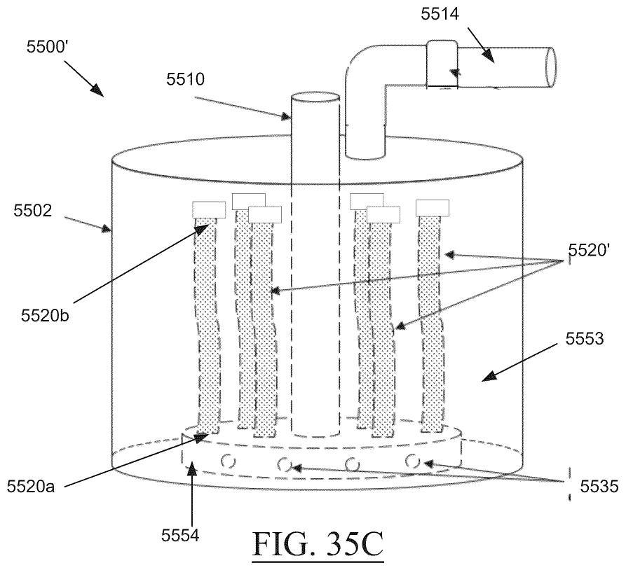

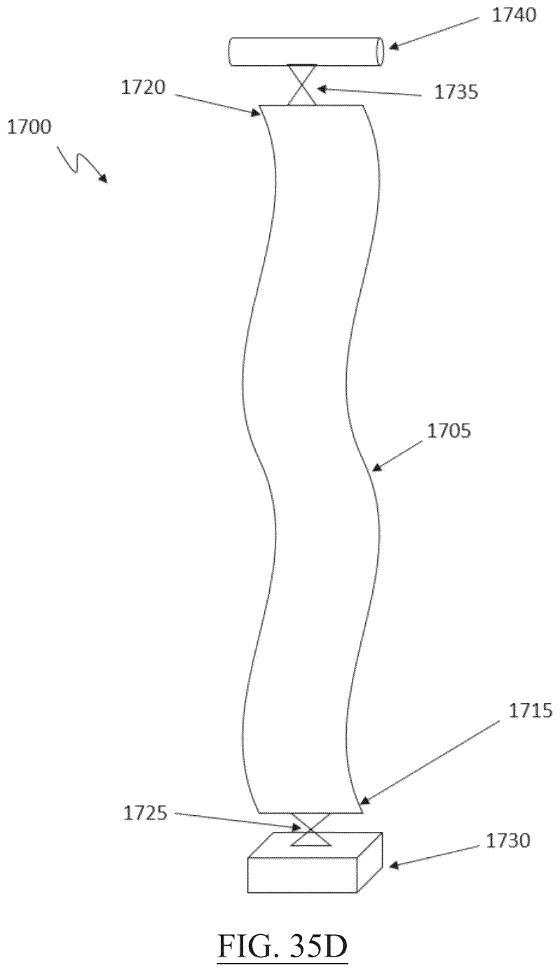

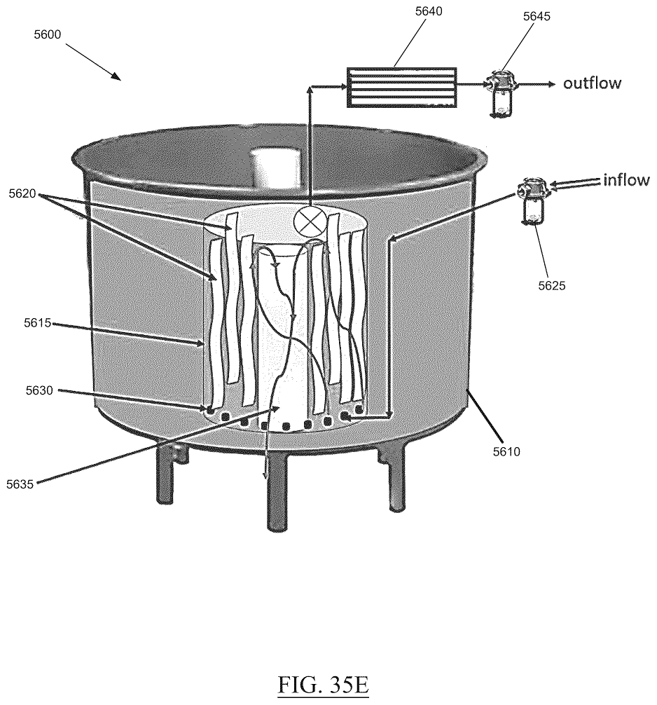

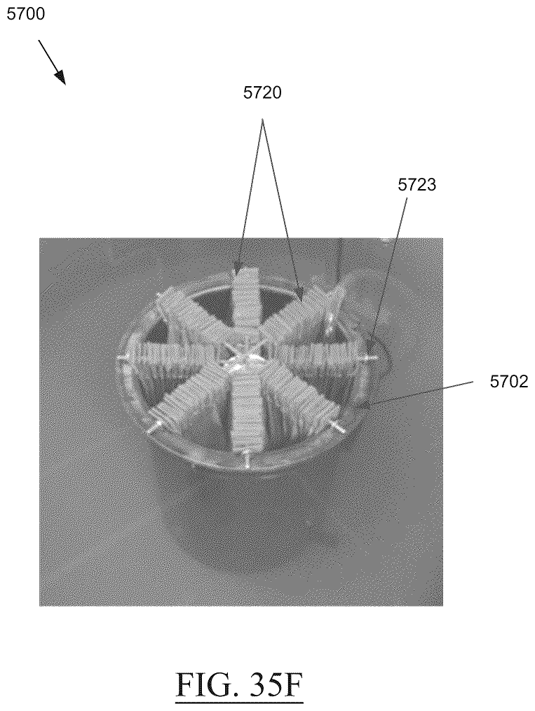

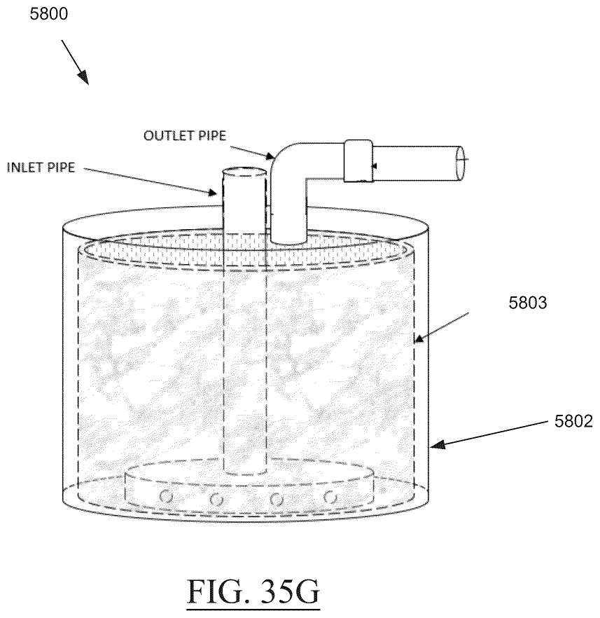

FIGS. 35A-C illustrate another example antifouling device 5500 with a body 5502 enclosing a defined volume 5553. One or more strip-like structures 5520 extend within the defined volume (e.g., in a use configuration). An inlet 5510 provides water (or other fluid) into the defined volume 5553, such as through one or more openings 5535 near a bottom of the defined volume 5553. The water follows along one of a plurality of flow paths formed around and/or through the one or more strip-like structures 5520 positioned within the defined volume 5553 before exiting through an outlet 5514 as conditioned water. With reference to FIG. 35B, the strip-like structure 5520 may include a body 5532 that is attached to a base 5528 at one end 5520a (FIG. 35B illustrates the body 5532 in a rolled-up configuration). The base 5528 may attach to one or more surfaces within the defined volume, such as the base member 5554 shown in FIG. 35A. Notably, the flexible nature of the strip-like structure 5520 allows a loose end 5520b to flow freely within the defined volume 5553, which may further aid in creating a mixing environment for the water. In some embodiments, a coating is applied to at least a portion of the strip-like structure 5520. In this regard, the water passing by and/or through the body 5532 of the strip-like structures 5520 may interact with the coating (which may contain a biocide therein). With reference to FIG. 35C, in some embodiments, one or more of the strip-like structures 5520′ within the antifouling device 5500′ may be attached on both ends such that the ends are secured. This may create desired flowpaths within the defined volume.

FIG. 35D illustrates another example strip-like structure 1700. The strip-like structure 1700 comprises an elongated sheet of a flexible, permeable material 1705, wherein the strip includes a coating (not shown) on one or both faces or sides of the material, wherein some portion of the coating extends at least partially into openings and/or pores (not shown) of the permeable element material. In this embodiment, the strip-like structure 1700 has a first end 1715 and an opposing second end 1720, wherein the first end optionally includes a first attachment structure 1725 which desirably allows the strip to be secured to an object, surface or similar support, which could include virtually any variety of attachments, anchors, frames, supports, securement and/or the like. In this embodiment, the attachment structure is secured to a weight or anchor 1730, which allows the strip material 1700 to be positioned and anchored within virtually any body of water or stream of water flow having a bottom or other surface against which the anchor is capable of resting. At the second end, this embodiment of a strip material 1700 further includes a second attachment structure 1735, which connects to a buoyant or floatable element 1740. In the disclosed embodiment, the floatable element 1740 will desirably possess sufficient buoyancy to maintain the strip material 1700 in a suspended position within the body of water, but not enough buoyancy to lift or raise the anchor 1730 off of the bottom or other surface of the body of water, desirably maintaining the strip material in a substantially vertical orientation with the floatable element 1740 submerged to some degree under the surface of the body of water. In alternative embodiments, the floatable element may float at or near the surface of the water, with the strip material extended downwards toward the weight, and the weight suspended within the water column.

In various embodiments, the strip-like structures can be secured at a single end of the material, with the remaining edges and opposing end left unattached, while in other embodiments the strip may be secured at both ends, which may then allow the strip to be tensioned and/or remain non-tensioned (as desired by the user). In active flow and/or current flow situations, a single edge attachment for the strip may be more desirous (i.e., allowing the strip to flutter or flap in the flow) while the dual edge and/or tensioned arrangements may be more desirous for low flow, quiescent and/or deep-water applications.

If desired, the strip material and/or portions thereof may be constructed from natural and/or degradable/biodegradable materials (and/or artificial materials which may degrade and/or disassociated in the presence of water or other fluids) which might allow the strip material to degrade and/or be disposed of after a desired length of treatment by natural or other activity without requiring active disposal by the user. Alternatively, the attachment structure between the strip material and the anchor or weight might comprise a degradable or frangible connection, with the connection breaking or severing at some desired point, wherein the attached floatable element could then bring the strip material to the surface for possible collection and disposal or analysis.

In some embodiments, the coating on the strip-like structure may be depleted relatively rapidly (e.g., in a period of hours or days), while in other embodiments, such depletion may be more gradual and/or extend for a much longer period of time. If desired, a plurality of different compounds might be provided by a plurality of replaceable strip-like structures.

In various additional embodiments, the shape of a strip-like structure(s) may be modified by a user in a variety of ways, including by compressing, folding, packing, squeezing, crumpling and/or otherwise reducing the strip in size and/or shape. If desired, such a reduced size construct could be placed inside of a container or other structure, such as a permeable container shaped like a ball or cube. If desired, such devices could be utilized in a wide variety of systems (such as loose structures as described herein).

FIG. 35E depicts another exemplary embodiment of an antifouling system 5600 for protecting various surfaces and/or other objects within a water flow system, and which the system includes the use of a plurality of strip-like structures. In this embodiment, the antifouling system includes a treatment tank, which comprise a generally solid body comprising an outer enclosure 5610 and an inner enclosure 5615, and a plurality of strip-like structures 5620 within the inner enclosure which in the disclosed embodiment are secured at one end and unsecured at the other end. A flow of raw water can pass through an inlet strainer 5625 and be introduced into the outer enclosure, where this flow can travel through openings 5630 in the tank and then pass along and/or across the strip-like structures 5620 (which may be coated and/or conditioned and/or treated with various coatings or paints as previously described herein), which in various embodiments could be contained within a replaceable material frame assembly or module or other modular system component. The raw water flow is desirably exposed to coated strip-like structures and passes along and/or through around the strip-like structures (e.g., the strip-like structures may be permeable). Various treated material strip-like structures may be sized to line an inner surface of the tank and/or sized such that a plurality of material strips can easily fit within the tank (e.g., 10 or 20 or 30 or 40 or 50 or 100 or 150 or 200 or 250 or 300 or more strips). Multiple strip-like structures may be sized and positioned vertically, horizontally, diagonally and or other orientations (including various combinations thereof) within the tank. The material strip-like structures may be attached to a tank wall or other structure on at least one side of the strip-like structures and may be positioned tight to contain tension. The treated water can then pass through a standpipe outlet 5635, pass through a substrate or piece of equipment to be protected 5640 (e.g., heat exchanger tubing), and then pass out through a strainer 5645 and out of the system (or alternatively can be recycled). A flow path outlet may be positioned proximate and/or distal from a protected surface or water supply system and/or one or more walls of the tank. Optional fluid strainers or filters may be positioned at inlets and/or outlets. During use, a pumping mechanism may be activated to supply raw water into the tank in a desired manner, and/or the pump operation may be reversed to draw water from the tank for use or to be released in the environment outside of the tank, if desired.

In one preferred embodiment, multiple (which in some embodiments can be between 125 and 250 strips, with 200 strips incorporated into the test embodiment) treated material strip-like structures (e.g., 5.1 cm×76.2 cm or 2″×30″) could be positioned in a vertical configuration (which may include non-tensioned suspension) within a 94.6 liter (25-gallon) tank. Water may optionally flow through a preconditioning stage and/or filtration and then enter the tank through intake holes positioned at the bottom of the tank. Once the cylindrical tank fills, the water may pass on top and through to the multiple permeable treated material strip-like structures and then spill over into a tank outlet. The tank outlet may contain an optional containing step with treated material or “bio balls” or similar device(s) therein or in an attached strainer or other device. The water can optionally flow into an additional strainer/filter and/or sediment removal device, and then the water can be utilized in a heat exchanger or other industrial device (such as described herein). Such antifouling systems may be utilized in fresh, salt and/or brackish water, or any other liquid(s) or fluid(s) contemplated or disclosed herein.

FIG. 35F depicts an exemplary similar antifouling device 5700 (“the strip tank”) with a plurality of strip-like structures 5720 that were positioned within a tank 5702. In particular, the plurality of strip-like structures 5720 hang downwardly from attachment rods 5723 into the defined volume of the tank 5702. This embodiment was utilized in testing. Each fiberglass/gel coat tank was 1874 liters (495 gallons) with a water depth of 76 cm (30 inches). Raw water from Lake Michigan Harbor was directed through a Groco brand water strainer prior to entering the strip tank. The water then flowed into the tank and along the material strips as previous described. The water in each tank was then delivered to a series of vertical stainless-steel tubes as proxies for heat exchange cooling tubes that might be used in industrial settings. The tubes each comprised sections of SS316 (polished) and SS304 unpolished. From these tubes the water flowed to a second outflow Groco brand water strainer (containing BioBalls) and finally to the drain for disposal.

FIG. 35G illustrates another example antifouling device 5800 (“the skirt tank”) that was also utilized for testing. The embodiment of FIG. 35G employed a centralized cylinder with a single wrap of a treated fabric tube 5803 which was positioned just inside of a tank 5802, and which wrap covered substantially all of the vertical inner perimeter wall of the tank 5802.

The various dimensions, flow conditions and associated components described in the strip tank experiment were similarly used in a test setup incorporating the skirt tank.

### Strip and Skirt Tanks—Test Results

In tests of the disclosed embodiments in fresh water from May 2020 until September 2020, the disclosed antifouling system of both tank systems inhibited invertebrate biofouling organisms from fouling a protected surface, including protection from zebra mussels, bryozoans, sponges, and pulmonated snails, with all entities being absent post-treatment from the replaceable cartridge interior and/or surfaces positioned downstream of the water outlet. In contrast, the control “upstream” structures such as the outer untreated portions of the tank and related control surfaces receiving harbor water inflow (including tank wall, central cylinder outside wall, cooling tubes external surface, multiplate artificial surfaces) had large populations of these fouling organisms present, including zebra mussels (>1575/m2); bryozoans (>28% surface coverage); sponges (>45/m2) and snails (>540/m2). More specifically, downstream surfaces such as the inner wall of the central cylinder, the standpipe outer wall, and cooling tube inner walls in a downstream heat exchanger structure had no colonization of the same invertebrate biofouling organisms (zebra mussels, bryozoans, sponges, and pulmonated snails), except for a single snail specimen living at the water/air interface in the central cylinder, which were spectacular results and demonstrated the commercial feasibility of the disclosed system.

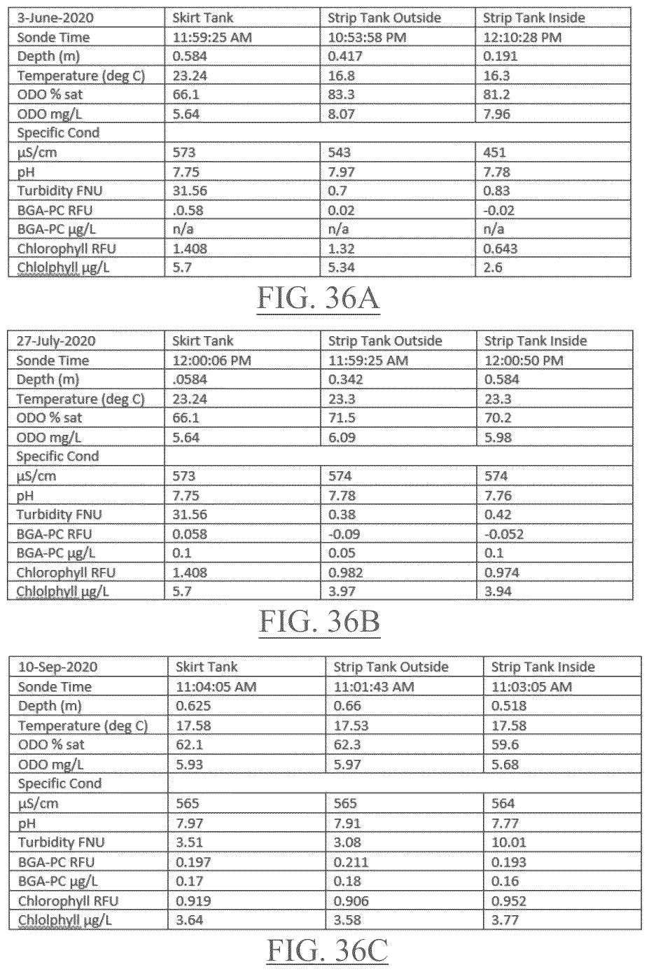

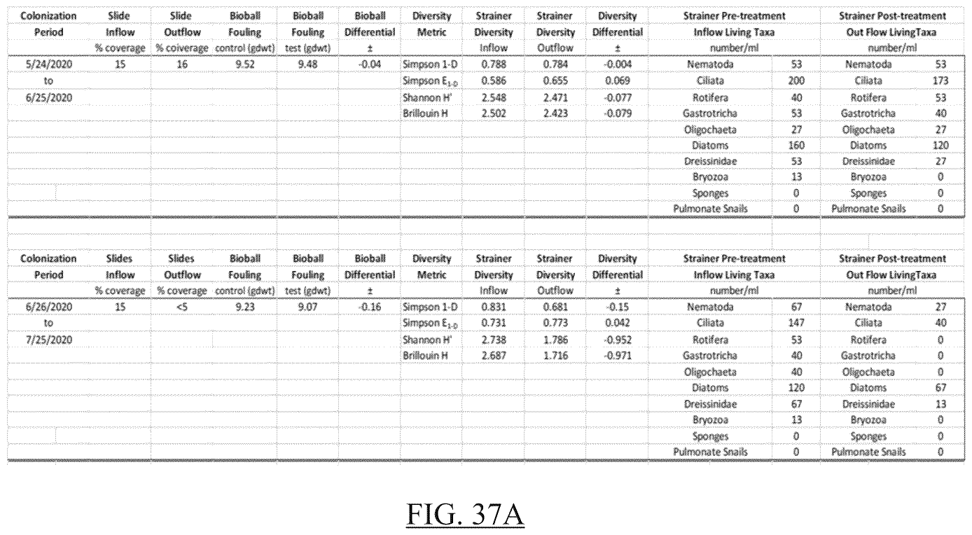

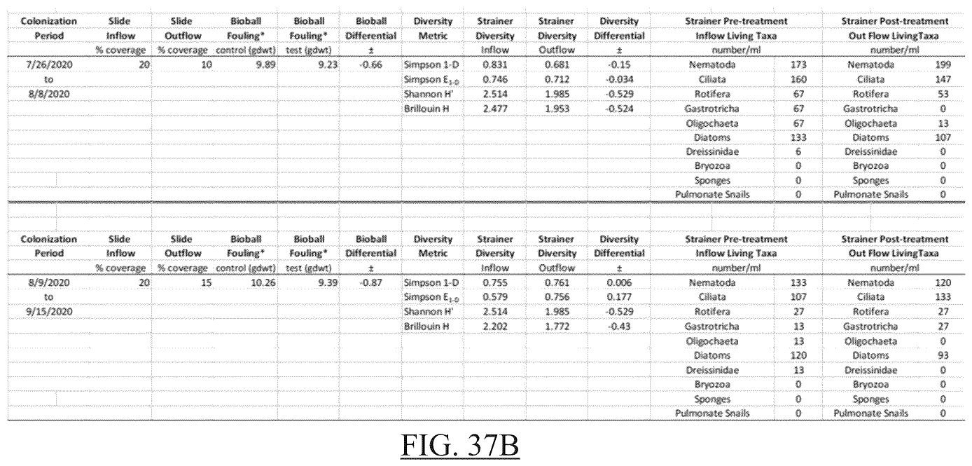

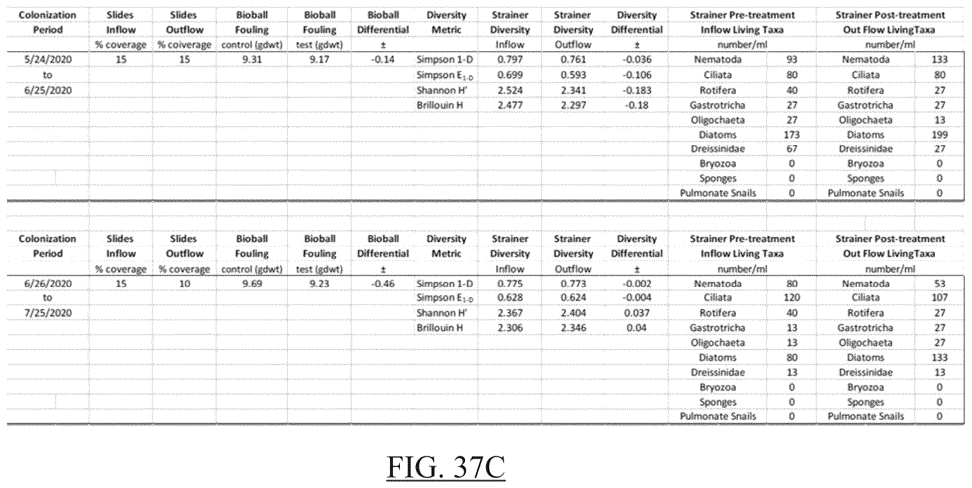

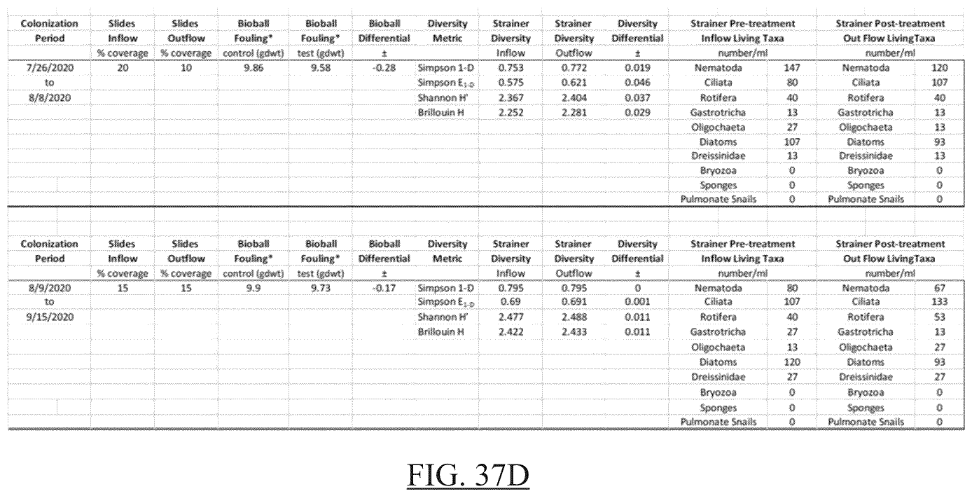

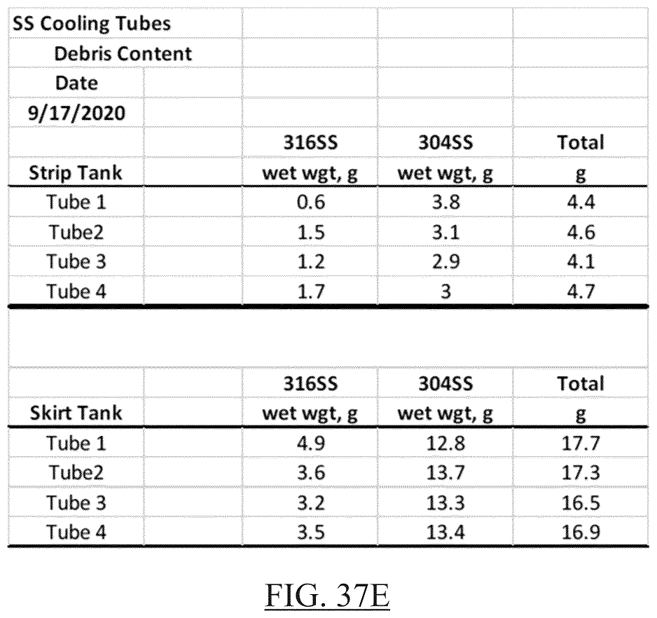

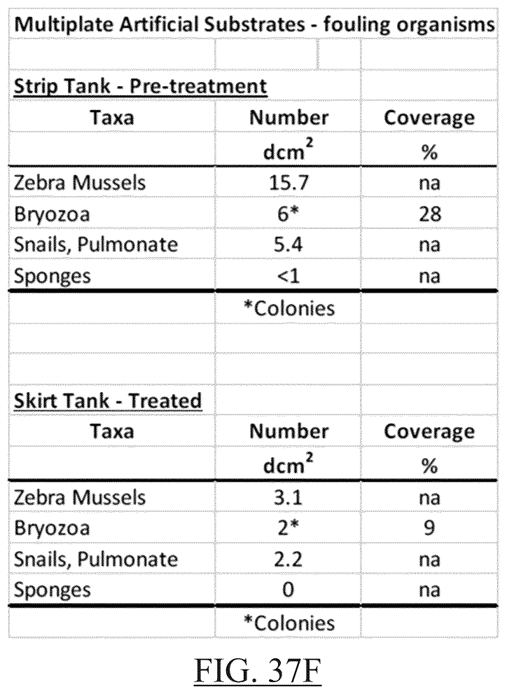

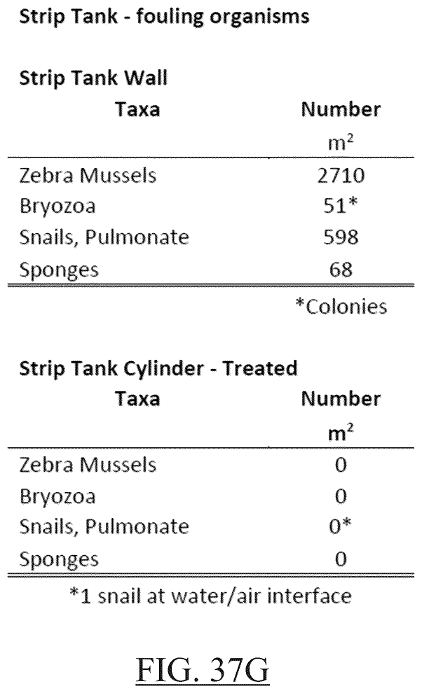

FIGS. 36A through 36C depict various water chemistry factors that were measured for the Strip and Skirt tank embodiments on 2 Jun. 2020, 27 Jul. 2020 and 10 Sep. 2020. FIGS. 37A through 37D depict various biota present in various locations within the test systems. FIG. 37E depicts debris levels within cooling tube analogs. FIG. 37F depicts biota found on artificial substrate analogs in the test systems, and FIG. 37G depicts biota found on the wall and inner cylinder of the Strip Tank test system.

### Strip Tank—Heat Exchanger Tubing Test

As part of the strip tank experiment, a series of heat exchanger tube analogs were attached to the outlet water flow of the strip tank. In the downstream heat exchanger tubing, there were no biofouling organisms present in the cooling tube lumens, although there was slight accumulation of some level of debris on the tube walls. In comparison, there was a much higher level of wall debris on upstream cooling heat exchange tubing lumens than on the equivalent downstream cooling tube lumens. The research opined that the differential in debris levels could be related to the presence of a microfilm or biofilm (and/or related bacteria or other microscopic plants/animals) on the inner walls of both upstream and downstream tubes, but that a greater level of biological activity, including that of small invertebrates, was present in the upstream tubes that had not passed through the antifouling system, especially that of nematodes and rotifers that were present in the tubes of the upstream tubes (while only a single active nematode was noted in the downstream tubes).

A comparison of diversity changes in the downstream tubes as compared to the upstream tubes indicated that, during the course of the 4-month experiment, the disclosed antifouling system components disproportionately decreased rare taxa relative to common taxa, suggesting a skewed spectrum impact of the biofouling treatment on microbial communities and relative biofilms which form on protected surfaces such as heat exchanger tube walls. Significantly, the tube walls of the downstream heat exchanger showed a considerable deterrent to biofouling, especially in proximity to the treated fabric material within the replaceable cartridge, and was especially effective in preventing mussel, bryozoan, sponge and snail biofouling on downstream surfaces as compared to a control heat exchanger tubing which was circulated with untreated cooling water. In addition, low numbers of mussel veligers were found in debris accumulation on the fabric material itself, although these organisms apparently did not metamorphose to juveniles—as neither juveniles nor adults were present on downstream surfaces.

### Skirt Tank—Test Results

According to the researchers, the skirt tank showed a considerable deterrent to biofouling especially nearer the treated fabric lining the tank wall and especially for preventing mussel, bryozoan, sponge and snail biofouling as compared to the strip tank wall that served as a control. Low numbers of mussel veligers were found in the debris accumulation on the skirt fabric, but they apparently did not metamorphose to juveniles as neither juveniles nor adults were present on the skirt.

The arrangement of the treated fabric in the replaceable material configurations tested and multiple downstream artificial surface plates provided an opportunity to observe biofouling differences over a distance of 65 cm after water ceased contact with one embodiment of the treated fabric (e.g., when the water stream exited the system water outlet) ranging from close to the fabric material to the multiplate and other surfaces located more distant from the treated fabric. An analysis demonstrated that Zebra mussels were effectively zero on the fabric material itself, with 7 organisms per square meter (7/m²) on the multiplate artificial surfaces and 31/m² on the most distal downstream location analyzed. Bryozoan biofouling was zero at the fabric material, to ˜1% coverage on the multiplate, to ˜10% coverage on the most distal location. Sponges and snails were consistently absent on the fabric material, the surfaces (e.g., multiplates) and the most distal locations. In general, the biofouling was considerably lower in all downstream areas as compared to fouling of equivalent control areas.

### Material Life

In the disclosed test systems, the treated material strips demonstrated a capacity to provide at least 4 months of protection from biofouling organisms for a water flow at a distance of 65 centimeters from an outlet of the strip tank. Biofouling was considerably lower in the treated water stream compared to a control (untreated) water stream for all water stream distances. Surfaces positioned within the treated water stream showed a considerable deterrent of invertebrate biofouling organisms including zebra mussels, bryozoans, sponges, and pulmonated snails. Low numbers of mussel veligers were found in the debris accumulation within the treated water stream, but these organisms never metamorphosed to juveniles or adults. Zebra mussels were present at greatly reduced levels within a meter of the strip tank outlet, and sponges and snails were consistently absent within the strip tank, on the fabric material, on downstream surfaces and at a furthest position downstream. The cooling tube inner walls exposed to treated water contained some lesser level of debris accumulation compared to control tube surfaces. Water turbidity was significantly higher near control surfaces than within the treated water flow, and a significantly thicker layer of biofilms were present on control surfaces as compared to surfaces within the treated water stream.

### Sediment Ingestion and Self-Cleaning

One significant benefit of various disclosed embodiments is an ability of some system components to provide adequate antifouling protection for extended periods of time at a wide variety of water flow rates and/or capacities, even where the raw water may contain a significant quantity of suspended solids and/or sediments. In this regard, various of the disclosed systems possess an ability to ingest, accommodate, process and/or purge large quantities of natural/artificial sediments, suspended solids and/or other materials through the system without clogging the antifouling system components or significantly reducing the system's antifouling effectiveness. Sediments, suspended solids and/or other materials are highly prevalent in natural or raw water, and these particulates are often made up of tiny grains of organic and/or inorganic materials like silt, sand, wood, plant fragments, rust or clay, plastics and/or metals as well as various fouling and non-fouling organisms. Sediments and turbidity (the even tinier pieces of sediments) are naturally occurring features of virtually all natural water sources, and the prevalence and distribution of these materials can be highly dependent upon a wide variety of factors, including increases/decreases in natural source water flow rates (e.g., increases in water volume after a big rain storm) as well as artificial sources (e.g., when water distribution systems or fire hydrants are used, flushed and/or repaired or as pipes deteriorate or are replaced).

In conventional filtration devices, sediments and other particles are typically removed from water flow by filters which commonly capture, retain and/or redirect these particles in the fluid flow. For example, some filters create a “cake” on the filter during the course of filtration, wherein the cake typically grows over time as particulate matter is retained on an inlet side of the filter. With increasing particulate layer thickness and/or density, the flow resistance of the filter cake generally increases. After a time, the filter cake must typically be removed from the filter, or water flow through the filtration medium is disrupted because the viscosity of the filter cake gets too high, and little to none of the aqueous fluid can continue to pass through the filter cake and the filter (e.g., the filter becomes clogged).

In various of Applicant's disclosed antifouling systems, however, sediments, suspended solids and/or other materials that may be carried into the antifouling device by the raw water flow will not clog or significantly impeded the antifouling effectiveness of the permeable material and related components, but these particulates are rather passed through the system components by a variety of flow mechanisms and/or self-cleaning features. More specifically, the cartridge design and spiral wound material configuration will desirably create fluid flow patterns that inhibit and/or prevent significant cake formation and/or sediment capture during system operation. For example, in the illustrated embodiment of FIG. 10, the placement and construction of the openings 235 in the inlet conduit 234 desirably direct a higher velocity flow of raw water into the flow channel at a location near and/or adjacent to the bottom of the spiral use configuration 220. In this regard, the position and configuration of the openings 235 desirably minimize quiescent or “slack water” zones in the inlet pipe and inlet water system, thereby inhibiting and/or preventing the deposition of sediment or other materials at the bottom of the inlet pipe. The raw water flow then travels through the vertical slots at a generally higher velocity, where this water initially contacts a substantially rigid vertical plate or frame member, which desirably redirects this initial “jet” of water away from the relatively more “delicate” or fragile wall surface of the permeable material and towards the arcuate channel path which extends between the spiral material walls. This “jet” of higher velocity water also can scour portions of the bottom surface within the spiral, further limiting and/or removing sediments or other deposits from the bottom surfaces inside the cartridge. Once in the spiral use configuration 220, the water flow can then follow a primary flow path along the spiral interwall path between adjacent material walls, with various portions of the water likely following a plurality of secondary flow paths through various wall sections via the pores and/or openings in the permeable wall material (e.g., “leap-frogging” to an adjacent spiral section), which can separate and/or rejoin the channel flow path at numerous locations along the spiral channel. Such secondary fluid movement can occur at almost any point along the spiral wall path, and depending upon localized pressure gradients and/or turbulent flow (as well as the effects of any particulates or other materials suspended in the water flow), such secondary flow might occur into and/or out of a given portion of a material wall at any given time point. Moreover, in many cases the bulk water flow will similarly travel generally upwards in the spiral (e.g., in a helical wound path) from the inlet openings (towards the bottom of the housing) to the outlet opening (located towards the top the housing). Because the bulk water flow will travel generally upward during its helical path from the inlet to the outlet, this bulk water flow can lift, suspend and expel many of the sediments and/or other particles that pass into and/or through spiral material, reducing and/or eliminating sedimentation or other buildup within the cartridge.

Another significant improvement in various disclosed embodiments relates to the water flow which travels along the arcuate path(s) or channel(s) between the adjacent walls of the material, as this channel flow can typically carry large amounts of particulate matter in the water flow completely through the device without allowing the particulates to adhere or settle on various material surfaces. This first flow path of the water or other fluid through the spiral wound pathway of the material will desirably travel along the curved arcuate path between the material walls. This water can travel at a relatively high velocity within the spiral, and when it passes over an “inside” surface of the curved walls (and to some extent the opposing “outside” surface of the curved walls), this water flow tends to dislodge, remove or otherwise “scour” any large particulates or flocs that might contact, form on and/or attempt to adhere to the material and/or “plug” the pores or openings in the permeable wall material, including any particulates or materials that may possess electrochemical cohesion. Moreover, the rotation path of the fluid around the material desirably creates a scouring action near the relatively flatter top and bottom surfaces of the device, which reduces and/or eliminates settling and/or floccing of sediments or other materials in those locations.

As another example, the pores of the material may be designed to be too small to allow the passage of various larger and/or mature fouling organisms through said pores, which might result in many of these larger organisms being drawn against and/or held at least partially within the pores—which contact may allow a chemical coated on or in the material (e.g., a biocide) to directly impact such larger organisms without requiring an equivalent high concentration of such chemical suspended throughout the entirety of the water flow. Desirably, the sideways or tangential channel water flow across the material causes a shearing effect on the surface of the material, potentially removing such larger organisms from the material surface and allowing other large organisms to be subsequently contacted and treated in a similar manner. By potentially inhibiting or limiting the passage of larger organisms through the walls of the material and applying highly effective doses of a chemical directly to the organisms as they contact and/or pass along or near (or through) the coated material, the present antifouling system provides for highly effective fouling protection without requiring high concentrations of additives suspended and/or eluted within the water flow.

In addition to scouring of the surfaces within the cartridge, the broad range of variability in the movement of fluid within the disclosed embodiment can also cause the flexible material to attempt to deform to a variety of ways in an effort to accommodate localized pressure differentials and/or flow dynamics within the device. Both the trans-pore flow and the channel flow, and the interactions therebetween, create highly complex fluid flow phenomena within the cartridge. For example, fluid flow passing through the pores (e.g., a myriad of tortuous micro-channels of different cross-sectional areas) creates a variable advection velocity field leading to a form of dispersion, while differing turbulent flow phenomena and boundary layer dynamics can proliferate within the channel flows, which can be further complicated by the various interaction zones which separate these two types of flow. Because the water flow and resulting flow regime differentials within the device can vary in different localized areas, the material can experience varying forces at different times and/or locations, which can cause the material (or individual portions thereof) to bend, deform, move, “flap” and/or “flutter” in a variety of ways and directions in a localized manner during system operation (e.g., in response to turbulent vortices in the fluid flow, among other factors) as well as during period of flow pressure or rate variation, which motions can mechanically dislodge particulates from the surface and/or interstices of the material (in a manner similar to beating a rug to remove dust and dirt particles for release to the air). These resulting “movements” of the material can be quite desirable, in that they can cause sediments or other suspended solids (and/or fouling entities) to separate or be removed from the material in a self-cleaning manner and can also inhibit or prevent deposition of such particulates, thereby enhance the ability of the cartridge and the material therein to accommodate and/or remove sediments or other suspended solids without clogging the system or significantly degrading component performance.

In the disclosed embodiment, the upper and lower edges of the spiral material can desirably be secured to upper and lower endplates, such as using an adhesive or epoxy (or other attachment means known in the art), while the inner edge of the spiral material can be secured to the redirection plate (attached to the inlet tube) as previously described, and the outer edge of the spiral material may optionally be secured to a stiffening beam (not shown). Desirably, the remainder of the flexible, permeable spiral material (e.g., located between the upper and lower endplates) remains generally free to move within the edge and/or end constrains such attachments provide, with the material desirably non-tensioned between the endplates in various embodiments (although tensioning of the material may be desirous in some applications). Because the permeable spiral material is flexible, it can desirably deform to accommodate the dynamic flow conditions within the cartridge, with such wall movement resulting in little or no sediments or other materials depositing or remaining on the walls, as such items are constantly removed or “scrubbed” from the walls through a combination of scouring action by the flowing water and flapping or snapping movement of the wall itself to dislodge any attached sediments. Any sediments or other materials which enter the cartridge are thus unlikely to become captured or entrained by the material or the cartridge structure, and thus the sediments/materials will be ejected and pass through the outlet.

Another significant benefit of the disclosed embodiments is the ability of the disclosed system components to induce trans-pore flow water through the walls of the material while inhibiting or preventing clogging and/or caking of the spiral wound material. A unique feature of the water flow within the continually bending material spiral is the presence of a radial pressure gradient created by inertia and/or centrifugal forces acting on the fluid molecules. Because of this, the fluid at the center of a curved passage moves towards the outer side and comes back along the wall towards the inner side. The pressure losses suffered in a bend are caused by both friction and momentum exchanges resulting from a change in the direction of flow of the individual water molecules. Both these factors depend on the bend angle, the curvature ratio and the Reynolds Number of the fluid. The overall pressure drop can be expressed as the sum of two components: 1) resulting from friction in a straight passage of equivalent length which depends mainly on the Reynolds number (and the surface roughness of the boundary material); and 2) resulting from losses due to change of direction, normally expressed in terms of a bend-loss coefficient, which depends mainly on the curvature ratio and the bend angle.

In various disclosed antifouling systems with spiral use configuration, the presence of the material spiral can desirably cause the water flow following the channel flow path to continually turn or bend around the spiral, which can create a localized area of somewhat higher fluid pressure on an inward facing wall of an adjacent material (e.g., occurring on the outward positioned material spiral), and a comparable localized area of somewhat lower fluid pressure on an outward facing wall of the next adjacent face of the material (e.g., occurring on the inward positioned material spiral), thus creating a pressure differential between the opposing faces of each material sheet. This pressure differential, as well as various momentum transfers within the fluid, can induce some amount of the fluid flow to attempt to pass through the pores of the material while other fluid flow continues down the channel. While through-wall and/or trans-pore passage of the fluid through the material is highly desirable in many of the disclosed embodiments, such flow can often be accompanied by the presence of sediments or other suspended solids which may promote particle deposition on the walls of the material, potentially occluding or clogging the small openings in the material to varying degrees (e.g., resulting in formation of a filter “cake” on or clogging of the permeable surface). In the present embodiment, however, sediments or other suspended solids will not readily form such a “cake” on the surface of the permeable material for a number of reasons, including (but not limited to): (1) the lateral movement of water flow along the channel walls, which “scours” or self-cleans such sediments or other suspended solids off of the channel wall surfaces, (2) the movement, “flapping” or “fluttering” of the flexible material walls which occurs during operation of the system, which can cause sediments or other suspended solids adhered to the channel wall surfaces to separate from such surfaces or not initial adhere, (3) the introduction of water flow at a lower point within the device (e.g., the inlet openings), which creates a bulk upward flow of the water through the device, which tends to lift, sustain and/or remove sediments or other suspended solids from various locations within the cartridge, (4) the employment of a slotted inlet openings and deflection surface which creates a high pressure jet of water along the lower portions of the material spiral, which cleans and removes sediments or other suspended solids from the bottom surfaces of the cartridge and material, and (5) the passage of fluid through the pores of the material, which tends to eject and/or prevent particulates from landing on and adhering to the inner walls of the channel. Desirably, a rate of particulate erosion and/or removal from the walls of the material (and/or throughout the device surfaces in general) will equal or exceed any rate of particulate deposition occurring within the device, such that no appreciable amounts of such particulates will be retained by the device and/or the spiral use configuration therein.

By reducing the presence of fouling organisms and/or altering normal biofilm formation within the conditioned fluid, the present antifouling systems may also desirably reduce much of the settling and/or collection of sediments, scales and/or other deposits within various locations of the water system. In addition to potentially creating depositional or sedimentary environments, fouling organisms and/or certain biofilms within a water system can form on both suspended and bedload sediments, potentially causing these materials to settle, adhere and/or accumulate in undesired regions of the system. Moreover, biofouling is known to accelerate the process of scaling in water systems, and thus avoiding such fouling occurrence can reduce and/or eliminate the formation of scales and/or other deposits within various locations of the water system.

### Inducement/Creation of Fouling Protection

Fouling protection of wetted surfaces within an aqueous system can entail a multi-pronged evaluation and analysis of a variety of factors. The speed and extent of which a surface is fouled can be due to a one or more of the following factors (e.g., alone or in various combinations thereof): (1) the composition and conditions of the fluid within the aqueous system (e.g., water chemistry factors), (2) the vitality and other conditions of the fouling organism (e.g., health, settlement and growth factors), (3) the conditions and composition of biofilms to which the fouling organisms can attach and/or otherwise interact, and/or (4) factors relating to the interaction between the fluid and surrounding surface boundaries/conditions (e.g., water pressure and flow rate, surface composition, profile and texture, heat transfer effects, etc.). By addressing one of more of these individual factors, or various combinations thereof, the disclosed antifouling systems and their components can create and maintain highly effective barriers to biofouling for extended periods of time. In various embodiments, the disclosed antifouling systems and associated components of a water system can desirably cause or facilitate (1) the direct or indirect establishment of water chemistry differences within portions of the water system, (2) the application to or treatment of water or other fluids with a variety of chemicals, eluants, additives and/or biocides, and (3) the formation of unique biological coatings, layers and/or biofilms on wetted surfaces within the water system, desirably to accomplish a reduction in the amount and/or extend of biofouling within portions of the water system.

Unlike prior art methods of protecting submerged surfaces from the effects of biofouling and other aquatic degradation, various embodiments of Applicant's disclosed inventions, systems and related methods seek to control fouling from an early stage using various combinations of physical and/or chemical control mechanisms or “cues” that can leverage a fouling organism's natural tendencies to avoid and/or prefer certain environmental conditions, chemical compounds and/or surface biofilm characteristics, which can result in highly durable and effective fouling protection that is easy to create and maintain and desirably results in little or no adverse environmental effects. In some aspects of the invention, the reduction and/or prevention of biofouling may be at least partially due to the impact of various “cues” which may exist in the water system and/or on various wetted surfaces. Some cues can encourage or facilitate settlement and colonization on surfaces by micro and/or macro-organisms, while other cues may discourage such activities, while still other cues may be relatively benign or neutral in their effects on an individual organism or species. In various aspects, the disclosed antifouling system components may create or induce a variety of water chemistry differences and/or may incorporate and/or release additives, chemicals, biocides and/or other substances which injure, stun and/or otherwise render fouling organisms less likely and/or incapable of settling, attaching, colonizing and/or growing on the protected wetted surfaces of the water system. By leveraging fouling and non-fouling organisms' natural competitive tendencies as well as their propensity to seek and/or avoid certain environmental conditions and/or other chemical cues, Applicant's disclosed systems, methods and/or devices can create highly effective barriers to biofouling for extended periods of time without loss of fouling effectiveness or significant contribution to the development of fouling resistance or environmental toxicity. For example, during testing of a successful use configuration of a spiral shape, a live fish was found within the defined volume—illustrating the lack of toxicity within the treated environment.

In various embodiments, an inhibition of fouling can be represented by a reduction in total cover or total cover increase of the protected surface and/or the material/device surface(s)/interstices by fouling organisms, compared to the total fouling cover or increased fouling cover of a substantially similar surface (e.g., without an antifouling system) submerged, partially submerged and or wetted in a substantially similar aquatic environment, which could be measured by visual inspection, physical measurement and/or based on an increased weight and/or volume of individual components and/or the combined surface and material/cartridge (e.g., with the increased weight due to the weight of the fouling organisms attached thereto) when removed from the aqueous medium. This reduction in fouling could be a 10% reduction in fouling or greater, a 15% reduction in fouling or greater, a 25% reduction in fouling or greater, a 30% reduction in fouling or greater, a 40% reduction in fouling or greater, a 50% reduction in fouling or greater, a 60% reduction in fouling or greater, a 70% reduction in fouling or greater, an 80% reduction in fouling or greater, a 90% reduction in fouling or greater, a 95% reduction in fouling or greater, a 98% reduction in fouling or greater, a 99% reduction in fouling or greater, a 99.9% reduction in fouling or greater, and/or a 99.99% reduction in fouling or greater. In various embodiments, this reduction may be measured in a variety of ways, including by weight, volume and/or extent of fouling organisms. In one example, weight increases might be determined in a wetted and/or dried state (or other humidity level), which may significantly affect the degree of total weight change for a given system design, especially where soft bodied fouling organisms and/or biofilms and their effects are being analyzed and compared.

Alternatively, the inhibition of fouling on the protected article(s) could be represented as a percentage of the amount of fouling cover and/or fouling mass (e.g., by volume and/or weight) formed on an equivalent unprotected surface. For example, a protected article could develop less than 10% of the fouling cover of an unprotected surface (such as where the protected surface develops a fouling cover less than 0.254 cm (0.1″) thick, and the unprotected equivalent surface develops a 2.54 cm (1″) thick or greater fouling cover), which would reflect a more than tenfold reduction in the fouling level of the protected surface and/or material/cartridge walls as compared to the fouling level of the unprotected surface. In other embodiments, the protected article could develop less than 1% fouling, or a more than one hundredfold reduction in the fouling level of the protected surface and/or material/cartridge walls. In still other embodiments the protected article could develop less than 0.1% fouling, which is more than a thousand-fold reduction in the fouling level of the protected surface and/or material/cartridge walls. In even other embodiments of the present invention, the protected surface and/or walls of the system components may have no appreciable fouling in any affected area(s) of the surface and/or material/cartridge walls, which could represent a 0.01% (or more) or even 0% fouling level of the protected surface and/or material/cartridge as compared to an unprotected surface (e.g., greater than a ten thousand fold reduction in the fouling level of the protected surface and/or material/cartridge walls—or more). The present disclosure hereby incorporates by reference herein ASTM D6990 (including ASTM D6990-20) and the Navy Ship Technical Manual (NSTM), which are known reference standards and methods used for measuring and describing exemplary amounts of fouling percent coverage and fouling thickness on a surface.

In still other alternative embodiments, a successful inhibition of fouling might be represented by a reduction in total cover, total cover increase, percentage of the amount of fouling cover and/or fouling mass of a given targeted fouling organism (or organisms) on the protected surface and/or the material/device surface(s)/interstices, even where other organisms (e.g., non-targeted organisms and/or neutral or relatively benign organisms) may actually increase in prevalence to some degree in these locations.

### Water Chemistry Changes and Artificial Environments

In various aspects of the present invention, the proper design and use of antifouling system components, such as described herein, can create artificial conditions within areas of the water system which influence and/or induce the behavior of biofouling organisms to effectively reduce and/or prevent the settlement of biofouling organisms on protected surfaces. While the employment and application of large quantities and/or high concentrations of caustic compounds, toxins and/or biocides are well accepted approaches for addressing certain types of biofouling, what is not well known is that a wide variety of non-toxic and/or non-biocidal compounds and substances (as well as extremely low or “trace” levels of known chemicals, toxins and/or biocides currently utilized for fouling control in much higher concentrations) and/or natural or artificial processes can have a significant effect on fouling organisms, many of which can be leveraged using various of the disclosed antifouling system components and related methods. In some embodiments, it may be the presence and/or absence of certain “welcoming” or “unwelcoming” cues on a surface to be protected (and/or on or in an associated biofilm) that may provide extended fouling protection for the surface. Controlling and/or influencing the presence, absence and/or other activity of such substances within various features of the water system, therefore, may have equivalent or greater antifouling effects than many of the current commercially available antifouling system which utilize large quantities and/or high concentrations of caustic compounds, toxins, biocides and/or other chemicals or compounds, but without the deleterious effects on system components, efficiencies and/or adverse environmental effects known to result from such commercial systems.

In some embodiments, water chemistry differences in the water system can be directly caused and/or influenced by the addition and/or removal of chemicals and/or compounds, while in other embodiments the antifouling system may create artificial conditions within the water system which induce various natural and/or artificial processes or progressions to create desired water chemistry differences which result in antifouling effects in various portions of the water system.

### Water Chemistry Differences

In various embodiments, the disclosed antifouling system components will desirably create one or more treated aqueous environments within and/or in the vicinity of the antifouling device and/or material and/or substantially downstream therefrom, which environments may be referred to as a “conditioned” or “treated” environments which may be less conducive to micro and/or macro-fouling of surfaces therein than would equivalent surfaces within a water flow that may be upstream of the conditioned environment (an “upstream environment”) or a similar environment where the antifouling system components have not been installed and operated (an “open” or “untreated” environment). In some embodiments, the presence and operation of the various antifouling system components may induce existing organisms and/or other factors to independently create water chemistry differences in the treated environment that affect settlement and/or growth of biofouling organisms, while in other embodiments coatings, additives, elutes and/or optional biocides may be employed, where the presence and/or release of these substances by components of the antifouling system may create various “differences” in the composition and/or distribution of various environmental factors, water chemistry factors, dissolved oxygen, and/or compounds within the conditioned environment and/or the water system as compared to similar factors and/or compounds within a normal open aqueous environment—with these “differences” potentially inhibiting and/or preventing significant amounts of biofouling from occurring (1) on any protected surfaces, objects and/or substrates, (2) on the inner or outer wall surfaces of the cartridge and/or the water flow system, and/or (3) on the surface of the material and/or within the interstices of openings and/or perforations in the material. Moreover, antifouling system components may create or induce the formation of a gradient of settlement cues or other water chemistry differences within the aqueous environment that induces and/or impels some and/or all of the micro- and/or macro-fouling organisms to avoid protected surfaces or other areas of the water system, while in other embodiments the various system components may create a microenvironment proximate to protected surfaces that may be conducive to desirable and/or non-fouling organisms, where such desirable and/or non-fouling organisms may injure, drive away, displace and/or “out compete” the unwanted fouling organisms, thereby reducing and/or eliminating fouling on the protected surface.

In some exemplary embodiments, water chemistry “differences” may include a difference of 0.1% or greater between inside (treated)/outside (untreated) measurements, or a difference of 0.01% or greater between inside/outside measurements, or a difference of 0.001% or greater between inside/outside measurements, or a difference of 0.0001% or greater between inside/outside measurements, or a difference of 2% or greater between inside/outside measurements, or a difference of 5% or greater between inside/outside measurements, or a difference of 8% or greater between inside/outside measurements, or a difference of 10% or greater between inside/outside measurements, or a difference of 15% or greater, or a difference of 25% or greater, or a difference of 50% or greater, or a difference of 100% or greater. In addition, such differences may be for a plurality of chemistry factors with unequal differences or may include an increase of one factor and a decrease of another factor. Various combinations of all such described water chemistry factors are contemplated, including situations where some water chemistry factors remain essentially the same for some factors, while various differences may be noted for other factors.

For example, in some of the disclosed antifouling systems and/or associated reservoir systems or other components described herein, the system can optionally provide (1) a barrier to significant levels of oxygen transport into the water supply system, and/or (2) a potential reduction of available energy and/or nutrient supplies within the reservoir for organisms and/or chemical reactions, which may reduce and/or prevent natural photosynthesis or other metabolic processes of microorganisms and/or undesirably chemical reactions from occurring within the reservoir or other system locations. In various embodiments, the antifouling systems described herein may desirably induce a differential in the dissolved oxygen levels and/or other water chemistry levels of the aqueous environment (e.g., within the downstream aqueous environment as compared to dissolved oxygen levels—or other water chemistry constituent—upstream from the system components) by at least 10%, by at least 15%, by at least 20%, by at least 25% by at least 50% by at least 70% by at least 90% or greater.

In many of the embodiments described herein, antifouling system may cause or induce some water chemistry features in the treated water to be “different” as compared to the surrounding aqueous environment, while other water chemistry characteristics within the treated water may remain the same as in the surrounding aqueous environment. For example, where dissolved oxygen levels may often be “different” between the differentiated environment and the open environment, the temperature, salinity and/or pH levels within the differentiated and open environments may be similar or the same. Desirably, the antifouling system can affect some water chemistry features in a desired manner, while leaving other water chemistry features minimally affected and/or “untouched” in comparison to those of the surrounding open aqueous environment. Some exemplary water chemistry features that could potentially be “different” and/or which might remain the same (e.g., depending upon enclosure design and/or other environmental factors such as location and/or season) can include one or more (or any combinations thereof) of dissolved oxygen, pH, total dissolved nitrogen, ammonium, ammoniacal nitrogen, nitrates, nitrites, orthophosphates, total dissolved phosphates, silica, alkalinity, salinity, temperature, turbidity, chlorophyll, etc., the various concentrations of which may increase and/or decrease at differing times, including differing concentrations of individual constituents at different durations of cartridge immersion.

### Optional Biocides

In various exemplary embodiments, the disclosed device(s) contemplate and/or may incorporate the use of optional biocides, toxins, and/or antifouling agent(s) in the material to provide biofouling protection for various wetted surfaces within the water system, including protection for the material itself, as well as protected surfaces and/or water intakes/outlets. In many embodiments, at least a portion of a surface of a material within an antifouling device may be impregnated by, infused with, coated by and/or impregnated with a biocidal substance, paint, coating, pigment and/or additive.

### Coatings/Biocides/Useful Life

In various embodiments, biocidal and/or antifouling agent(s) may be integrated into the cartridge/material and/or other system components and/or other portions thereof to desirably protect the antifouling system itself from unwanted fouling. In general, a biocide or some other chemical, compound and/or microorganism having the capacity to destroy, deter, render harmless and/or exert a controlling effect on any unwanted or undesired organism by chemical or biological means may optionally be incorporated into and/or onto some portion(s) of the material, such as during manufacture of the material or material components, or the coating and optional biocide et al can be introduced to the material after manufacture. Desirably, the one or more biocides in/on the material alter the natural colonizing sequence and inhibit and/or prevent colonization of aquatic organisms on the material surfaces and/or within openings within the material and the cartridge or other system components, as well as to repulse, incapacitate, compromise and/or weaken biofouling organisms small enough to attempt or successfully penetrate through the openings in the material within the cartridge or alternatively an external biocide release/control mechanism, such that they are less able to thrive within the artificial or synthetic local aquatic environment downstream of the antifouling system. In various embodiments, the cartridge desirably incorporates a material which maintains sufficient strength and/or integrity to allow the protection and/or inhibition of biofouling (and/or enables the creation of the desired artificial local aquatic environment or synthetic local aqueous environment) for a useful life of not less than about 3 to 7 days, 7 to 15 days, 3 to 15 days, at least 1 month, at least 2 months, at least 3 months, at least 6 months at least 12 months, at least 2 years, at least 3 years, at least 4 years and/or at least 5 years or longer.

### Biocide can Protect Cartridge Components and Material

In various embodiments, the antifouling device can include a biocide coated and/or impregnated material (such as within one or more structures arranged in a use configuration) which will desirably inhibit biofouling growth onto and/or within the device itself and/or components therein, which will greatly enhance the performance, service life and/or serviceability of components within the antifouling system. The presence of the biocide in various embodiments will desirably inhibit attachment, settling and/or growth of organisms on the outer and/or inner surfaces of the device or components therein, which can maintain flexibility of the material and/or device components as well as significantly reducing the chance for ripping, tearing and/or other failure of the material due to the presence and/or increase in gross weight caused by the fouling organisms. In addition, the presence and distribution of the biocide will further desirably prevent and/or inhibit fouling organisms (especially spores, propulgates, larvae and/or juvenile forms) from attaching, settling and/or growing within the openings and/or “pores” of the material, as well as desirably inhibit fouling organism activity on or in sediments or other objects within the water flow. In many cases, a distinction can be made among ‘microfouling’ (often referred to as ‘slime’) due to unicellular microorganisms such as bacteria, diatoms and protozoa, which form a complex biofilm; ‘soft macrofouling’ comprising macroscopically visible algae (seaweeds) and invertebrates such as soft corals, sponges, anemones, tunicates and hydroids; and ‘hard macrofouling’ from shelled invertebrates such as barnacles, mussels and tubeworms. It is often possible that a given remediation and/or chemical treatment, biocide and/or antifouling agent dosing level may have differing effectiveness on juvenile and adult members of the same species, as well as differing effectiveness based on a host of water chemistry factors, including pH, dissolved oxygen levels, water temperature, and/or many other factors.

### Biocides—Multiple Additive Ratios

A wide variety of supplemental coatings incorporating various biocides and/or other dispensing and/or eluting materials may be incorporated into a given antifouling system design to provide various antifouling advantages. For example, coatings which release Econea and/or zinc pyrithione in varying amounts and/or timing can be useful in combatting biofouling—with Econea primarily targeting “hard shell” organisms and zinc pyrithione or copper pyrithione primarily targeting “soft or no shell” organisms—including embodiments having initially high release rates which significantly reduce after only a few hours, days and/or weeks after immersion, as well as other embodiments having initially low release rates which increase over time of immersion. An exemplary coating can incorporate a single biocide or biocide formulation that targets one or more fouling species, or a coating can incorporate two or more biocides or biocide formulations in varying ratios (such as, for example, combinations of Econea and zinc pyrithione in a single coating formulation), with each biocide optionally targeting one or more different fouling species and/or differing life stages of a similar fouling organism. The selected biocides and their concentrations may vary based on a given application and type of biofouling, which may be dependent upon a variety of factors including the type of aqueous environment, the geographic location of fouling protection, the season of the year, various local fouling pressures, the specific water application for the antifouling enclosure, the design and features of the antifouling system, the desired duration of fouling protection and/or the material and/or type of surface(s) for which protection is desired. In some exemplary embodiments, a ratio of a first biocide to a second biocide in a coating formulation can be approximately 1:1, approximately 1:2, approximately 1:3, approximately 1:4, approximately 1:5 approximately 1:10. Approximately 1:15, approximately 1:20, approximately 1:255, approximately 1:50, approximately 1:100 or greater. In one particularly useful embodiment, a ratio of Econea to zinc pyrithione (or copper pyrithione) can be approximately 3:1 (e.g., 75% Econea to 25% zinc or copper pyrithione) in an exemplary coating formulation that targets both hard- and soft-shell organisms.

### Fouling Protection—Specific Organisms—Time of Protection

In various embodiments, the antifouling system components described herein can significantly reduce and/or eliminate biofouling by native taxa including small nematodes, crustacean such as cladocerns, rotifers, gastrotrichs, oligochaete worms, diatoms, protozoa, dreissenid quagga/zebra mussels, and ectoproct bryozoans. The various embodiments and materials described therein can include replaceable material suitable for extended periods of time and/or specified minimum volumes of water or other fluids passing therethrough. For example, one embodiment may provide at least 1 days' worth of reduced settlement of biofouling organisms on downstream surfaces, while other embodiments may provide multiple days of effective protection, a week's worth of protection, two weeks' worth of protection, a month's worth of protection, or 6 months of protection, a year's worth of protection, two or more years' worth of protection, at least 5 or more years' worth of protection and so on. In various embodiments, the antifouling systems disclosed herein can substantially reduce settlement and colonization of fouling organisms such as quagga and zebra mussels by 86% or greater compared to an unprotected system. Other embodiments may prevent settlement and colonization of mature quagga mussels and zebra mussels for at least 4 months on a surface. Early veligers zebra mussels which pass through the antifouling system may be capable of settling but fail to grow from juvenile to adult stage. The point of impact may be between metamorphosis from the early veliger to the pediveliger stage.

### Targeting Specific Organisms

In many instances, specific species of fouling organisms will survive and thrive within an optimal range or ranges of conditions, including ranges of temperature, oxygen or other dissolved gas levels, dissolved solid levels, pH, water flow rate and other conditions. With regards to water flow rates, specific optimal flow rates will cause biofouling often depending on the type of fouling organism. Many fouling organisms have adapted to “higher” flowing waters to survive; for example, zebra mussels were originally river species and thrive in higher flow rates. The optimal flow rate for many fouling organisms can be dependent on the organisms' ability to swim and what/how they eat (e.g., higher flow rates often help to deliver food to immobile or less mobile organisms and/or filter feeders). Often, if a flow rate gets too low or below a critical low flow level for the organism, the organism may “starve,” start to breakdown and become unhealthy due to lack of food and nutrients (including dissolved oxygen, nitrogen and/or other factors). If a flow rate becomes too high, some organisms may not have the time or means to settle and/or flourish on a surface. In general, most organisms have a “sweet spot” for their optimal flow rate, which may be exploited in some embodiments as part of an antifouling system.

In various embodiments, the ability of a given antifouling system design to inhibit and/or prevent fouling of a surface and/or water system component may vary with a variety of factors, including water flow, temperature, bio-floral type, growing season, salinity, sunlight, available nutrients and/or oxygen, pollutants, etc. In some cases, a minimal amount or level of “treatment” may be necessary to achieve a desired level of protection, while in other embodiments more significant treatment levels may be necessary to achieve a desired result, especially in situations where biofouling may be more prevalent. In some instances, only a few seconds, minutes, or hours of fouling protection may be provided by the antifouling system components to a given quantity of water in the water flow, but such protection may be sufficient to provide a desired level of protection depending upon the type and/or construction of surface components to be protected and/or the water system design. For example, a heat exchanger located directly downstream from an antifouling device might require only a few seconds of antifouling effectiveness after the water leaves the antifouling device (such as where biofouling organisms may be momentarily “impelled” to avoid colonization and/or growth for a very short period of time), because in this brief period of time the water flow may have already passed through the heat exchanger tubes before the organisms regain their “fouling” ability and/or effectiveness. Thus, the fouling effectiveness time or effects needed for optimum results may be tuned or modified based on the application and/or targeted biofouling entities. Some applications may provide only 1 or 2 seconds of effectiveness for a given region of moving water flow, or only 5 seconds, or 10 seconds, 30 seconds, 1 minute, 4 minutes, 10 minutes, 30 minutes, 1 hour, 2 hours, 4 hours, 6 hours, 12 hours, 24 hours and/or a day or longer.

### Systems can Optionally Affect Young and Mature Organisms Differently

In some cases, a biocide may have very different levels of effectiveness on adult and juvenile members of the same species, with a significantly higher dosage of a given biocide often required to prevent fouling activities by larger and/or mature organisms as compared to the dosages needed to protect against smaller and/or juvenile organisms. In one exemplary embodiment, an antifouling system can include an optional biocide impregnated material or material along and/or through which some or all of a water flow may pass. Desirably, these embodiments of an antifouling enclosure or a similar treatment device will have a first effect on various mature and/or larger fouling organisms or other materials, including adult organisms of many fouling species, and larger settling larvae, like tunicates, and will have a second effect on various “smaller” and/or immature fouling organisms, where the first and second effects on the various organism types may be similar or different, including between mature and immature members of the same species, with such effects desirably resulting in an overall reduction and/or inhibition of fouling on a targeted or protected surface. Such inhibition can desirably include inhibition against colonizing wetted surfaces for a limited period of time, such as, for example, the amount of time necessary for a targeted fouling organism to pass through heat exchange tubing and/or the entirety of a water system (in a single-pass system, for example).

### Coating/Biocide—Swap Out Material

In various embodiments disclosed herein that may incorporate biocides or other releasable additives/components, a material with an optional coating containing various releasable components may be secured and/or otherwise contained within the antifouling device, which can allow the material (and/or a cartridge containing said material) to be replaced and/or “swapped out” if desired for maintenance and/or repair, including occasions where the level of a releasing or dispensing component, such as biocide releasing from the coating or material may have reached a minimal level, may have exceeded its useful life and/or may not be appropriate for a given fouling environment (e.g., seasonal changes in fouling effects may mandate seasonal replacement of cartridges to cartridges that target appropriate seasonal fouling entities). The treatment assembly can be operable as a vertical or horizontal unit with the spiral material (or other material packing arrangement) placed internally into the antifouling device and/or other component—thus the material can be easily replaced as necessary, either to modify the treatment characteristics and structural dimensions or to restore antifouling effectiveness as desired.

### Paints—Commercial Examples

In at least one exemplary embodiment, an antifouling device can comprise a spun polyester material having a surface and/or subsurface coating of a biocide paint such as Pettit Hydrocoat Blue non-solvent based paint (commercially available from Kop-Coat Marine Group of 36 Pine Street, Rockaway, NJ 07866 USA) or Sherwin Williams Seaguard Red solvent based paint (commercially available from Sherwin Williams Corp. of 101 W. Prospect Ave, Cleveland, OH 44115 USA), which are water-based and/or solvent-based coatings containing registered biocides, with the coating applied to the material by various means known in the art, including by brushing, rolling, painting, dipping, spraying, production printing, encapsulation and/or screen coating (with and/or without vacuum assist to augment and/or restore coating material permeability). Coating of the material may be accomplished on one or both sides of the material, as well as single-sided coating on the inner facing side of the materials, although single-sided coating on the outwardly facing side of the material (e.g., away from the surface and towards the open aqueous environment) has demonstrated some level of effectiveness while minimizing biocide content, cost, and maintaining advantageous flexibility. While water-based (“WB”) biocidal coatings are primarily discussed in various embodiments herein, solvent-based (“SB”) biocidal coatings can alternatively be used in a variety of applications (and/or in combination with water-based paints and coatings), if desired.

### Commercial Biocides

In various embodiments, an antifouling device may desirably include one or more additives and/or anti-biofouling agents(s) attached to and/or embedded within the material contained therein (e.g., the various elements of the material) to inhibit and/or prevent biofouling of the antifouling system and downstream thereof. In a preferred embodiment, an anti-biofouling agent for an antifouling material can be a coating which contains a combination of Econea™ (tralopyril or 4-bromo-2-(4-chlorophenyl)-5-(trifluoromethyl)-1H-pyrrole-3-carbonitrile—commercially available from Janssen Pharmaceutical NV of Belgium) and/or zinc omadine (e.g., pyrithione) in various ratios and/or combinations. Alternatively or in addition, other anti-biofouling agents currently available and/or developed in the future can be used in a wide variety of combinations, such as zinc, copper, silver, other metals or derivatives thereof (including powders, particles, nanoparticles and nanowires thereof), as well as other anti-biofouling agents known to one of skill in the art. Moreover, antifouling compounds from microorganisms and their synthetic analogs could be utilized, with these different sources typically categorized into one or more of ten types, including fatty acids, lactones, terpenes, steroids, benzenoids, phenyl ethers, polyketides, alkaloids, nucleosides and peptides. These compounds may be isolated from seaweeds, algae, fungus, bacteria, and marine invertebrates, including larvae, sponges, worms, snails, mussels, and others. One or more (or various combination thereof) of any of the previously described compounds and/or equivalents thereof (and/or any future developed compounds and/or equivalents thereof) may be utilized to create an antifouling system which prevents both microfouling, such as biofilm formation and bacterial attachment, and macrofouling, such as attachment of large organisms, including barnacles or mussels, for one or more targeted species, or may be utilized as a more “broad-spectrum” antifoulant for multiple biofouling organisms, if desired. In addition, it should be understood that a wide variety of biocides, pesticides, insecticides, herbicides, fungicides, disinfectants, sterilants and/or other substances and/or compounds could be incorporated into the various embodiments disclosed herein, including within coatings or the components of the materials themselves, including one or more of the various substances identified and/or approved/pending approval by various international regulatory authorities such as the United States Environmental Protection Agency—insecticides (https://www.epa.gov/caddis-vol2/insecticides), herbicides (https://www.epa.gov/caddis-vol2/herbicides), fungicides and pesticides https://www.epa.gov/pesticide-registration) and disinfectants (https://www.epa.gov/pesticide-labels/dfe-certified-disinfectants); the U.S. Food and Drug Administration—disinfectants and sterilants, the European Chemicals Agency—disinfectants, preservatives, pest control, and other biocidal products (see https://www.echemportal.org/echemportal/content/participants/701 and https://echa.europa.eu/information-on-chemicals/biocidal-active-substances), and relevant national chemical databases of member countries of the World Health Organization. The identification and disclosure of each of these substances and lists thereof are incorporated by reference herein, and the use of such substances, either in addition to those disclosed herein as well as in place of the various substances disclosed herein, alone or in any combinations thereof, are specifically contemplated by this disclosure.

### Biocide/Coating—Application Weights

In various embodiments, a biocide coating or paint can desirably be applied to the material in an amount ranging from, for example, 170 grams per square meter to 235 grams per square meter, although applications of less or more grams per square meter are contemplated, such as 150-190 grams per square meter, 170-180 grams per square meter, 170 grams per square meter or less, 100 grams per square meter or less, more than 235 grams per square meter, more than 300 grams per square meter, or other amount ranges. In various alternative embodiments, the coating mixture could comprise one or more biocides in various percentage weights of the mixture, including weights of 10% biocide or less, such as 2%, 5% and/or 7% of the mixture, or greater amounts of biocide, including 10%, 20%, 30%, 40% 50% and/or more biocide by weight of the coating mixture, as well as ranges encompassing virtually any combination thereof (e.g., 2% to 10% and/or 5% to 50%, etc.). Where the device and/or the material therein may be particularly large and/or a large water flow is anticipated, it may be desirous to significantly increase the percentage of biocide in the coating mixture, which would desirably reduce the total amount of coating required for protection of the material, the cartridge and/or any protected surfaces.

### Environmentally Friendly Biocides

In addition to creating localized conditions that inhibit fouling of a protected surface, many of the embodiments described herein can be extremely environmentally friendly, in that any toxic and/or inhospitable conditions created locally within the water flow from the antifouling system and/or its components can often quickly dissipate and/or be “neutralized” within and/or outside of the antifouling system. For example, while fouling organisms may be inhibited from settling within the antifouling system and/or attached water system, it is highly likely that such organisms might regain functionality once they exit the protected areas and/or the entire water system, which would result in no significant or lasting effect on the aquatic environment, even in close proximity to the antifouling system itself. This is highly preferable to existing antifouling devices and/or paints that incorporate high quantities, concentrations and/or levels of biocides and/or other agents, some of which are highly toxic to many forms of life (including fish and humans and/or other mammals), and which can persist for decades in the marine environment. More specifically, zinc pyrithione has a photo-degradation half-life of approximately 8.3±0.9 min, and decomposes rapidly in direct sunlight and when exposed to UV light in seawater, while Econea does not accumulate in the marine environment, due to its rapid degradation in sea water (3 h and 15 h at 25° C. and 10° C., respectively).

### Reduced Need for Active Intervention or Maintenance

As described herein, many of Applicant's disclosed antifouling systems can provide significant fouling protection with little or no need for constant monitoring and/or active user intervention, allowing the antifouling systems to provide fouling protection for extended periods of time in a variety of conditions. Moreover, even where bioactive substances may be utilized in combination with various disclosed system components, such active substances can be utilized in extremely low quantities and/or concentrations and still accomplish their desired fouling protective functions. In many embodiments, the active substances, other additives and/or biocides described herein can desirably break down extremely quickly within an aqueous environment, they will not transform into more toxic or persistent compounds, they do not create any chronic toxicity effects, and any potential deleterious effects of Applicant's disclosed systems, methods and/or devices are generally confined to a highly localized targeted region in which biofouling protection is desired, and thus will not contaminate the general food chain or remain persistent in the surrounding environment for extended periods of time. For example, in various embodiments, an antifouling system can incorporate a natural fiber material such as 80×80 burlap in the material, which may degrade relatively quickly and the underlying degradation process can contribute to a significant measurable pH difference within the water system, which may be useful in various aqueous environments. If desired, various embodiments could incorporate degradable and/or hydrolysable materials and/or linkages (e.g., between components and/or along the polymer chains of the component materials) that allow the components of the material to degrade after a certain time in the aqueous medium.

### Material—Coating—Flexible—Low Biocide Levels

In various embodiments, the additional incorporation of a biocide coating or other coating/additives in some embodiments may also improve durability and functional life of the material and/or antifouling device and/or its components, in that biofouling organisms and/or other detrimental agents can be inhibited and/or prevented from colonizing the flexible material and/or perforations therein for a period of time after immersion, thereby desirably preserving the flexible, perforated nature of the material of the system and the advantages attendant therewith. Where the biocide may be primarily retained proximate to the material (e.g., where the biocide may have very low or no biocide release levels outside of the material and/or the cartridge/canister), the biocide will desirably significantly inhibit biofouling of the cartridge and/or other antifouling system components, while the presence of the antifouling system and the conditioned or differentiated aqueous environment created adjacent to and/or downstream thereof will desirably reduce and/or inhibit biofouling of the protected water system, sediments therein and/or other surfaces. In various exemplary embodiments, it is possible for the biocide to have extremely low and/or no detectable levels in water downstream from the cartridge/canister and/or in water released from the water system (e.g., below 30 ng/L) and still remain highly effective in protecting the water system and/or system components from biofouling for a variety of reasons. In one example, biocide release rates from a coated fibrous material were detected as 0.2-2 ppm and/or lower between 7 days in artificial sea waters and low local concentrations (e.g. biocide release rates) were detected as 0.2-2 ppm and/or lower between 7 days in artificial sea waters, and these release rates were effective at protecting the fibrous materials and downstream protected surfaces from biofouling.

### Controlled/Continuous Release Rates

One unique feature of various of Applicant's disclosed embodiments is the ability of the disclosed systems to deliver a continuous or “baseline” level of biocide(s) and/or other substances into the water or other fluid flow, even for large quantities of water that pass through the canister and/or other portions of the water system. The bacteria and/or other organisms which make up a fouling community can be up to a thousand times more resistant to chemicals, biocides and/or antibiotics than the same bacteria/organisms grown in a controlled liquid medium. Various mechanisms responsible for such resistance include (1) the physical and chemical diffusion barrier that constitutes the matrix of the biofilm to the penetration of biocides/antimicrobials, (2) the slowed growth of biofilm bacteria/organisms due to possible nutrient limitations, (3) the existence of microenvironments that antagonize the action of biocides/antibiotics, and (4) the activation of stress responses, which cause changes in the physiology of the bacteria/organisms and the appearance of specific biofilm phenotypes that actively combats the negative effects of antimicrobial substances. Due to this resistance, antifouling substances which seek to treat and/or manage existing fouling communities and/or biofilms must be highly effective and incorporated at considerably high concentrations, which can lead to harmful effects on the environment and/or damage to the water supply system. In contrast, the continuous elution of biocide(s) and/or other substances provided by Applicant's disclosed embodiments can significantly impact and/or affect fouling organisms at a much more vulnerable stage—before they attach and/or integrate into the fouling community on a targeted surface.

In combination with the continuous flow of water or other fluids through the canister, this substance delivery can be highly effective at reducing and/or eliminating biofouling and its related effects within the canister itself and well as on downstream substrates and/or other substrates. While in some embodiments the quantity of biocide(s) and/or other substances incorporated into coatings used within Applicant's devices may be comparable to those of various commercially available products, Applicant has discovered that highly effective antifouling effects can be provided by a properly designed and operated system at much lower concentrations of such biocide(s) and/or other substances than previously considered possible.

In various embodiments, a biocide or other additive/active ingredient may be tuned or optimized to the environmental parameters, water chemistry, and/or types and amounts of organisms. Biocide concentrations, release rates and release profiles may vary based on water flow rates, water dwell times, water exchange, water mixing, water turbulence, water temperature, fouling growth seasons and/or similar factors. Total biocide released or dispensed may be calculated based on the total active ingredient or biocide per total volume of water consumption or water flow through, on or around the material over a set time within a water system. In a preferred embodiment, total biocide released in flowing water after 30 days may be at least 500 parts per million (ppm), at least 100 ppm, at least 80 ppm, at least 50 ppm, at least 40 ppm, at least 30 ppm, at least 25 ppm, at least 20 ppm, at least 15 ppm, at least 10 ppm, at least 5 ppm, at least 1 ppm, at least 75 parts per billion (ppb), at least 50 ppb, at least 10 ppb, at least 5 ppb, at least 1 ppb, or at least 0.1 ppb. In some embodiments, total biocide released in flowing water after 60 days may be at least 500 ppm, at least 100 ppm, at least 50 ppm, at least 50 ppm, at least 40 ppm, at least 30 ppm, at least 25 ppm, at least 20 ppm, at least 15 ppm, at least 10 ppm, at least 5 ppm, at least 1 ppm, at least 75 ppb, at least 50 ppb, at least 30 ppb, at least 10 ppb, at least 5 ppb, at least 1 ppb, or at least 0.01 ppb.

### Biofilm Formation

When an antifouling system such as those described herein is utilized, the biological colonizing sequence on surfaces within the cartridge and/or downstream, including such surfaces as heat exchanger tubing, may be interrupted (disrupted, altered, different, etc.) to reduce and/or minimize the settlement, recruitment and ultimate macrofouling of the surfaces, even in the presence of elevated water temperatures or pH. If desired, a coating may experience significant additive release upon initial placement around a surface to be protected, thereby potentially establishing an initial higher impacting level affecting fouling or other organisms, with the additive release levels significantly reducing over a period of time. In some embodiments, a material may optionally incorporate a coating containing an additive which initially releases and/or otherwise dispenses for a limited period of time after initiation of fluid flow, where the period of time may be sufficient to allow the water system to develop a differentiated environment, wherein the differentiated environment can generate various inhibitory substances to provide subsequent biofouling protection to the surface after the initial additive release has dropped to lower and/or ineffective levels and/or has ceased eluting, releasing and/or dispensing.

In various embodiments, the initial placement of an antifouling device or other system component in proximity to and/or upstream from a surface can cause and/or induce the formation of a “protective” biofilm layer on the surface of the surface, with this biofilm layer having various desirable properties such as (1) forming a biofilm layer which minimizes insulation or biofilm interference with heat transfer through an underlying surface and/or (2) forming a biofilm layer which subsequently protects the surface from significant additional fouling, which may even include the provision of biofouling protection after the integrity of the antifouling system components may be violated and the surface potentially directly exposed to the outside environment. In various embodiments, a proactive or non-settling biofilm may contain one or more of the following as compared to a “natural” biofilm: (1) a different amount of life and/or organisms, (2) a different variation of composition of organisms, (3) a different thickness of the biofilm and/or (4) a different structural integrity of the biofilm. For example, a permeable material may have a coating on one or both of the outer/inner surfaces, which may extend at least partially into the plurality of pores of the material and/or completely through the material, wherein the coating releases an additive into the water which alters a natural mix of organisms within the water flow and/or inhibits a plurality of organisms from colonizing one or more surfaces positioned within or downstream from the cartridge/canister, wherein said colonizing organisms comprise a reduction in diversity of at least one cyanobacteria, diatom or bacteria compared to a naturally created biofilm in water outside of the water circuit.

### Desirable Biofilms Formed

In various embodiments, desired biofilms can be formed on the protected surface, can be formed within and/or outside of the cartridge/material, and/or formed inside of the cartridge/material itself. Biofilms on each location can be different based on variable amounts and/or distributions of bacteria, cyanobacteria, diatoms, different bacteria phyla, diversity, thickness, insulative ability and/or integrity, as well as by other measures. In some embodiments, the relatively high velocity of the treated water flow can “supercharge” the protective or artificial biofilm, which in some embodiments may “grow” or form faster as higher amounts of “protective” biofilm are added to the surface. In various embodiments the cartridge/material desirably create an artificial aquatic environment to “grow” one or more “protective” biofilms on surfaces, which may inhibit and/or delay the ability for unwanted organisms to attach to surfaces. In various alternative embodiments, an “artificial” biofilm created herewith may smooth a surface such that there are fewer rough or sharp zones for fouling organisms, sediments and/or scales to settle or be trapped within.

### Antifouling Biofilm

In various embodiments, an antifouling biofilm can be created on surfaces within a water flow system, such as, for example, within a manufacturing or power plant, wherein a water flowing within said water circuit passes at least once or periodically passes through a cartridge comprising at least one layer of a flexible permeable material having an outer surface, an inner surface and a plurality of pores extending therebetween, wherein the cartridge creates or induces a change in one of more water chemistry factors that inhibits a plurality of organisms from colonizing one or more surfaces positioned within or downstream from the cartridge, wherein said antifouling biofilm comprises a reduction in diversity of at least one of cyanobacteria, diatom, fungi, prokaryotic cells or bacteria compared to a naturally created biofilm on an equivalent surface located in water outside of the water circuit. In essence, the antifouling system reduces biofouling on surfaces.

In various embodiments, the design and use of the disclosed antifouling systems, under certain conditions, can potentially promote, induce and/or impel the formation of a layer, film (including, but not limited, to, a biofilm), residue, accumulation and/or deposit of material on a surface and/or on the system walls that reduces, repels, inhibits and/or prevents micro and/or macro organisms from subsequently attempting to colonize, recruit and/or foul some or all of a protected surface (e.g., providing some level of “biofouling inoculation” to the surface and/or the entirety of an object). For example, various embodiments of the antifouling systems disclosed herein can cause the generation of a unique aqueous environment within portions of the water system, resulting in the creation of a unique mixture of microbes and/or microflora within the environment, including within one or more aqueous layers proximate to one or more surfaces to be protected. In many embodiments, the unique mix and/or distribution of microbes/microflora within the conditioned water system can induce and/or influence the creation of a microbial biofilm or other layer on the surface which, in combination with various surface bacteria, may release compounds that affect the settlement, recruitment and/or colonization of fouling organisms on the surface. In various embodiments, once such a unique microbial biofilm layer is established, this layer may remain durable and/or may maintain its signature and/or be self-replenishing which, in the absence of the antifouling system operation (e.g., where the system components may subsequently be isolated from the water stream, such as where they may be halted in operation, removed and/or damaged, either temporarily and/or permanently), and this existing layer could continue to protect the surface from certain types and/or amounts of biofouling for extended periods of time. In various embodiments, the biofilm may contain different compositions and may have differing composition, structural integrities, thicknesses, etc., based on (among other things) local environmental conditions including temperature, salinity, water pressure/depth, chemical composition, season of the year, type of protected surface and/or the type of biofouling organisms from which the surface is to be protected. In at least one exemplary embodiment, the biofouling system can promote the creation of a unique biofilm layer or other coating on a protected surface that allows a greater amount of thermal transfer into a cooling water flow, such as by creating (1) a biofilm that is less thermally resistant to heat transfer through the underlying surface such as a wall of a heat exchange tube, (2) a biofilm surface which promotes turbulent or other flow near the walls of the surface that increases overall thermal flow from the surface into the turbulent water (even if the biofilm itself may actually increase thermal resistance of the system in localized areas of the surface), thereby increasing the thermal efficiency of the heat exchanger for an extended period of time as compared to an unprotected or unconditioned system, and/or (3) a biofilm that may be less extensive and/or which allows less sediment deposition and/or scaling formation on protected surfaces than in an unprotected or unconditioned system.

### Differentiated Environment Creates Unique Biofilm

In various embodiments, the components of the disclosed embodiments will desirably provide a reduction, cessation and/or reversal of biofouling and/or the creation of a desired enclosed environment that deters settling of biofouling organisms or other deposits and/or that is conducive to formation of a desired antifouling layer and/or biofilm on the surface—e.g., initiating the creation of a desired local aquatic environment (e.g., the “differentiated environment”) upon being deployed to influence the formation of an advantageous biofilm which results in decreased biofouling on the protected surface or article. In various embodiments, this “differentiated environment” may be created within seconds, minutes and/or hours of antifouling system deployment upstream from a surface, while in other embodiments it may take longer to create a desired “differentiated environment.” If desired, an antifouling system may be deployed before a surface to be protected is placed therein, while in other embodiments the system components can be deployed concurrently with the surface or water supply intake or the antifouling system can be deployed long after the surface has been immersed and/or maintained in the aqueous environment. In various embodiments, the creation of significant water chemistry differences and/or other unique aspects of a treated aqueous environment may begin immediately upon cartridge insertion and antifouling system activation, or may be created within a few seconds, a few minutes or even hours of the antifouling system being placed in the aqueous environment (which could include the antifouling system being placed alone in the environment and/or in proximity to the surface to be protected), while in other embodiments the initiation and/or creation of a desired aqueous conditions (which may include creation of the complete differentiated environment as well as creation of various fouling inhibiting conditions which may alter and/or be supplemented as further aspects of the differentiated environment are induced) may require the antifouling system to be in operation upstream from the surface for at least 2 hours, at least 3 hours, at least 6 hours, at least 12 hours, at least 18 hours, at least 1 day at least 2 days, at least 3 days, at least 4 days, at least 5 days, at least 6 days, at least 1 week, at least 2 weeks, at least 3 weeks, at least 4 weeks, at least a month, at least 2 months, at least 3 months and/or at least 6 months or longer.

### DNA Analysis of Artificially Created Biofilms

DNA analysis has confirmed that surface biofilms forming on various protected surfaces downstream of the disclosed antifouling system embodiments are significantly different from those formed on similar surfaces in unprotected areas, including within open waters, and this is also true of the biofilm forming communities present on or within the permeable material as well as the biofilms that form in/on an inner wall surface of the antifouling system components or other locations. For example, biofilms that appeared on PVC and bronze article coupons in open waters were thicker and more diverse compared to biofilms appearing on PVC and bronze article coupons protected by embodiments of the present invention. In addition, macrofouling was observed on articles in open water, whereas little to no macrofouling was present on the protected surfaces. In some embodiments, the biofilm on the protected surfaces was less diverse than the open biofilms, with different amounts of diatoms, bacteria, cyanobacteria and differing distributions of bacterial phyla (although in some alternative embodiments the biofilm on the protected surfaces may have the same diversity level and/or be more diverse than the open biofilms). In addition, the dominant bacterial phyla and bacterial distribution on each protected surface were markedly different for each different antifouling system design or operation as compared to those of the unprotected surfaces. For example, a PVC surface protected by a spun poly material and associated antifouling system components was dominated by Proteobacteria and Bacteroidetes. In contrast, a bronze surface protected by a spun poly material and associated antifouling system components was dominated by Proteobacteria, with a much smaller remainder portion being dominated by Bacteroidetes. Additionally, biofilm “integrity” for protected surfaces is often quite different from unprotected samples, in that the biofilm on some of the protected surfaces appeared easier to remove and/or clean from the surfaces as compared to open (e.g., unprotected) surfaces.

Biofilm that Alters Charge of Water or Surface

In various embodiments, an “inhibition” of and/or improvement in fouling might be represented by the creation of a biofilm or other coating which alters various charge conditions (e.g., charge and/or energy) between of the water flow passing along, around and/or through the walls of the surface (including layers such as hydrodynamic, concentration and/or thermal boundary layers), which could include altering a charge of the fluid and/or the surfaces or portions thereof, as well as that of sediments or other materials therein. Since fouling occurs in an aqueous solution, the properties of the fluid strongly mediate the interaction of the fouling organism and material. Ions and water molecules adsorb to a biomaterial surface to form an electric double layer immediately upon immersion. This electric double layer effectively establishes a charge or charges associated with surface, which influences protein layers which adsorbs to the surface within seconds to minutes following immersion. The protein conformation is strongly influenced by both the physical and chemical properties of the surface, including the electrostatic charge. Protein conformation defines functionality with respect to cell adhesion, and the protein layer acts as a conditioning film for the settlement of micro-organisms such as diatoms and bacteria on the surface—which means the electrostatic charge strongly affects the nature of the interaction of proteins and cells with the surface. For example, an electric double layer might be initially established at a surface of a solid such as a linear polymer in less than a second upon immersion, where the electric double layer mediates the adsorption and conformation of proteins. Where subunits of fibronectin might be present in the aqueous medium and are adsorbed to the surface, these subunits can be responsible for binding to gelatin (e.g., gelatin111), such as where they mediate the binding of a cell to the surface via integrins (e.g., α and β subunits) in a cell membrane. Once a bacterial cell is bound to the surface, it can undergo a phenotypic change and excrete an EPS coating, and over time cells are bound, replicate and continue to build the EPS. Larger cells such as Ulva (an important biofouling and green tide-forming alga) may subsequently interact with the initial biofilm, and the biofilm may also create “swarmer” cells, which can leave the biofilm to inoculate other surfaces in the aqueous environment. However, where the charge of the surface and/or the surface energy is altered (and/or the fluid charge and/or energy may be altered) by the antifouling systems described herein or the effects thereof, the normal cascade leading to biofouling of the surface may be altered, interrupted, slowed and/or eliminated.

Biofilm that Eases/Simplifies Remediation

In another exemplary embodiment, the disclosed antifouling systems can promote the creation of a unique or artificial or engineered biofilm layer or other coating on the protected surface that may be easier to remove, remediate and/or clean as compared to growth and/or deposits that may occur on the tubes of an unprotected system, significantly reducing the time and effort required to repair and/or maintain the protected equipment in a highly efficient working condition. In various of the disclosed embodiments, the presence of the material may induce a unique quantity and/or diversity of bacteria and/or other microorganisms within the treated water system that may induce or promote the formation of one or more biofilm(s) within the water system, wherein such biofilms may be “less tenaciously attached” to a given surface than biofilms normally encountered in unprotected environments. Such biofilms may facilitate the removal and/or “scraping off” of fouling organisms from the surface and/or from intermediate biofilm layers. In such cases, the microflora and/or microfauna may comprise different phyla (e.g., different bacteria and/or cyanobacteria and/or diatoms) from those located in natural or untreated aqueous environments. In some embodiments, the resulting biofilms may have less bulk and/or may be thinner or contain a compromised structural integrity, which may allow simplified removal and/or cleaning steps to effectively remove biofouling or other substances from the protected surfaces (e.g., simply running a pipe cleaner or tube brush down the fouled pipes to effectively remove the fouling—rather than requiring extensive drilling, grinding and/or tube replacement during maintenance operations). In some embodiments, the biofilm may not allow subsequent attachment of biofouling organisms on top of and/or into the biofilm.

In some embodiments the disclosed antifouling systems can promote the creation of a unique or artificial or engineered biofilm layer or other coating on the protected surface that may make it easier for existing biofouling cleaning and/or treatment systems (e.g., chlorine production or other systems) to reduce and/or remove and/or otherwise remediate biofouling effects within an existing water system. In some cases, the antifouling system may function to make the existing treatment or remediation systems more efficient, more effective, and/or may allow the system to require remediation at lower treatment levels or at longer treatment intervals (e.g., using the pre-existing system) than would be required if the disclosed antifouling systems were not installed and operated.

### Biofilm Layer Retention and Durability

In various embodiments, the layers, biofilms and/or deposits capable of inhibiting fouling formation described herein may remain durable and/or effective for a variety of time periods, depending upon application, surface characteristics and/or targeted fouling entities, including relatively shorter time periods such as remaining effective for up to 10 minutes, 30 minutes, 1 hour, 2 hours, 4 hours, 6 hours, 12 hours and/or 24 hours, as well as for extended time period such as up to 1 week, 2 weeks, 4 weeks, a month, 2 months, 6 months, 1 year, 2 years, 3 years, 4 years, 5 years, 10 years and/or longer time periods, including an indefinite duration (e.g., permanent antifouling effects). Such antifouling effects may remain effective during the entirety of the described time periods, or such effects may increase, decrease and/or fluctuate to various levels during those time periods.

In various embodiments, the disclosed antifouling systems could be utilized to create an engineered/artificial biofilm which inhibits biofouling growth, with such biofilm formed on one or more surfaces, objects and/or substrates in a controlled environment (e.g., in a lab or industrial manufacturing facility) prior to the object's use and/or initial “wetting” in its intended environment of use. Such biofilms “grown” on the object in a lab and preconditioned on the surface before the system is used could effectively inoculate those surfaces from the effects of biofouling for extended periods of time.

### Inoculating Biofilm/Existing Biofilm Treatment

Once a unique antifouling biofilm has been formed on a surface, various physical and/or chemical characteristics of this new biofilm and related structures can greatly affect the quantity, quality, viability and/or tendencies of other organisms (e.g., “follow on” organisms) to attach and/or adhere to the biofilm protected surface (or to desirably not colonize or thrive, in the case of fouling entities). Such protection could include an ability to protect an object before the object is initially wetted by an aqueous medium for the first time (e.g., an object's initial contact with the aqueous environment), as well as the protection of a previously wetted object that may have been removed from a first aqueous medium and cleaned, descaled and treated before being placed in the same or a different aqueous environment.

In other embodiments, the antifouling system components may be installed to protect a surface of an object already wetted in an aqueous environment and/or already possessing a natural biofilm thereon, including objects that may have been previously wetted for extended periods of time and/or already having significant amounts of biofouling thereupon, where the antifouling system may alter and/or overcoat the pre-existing biofilm to provide antifouling protection as described herein.

### Reservoirs or Holding/Receiving Tanks

In some cases, water or other fluids which have contacted and/or been treated and/or processed by components of the antifouling system may be contained or retained within a reserve, reservoir, holding tank, cache and/or some other location within the water system for anticipated future use. Where an entire flow of treated water is not directed to immediate use, such reservoirs can desirably contain a few minutes, a few hours and/or even a few days' worth of treated liquid for eventual use by one or more downstream devices and/or uses (e.g., as cooling fluid for a heat exchanger, as source water for a desalination plant, or any other intended uses).

In some embodiments, a reservoir or “holding tank” may be employed as part of the antifouling system to collect and/or store water or other fluids which may be intended to pass through the antifouling system, while in other embodiments a reservoir or holding tank may be employed to collect and/or store water or other fluids which have already passed through the antifouling system, including before such water is utilized in an industrial process such as a heat exchanger or other system components which desire biofouling protection. Depending upon the water usage and/or storage/holding drum size, as well as the amount of time that water molecules remain within the reservoir, natural and/or artificial processes may alter some of the water chemistry factors within the reservoir, such as by the activity of natural and/or artificial oxygen scavengers within the water column that may reduce the dissolved oxygen level in the water, such that the dissolved oxygen level may be depleted prior to traveling into the antifouling system and/or into a usage inlet.

In one optional embodiment incorporating a reservoir or storage tank, a method for determining an appropriate design, size, shape and/or other features of the of reservoir and/or antifouling system can be utilized to determine a recommended minimum enclosed volume and/or water exchange rate to desirably reduce and/or eliminate biofouling within the reservoir and/or to accommodate increased water usage needs while accommodating potentially slower flowrates through the antifouling system. In some embodiments, such as in a replaceable material configuration, one or more reservoirs may be utilized to “balance” water usage over a period of operation time, and may provide a water source and/or other source water for a heat exchanger or other components in a commercial or industrial plant (e.g., a power plant, a desalination plant, a refinery and/or other manufacturing facility), wherein the disclosed methods can potentially be utilized to reduce and/or eliminate biofouling within the water and/or other conduits of the plant, and in some embodiments without any need for additional filtration and/or microfiltration of the treated water.

In some embodiments, the volume of a reservoir may be sufficiently large to contain a significantly large fraction of a scheduled use of the liquid, such that the liquid can remain within the reservoir for a desired amount of time to allow desirable water chemistry changes to occur (e.g., reaching a desired “dwell time” to attain the desired water chemistry changes) to reduce and/or eliminate biofouling from occurring within the reservoir and/or the facility's water piping. In some other embodiments, the volume of the reservoir may be smaller and may not contain a significantly large reserve amount of liquid (as compared to the anticipated flow rate into the equipment inlet during use), in which embodiments the liquid might not remain within the reservoir for a desired dwell time to allow the desired water chemistry changes, but may rather primarily rely on the antifouling system, the replaceable material cartridge and components thereof to desirably reduce and/or eliminate biofouling from occurring within the reservoir and/or the facility's water piping and/or heat transfer surfaces.

In various embodiments, antifouling system design may be impacted by a variety of considerations which impact “dwell time” of treated water within the water system, including the opportunity for the intended water usage to accommodate increased size canisters and/or reservoir storage to desirably increase “dwell time” of treated water during and/or subsequent to canister passage and/or prior to water usage. For example, the presence of a reservoir or holding tank to retain a significant amount of “treated” water for a period of time prior to water usage can allow that treated water to experience various water chemistry differences or other transformations which are described herein and which can significantly reduce the opportunity for fouling to occur. An appropriately designed and sized antifouling system which incorporates such a reservoir or holding tank to provide increased “dwell time” for the treated water may utilize smaller cartridges and/or a lesser amount of insert material to treat the water supply than an antifouling system that has no reservoir or holding tank available (yet the system must provide an equivalent amount of water). Similarly, an antifouling system that utilizes larger canister sizes (e.g., increased volume) for the insert material may provide an increased “dwell time” for the treated water as it passes through the canister, which may provide improved fouling protection for the water system as compared to an antifouling system utilizing smaller, lower volume canisters to treat an equivalent amount of water. In other instances, dwell time may be increased by altering the volume and/or flow rate of the water passing through the canister and/or other system components in a variety of ways, which dwell time increases may allow for reductions in the required amount of insert fabric and/or the level of antifouling treatment necessary to obtain the ultimate fouling reductions. In many instances, an increase in dwell time of treated water at appropriate points within the antifouling and/or water system can dramatically contribute to the system's antifouling effectiveness and should be a consideration in all antifouling system designs.

In some embodiments, a housing of the antifouling system may be considered a tank or reservoir which may induce the creation of various water chemistry “differences” to create, maintain and manage the various desired antifouling effects on surfaces within the water system. For example, in many process applications a flow rate of 10.43 to 12.52 liters per minute per metric cooling ton (2.5 to 3 gal/min per cooling ton) is sufficient to achieve turbulent flow through a heat exchanger. Turbulent flow occurs when the velocity of the fluid increases and the streams of fluid flow start to destabilize—thus more mixing occurs. In such mixing, the cooling fluid is warmed by the surface of the pipe or heat exchanger but then is mixed with the cooler fluid in the center of the pipe. This action pulls more heat off the side wall of the pipe or heat exchanger surface. The net effect is a significant increase in the amount of heat transfer to the process fluid. When a treatment unit such as those disclosed herein are is used in such an application, the dwell time for the water passing into and through the cartridge can be a wide variety of times, including, in one nonlimiting exemplary embodiment, an average of approximately 15 minutes (e.g., for the 162.8 liter or 43-gallon unit capacity), which may be sufficient to induce some of the water chemistry “differences” described herein.

### Supplemental Conditioning of Water System

In some embodiments, it may be desirous to provide supplemental modification of a water flow at a location within the water system, which may include modification of the water flow prior to, during and/or after the water passes through the antifouling system components and/or modification of the water flow at a location proximate to and/or upstream from a surface/object to be protected (optionally with or without operation of a cartridge of an antifouling system as described herein). In some embodiments, such modification may include the use of natural and/or artificial mechanisms and/or compounds to alter various components of the water chemistry, such as by causing an accelerated depletion and/or replacement of the dissolved oxygen or other change in water chemistry in the aqueous environment by the introduction of one or more aerobic microbes, chemicals and/or compounds (including oxygen depleting compounds) into the aqueous environment.

In some instances, it may be desirous to supplement antifouling system treatment of a water flow on an as-needed basis, which may include an initial “starter” treatment prior to or during system startup or installation and/or a periodic “refresher” treatments as the water passing through the antifouling system may require supplemental treatment(s). Moreover, various water conditioning treatments described herein may be utilized in smaller reservoirs and/or even within the suction piping of a facility on a continuous basis, if desired. In such a case, the various water conditioning treatments described herein could be used to condition the water continuously (such as in a water plant) with nitrogen or other gases and/or chemicals. Such treatments may be particularly useful where a closed loop processing technique to continuously treat water may be desirous (for example, with a closed testing and treatment loop to determine and/or maintain a desired water chemistry level such as oxygen levels, etc.) within certain ranges. In various embodiments, the various antifouling system designs and/or water conditioning treatments described herein may be utilized separately and/or together on an as-needed basis, which could include passing all water in the system in proximity to and/or through a replaceable material during low water demand periods, and the use of multiple techniques (including supplemental treatment, if desired) concurrently during periods of higher water demand, if desired. It should also be understood that different environmental conditions may necessitate different treatments for the aqueous medium, including seasonal and/or other differences in temperature, sunlight, salinity, high/low water levels, ambient and/or post cooling water temperatures, high/low fouling season, etc.

In various embodiments, a modification compound could comprise a solid, a powder, a liquid, a gas or gaseous compound and/or an aerosol compound which is introduced into the aqueous environment prior to and/or concurrent with the water contacting the surface. In some embodiments, the modification compound may be provided to the aqueous environment for a limited or desired period of time, and then such addition ceased after the desired modification of the water has occurred (e.g., creation of a “differentiated” aqueous environment). In other embodiments, the modification compound may be distributed into the aqueous environment, with some embodiments of the compound potentially dissolving and/or distributing into the water while other compounds may remain in a solid and/or granular state. In still other embodiments, the modification compound may alter the density and/or salinity of the water or other liquids within the aqueous environment, or otherwise bind the oxygen more securely to the water or other compounds or make it less available to fouling organisms.

In some embodiments, a modification compound may be attached to and/or integrated into components such as those of the antifouling system, including within the material construction of the permeable material and/or any coatings therein/thereon. In one exemplary embodiment, an antifouling system can include a supplemental water conditioning unit having a system that creates some water chemistry difference in the water flow, such as by removing at least a portion of a dissolved oxygen in a water flow before, during and/or after having passed through various of the cartridge embodiments described herein. In at least one alternative embodiment, a modification compound or compounds may be released into water adjacent to or near the antifouling system (e.g., upstream and/or downstream of the cartridge), which compound(s) may optionally flow into and/or through the cartridge and/or material therein. In still other embodiments, the modification compound and/or constituents thereof may be deployed in combination with some components placed outside of the aqueous environment, which other components could be placed within the cartridge and/or other components and/or in the differentiated environment.

If desired, a modification compound could include a water and/or salt-activated material which reacts with the aqueous medium, having a limited duration such as 10 minutes, 1 hour, 12 hours and/or 2 days for which the compound affects the dissolved oxygen level and/or other water chemistry level(s) within the water system, or could be effective for longer periods of time such as 1 week or 1 month or 1 year. If desired, the modification compound or other chemical could be positioned within the replaceable cartridge or material or within individual replaceable bags that can be positioned within and/or outside of the antifouling system, with the compound or chemical in the bags “depleting” over time and potentially requiring replacement as needed.

### Preconditioning and Duplicative Treatments

In various embodiments of antifouling systems, the system components may include one or more components that desirably modify one or more aspects of the water chemistry within treated waters of the water system, such as where Dissolved Oxygen (DO) and/or other water chemistry elements are altered or changed to desired levels as well as desirably providing sufficient time for fouling organisms to assess and evaluate settlement “attractiveness” within the protected environment (and such organisms will desirably “decide” to not settle and/or grow within the treated or affected regions). In some embodiments, artificial active measures may be taken to cause desired water chemistry changes within the antifouling system, such as during times of higher water flows where the treatment material assembly might be less effective and/or unable to prevent fouling for such extremely high water flows, with such artificial active measures possibly ceasing when the water flow is lowered at a later time and the treatment material can effectively provide a desired level of fouling protection. In some cases, optional “preconditioning” of the water supply may also be highly useful where water flow may be routed around the treatment system, such as during system maintenance and or repair, or if water flow requirements exceed antifouling system capacity and supplemental untreated water (e.g., including the use of completely raw water and/or combinations of treated and raw water) passes over the surface(s) to be protected.

### Supplemental Treatment—Quantification and Times

In various embodiments, it may be desirous to provide a continuous and/or periodic water conditioning treatment, such as described herein, and which may optionally include “artificially” inducing and/or accelerating various water chemistry factors, including those described herein. In some instances, the condition of water chemistry within a water stream may be monitored on a periodic and/or continuous basis, with one or more water conditioning treatments being applied or removed from the water stream on an as-needed basis. In various embodiments, the modification compounds described herein will desirably induce a reduction in the dissolved oxygen levels of the aqueous environment within/after a few seconds or application and/or within/after a few minutes of application (e.g., 1 minute to 5 minutes to 10 minutes to 20 minutes to 40 minutes to 60 minutes of applied nitrogen bubbling) and/or within/after a few hours of application by at least 10%, by at least 15%, by at least 20%, by at least 25%, by at least 50%, by at least 70%, and/or by at least 90% or greater.

### Supplemental Treatment—Microorganisms—Aerobic Bacteria

For example, an antifouling system as described herein can be positioned upstream of a water intake for a water system, and a supplemental oxygen depleting compound or substance comprising one or more species of microorganisms of an aerobic bacterium, such as aerobic bacteroides, can be artificially introduced into the raw water and/or water system, desirably accelerating a reduction in dissolved oxygen levels within the water system. Such introduction could be by way of liquid, powdered, solid and/or aerosolized supplement thrown or deployed into the water and/or enclosed/bounded aqueous environment, or alternatively the oxygen depleting bacteria or other constituents could be incorporated into a layer or biofilm formed in or on an inner surface of the cartridge and/or fibrous material walls prior to deployment. Desirably, the aerobic bacteroides could comprise a bacterial species already present in the aqueous environments, wherein eventual release of such bacteria from the water system would not be detrimental and/or consequential to the surrounding environment. In a similar manner, the introduction of other microorganisms is contemplated herein.

### Supplemental Treatment—Oxygen Depleting/Absorbing Chemicals

In various embodiments, a chemical element or compound may be introduced into the reservoir to desirably absorb, displace and/or bind dissolved oxygen in the water, such as powdered iron (e.g., zero-valent iron Fe0 or partially oxidized ferrous iron Fe₂⁺). Alternatively, additives such as salt may be added to the aqueous environment to alter the amount of available dissolved oxygen within the water.

In another exemplary embodiment, the modification compound could comprise a crystalline material that absorbs oxygen from the aqueous environment, such as a crystalline salt of cationic multi-metallic cobalt complexes (described in “Oxygen chemisorption/desorption in a reversible single-crystal-to-single-crystal transformation,” published in CHEMICAL SCIENCE, the Royal Society for Chemistry, 2014). This material has the capability of absorbing dissolved oxygen (O₂) from air and/or water, and releasing the absorbed oxygen when heated (e.g., such as being left out in ambient sunlight) and/or when subjected to low oxygen pressures. If desired, this oxygen absorptive material could be incorporated into the wall material of the antifouling system such that oxygen is immediately absorbed when the cartridge is placed within the water in proximity to the protected surface, but such oxygen absorption would taper off after a period of time after placement. Subsequently, the element or bag could be removed from the water (such as after protection is no longer desired) and left in the sunlight to release the absorbed oxygen and “recharge” for the next use.

### Supplemental Treatment—Sparging

In another exemplary embodiment, the modification compound could comprise a gas or gaseous compound such as nitrogen or carbon dioxide (or some other gas or compound) that could be introduced into the antifouling system in gaseous form or which could be released from a pellet or other liquid or solid compound (including potentially the “dry ice” form of CO2). Such introduction or “sparging” could comprise injection of gaseous and/or liquid nitrogen and/or N2 bubbles into the water inside the antifouling system, or within/along the walls of the antifouling system. In some embodiments an antifouling system such as described herein can be combined with an installed nitrogen dosing system and monitoring probe for oxygen levels that controls the periodic renewal of the nitrogen flush when needed. In various embodiments, nitrogen injection may be accomplished using a small nitrogen tank with a porous weighted dispenser (e.g., an aquarium aeration stone or open cell foam dispenser) while other embodiments may utilize an on-site nitrogen generator to purify nitrogen from the air, and then dispense this nitrogen through a pumping system. If desired, the nitrogen dispensing system could include a bubble dispensing system that releases bubbles of a single range of sizes or of varying size ranges, if desired. In at least one embodiment, a nitrogen nanobubble infusing system may be utilized.

In at least one alternative embodiment, a gaseous compound injection suitable for use in or with the various antifouling systems described herein could comprise an ozone injection system such as the Ozonix® system, commercially available from Ecosphere Technologies, Inc. of Stuart Florida, USA.

In some embodiments, the “sparging” effect (or similar effect) may be generated through one or more coatings applied to the structures described herein.

### Scale/Precipitation Reduction and Mic Avoidance

In some embodiments, the design and use of the disclosed antifouling systems, under certain conditions, can potentially reduce scaling and corrosion of protected surfaces. Scale formation, corrosion and fouling problems are common in many water systems, especially seawater and brackish water, which contain dissolved salts and finely suspended solids. In many cases, slime growths, fungi and/or algae development on surfaces can influence and/or accelerate pitting, microbiologically influenced corrosion and/or erosion of wetted surfaces. Moreover, biofilms and/or fouling on surfaces can promote the capture and/or settlement of sediments, scaling and/or mineral deposition on surfaces. By altering and/or reducing the composition, structural integrity, thickness and/or extent of biofilm and/or fouling on surfaces as described herein, the disclosed antifouling systems can dramatically reduce the resulting levels and/or types of scale and corrosion within the aqueous system. In addition, the disclosed system components can also desirably alter various water chemistry components in the conditioned fluid, including such chemistry components as pH, hardness and/or alkalinity, which if properly managed can significantly reduce and/or eliminate the potential for scaling and/or corrosion of surfaces within the aqueous system. Depending upon the design and/or use of the disclosed systems, precipitates such as calcium carbonate, calcium sulfate. calcium oxalate, barium sulfate, magnesium hydroxide, various silicates, aluminum oxides, aluminum silicate, copper, phosphates and/or magnetite may be reduced and/or eliminated.

### pH Modification—Scale Formation

In some embodiments, an antifouling system or various components thereof may contribute to a measurable change in pH level of the protected environment, especially where one or more “target” fouling organisms (e.g., organisms meant to be affected in some manner by the antifouling system) may be sensitive to increases or decreases in pH levels and respond “negatively” to them. In many cases, marine organisms are very sensitive to slightly acidic pH changes (pH<8). In contrast, freshwater organisms typically live well in the range of 7 pH to 8.4 pH and start responding negatively once ammonium levels increase. In some embodiments, an effective change in pH to accomplish some or all of the objectives of the present invention may be a level of change that can be much less than what would negatively affect metals and other materials within a protected system. If desired, a pH controlled antifouling system can provide an added benefit of reduced scale formation with a decrease in pH in a given fluid system, which may be provided at a lower level than would negatively affect materials from which the water system is constructed.

### Biofilm Reduces Scale Formation/Mic

In addition to directly reducing heat transfer efficiency, biofouling can also contribute to or lead to accumulation of debris on tube walls, damage to and/or failure of moving surfaces such as valves and pumps, as well as scaling and/or corrosion on wetted metallic surfaces. In addition to creating sediment collection areas, less oxygen may be accessible to the materials of and/or cells next to the tube wall as the biofilm thickens. Bacteria such as sulfate-reducing strains and others can generate metabolites that attack wall materials such as metals in a process called microbiologically influenced corrosion (MIC). In studies carried out in the 1980s and early 1990s, it was estimated that the costs of cleaning, fluid treatment, replacement of parts and loss of production due to heat exchanger fouling was approximately 0.25% of the GDP of all industrialized countries combined. For a process plant, the estimated cost for repairing only the heat exchangers and boilers was approximately 15% of the annual maintenance costs of the entire plant, with about half of this value due solely to fouling. In 2016, the Worldwide Corrosion Authority (NACE International) estimated that the global cost of corrosion was 2.5 trillion US Dollars.

Various embodiments may include materials or related components that contribute to a reduction of microbiologically influenced corrosion (MIC) from a plurality of biofouling organisms in a water stream of a water system, where the antifouling system can include a flexible porous material contained within a replaceable cartridge or similar housing (with an optional coating comprising a biocide that is applied to one or both opposing surfaces of the material therein), the material having a plurality of pores extending from the first surface to a second surface of the material, and placing said cartridge in the water stream, wherein at least a first portion of the water stream flows through the plurality of pores from the first surface to the second surface and a second portion of the water stream flowing along at least one surface of the material, the antifouling system inducing water chemistry changes and/or optionally releasing the biocide from the coating into the water stream, with the water chemistry changes and/or optional biocide inhibits the plurality of biofouling organisms from colonizing a surface positioned downstream from the material assembly.

### Example 1—Fresh Water Antifouling Systems

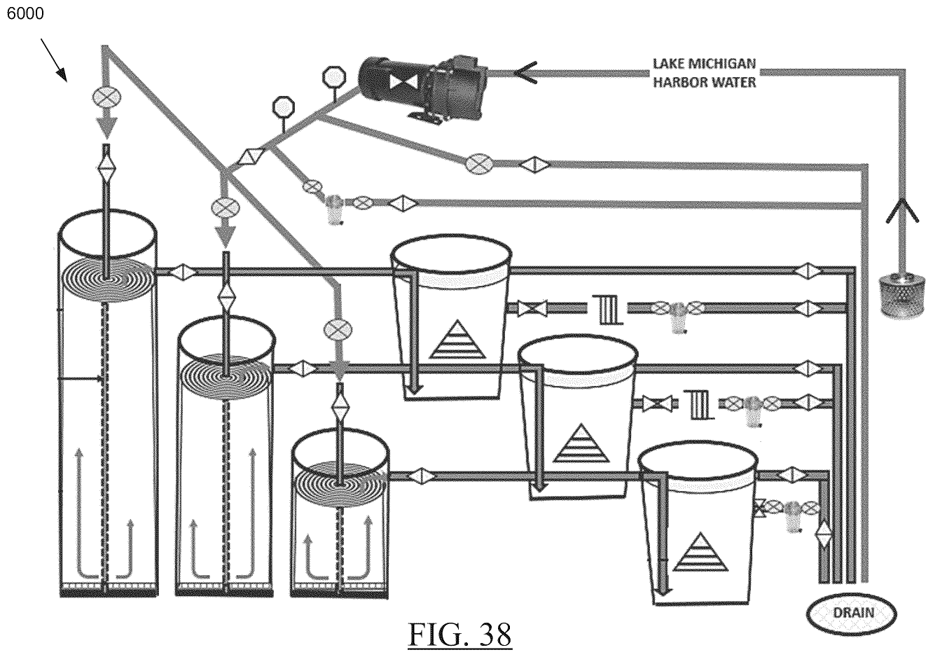

FIG. 38A depicts a schematic representation of one exemplary embodiment of an antifouling protection system 6000 which utilized a plurality of antifouling devices, each containing a spiral use configuration which comprised one or more biocides. In this embodiment, the cartridges and associated materials were similar in design and construction to the embodiment of FIG. 10. The fluid source was fresh water taken directly from the Milwaukee Inner Harbor of Lake Michigan, which was drawn through an intake strainer having a 0.635 cm (0.25″) debris strainer, and then the water was passed to an intake pump having a 0.953 cm (0.375″) debris strainer therein. A series of pressure control sensors and/or relief valves were provided in the system to allow for water release and/or redirection if a reduced need for water or over-pressure condition was detected in the antifouling system. The raw water was sent through a valve manifold to a plurality of antifouling devices with crossflow cartridges, where the water desirably passed through materials within the series of cartridges as described herein. An outlet water flow from each of the antifouling treatment units was then directed to a reservoir system of barrels, depicted in this embodiment as 30-gallon (113.6 liter) reservoir barrels, the barrels containing protected surface analogs (e.g., multiplate sampler plates or “trees”). The continuous flowing water eventually reached an overflow outlet in each of the barrels, and the overflow water was discharged to a drain system and released. Biofouling results on the sampler plates and other system components were then determined and tabulated.

In this experiment, four different antifouling devices were used (although three are shown in FIG. 38A), with each device having differing heights with correspondingly different sized materials therein, with the output of each antifouling device sent to an individual separate 30-gallon reservoir barrel. The antifouling devices were all constructed of 40.6 cm (16-inch) diameter, 0.318 cm (⅛-inch) wall thickness PVC tubing. Tables 5 through 12 (below) provide various construction and operational characteristics of the antifouling systems, the devices and their respective spiral use configurations. Each of the devices included at least one valve at its base to facilitate drainage for maintenance and cleaning. In the various disclosed embodiments, residence time (e.g., dwell time) averaged 3.11 minutes across all spiral use configurations.

TABLE 5
Spiral Material Cartridge Characteristics
EXPERIMENTAL SPIRAL CARTRIDGE DIMENSIONS - AS TESTED

| Spiral Diameter | 40.64 cm | (16 inches) |
|---|---|---|
| Spiral Spacing and Vertical Spacers | 0.635 cm | (0.25 inches) |
| Fabric + Coating Width | nominally 1.5 cm | |
| | (0.059 inches) | |
| Spiral Fabric Length (unrolled) | 16.75 meters | (55 feet) |
| Spiral Heights (fabric width) | four heights - 66.0, 91.4, 116.8, | |
| | 142.2 cm (26, 36, 46, 56 inches) | |
| Central Inflow Pipe diameter | 3.81 cm | (1.5 inches) |
| Diffuser Bar: | 3.81 cm | (1.5 inches height) |

TABLE 6
Spiral Material Fabric Dimensions
EXPERIMENTAL SPIRAL FABRIC DIMENSIONS

| | | | | Area (one | Area (two | Cartridge |
|---|---|---|---|---|---|---|
| | Height | Height | Length | sided) | sides) | Height |
| ID | cm | M | M | M² | M² | cm |
| Number | (Inches) | (Feet) | (Feet) | (ft²) | (ft²) | (in) |
| 1 | 141.0 | 1.41 | 16.76 | 23.60 | 47.19 | 162.56 |
| | (55.5) | (4.63) | (55) | (254) | (508) | (64) |
| 2 | 116.8 | 1.17 | 16.76 | 19.60 | 39.21 | 137.16 |
| | (46) | (3.83) | (55) | (211) | (422) | (54) |
| 3 | 91.4 | 0.91 | 16.76 | 15.33 | 30.66 | 111.76 |
| | (36) | (3) | (55) | (165) | (330) | (44) |
| 4 | 66.0 | 0.66 | 16.76 | 11.06 | 22.11 | 86.36 |
| | (26) | (2.17) | (55) | (119) | (238) | (34) |

TABLE 7
Receiving Tank Volumes
RECEIVING TANK VOLUMES

| | | |
|---|---|---|
| Control | 79.5 liters | (21 gallon) |
| 26″ device | 117.9 liters | (47 gallons) |
| 36″ device | 117.9 liters | (47 gallons) |
| 46″ device | 117.9 liters | (47 gallons) |
| 56″ device | 117.9 liters | (47 gallons) |

TABLE 8
Device Flow Rates
Device Flow Rates (during pump operation)
Flow rates were consistent throughout the
duration of the study in these ranges

| | | |
|---|---|---|
| Control | 9-15 L/min; avg | 12.1 L/min; 3.2 Gal/min |
| 26″ device | 21-25 L/min; avg | 24.2 L/min; 6.4 Gal/min |
| 36″ device | 32-35 L/min; avg | 34.8 L/min; 9.2 Gal/min |
| 46″ device | 40-43 L/min; avg | 42.0 L/min; 11.1 Gal/min |
| 56″ device | 51-56 L/min; avg | 54.1 L/min; 14.3 Gal/min |

TABLE 9
Heat Exchanger Tube Flow Rates
GROCO/cooling Tube Water Flow 1000 ml (seconds)

| | |
|---|---|
| Control | 3.41 seconds |
| 36″ device | 3.86 seconds |
| 46″ device | 3.55 seconds |
| 56″ device | 3.32 seconds |

TABLE 10
Treated Water Residence/Dwell Time in Device(s)
Residence Time (Dwell Time)

| | |
|---|---|
| 26″ device | 3.15 minutes |
| 36″ device | 3.09 minutes |
| 46″ device | 3.24 minutes |
| 56″ device | 2.95 minutes |

TABLE 11
Water Depth in Device With Material Present
VOLUME DATA
Water Depth in Cartridges with spirals inserted

| | |
|---|---|
| 26″ device | 29.75″ |
| 36″ device | 39.75″ |
| 46″ device | 50.75″ |
| 56″ device | 60.75″ |

TABLE 12
Water Depth in Device With Material Removed
VOLUME DATA
Water Depth in Devices without spirals

| | |
|---|---|
| 26″ device | 23.2″ |
| 36″ device | 32.7″ |
| 46″ device | 41.3″ |
| 56″ device | 48.5″ |

In the experimental apparatus described herein, water flow rates for each cartridge were produced by a 1 phase, 240 ac volts, continuous run, Goulds GT20 irrigation pump (GPM @Head 65 @97 ft.). The flow rate for the 26″ spiral was 24.2 L/min, for the 36″ spiral wase 34.8 L/min, for the 46″ spiral was 42.0 L/min and for the 56″ spiral was 54.1 L/min for the duration of 5 months from May 6 to October 11. All of the system components and reservoir tanks ranged in temperature between 15 C-25 C over the 5-month test period.

### Results

The freshwater test results indicated that biofouling (>500 μm) in the reservoir barrels for all antifouling systems was reduced by >9900 compared to the control after 5 months of continuous water flow. For example, all reservoir barrels for the antifouling systems had tank loads of living biofouling organisms at 0, while the reservoir barrel for the control was 124,000/m2 in the control. Similarly, the control system accessory pump surfaces had a density of 9027/m2 while the three antifouling system pumps had 0/m2. The 3-plate artificial substrate load of fouling organisms was zero in the antifouling systems reservoir barrels compared to 10,740/m2 in the control reservoir barrel. Based on the over 5-month duration of the experiment with remarkable biofouling prevention, it is estimated that the cartridge and material have a minimum useful life of at least 6-12-months, and probably much longer considering the extremely harsh conditions of the raw water source, which was a worst-case situation.

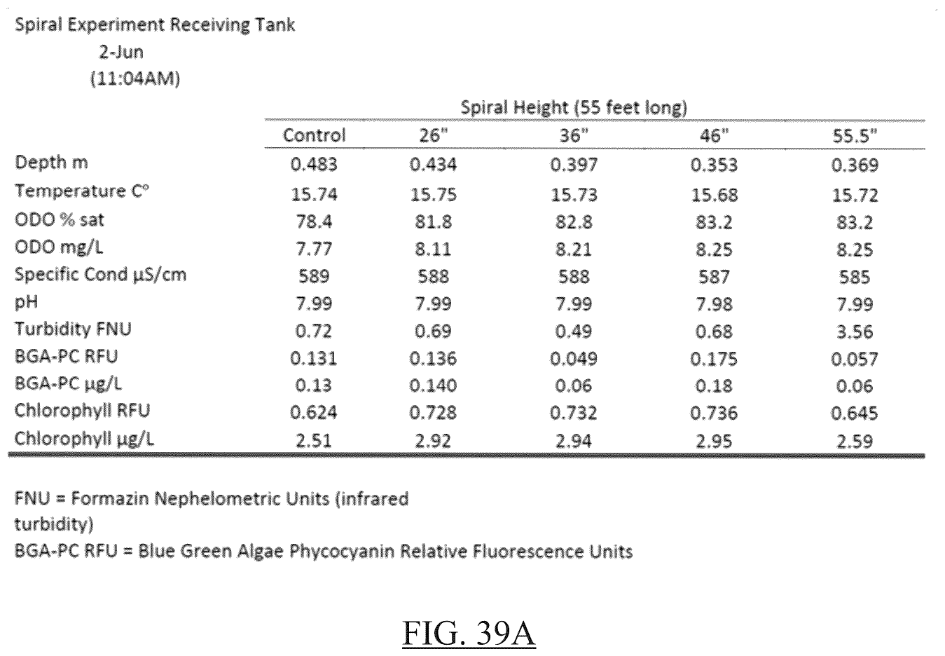

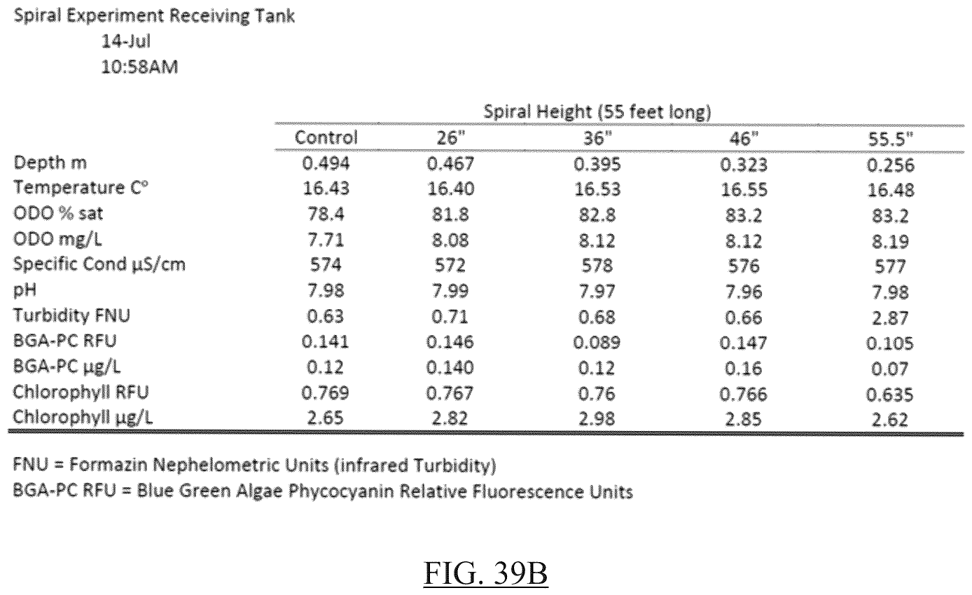

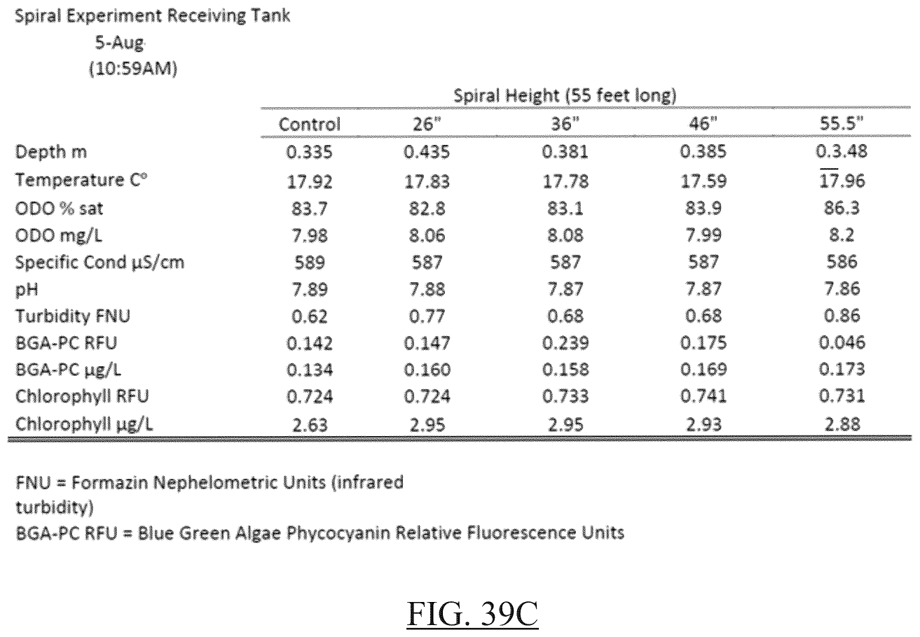

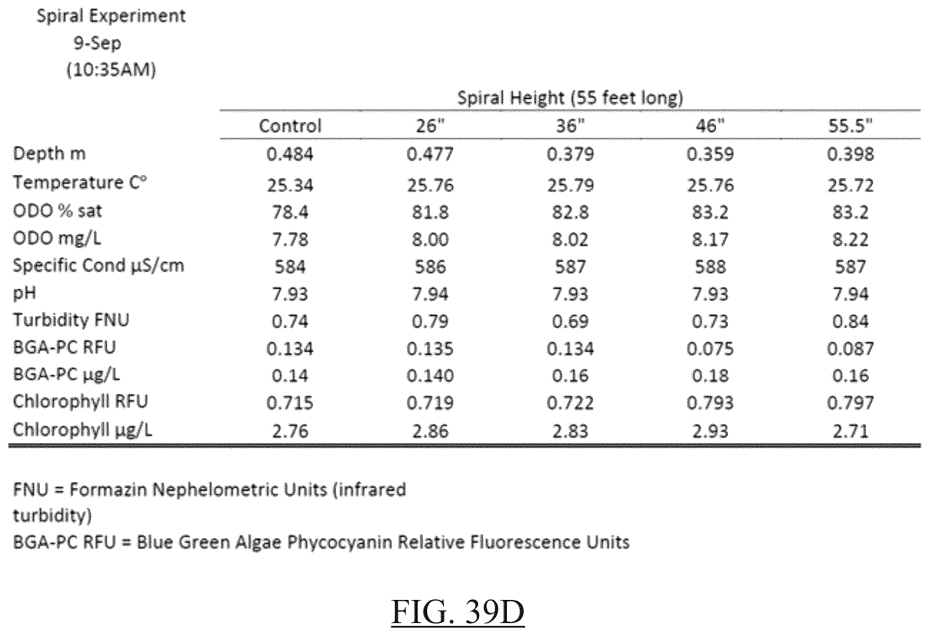

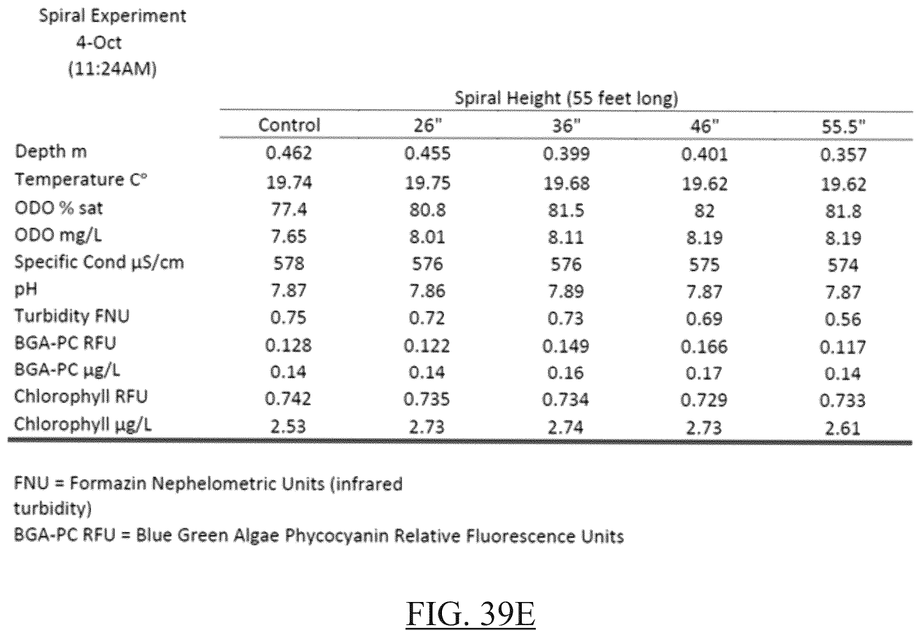

FIGS. 39A through 39E depict tabular views of various water chemistry measurements and organism data taken from the water flow in the different test systems during the experimental study period, which began on May 6, 2021 and concluded on Oct. 11, 2021. FIG. 39A depicts results from Jun. 2, 2021. FIG. 39B depicts results from Jul. 14, 2021. FIG. 39C depicts results from Aug. 5, 2021. FIG. 39D depicts results from Sep. 9, 2021. FIG. 39E depicts results from Oct. 4, 2021 (near conclusion of the test on Oct. 11, 2021).

### Control Surface and System Components

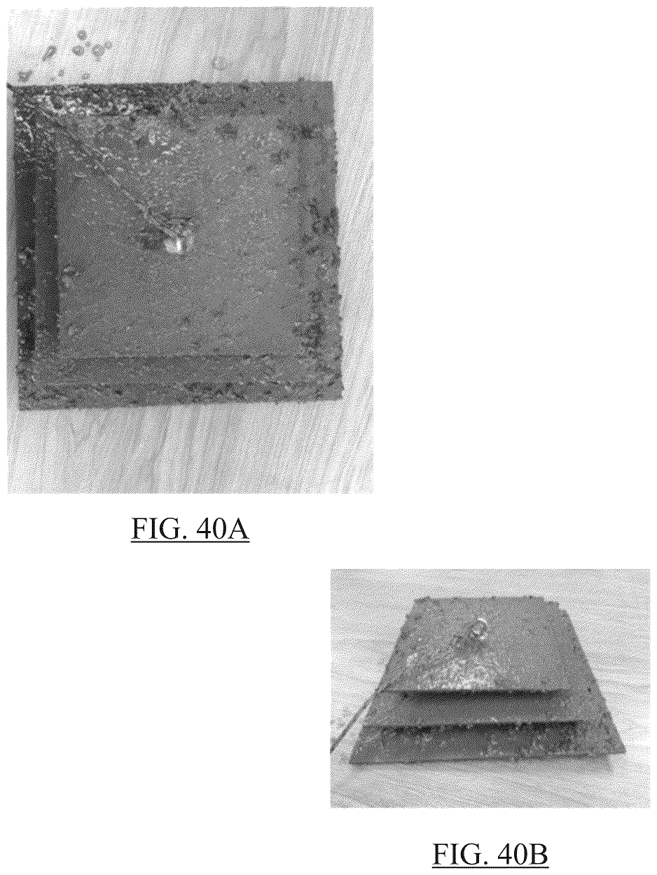

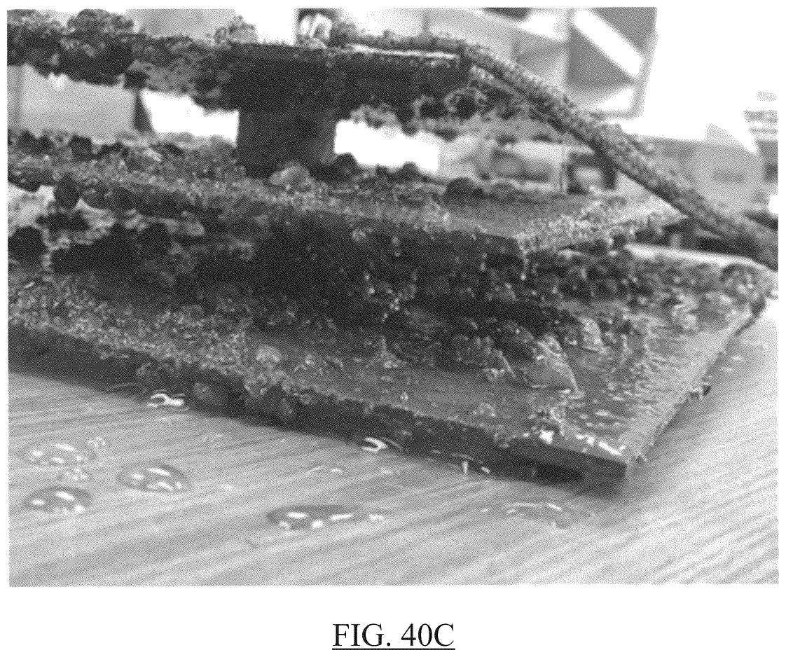

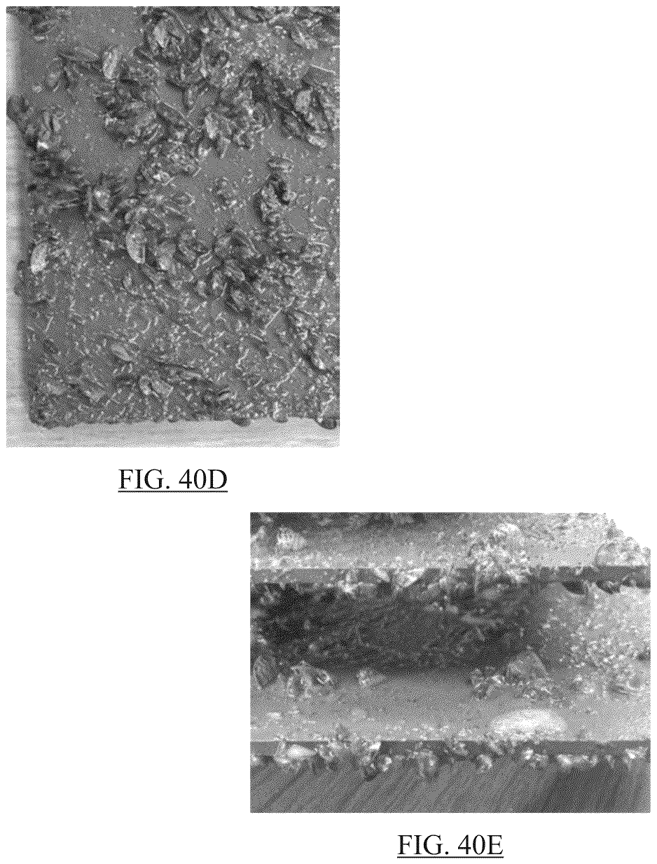

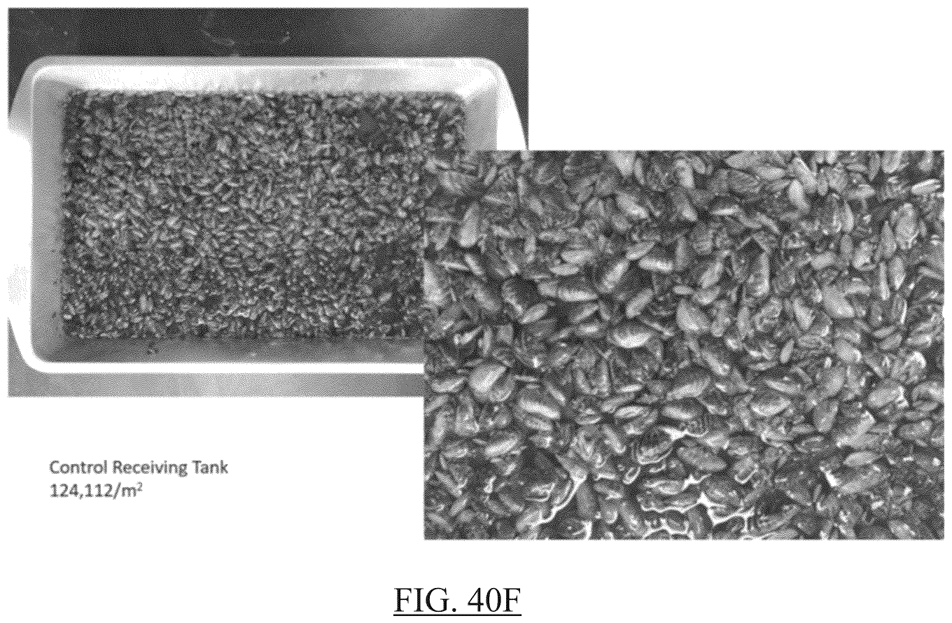

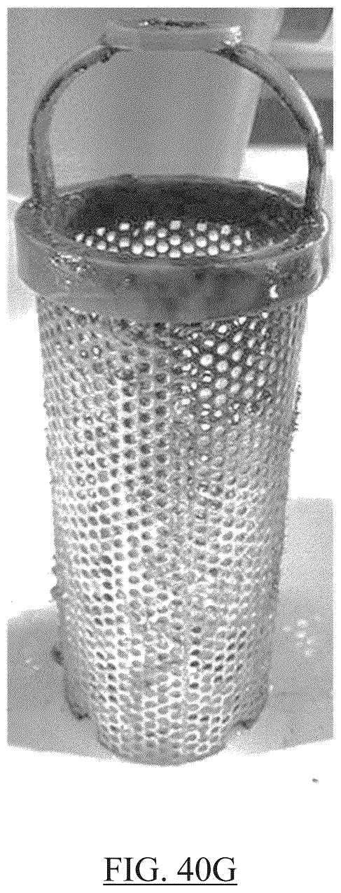

FIGS. 40A through 40E depict various views of fouling that occurred on the control surface and related system components in the control arm of the experiment for this period of the antifouling effectiveness test. As best seen in FIG. 40F, the control receiving tank was completely overrun with fouling organisms, and the 3-plate artificial surface load of fouling organisms was 10,740/m² in the untreated control tank—which was the normal expected fouling growth in this natural environment. The control receiving tank contained heavy biofouling from Dreissenid mussels, largely Quagga mussels (Dreissena bugensis) with fewer Zebra mussels (Dreissena polymorpha), 124,112/m² (relative density based on collection pan size). These mussels were 90-95% living and of reproductive size.

FIG. 40G depicts fouling on an inlet strainer for the control system, which harbored numerous living zebra mussels, Bryozoa, Physa snails, and Amphipoda crustacea. Similarly, the surfaces on a control receiving tank accessory pump (located in the bottom of the receiving tank) had a biofouling density of 9027/m².

### Protected Surfaces and Antifouling System Components

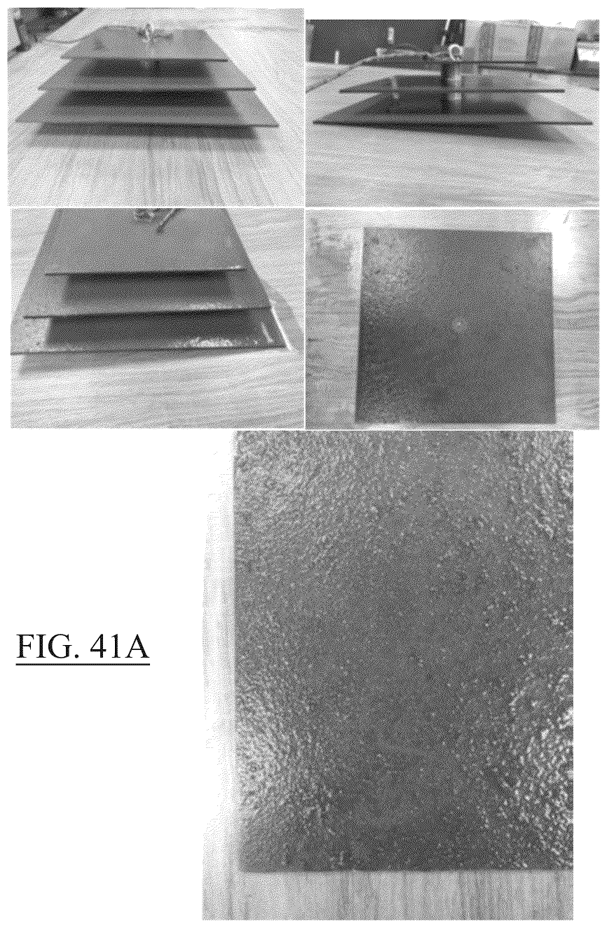

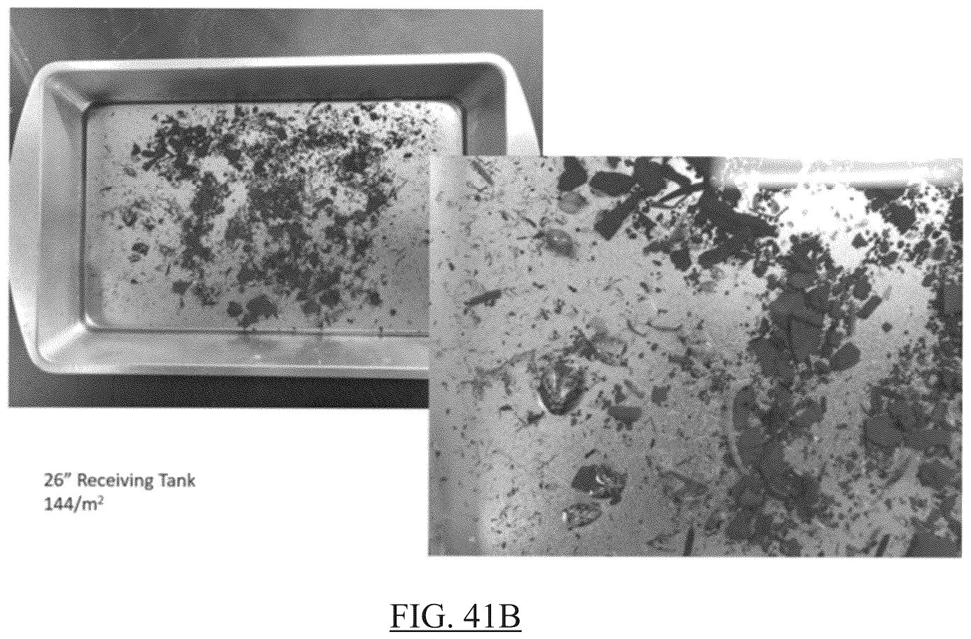

Results from the 21-week test for the protected systems were remarkable. FIG. 41A depicts various views of the surfaces of the surface in water treated by the 66 cm (26″) antifouling device, showing no significant macrofouling entities and very limited levels of slime cover. FIG. 41B depicts the 66 cm (26″) Receiving Tank, which yielded 6 dead specimens (equivalent to 144/m²), or for living mussels 0/m². Note the large Chironomidae midge larva, Chironomus, (arrow) that was living. There were several living Physa pulmonate snails present. Chironomus and Physa are not considered fouling organisms.

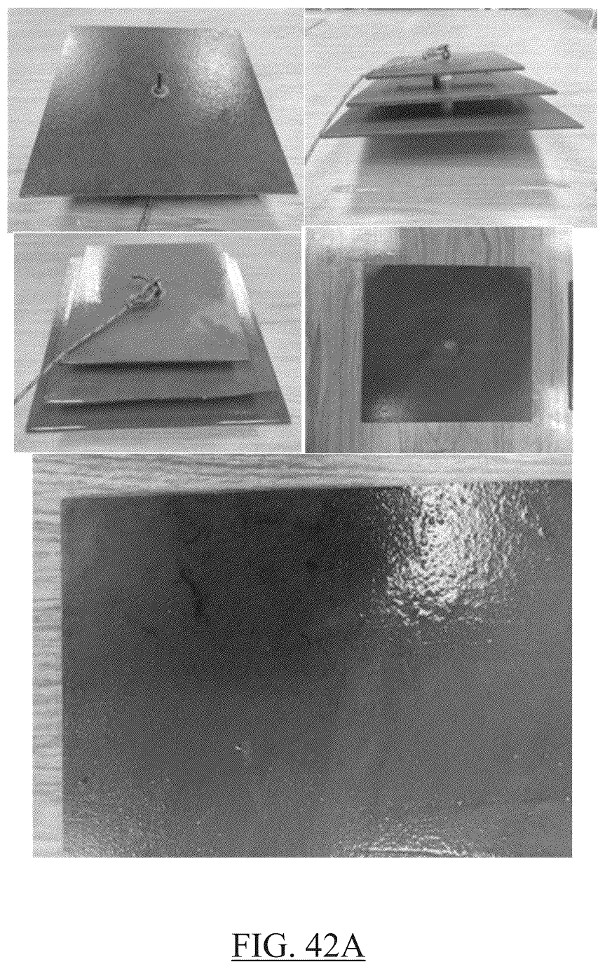

Similarly, FIG. 42A depicts various views of the surfaces of the surface in water treated by the 91.4 cm (36″) antifouling device, again showing no significant macrofouling entities and even less slime cover. FIG. 42B depicts the 91.4 cm (36″) Receiving Tank, which yielded 3 dead mussels (equivalent to 77/m²) or for living mussels 0/m².

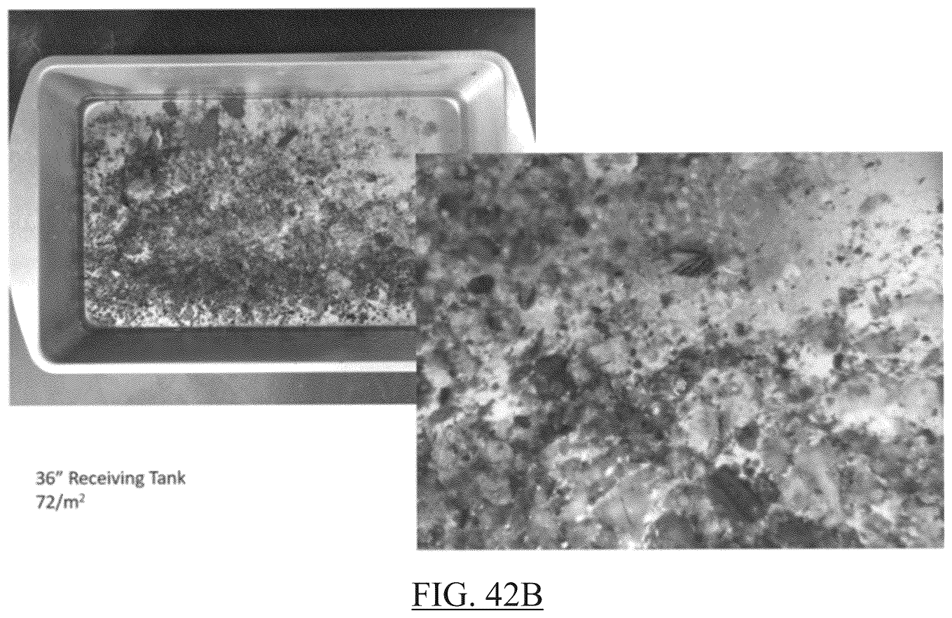

FIG. 43A depicts various views of the surfaces of the surface in water treated by the 116.8 cm (46″) antifouling device, showing few macrofouling entities and little slime cover. FIG. 43B depicts the 116.8 (46″) Receiving Tank which yielded 3 dead mussels (equivalent to 77/m²) or for living mussels 0/m².

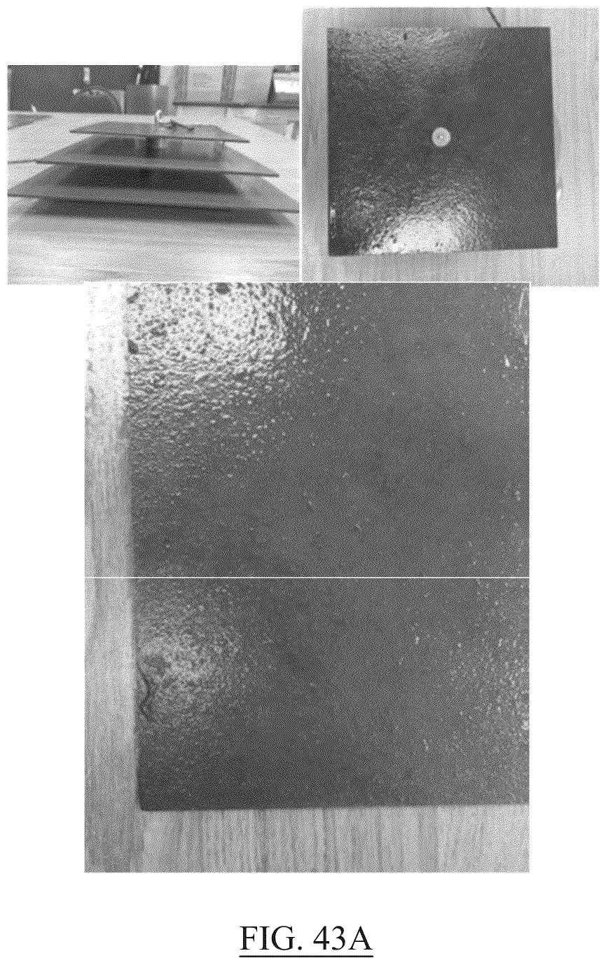

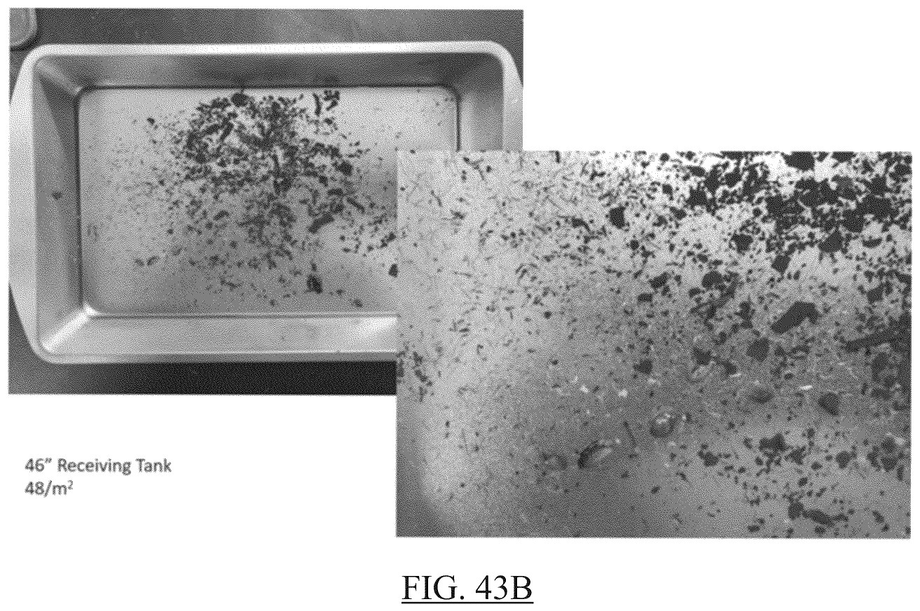

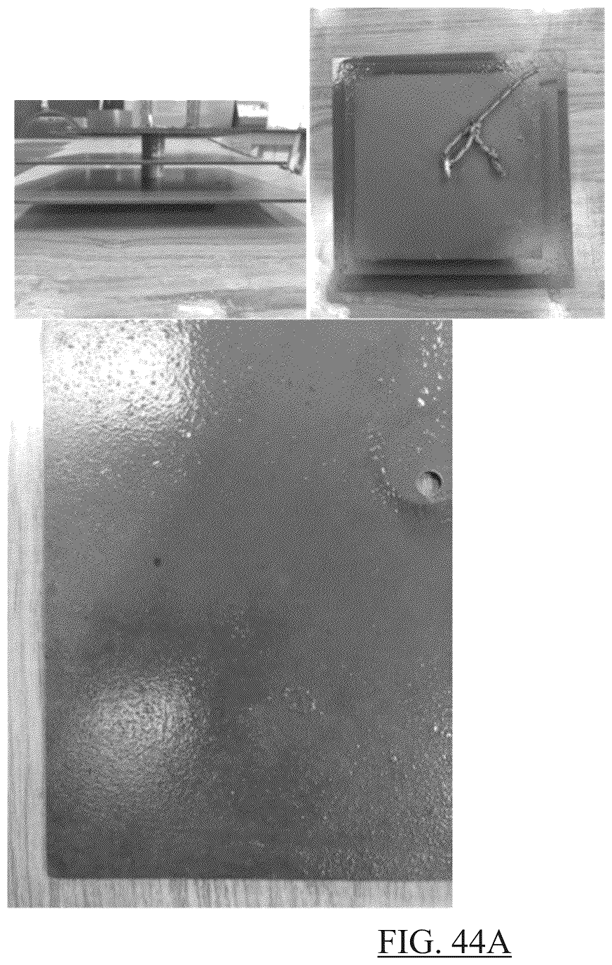

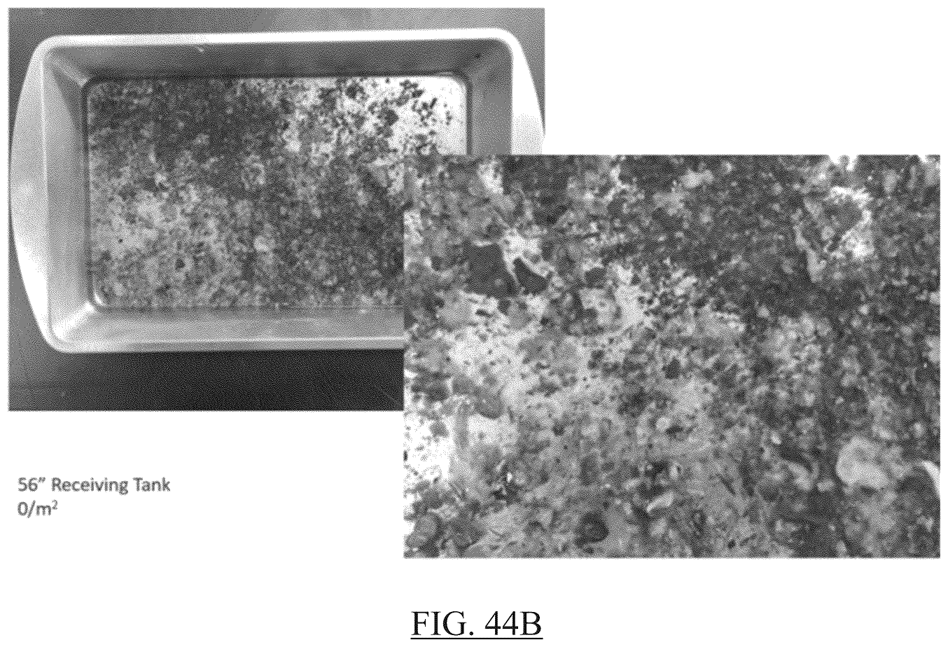

FIG. 44A depicts various views of the surfaces of the surface in water treated by the 142.2 cm (56″) antifouling device, again showing no significant macrofouling entities and little slime cover. FIG. 44B depicts the 142.2 cm (56″) Receiving Tank, which yielded 0 mussels or 0/m².

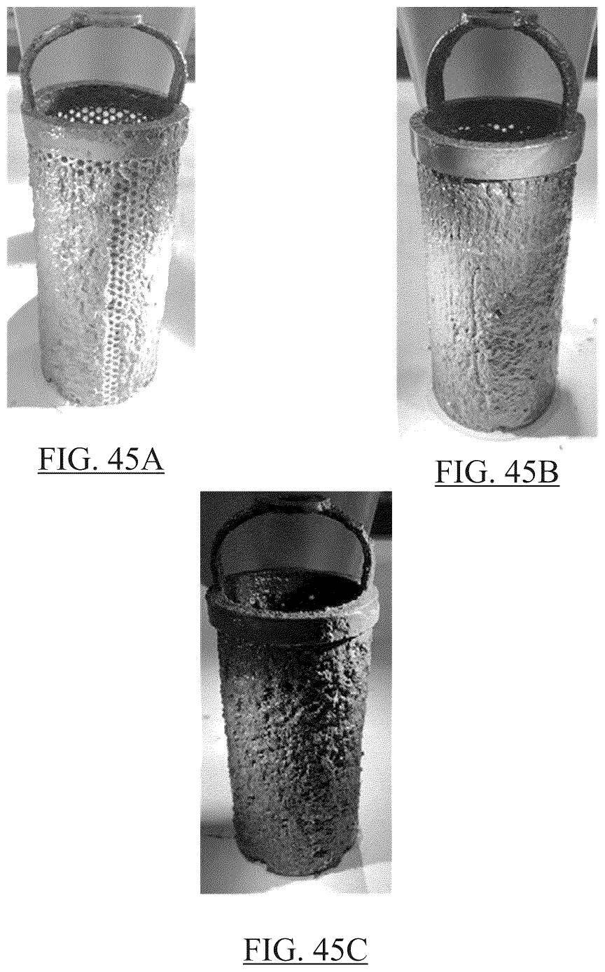

FIG. 45A-C depicted inlet strainers for the 66 cm (26″), the 91.4 cm (36″) and the 116.8 cm (46″) antifouling devices, respectively. These strainers did not have living biofoulers; however, they did each have sediment buildup, as the accessory pump intake was located in the bottom of each receiving tank, where sediment accumulated.

### Heat Exchange Tubing Analogs

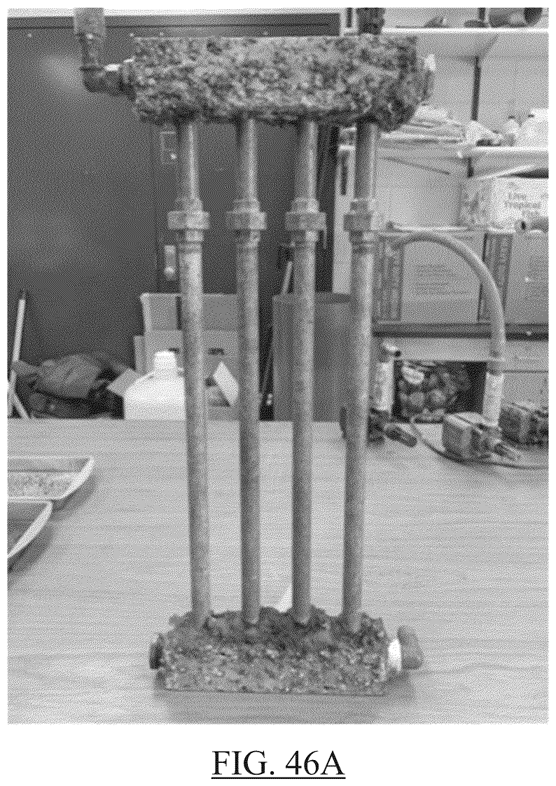

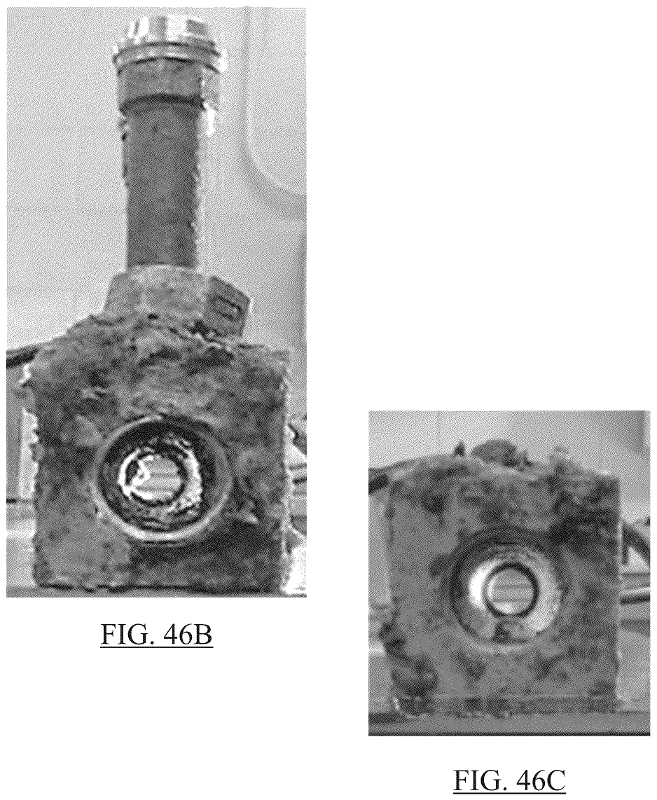

As best seen in FIGS. 46A through 46C, a series of stainless steel cooling tube analogs had no colonization, external or internal, of fouling organisms in the tube interiors. The internal tube surfaces did have some sediment buildup as the accessory pump intake was near the bottom of the receiving tank that accumulated sediment. The aluminum surfaces also had a small amount of fungus growth, which is known to attack aluminum and calcium nodules, giving these structure a somewhat rough appearance in FIGS. 46A-C.

### Results Summary

The results of the freshwater test after +5 months indicated that biofouling (>500 m) in the crossflow spiral use configuration fed receiving tanks was reduced by >99% compared to the control. For example, all spiral use configuration tank loads of living biofouling organisms were 0 compared to 124,000/m² of the control. Similarly, the control receiving tank accessory pump surfaces had a density of 9027/m², while the three-test spiral use configuration tank pumps had 0/m². The 3-plate artificial surface load of fouling organisms was zero in the spiral material treated test receiving tanks, compared to 10,740/m² in the untreated control tank. The greater than 5-month duration of the experiment with remarkable biofouling prevention results supports the conclusion that Applicants antifouling systems with spiral use configurations of varying shapes, sizes and/or flow patterns can be utilized for a minimal 6-12-month material life, and possibly much longer, considering the extremely harsh conditions of the raw water source utilized in this test, which could represent a “worse case” situation for most fresh water environments. As can be seen from the figures as compared to those of the control system, all of the antifouling wound system embodiments were highly effective in preventing fouling of the surface as compared to the control system. All of the protected surfaces showed little to no biofouling of the protected surfaces after 5 months of continuous water flow. The difference between the fouling conditions of the control and test spirals were noted as remarkable and unexpected by the researchers involved in the study.

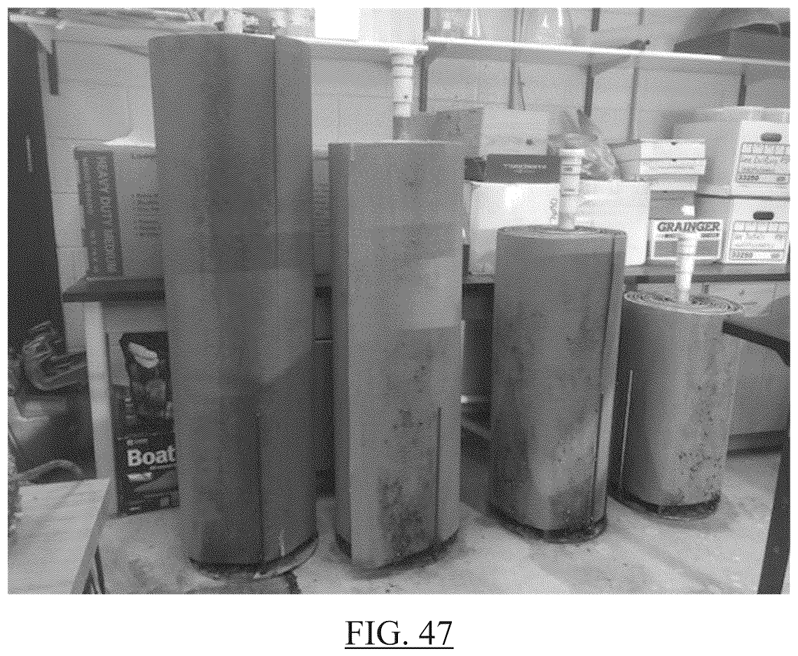

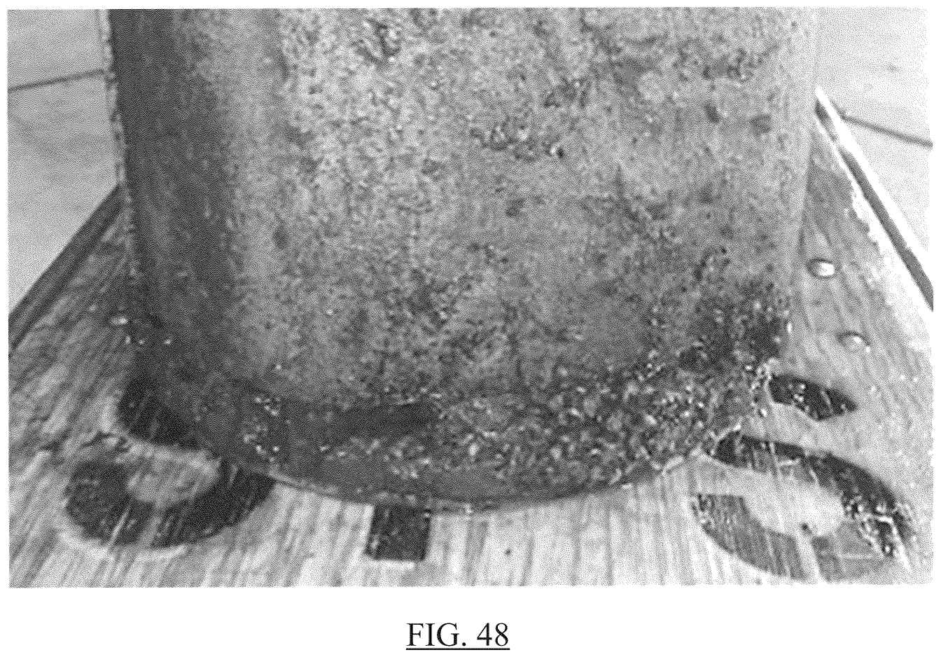

FIG. 47 depicts unrinsed 142.2 cm (56″), 116.8 cm (46″), 91.4 cm (36″) and 66 cm (26″) spiral use configurations from these tests after conclusion of the experiment. As best seen in FIG. 48, an extremely large colony of mussels (in some cases >100,000/m²) had settled and were present in the diffuser space at the bottom of the 66 cm (26″) height spiral module in the experiment (likely due to the unprotected raw water passing from the intake tube into this space initially before redirection upwards in the cartridge—with the presence of such mussels common in this space in all experimental modules), but this significant fouling presence did not result in any fouling downstream of the modules, which reinforces the outstanding and unexpected performance of the antifouling system—even where the intake water was massively infested with these highly invasive fouling organisms. Because the mussels in these intake locations were alive at the conclusion of the experiment, and were apparently healthy and capable of reproduction, it is believed that any veligers produced by this infestation in each test setup were inactivated to a high extent, as none were found in the receiving tanks. Moreover, considering the 5-month continuous exposure of the various experimental material, and the 181,440,00 liters (45,360,000 gallons) of water which was estimated to have passed through the 142.2 cm (56″) device during the experiment (with varying amounts in the other test setups), the results described herein are remarkable and were unexpected by the researchers.

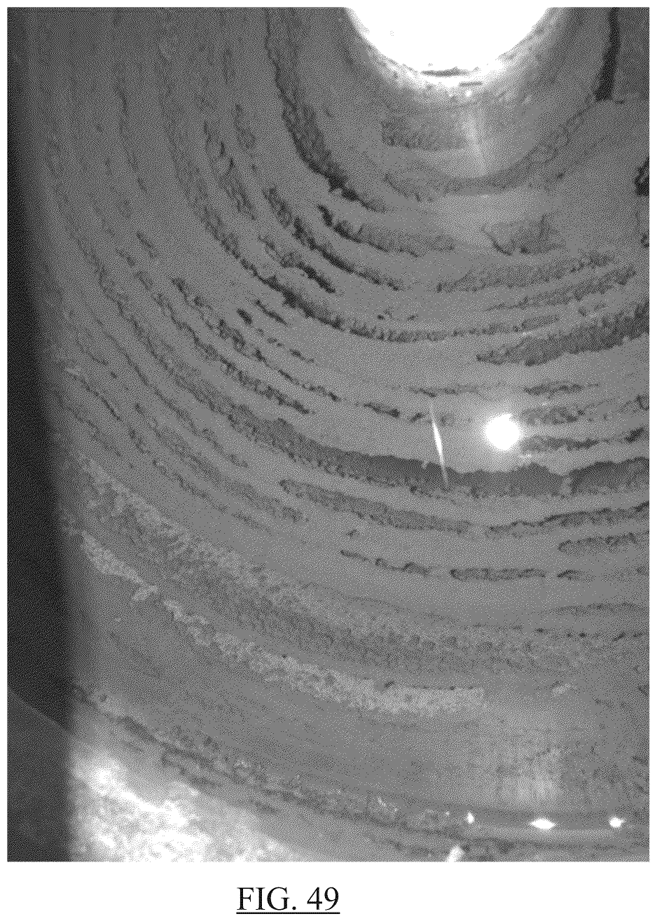

FIG. 49 depicts sediment build up on a top edge of the material of one of the spiral use configurations. In this embodiment, the top edge of the fabric was cut during manufacture, with fabric fraying evident—however the module still performed within expectations. In alternative future embodiments, the top edge of the spiral material may be sealed or hemmed, or otherwise secured or “potted” to prevent water leakage past the top and/or bottom of the fabric spiral. Most notably, the sediment accumulation also did not appear to impact the performance of the spiral material. Moreover, the amount of sediment present in the spiral material, as well as all of the sediment that appeared to have passed through the antifouling system, did not appear to clog or otherwise affect the functionality and/or effectiveness of the antifouling system to any appreciable extent. It is believed that the arrangement of the various system components combines with the flexibility and/or permeability of the material strongly contributed to the “self-cleaning” nature of the antifouling system, with water flow and fabric movement continually scouring, processing and/or removing sediment that may deposit and/or clog various surfaces and/or pores of the material fabric during system operation.

### Example 2—Saltwater Antifouling Systems

### Experimental Test

In another experimental test of the antifouling systems described herein, a 56″ tall crossflow antifouling device with a spiral use configuration, similar in construction and operation to the 142.2 cm (56″) antifouling device detailed above, was installed at the Florida Tech Anchorage, a 4,046 m² (3.5-acre) site located at 1216 East River Drive in Melbourne, Florida, USA (positioned at the confluence of Crane Creek and the Indian River Lagoon). Water flow for this test was started on Mar. 3, 2022, and an assessment of antifouling system performance was conducted on Sep. 21, 2022 (after 6 months of performance).

This experiment involved a common raw saltwater source being pumped directly from open environmental water, which source supplied both a control tank and a treated water tank, with the control tank being filled with the raw water directly, and the treated water tank filled with water that first passed through the antifouling device and then this water entered the treated water tank. The volume of each of the control and treated water tanks was set at approximately 189.3 liters (50 gallons), with each tank having a separate overflow which drained water at the tank surface that exited directly to the Creek/Lagoon.

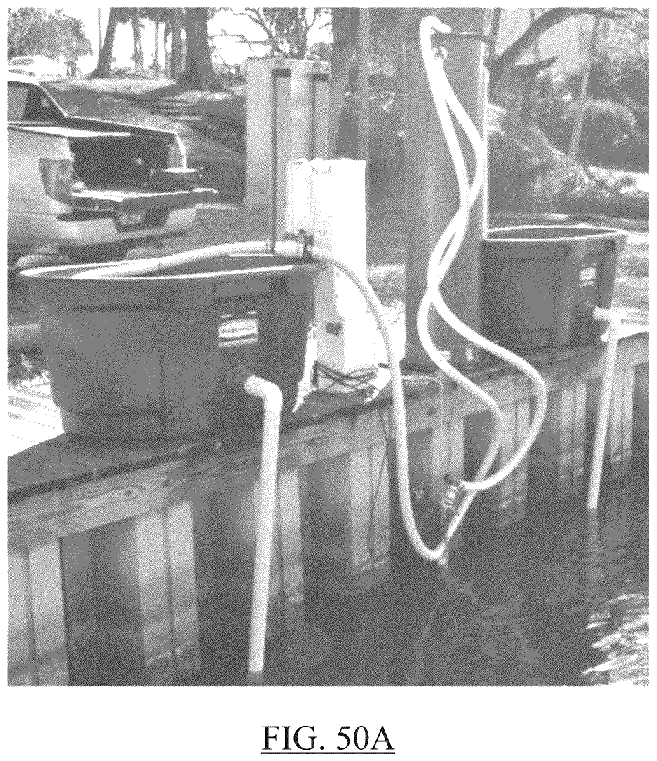

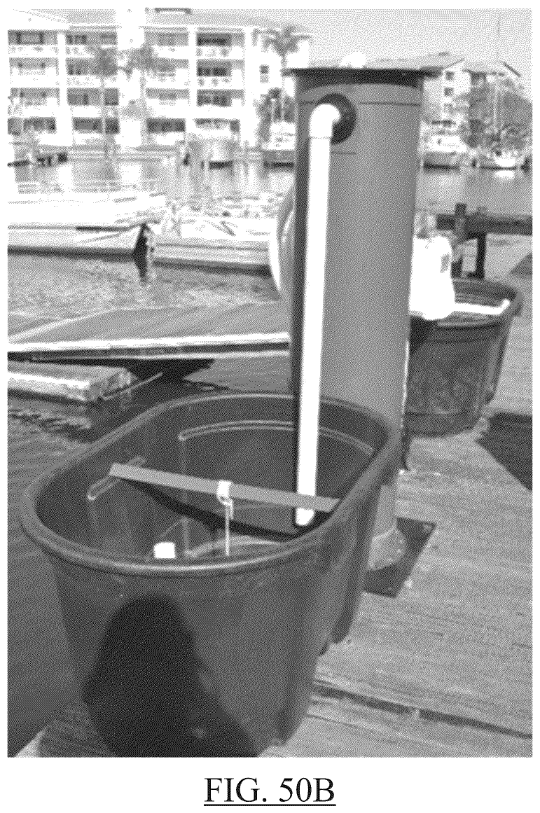

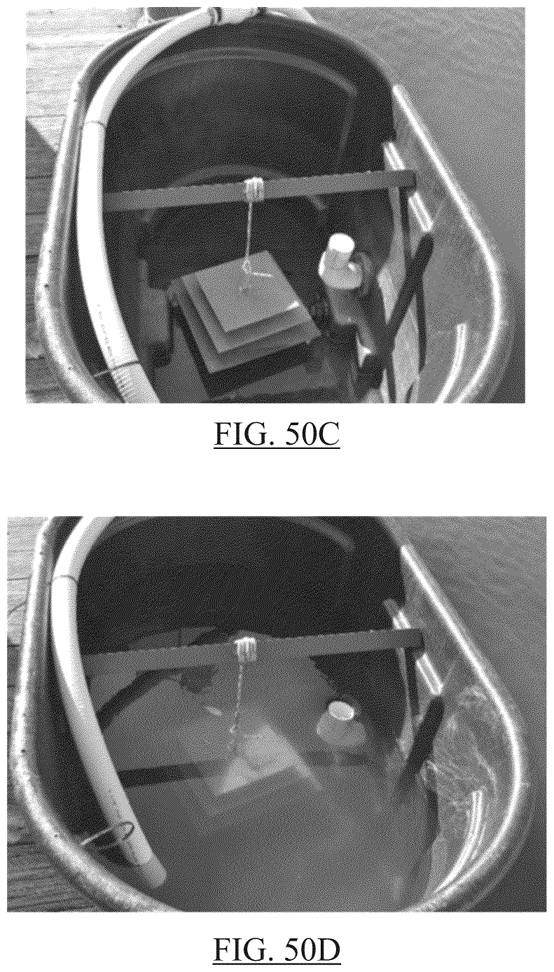

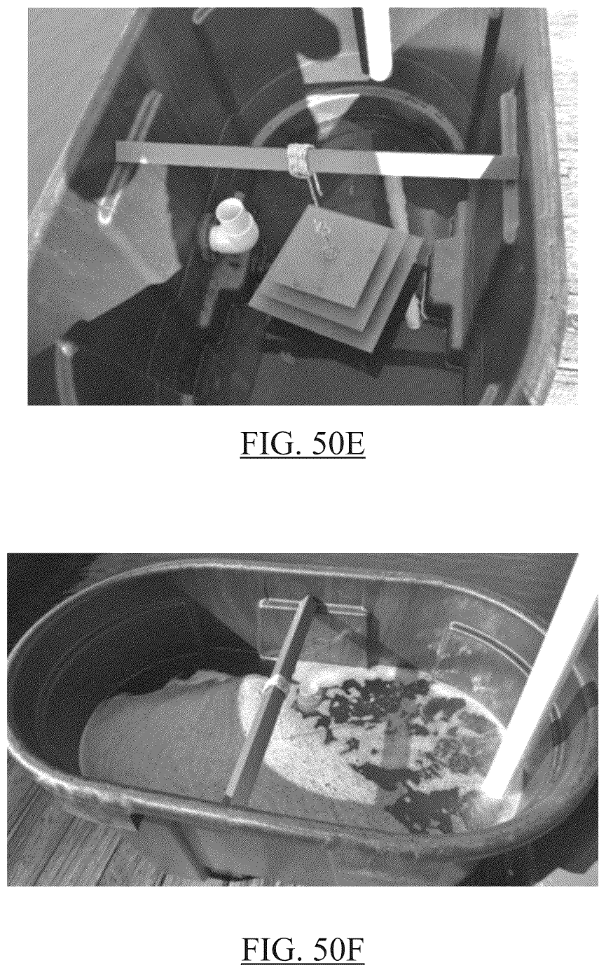

FIGS. 50A through 50F depict various views of the experimental test setup and surrounding environment. FIG. 50C depicts the control tank in a dry condition, while FIG. 50D depicts the control tank during test operation. Similarly, FIG. 50E depicts the protected tank in a dry condition, while FIG. 50F depicts the protected tank during test operation.

For each tank, a first surface was suspended in the water from a central cross beam, and a second surface was placed on the bottom surface of the tank next to the suspended surface.

The researchers noted that at some point in early May the control tank ball valve was shut accidentally, and the control tank did not have water flowing into it for up to 3 days over a weekend (it was uncertain exactly when the water flow was halted during that three-day period). Visual inspection of the control tank revealed that most of the fouling appeared to have died and the tank became stagnant and anoxic (so it was assumed that the flow had been halted for most, if not all, of the three-day period).

### Results Summary—6 Months

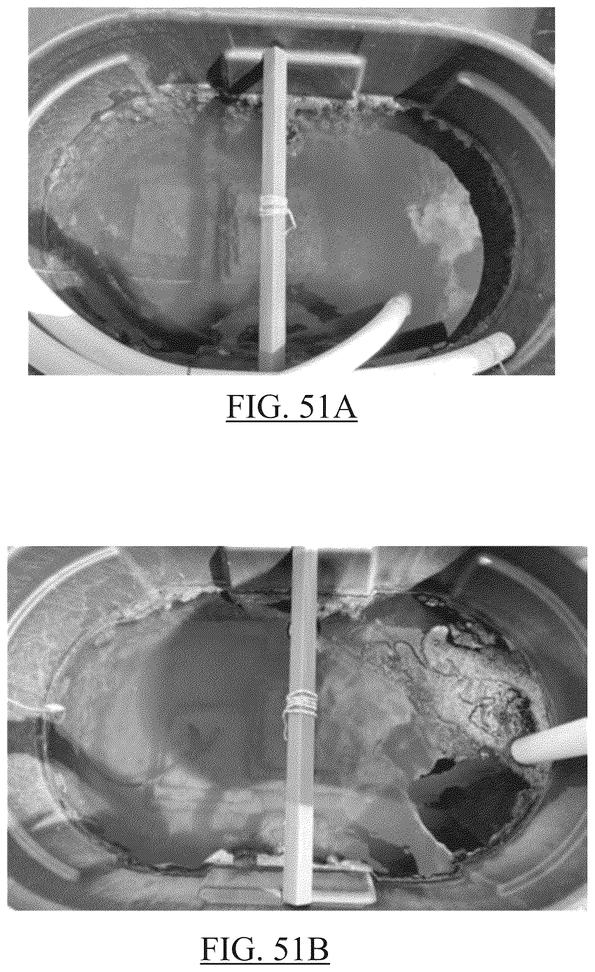

At the six-month point into the test (on Sep. 21, 2022), the water flow to both tanks was halted and the control and protected tanks drained, with photographs taken of the control tank walls (FIG. 51A) and the treated tank walls (FIG. 51B).

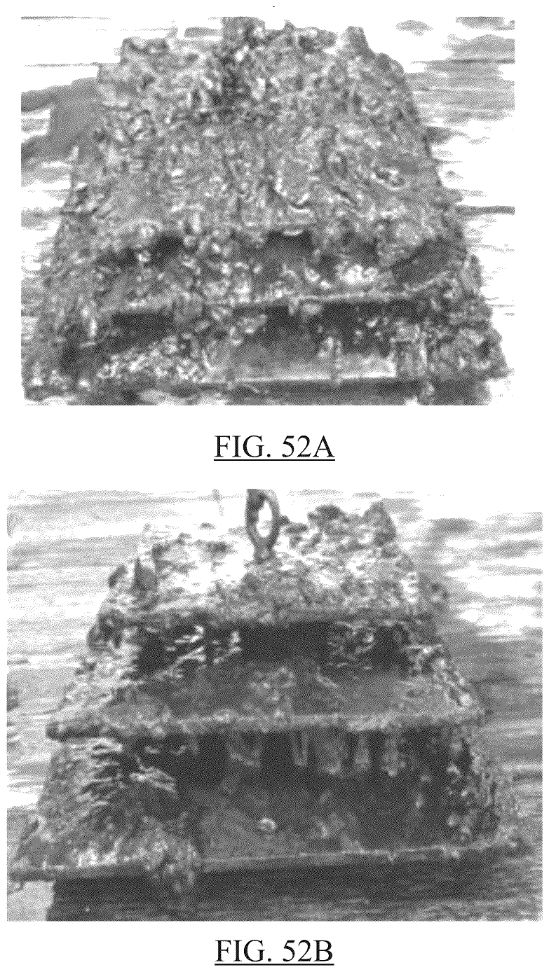

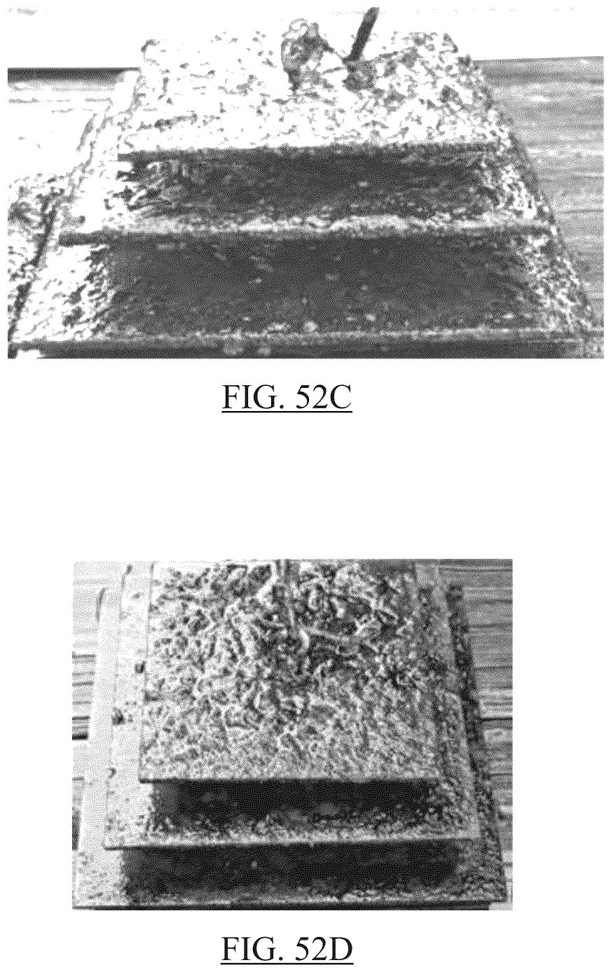

The surfaces from the control tank and the treated tank were removed and photographed, with FIG. 52A showing the suspended control surface, FIG. 52B showing the surface placed control surface, FIG. 52C showing the suspended protected surface and FIG. 52D showing the surface placed protected surface.

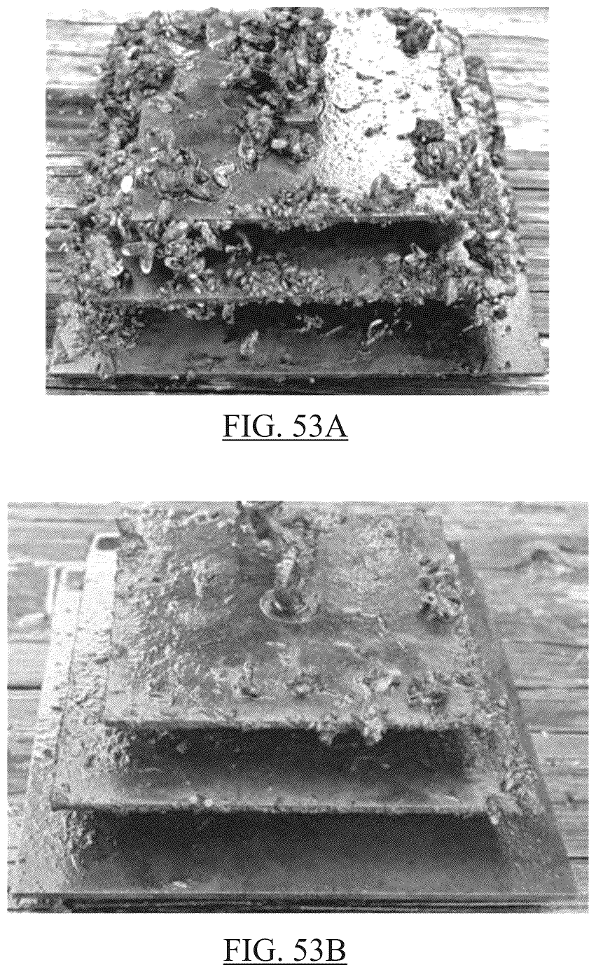

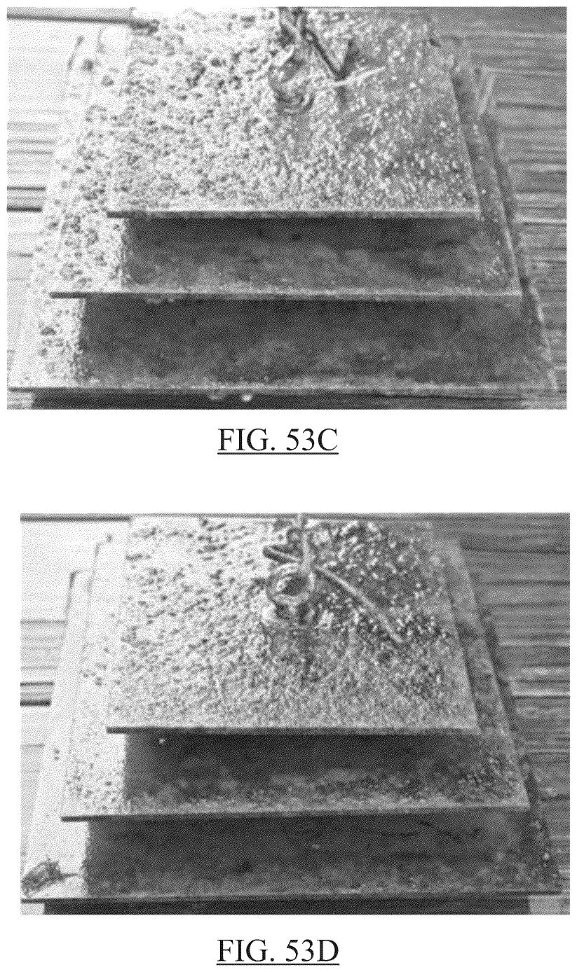

The surfaces were then washed using pressurized water and additional photographs taken, with FIG. 53A showing the washed suspended control surface, FIG. 53B showing the washed surface placed control surface, FIG. 53C showing the washed suspended protected surface and FIG. 53D showing the washed surface placed protected surface.

It became quickly apparent to the researchers that the antifouling system with spiral use configuration was quite successful in protecting downstream surfaces from the effects of biofouling in a salt water environment, and the researchers noted that the antifouling device was still effectively protecting the downstream surfaces (and other system surfaces) from biofouling for at least three months, while mussels began to recruit on the Christmas trees and side of the tank by 4 months, and these mussels had increased in size and number by 6 months. The researchers further opined that the spiral wound material in the cartridge of the antifouling system clearly delayed the onset of fouling and changed the composition and/or limited the cover of fouling as compared to the open/control system.

According to the researcher's analysis, after six months, in the open treatment, both the walls of the tank and the surface “Christmas trees” were heavily fouled with thick silty biofilms, algae, barnacles, tube worms and lots of mussels and oysters. On the suspended control surface, the barnacles and tube worms were alive, with a new settlement of mussels on the suspended surfaces. The surface placed surface was partially buried in sediment, and most of the fouling was dead from this apparently anoxic environment, with some living mussels and tube worms. In contrast, the protected tank and surface “Christmas trees” only had a thick, tenacious biofilm formed thereon and had begun to accumulate some mussels, which were growing and healthy.

With regards to silt deposition and/or formation, the silt differed significantly between the two treatments. The silt in the antifouling system was very loose and gelatinous, while the silt in the control system was more compact and less cohesive. In both treatments, the silt was thick enough that the researchers took photos of the silt, then rinsed the silt off and took additional photos. While the silt appeared to be anoxic and had stained the PVC in both treatments, there appeared to be more silt present in the antifouling system.

Because the depth of the silt and sediment in both tanks was sufficient to bury the bottom placed surfaces to at least half of their heights, both tanks were completely drained, and most of the sediment and silt were rinsed out.

### Example 3—Morehead City 1

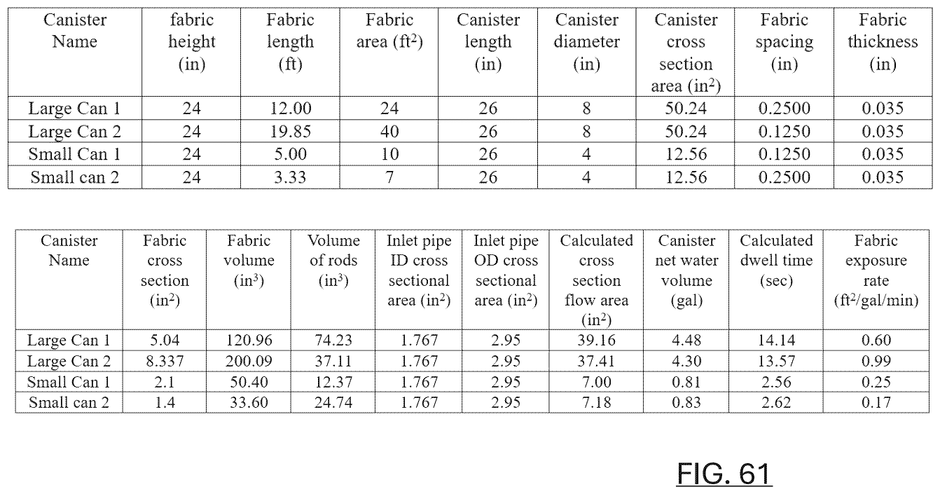

In another experimental test of the antifouling systems described herein, a test was conducted which drew raw estuarine water from a body of water (e.g., Bogue Sound, North Carolina, USA) and utilized various spiral-wound canister designs (with design specifications shown in FIG. 61) incorporating biocide-treated fabric, having different canister sizes. Three water tables were assembled to contain one of two large canisters, one of two small canisters, and one with a non-canister Control. The experimental procedure was to move raw estuarine water at a flow rate of 71.9 liters per minute—LPM (19 gallons/minute—GPM) from the adjacent sound through the canisters and into a 121.1 liter (32-gallon) receiving container which housed a three-plate, artificial substrate to collect fouling organism data. The water then flowed to outflow pipes with a clear section of PVC-pipe to be able to view the relative flow of water, and eventually into a small receiving pond. Using an average flow of 71.9 LPM (19 GPM), estimated dwell time in seconds and calculated average water velocity were: Large Canisters 14.14 seconds (4.27 cm/s or 0.14 ft/s) and 13.57 seconds (4.48 cm/s or 0.147 ft/s); Small Canisters 2.56 seconds (23.8 cm/s or 0.781 ft/s) and 2.62 seconds (23.3 cm/s or 0.76 ft/s).

The fouling plates were then photographed once per week on August 15, 23, 30 and Sep. 7, 2023, with three images per substrate: bottom plate, top plate, and side-view. Water quality data such as salinity, temperature and dissolved oxygen was also collected each week. Water temperature, salinity, and dissolved oxygen (DO) were relatively consistent during the period August 7 to Sep. 7, 2023. For example, water temperature ranged from 27.8 degrees C. (82 degrees F.) to 29.4 degrees C. (85 degrees F.), salinity ranged from 34.5 ppt to 37.5, and DO was always normoxic and above 5.8 mg/DO/l. The salinity values are consistent with ocean salinity.

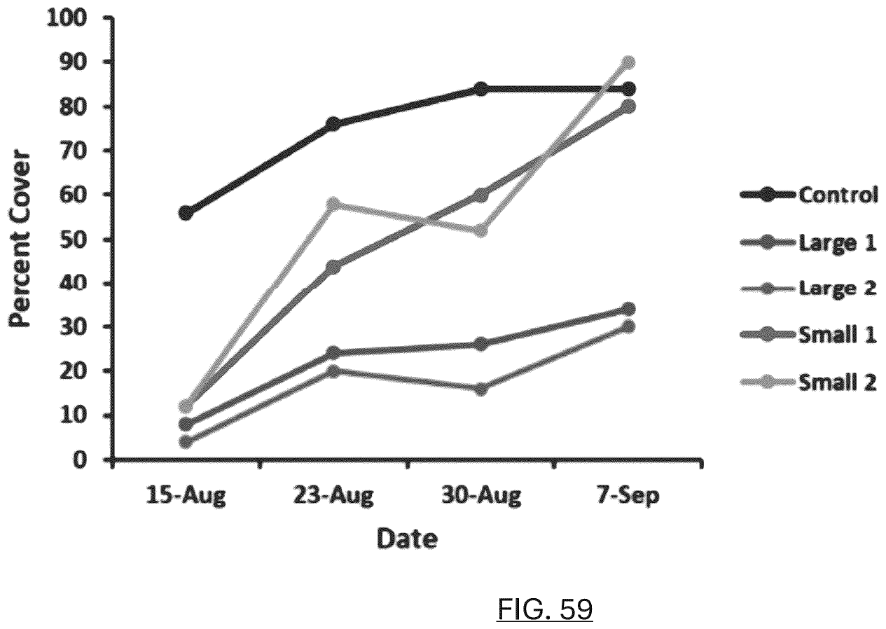

As best seen in FIG. 59, within 1-week of exposure to raw seawater, the control plate had ˜55% cover of fouling organisms, whereas there was 10% or less % fouling on plates linked to the experimental canisters, irrespective of canister treatment. After two weeks of exposure, the % fouling on the control plate was nearly 80%, followed by the two small canisters (45% and 58%), and the large canisters (20% and 24%). At the termination of photographic record on Sep. 7, 2023, there was essentially no difference in % cover of fouling organisms on the control versus the two small-canister treatments, whereas the % cover on the large canister treatments was ˜30%, with little difference between large canister 1 versus 2.

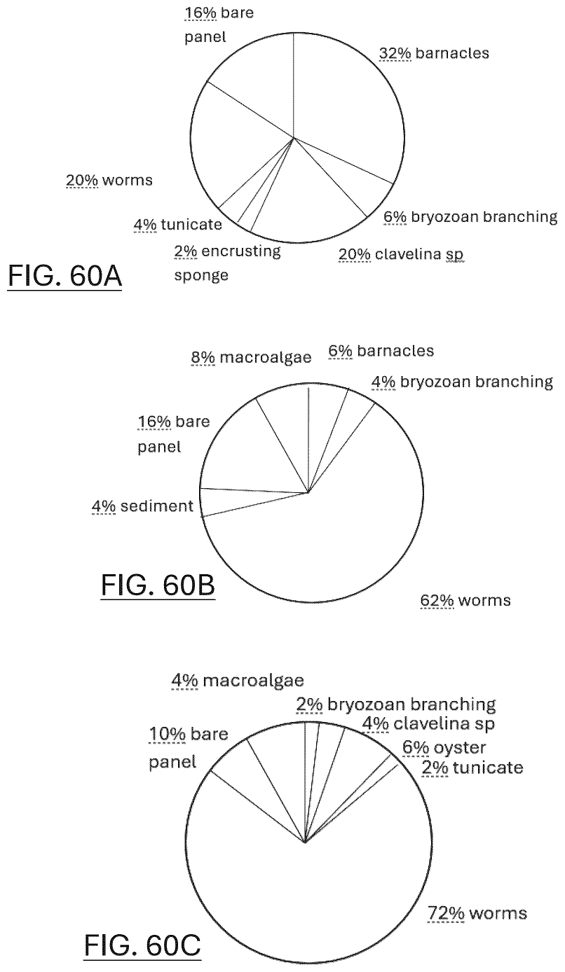

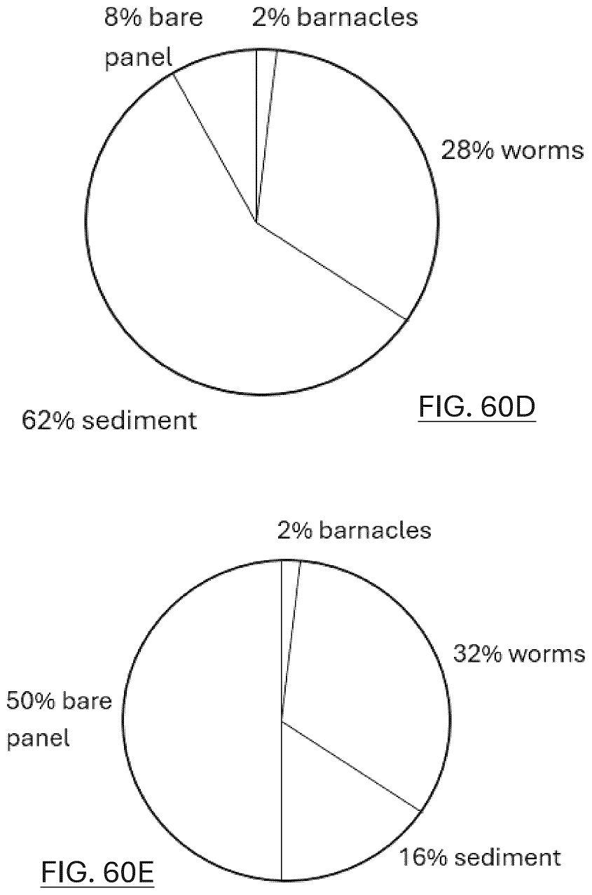

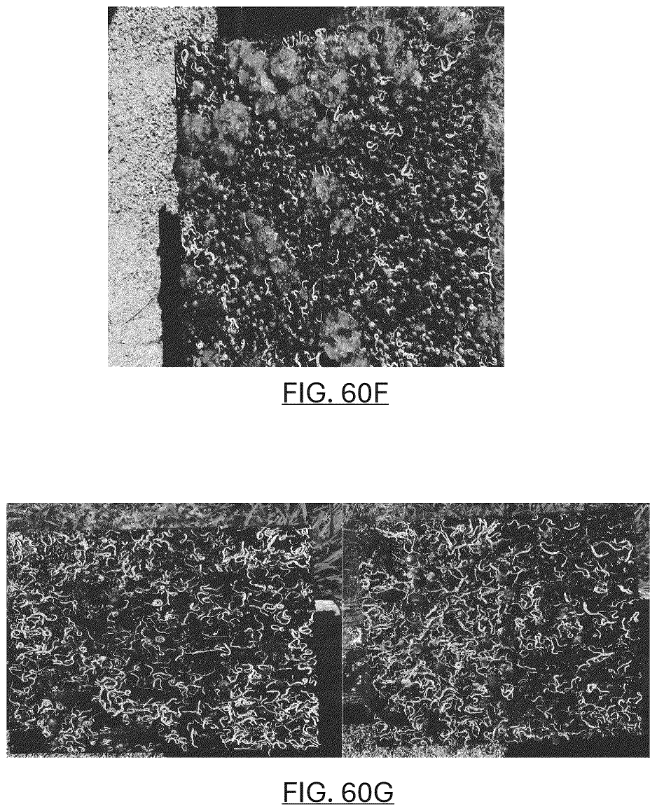

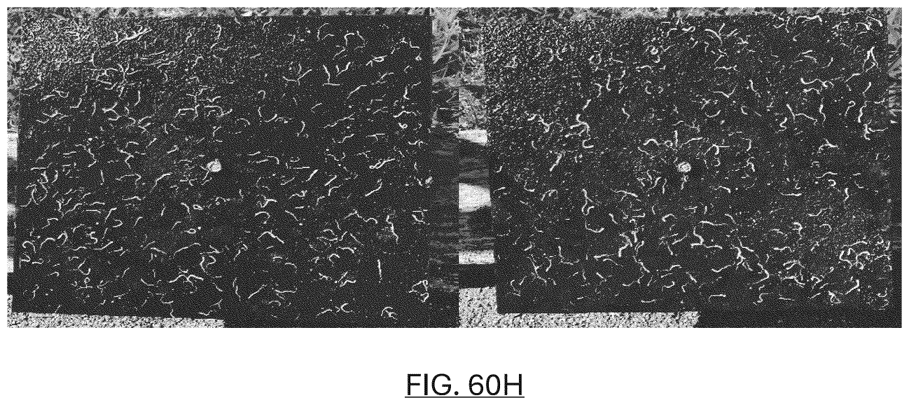

As shown in FIGS. 60A-60H, the differences in percent cover of the various taxonomic groups on September 7 (the end of the experiment) was striking. Bottom plates exposed to water from the large canisters were dominated by bare substrate and tube worms with only 2 taxonomic groups present (FIGS. 60D, 60E and 60H). Plates exposed to water from the small canisters were also dominated by tube worms followed by bare substrate, with six taxonomic groups present (FIGS. 60B, 60C and 60G). The control plate was dominated by barnacles and tunicates (including invasive Clavelina oblonga), with very little bare substrate (FIG. 60F).

Percent fouling decreased with increasing exposure to the biocide fabric within the experimental canisters, with the greatest change occurring within one-week of exposure to raw seawater. There appeared to be relatively little difference in fouling due to the degree spacing of the fabric within a given canister size, however there was ˜50% less fouling on plates when exposed to the large canisters versus the small canisters at the termination of the photographs on Sep. 7, 2023. It is believed that the increased volume of the larger canisters desirably provided a commensurate increase in “dwell time” of the water within those canisters (e.g., 14.14 and 13.57 seconds for the large canisters as compared to 2.56 and 2.62 seconds for the smaller canisters), which dramatically improved the effectiveness of the fouling reduction for those treatments. However, even the relatively brief dwell time of 2 to 3 seconds for the smaller canisters provided a significant improvement in fouling protection over the control.

As previously noted, an antifouling system that utilizes larger volume canisters can often provide an increased “dwell time” for the treated water as it passes through the canister, which will desirably improve fouling protection for the water system and may optionally allow for a reduction in the amount of fabric or other materials employed within the canister. In other instances, the dwell time may be increased by altering a volume and/or flow rate of the water passing through the canister and/or other system components in a variety of ways, including by the judicial use of supplemental holding tanks and/or reservoirs within the water system, to obtain a level of antifouling treatment necessary to obtain the ultimate fouling reductions.

### Example 4—Morehead City 2

In another experimental test of the antifouling systems described herein, a test was conducted which drew raw estuarine water from a body of water (e.g., Bogue Sound, North Carolina, USA) and utilized various canister designs incorporating biocide-treated fabric, having different packing configurations and/or orientations of the canister. Five treatments were included: (1) Control (horizontal orientation of the canister with no treated fabric), (2) horizontal orientation of the canister with spiral water flow, (3) vertical orientation of the canister with spiral water flow, (4) vertical orientation of the canister with direct (e.g. linear) water flow, and (5) horizontal orientation of the canister with direct (e.g., linear) water flow. Experimental three-plate, artificial substrate plates were provided for collection and quantification of fouling organisms. The experiment was initiated on Oct. 19, 2023, and terminated on Dec. 12, 2023. Water flow rates were measured via digital meters and flow adjusted as necessary on 29 separate days during the 55-day experiment. The fouling plates were photographed once per week in 2023 on October 25, November 2, 9, 16, 22 and 30, and December 7 and 12, with three images per substrate: bottom plate, top plate, and side-view. Water quality data such as salinity, temperature and dissolved oxygen was also collected each week.

The water temperature ranged from 19.72 C (67.5 degrees F.) on October 25 to 13.3 C (56 degrees F.) during November 30 to December 12. Salinity and dissolved oxygen were relatively consistent over time, with salinity averaging 34 ppt and DO 7.8 mg/DO/l. The salinity values were consistent with ocean salinity, and DO levels were considered normoxic. Water flow averaged 50.72 LPM (13.4 gallons per minute), and mean flow rates did not vary significantly according to the five treatments.

### Experimental Results

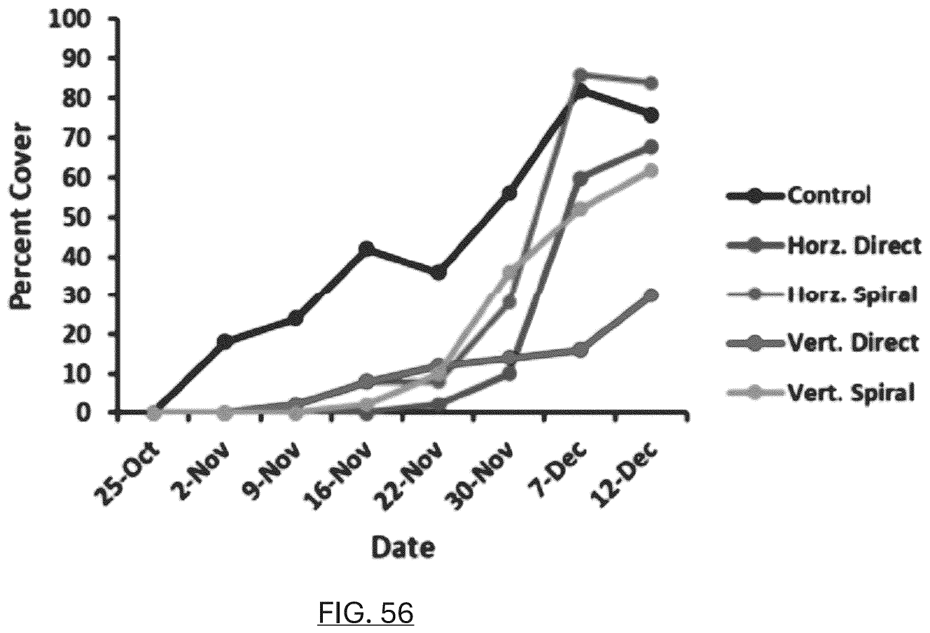

FIG. 56 depicts precent cover results for this experiment. The percent cover of fouling organisms increased steadily on the control plate reaching a peak of ˜80% cover when the study was terminated on December 12. Conversely, the percentage cover of fouling organisms on the treatment plates did not increase substantially until November 22, ˜5 weeks after the start of the experiment. At the termination of the experiment on December 12, the vertical direct treatment displayed the lowest percent cover of fouling organisms at 30%, followed by the vertical spiral and horizontal direct treatments at ˜60-65% cover, followed by control and horizontal spiral at ˜80-90% cover.

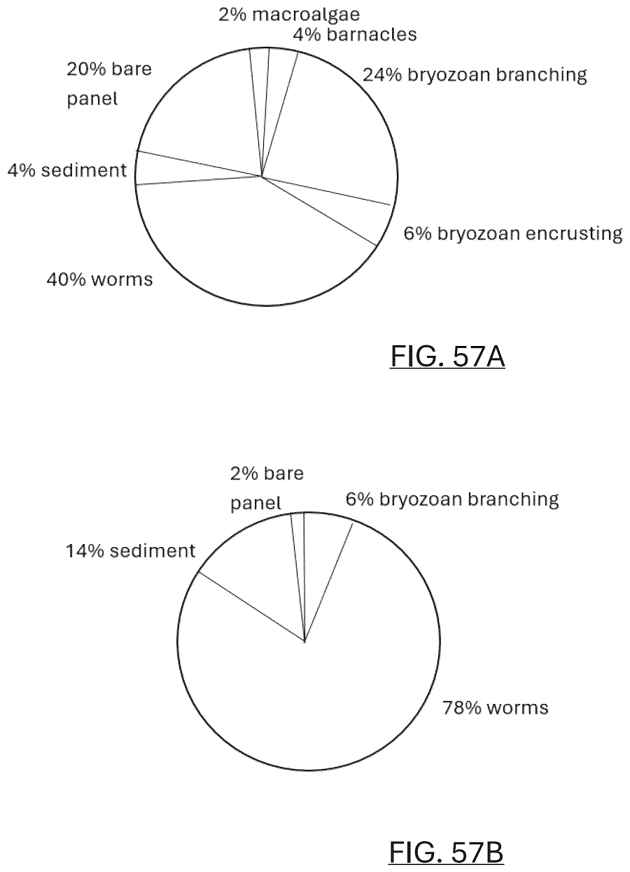

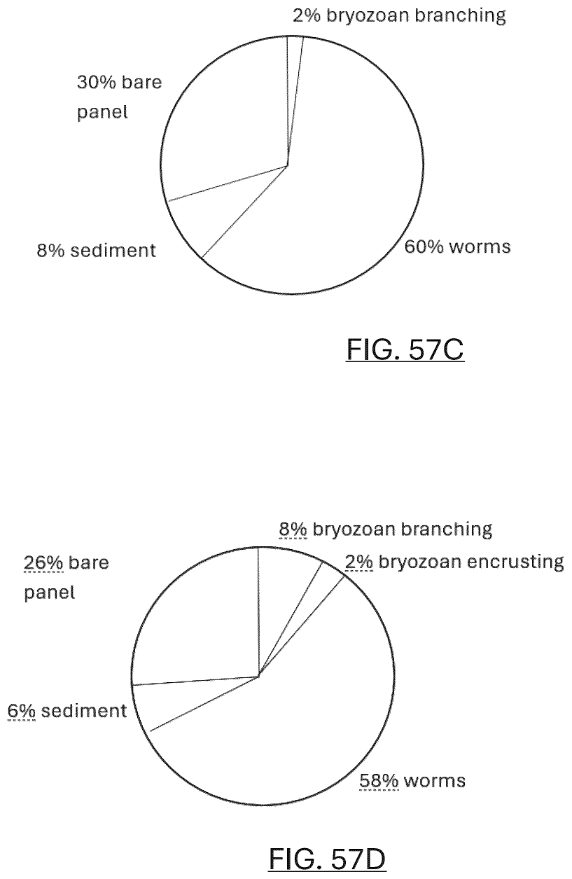

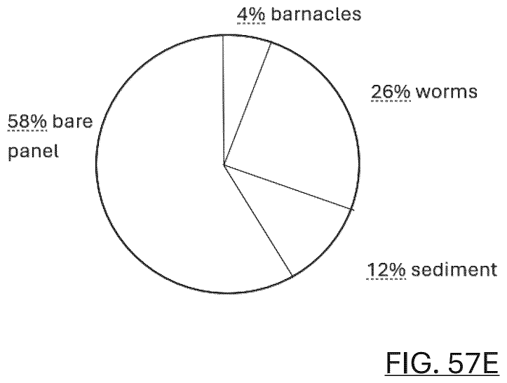

As best seen in FIGS. 57A through 57E, the control treatment had the most diverse fouling community, with five species dominated by worms, and with 20% bare substrate at the end of the experiment. Worms dominated the fouling community for the remaining four treatments. For example, the horizontal spiral treatment (FIG. 57B) had two species (worms and branching bryozoans) and only ˜2% bare substrate. The vertical spiral treatment (FIG. 57C) also had two species (worms and branching bryozoans) with 30% bare substrate. The horizontal direct treatment (FIG. 57D) had three species (worms, branching bryozoans, and encrusting bryozoans) and 26% bare substrate, and the vertical direct treatment (FIG. 57E) had two species (worms and barnacles) and 58% bare substrate (FIG. 6).

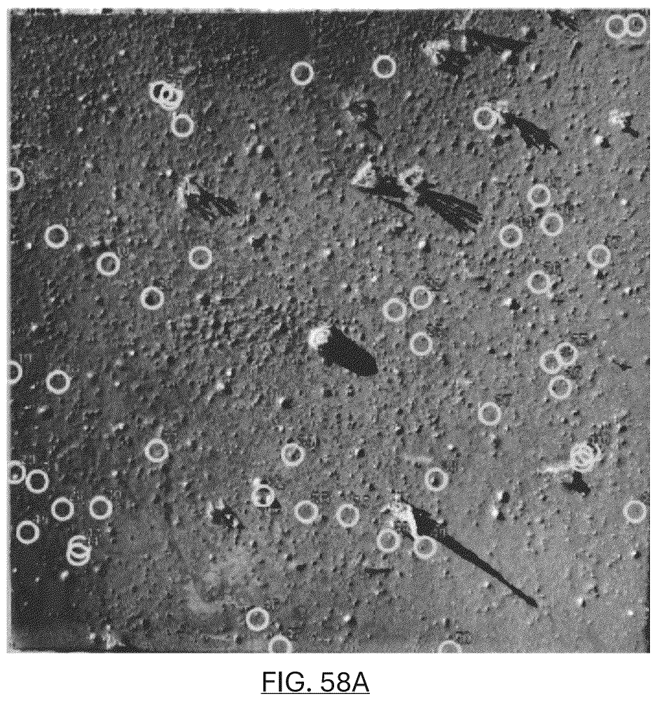

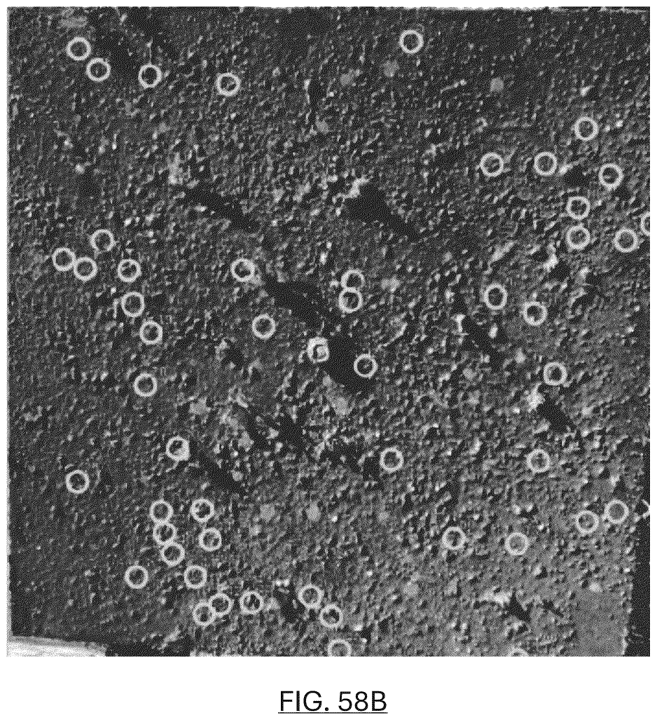

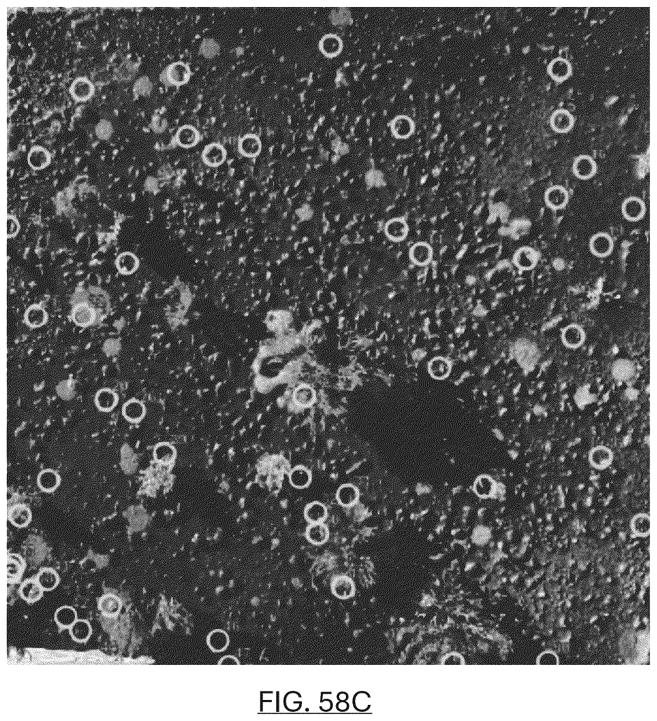

The primary goal of the experiment was to determine if the canister designs would vary in effectiveness due to changes in orientation. While all canisters provided adequate fouling protection, the vertical direct flow treatment (see FIG. 58A) appeared to cause the greatest reduction in percent cover of fouling organisms of all the treatments, while the horizontal spiral treatment (see FIG. 58B) appeared to be less effective at reducing fouling, although still adequate for various applications as compared to the control system (see FIG. 58C).

### Example 5—Cmast

In another experimental test of the antifouling systems described herein, a test was conducted which drew raw estuarine water from a body of water (e.g., Bogue Sound, North Carolina, USA) at a flow rate of at least 151.4 LPM (40 gallons/minute) into each of two experimental tanks and a lower flow of water into a control tank. The test involved a control tank and two vertical linear flow experimental canisters, with tank 1 having a spiral element and tank 2 having a pleated element. Water flowed through each of the canisters into a receiving container which housed a three-plate, artificial substrate to collect fouling organism data, with the control tank also having a three-plate, artificial substrate. Water flow rates were measured via digital meters and flow adjusted as necessary on 42 separate days during the experiment (e.g., initiated on Feb. 8, 2024, and terminated on Apr. 10, 2024).

Two 10.16 cm (4-inch) diameter canisters were created and filled with two variants of the coated materials (e.g., BTI high permeable/dual sided fabric). Large couplings were placed in the center of each of the canisters to ease disassembly and evaluation post experiment.

The first canister—Pleated Canister (C-P)—was filled with 147.32 cm×60.96 cm (58″×24″) of fabric, which was hand pleated. The pleated fabric was wrapped around a center PVC pipe for support, and 3D printed rings or spacers were placed on each end for the pleat folds to give added support. The second canister—spiraled fabric canister (C-S)—was similar in design to the spiral direct flow canister of FIG. 15, incorporating corrugated spacers as shown in FIGS. 13C-13E. In this embodiment, 139.6 cm×60.96 cm (55″×24″) of fabric was attached to a center PVC pipe for support and rolled with 0.3175 cm (⅛″) thick corrugated spacers, with less fabric used in this C-S variant due to space limitations with the spiral configuration.

The C-P and C-S canisters were installed on Feb. 8, 2024 into a manifold system and placed in a vertical orientation. Hayword perforated basket strainers were installed inline before each canister to approximate strainers found in the boating industry. Strainers were used predominantly to filter large debris and shells. After passing through the canisters, water was diverted through a flow meter and into a 151.4 liter (40-gallon) collection bin. The collection bin held a suspended biofouling tree and contained holes for gravity overflow of water. Due to flow constraints on the system, pseudo-control was placed at approximately 5 gal per minute with no strainer, at the manifold, which control was not meant to be a direct comparison but to give insight to biofouling species in the water column. Canister flow rates were targeted at 151.4 LPM (40-gpm).

The fouling plates for each of the experimental set-ups were photographed once per week, with three images per substrate: bottom plate, top plate, and side-view. Water quality data such as salinity, temperature and dissolved oxygen were also collected each week. As expected from previous experiments, the bottom plate in each experimental setup appeared to be the most responsive surface to fouling. Accordingly, images of the bottom plate were used to quantify percent fouling and the species responsible for fouling via CoralNet image analysis software (https://coralnet.ucsd.edu/) by randomly assigning 50 points on each plate and quantifying the percent cover out of 50 random points.

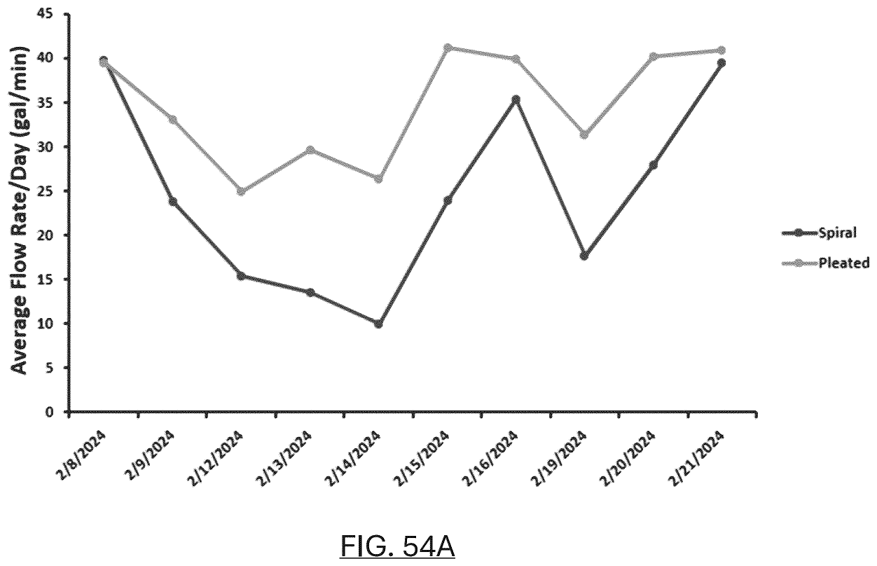

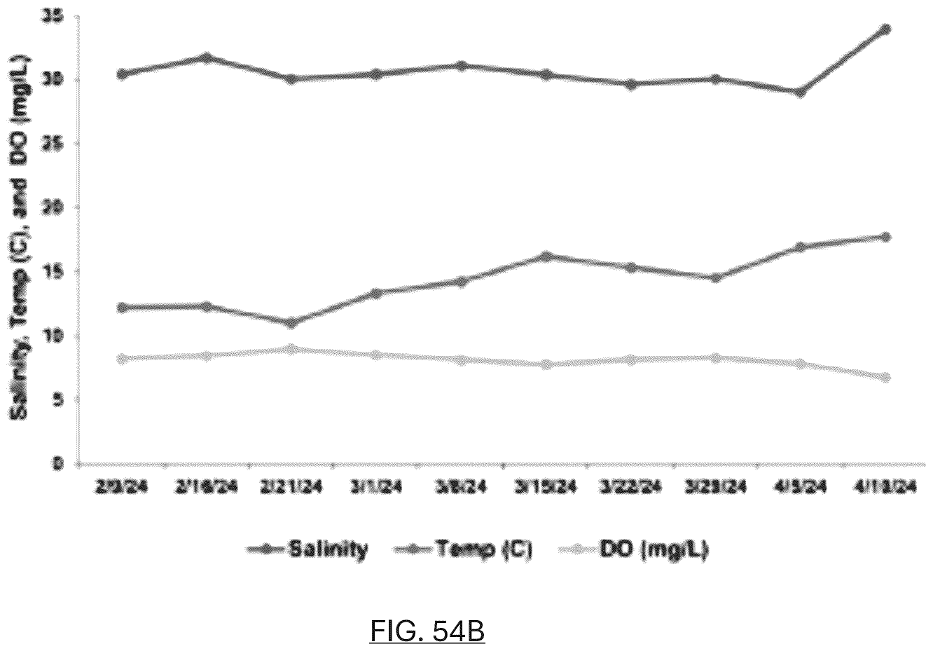

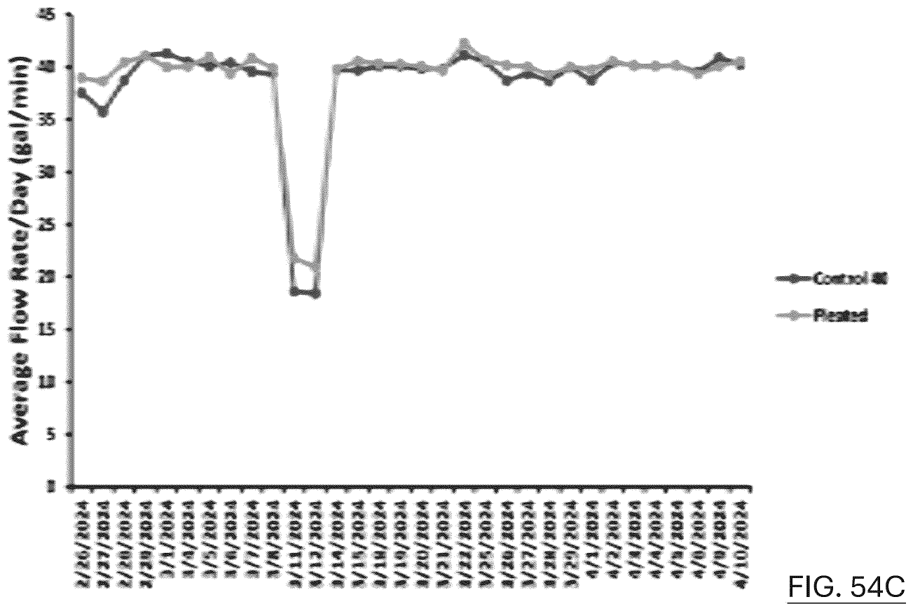

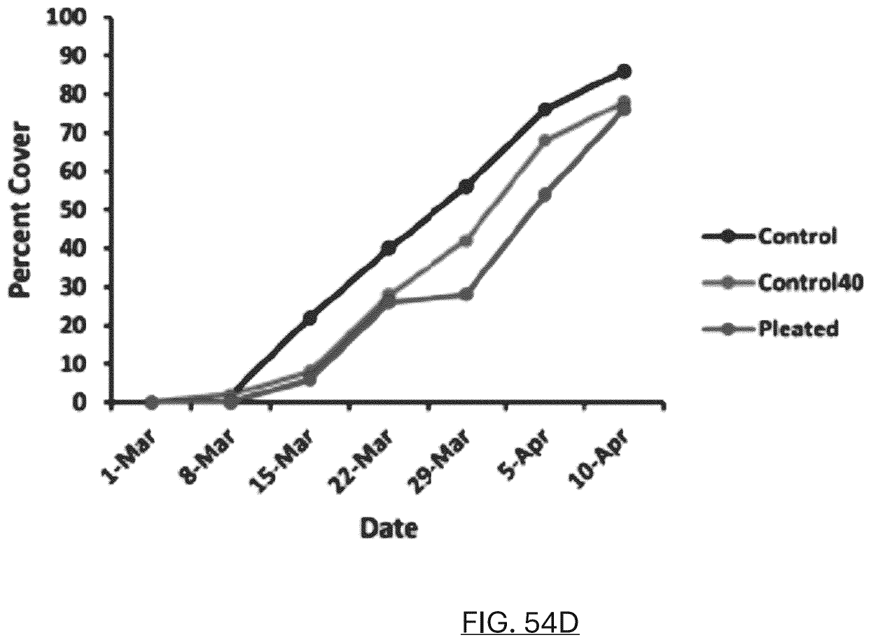

As best seen in FIG. 54B, the water temperature during the experiment ranged from 11.0 degrees to 17.7 degrees C., which is typical for the area during that time frame. Salinity and dissolved oxygen were relatively consistent over time, with salinity averaging 31 ppt and DO 8.08 mg/L. The salinity values were consistent with estuarine salinity, and DO levels were considered normoxic.

At the start of the experiment, both canisters were experiencing approximately 40 gallon per minute of flow. However, after a weekend of operation the flow rate drastically dropped in the system (see FIG. 54A). It was determined that the spiral canister was the primary cause of system backpressure and/or clogging. On Feb. 22, 2024, it was decided to remove the direct spiral flow canister and retool the experiment to continue evaluation of C-P for the rest of the low fouling season. The experiment was replumbed to run C-P against a 151.4 LPM (40-gpm) control. After C-S removal, the experiment was reset with a new goal of longer-term evaluation of C-P with a secondary goal of finding if antifouling effects would be significant. At the time of changing the plumbing on Feb. 22, 2024, approximately 2,649,788 liters (700,000 gallons) of water had been passed through C-P. New biofouling trees were placed in the 151.4 LPM (40-gallon) collection bins, with the 18.92 LPM (5-gpm) pseudo control keeping the original biofouling tree.

The C-P canister was disassembled after 6 added weeks of experimentation (once water temperatures began to rise in the Spring. No cleaning or any other action was applied to the canister throughout the entire operation from Feb. 24, 2008-Apr. 10, 2024. The canister remained in operation with no noticeable flow problems. Teardown showed a fair amount of material that was captured at the entrance of the canister without the canister showing signs of back pressure or clogging. It is theorized that the triangle shapes created by pleat folds allowed for flow pathing into the canister to still happen without blockage or material collapse leading to increases in backpressure and/or flow reductions. The pleated fabric also had minimal sediment on the fabric at the conclusion of this experiment.

For the second part of the experiment, the direct flow of 151.46 LPM (40 gal/min) included a 151.46 LPM (40-gallon) control to test against the pleated canister. Both the Control 40 and Pleated treatments had flow rates between 132.5 and 159 LPM (35 and 42 gal/min), with minor adjustments made daily to maintain the optimal 151.46 LPM (40 gal/min). The one exception occurred on Mar. 11, 2024 and Mar. 12, 2024 after a large rain event causing sand to clog the main intake pipes. After they were cleaned both the pleated and control 40 regained optimal flow rates again. Mean flow rates did not vary significantly between the control 40 and pleated treatments (p=0.664). FIG. 54C and Table 13 (below) depict daily flow rates for this experiment, which ranged from a low of 132.5 LPM (35 GPM) to a high of 159 LPM (42 GPM) (except for the transient flow blockage occurring from 3/11 to 3/14).

TABLE 13
Daily Flow Rates and Cumulative Flow Volumes

| | Control Flow Rate | Pleated Canister Flow | Control Volume Total | Pleated Canister Volume Total |
|---|---|---|---|---|
| Day | liter/min (GPM) | Rate liter/min (GPM) | liters (Gallons) | liters (Gallons) |
| 2/26 | 143.8 (38) | 147.6 (39) | 207138 (54,720) | 212589 (56,160) |
| 2/27 | 132.5 (35) | 147.6 (39) | 397922 (105,120) | 452177 (112,320) |
| 2/28 | 147.6 (39) | 151.4 (40) | 601511 (161,280) | 643217 (169,920) |
| 2/29 | 155.2 (41) | 155.2 (41) | 834001 (220,320) | 866707 (228,960) |
| 3/1 | 155.2 (41) | 151.4 (40) | 1053707 (279,360) | 1084747 (286,560) |
| 3/4 | 151.4 (40) | 151.4 (40) | 1711611 (452,160) | 1738866 (459,360) |
| 3/5 | 151.4 (40) | 153.3 (40.5) | 1929651 (509,760) | 1959631 (517,680) |
| 3/6 | 151.4 (40) | 147.6 (39) | 2147691 (567,360) | 2172220 (573,840) |
| 3/7 | 151.4 (40) | 153.3 (40.5) | 2365730 (624,960) | 2392985 (632,160) |
| 3/8 | 151.4 (40) | 151.4 (40) | 2583770 (682,560) | 2611025 (689,760) |
| 3/11 | 68.1 (18) | 83.3 (22) | 2878124 (760,320) | 2970791 (784,800) |
| 3/12 | 68.1 (18) | 79.5 (21) | 2976242 (786,240) | 3085262 (815,040) |
| 3/14 | 151.4 (40) | 151.4 (40) | 3412321 (901,440) | 3521341 (930,240) |
| 3/15 | 151.4 (40) | 153.3 (40.5) | 3630361 (959,040) | 3742106 (988,560) |
| 3/18 | 151.4 (40) | 151.4 (40) | 4284480 (1,131,840) | 4396225 (1,161,360) |
| 3/19 | 151.4 (40) | 151.4 (40) | 4502520 (1,189,440) | 4614265 (1,218,960) |
| 3/20 | 151.4 (40) | 151.4 (40) | 4720559 (1,247,040) | 4832305 (1,276,560) |
| 3/21 | 151.4 (40) | 151.4 (40) | 4938599 (1,304,640) | 5050344 (1,334,160) |
| 3/22 | 155.2 (41) | 159.0 (42) | 5162090 (1,363,680) | 5279286 (1,394,640) |
| 3/25 | 151.4 (40) | 151.4 (40) | 5381130 (1,421,280) | 5497326 (1,452,240) |
| 3/26 | 147.6 (39) | 151.4 (40) | 5592718 (1,477,440) | 5715366 (1,509,840) |
| 3/27 | 151.4 (40) | 151.4 (40) | 5810758 (1,535,040) | 5933405 (1,567,440) |
| 3/28 | 149.5 (39.5) | 149.5 (39.5) | 6026072 (1,591,920) | 6216857 (1,642,320) |
| 3/29 | 151.4 (40) | 151.4 (40) | 6244112 (1,649,520) | 6366759 (1,681,920) |
| 4/1 | 149.5 (39.5) | 151.4 (40) | 6890055 (1,820,160) | 7020878 (1,854,720) |
| 4/2 | 151.4 (40) | 151.4 (40) | 7108094 (1,877,760) | 7238577 (1,912,320) |
| 4/3 | 151.4 (40) | 151.4 (40) | 7326134 (1,935,360) | 7456958 (1,969,920) |
| 4/4 | 151.4 (40) | 151.4 (40) | 7544174 (1,992,960) | 7674998 (2,027,520) |
| 4/5 | 151.4 (40) | 151.4 (40) | 7762213 (2,050,560) | 7893037 (2,085,120) |
| 4/8 | 149.5 (39.5) | 149.5 (39.5) | 8408156 (2,221,200) | 8538980 (2,255,760) |
| 4/9 | 153.3 (40.5) | 151.4 (40) | 8628921 (2,279,520) | 8757020 (2,313,360) |
| 4/10 | 151.4 (40) | 151.4 (40) | 8846961 (2,337,120) | 8975059 (2,370,960) |

### Experimental Results

FIG. 54D depicts various precent cover results for this experiment. For the control plate, the percentage cover of fouling organisms increased steadily during the test, reaching a peak of ˜86% cover when the study was terminated on April 10. The control plate consistently had the highest percent cover throughout the experiment. The percent cover for the control 40 peaked at 78% and for the pleated canister peaked at 76%. The control 40 and pleated treatments maintained similar coverage of fouling organisms for the first four weeks of the experiment, until March 29 when the percent cover on the control 40 increased more than on the pleated. This stayed consistent until April 10th when the percentage covers were about the same again.

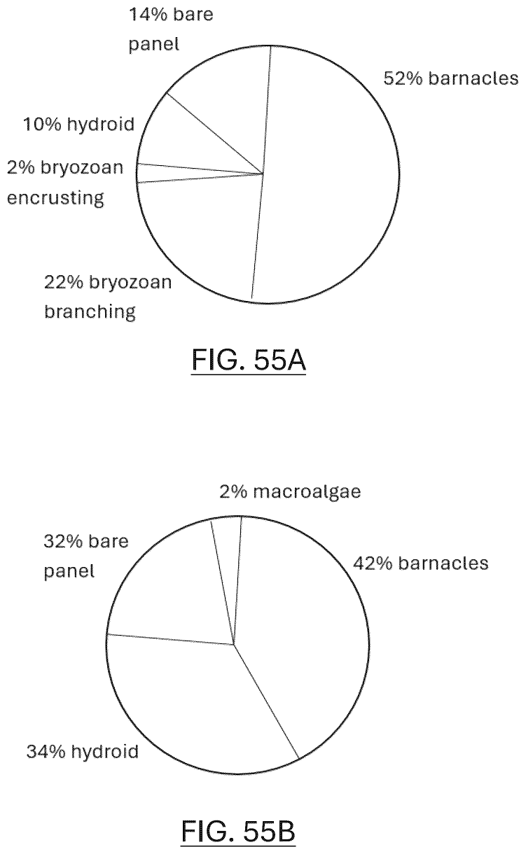

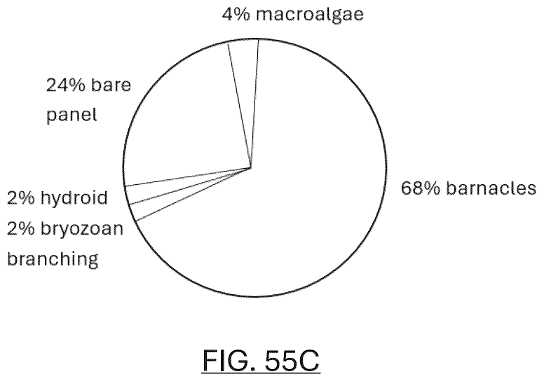

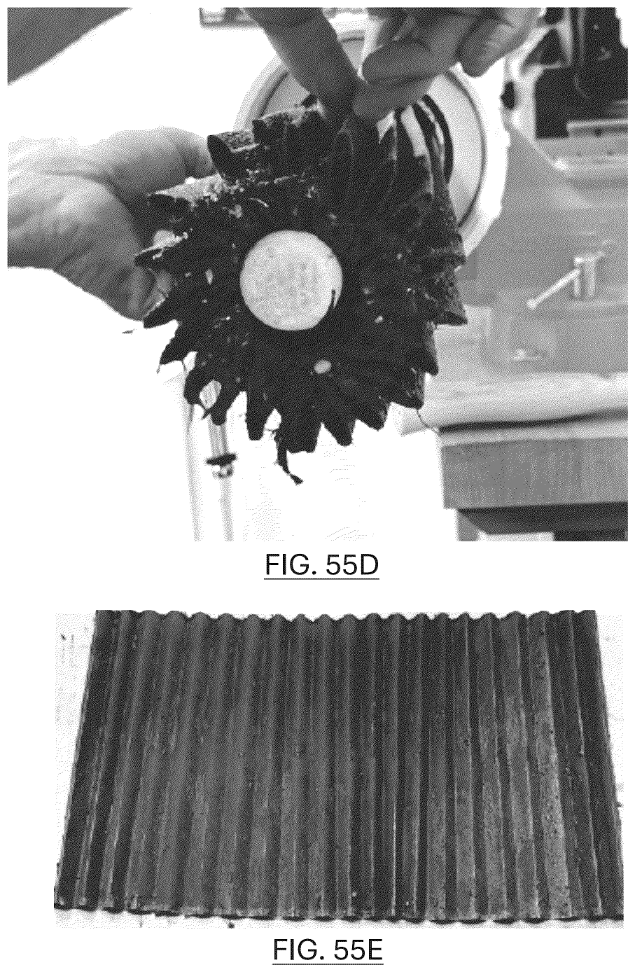

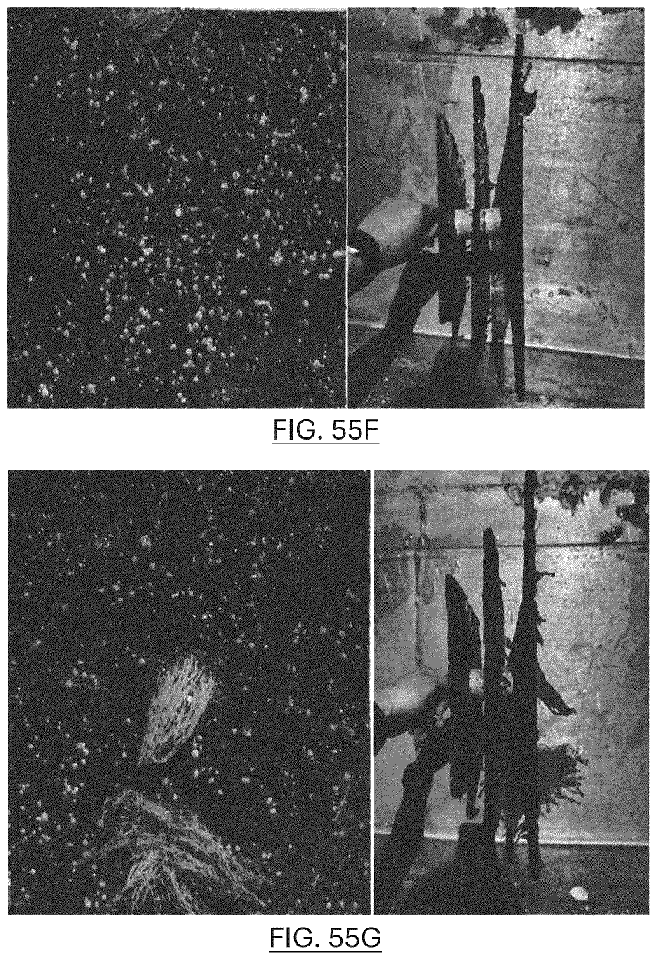

As best seen in FIG. 55A, the control treatment appeared to have the most diverse fouling community, and percent cover was dominated by barnacles, branching bryozoans, and hydroids, with 14% bare substrate at the end of the experiment. As shown in FIG. 55B, barnacles and hydroids dominated the fouling community for the control 40 treatment with 22% bare substrate at the end of the experiment. As shown in FIG. 55C, the pleated treatment was dominated by barnacles with 24% bare substrate at the end of the experiment.

One primary objective of the experiment was to determine if the pleated canister design would be resilient to high flow rates and sediment ingestion. Nearly all the suspended sediment from over 11,356,235 liters (3 million gallons) of raw water passed through the pleated canister with no impact from clogging. The canister remained in operation with no noticeable flow problems. Disassembly was concluded once water temperatures began to rise to biofouling conditions. No cleaning or any other action was applied to the canister throughout the entire operation from Feb. 8, 2024-Apr. 10, 2024. FIG. 55E depicts the disassembled insert from the pleated canister after 6 added weeks of experimentation, where the fabric had minimal sediment buildup at conclusion of experiment. As best seen in FIG. 55D, a fair amount of material was captured at the entrance of the canister, but the canister showed no signs of back pressure or clogging. This material was minimal compared to the amount of material which passed through the canister over the course of the experiment. It is believed that the triangle openings created by pleat folds allowed for flow pathing into the canister to still occur without significant backpressure, while the spacers of the spiral equivalent (FIGS. 13C through 13E) allowed creation of a more complete blockage at the insert entrance, leading to the collapse and backpressure.

At the conclusion of the second half of the experiment, there was a visible effect to biofouling caused by the pleated canister. While there was still a substantial amount of fouling seen on all biofouling trees, the diversity of organisms was noticeably less for the C-P treatment (FIG. 55F) as compared to the control (FIG. 55G), which difference was also visually noticeable in the walls of the respective collection bins. Regarding biofouling, the percent cover was the highest for the original control, which experienced a much lower flow rate than the control 40 and pleated treatments. This may be because the higher flow rates for the control 40 and pleated treatments were aiding in reducing fouling. The control 40 and pleated treatments started out with similar percent coverage, but halfway through the experiment the pleated canister seemed to be more effective at reducing fouling. This may be because the initial fouling organisms (barnacles) would be small enough to pass long/through the pleated fabric zone without being significantly affected. As larger fouling organisms (hydroids, bryozoans, macroalgae) continued to pass through the pleated canister, they seemed to be more negatively impacted by the pleated canister and refrained from settling on the plate. Eventually (e.g., after seven weeks) the percent coverage from fouling organisms in the C-P system became high enough that it matched the percent of fouling organisms on the control 40 plate, which effectiveness may vary due to varied flow rates and/or canister construction/dimensions.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

All references, including publications, patent applications, and patents, cited herein are hereby incorporated by reference to the same extent as if each reference were individually and specifically indicated to be incorporated by reference and were set forth in its entirety herein.

The various headings and titles used herein are for the convenience of the reader and should not be construed to limit or constrain any of the features or disclosures thereunder to a specific embodiment or embodiments. It should be understood that various exemplary embodiments could incorporate numerous combinations of the various advantages and/or features described, and all manner of combinations of which are contemplated and expressly incorporated hereunder.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A device for reducing biofouling in a water flow system, the device including a defined volume between an inlet and an outlet, wherein the inlet receives water from an external water source, the device comprising:
at least one structure positioned within the defined volume, wherein the at least one structure is formed at least partially of a material that is or becomes permeable, wherein the at least one structure defines a first side and a second side;
wherein the at least one structure is arranged in a use configuration within the defined volume so as to define a plurality of flow paths within the defined volume leading from the inlet to the outlet, wherein the plurality of flow paths divide up the defined volume so as to increase a ratio of a contact surface area of the at least one structure to water volume within the defined volume relative to the defined volume without the at least one structure.

2. The device of claim 1, wherein the at least one structure comprises biocide coating applied on at least one of the first side or the second side, wherein the water contacts the biocide to reduce fouling within the water flow system downstream of the outlet.

3. The device of claim 1, wherein the water is designed to pass through the defined volume and show a reduction in biofouling coverage of 95% taken across a square foot of surface area of a surface within the water flow system at 5 feet downstream of an outlet of the defined volume over a period of 30 days, in comparison to a control environment.

4. The device of claim 1, wherein, when arranged in the use configuration, the at least one structure forms a spiral defining a length and a diameter, wherein the diameter extends in a spiral-shaped cross-section with spacing between adjacent walls of the spiral, wherein the spacing between the adjacent walls causes formation of the plurality of flow paths for the water.

5. The device of claim 4, wherein the spiral is positioned within the defined volume so as to define a first flow path leading from the inlet to the outlet, wherein the first flow path passes along at least one of the first side or the second side of the structure.

6. The device of claim 5, wherein the plurality of flow paths further includes a second flow path extending through one or more pores within the at least one structure, wherein each of the one or more pores extends from the first side to the second side of the structure.

7. The device of claim 1, wherein the at least one structure is positioned within a pipe between the inlet and the outlet.

8. The device of claim 6, wherein the spiral is positioned within the defined volume such that the water flows through the spiral from a center of the spiral to an exit of the spiral.

9. The device of claim 1, wherein a first biocide coating is applied on the first side and a second biocide coating is applied on the second side such that water passing through each of the plurality of flow paths contacts both the first biocide coating and the second biocide coating, wherein the first and second biocide coating are different.

10. The device of claim 1, wherein, when arranged in the use configuration, the at least one structure comprises a double spiral defining a length and a diameter, wherein the diameter extends in a double spiral-shaped cross-section with spacing between adjacent walls of the double spiral, wherein the spacing between the adjacent walls causes formation of the plurality of flow paths for the water.

11. The device of claim 10, wherein a first biocide coating is applied on a first spiral of the double spiral and a second biocide coating is applied on a second spiral of the double spiral such that water passing through each of the plurality of flow paths contacts both the first biocide coating and the second biocide coating, wherein the first and second biocide coating are different.

12. The device of claim 1, wherein the double spiral is configured such that water flows in different directions through adjacent channels to form a counter current to encourage water exchange between the adjacent channels through the walls of the double spiral.

13. The device of claim 1, wherein at least some of the plurality of flow paths define a curvilinear profile to encourage increased water flowrates.

14. The device of claim 1, wherein, when arranged in the use configuration, the at least one structure comprises a plurality of loose structures positioned within the defined volume.

15. The device of claim 14, wherein each of the plurality of loose structures contain biocide coating thereon or therein.

16. The device of claim 15, wherein the plurality of loose structures are one or more of shaped structures, cube-shaped structures, strip-like structures, or permeable foam or rock structures.

17. The device of claim 1, wherein, when arranged in the use configuration, the at least one structure comprises a plurality of blade-like structures extending at least partially across the defined volume at least one of different heights or different directions.

18. The device of claim 17, wherein the blade-like structures are attached in a stationary manner within the defined volume and define a tortious pathway within the defined volume.

19. The device of claim 17, wherein the blade-like structures are configured to rotate within the defined volume based on at least one of force exerted by the water flowing within the defined volume or operation of one or more motors driving the rotation.

20. The device of claim 17, wherein the blade-like structures contain biocide coated thereon or therein.

21. The device of claim 1, wherein, when arranged in the use configuration, the at least one structure forms a plurality of strip-like structures, wherein each of the plurality of strip-like structures are fixedly attached on one end within the defined volume and loose on the other end within the defined volume.

22. The device of claim 21, wherein each of the plurality of strip-like structures contains biocide coated thereon or therein.

23. The device of claim 1, wherein, when arranged in the use configuration, the at least one structure forms at least one tube-like structure defining a first flow path along a channel defined within the at least one tube-like structure and one or more second flow paths extending through one or more pores within a wall of the at least one tube-like structure such that water within the defined volume is able to flow through either or both of the first flow path and the one or more second flow paths before leaving the defined volume through the outlet.

24. The device of claim 23, wherein the at least one tube-like structure contains biocide coated thereon or therein.

25. The device of claim 1, wherein, when arranged in the use configuration, the at least one structure forms a plurality of pleated structures defining a first flow path along a channel defined between adjacent pleated structures and one or more second flow paths extending through one or more pores within a wall of each of the pleated structures such that water within the defined volume is able to flow through either or both of the first flow path and the one or more second flow paths before leaving the defined volume through the outlet.

26. The device of claim 25, wherein the plurality of pleated structures contain biocide coated thereon or therein.

27. The device of claim 25, wherein each of the plurality of pleated structures are formed by applying one or more folds to a length of the material.

28. The device of claim 27, wherein the plurality of pleated structures each define a zig-zag pattern within the defined volume.

29. The device of claim 25, wherein the plurality of pleated structures are arranged concentrically and axially inline between the inlet and the outlet.

30. The device of claim 1, wherein the device is a replaceable canister that can be mounted within the water flow system.

31. The device of claim 1, wherein the device forms a cartridge.

32. The device of claim 1, wherein the at least one structure comprises at least one of mesh, lattice, fenestration, or holes that enable fluid flow therethrough.

33. The device of claim 1, wherein the water is designed to pass through the defined volume and there is a reduction in pressure measured at an inlet of the defined volume in the range of 0% to 5% over a period of 30 days.

34. The device of claim 1, wherein the water is designed to pass through the defined volume and there is an increase in weight of the at least one structure in dried form in the range of 0% to 5% over a period of 30 days.

35. A system for reducing biofouling in a water flow system, the system comprising:
a water flow volume defining a defined volume and including an inlet and an outlet, wherein the inlet receives water from an external water source;
at least one structure positioned within the defined volume, wherein the at least one structure is formed at least partially of a material that is or becomes permeable, wherein the at least one structure defines a first side and a second side;
wherein the at least one structure is arranged in a use configuration within the defined volume so as to define a plurality of flow paths within the defined volume leading from the inlet to the outlet, wherein the plurality of flow paths divide up the defined volume so as to increase a ratio of a contact surface area of the at least one structure to water volume within the defined volume relative to the defined volume without the at least one structure.

36. The system of claim 35, wherein the at least one structure comprises biocide coating applied on the first side and the second side, wherein the water contacts the biocide to reduce fouling within the water flow system downstream of the outlet.
